(19) United States
(12) Patent Application Publication
(10) Pub. No.: US 2001/0031652 A1
(43) Pub. Date: Oct. 18, 2001

(54) 1*doll

(75) Inventors: Oz Gabai, Tel Aviv (IL); Jacob Gabai, Tel Aviv (IL); Nimrod Sandlerman, Ramat Gan (IL); Moshe Cohen, Tel Aviv (IL)

Correspondence Address: DARBY & DARBY P.C., 805 Third Avenue, New York, NY, 10022, US

(73) Assignee: CREATOR LTD.

(21) Appl. No.: 09/742,943

(22) Filed: Dec. 20, 2000

Related U.S. Application Data
(62) Division of application No. 09/081,889, filed on May 20, 1998.
Application No. 09/081,889 is a continuation-in-part of application No. PCT/IL96/00157, filed on Nov. 20, 1996.
Application No. 09/081,889 is a continuation-in-part of application No. 08/561,316, filed on Nov. 20, 1995, now Pat. No. 5,752,880.

(51) Int. Cl. G06F 17/00

(52) U.S. Cl. 463/1

(57) ABSTRACT

Apparatus for a wireless computer controlled toy system is disclosed, the apparatus including a computer system operative to transmit a first transmission via a first wireless transmitter and at least one toy including a first wireless receiver, the toy receiving the first transmission via the first wireless receiver and operative to carry out at least one action based on said first transmission. A method for controlling the toy system is also disclosed.

### FIELD OF THE INVENTION

The present invention relates to toys in general, and particularly to toys used in conjunction with a computer system.

### BACKGROUND OF THE INVENTION

Toys which are remotely controlled by wireless communication and which are not used in conjunction with a computer system are well known in the art. Typically, such toys include vehicles whose motion is controlled by a human user via a remote control device.

U.S. Pat. No. 4,712,184 to Haugerud describes a computer controlled educational toy, the construction of which teaches the user computer terminology and programming and robotic technology. Haugerud describes computer control of a toy via a wired connection, wherein the user of the computer typically writes a simple program to control movement of a robot.

U.S. Pat. No. 4,840,602 to Rose describes a talking doll responsive to an external signal, in which the doll has a vocabulary stored in digital data in a memory which may be accessed to cause a speech synthesizer in the doll to simulate speech.

U.S. Pat. No. 5,021,878 to Lang describes an animated character system with real-time control.

U.S. Pat. No. 5,142,803 to Lang describes an animated character system with real-time control.

U.S. Pat. No. 5,191,615 to Aldava et al. describes an interrelational audio kinetic entertainment system in which movable and audible toys and other animated devices spaced apart from a television screen are provided with program synchronized audio and control data to interact with the program viewer in relationship to the television program.

U.S. Pat. No. 5,195,920 to Collier describes a radio controlled toy vehicle which generates realistic sound effects on board the vehicle. Communications with a remote computer allows an operator to modify and add new sound effects.

U.S. Pat. No. 5,270,480 to Hikawa describes a toy acting in response to a MIDI signal, wherein an instrument-playing toy performs simulated instrument playing movements.

U.S. Pat. No. 5,289,273 to Lang describes a system for remotely controlling an animated character. The system uses radio signals to transfer audio, video and other control signals to the animated character to provide speech, hearing vision and movement in real-time.

U.S. Pat. No. 5,388,493 describes a system for a housing for a vertical dual keyboard MIDI wireless controller for accordionists. The system may be used with either a conventional MIDI cable connection or by a wireless MIDI transmission system.

German Patent DE 3009-040 to Neuhierl describes a device for adding the capability to transmit sound from a remote control to a controlled model vehicle. The sound is generated by means of a microphone or a tape recorder and transmitted to the controlled model vehicle by means of radio communications. The model vehicle is equipped with a speaker that emits the received sounds.

### SUMMARY OF THE INVENTION

The present invention seeks to provide an improved toy system for use in conjunction with a computer system.

There is thus provided in accordance with a preferred embodiment of the present invention a wireless computer controlled toy system including a computer system operative to transmit a first transmission via a first wireless transmitter and at least one toy including a first wireless receiver, the toy receiving the first transmission via the first wireless receiver and operative to carry out at least one action based on the first transmission.

The computer system may include a computer game. The a toy may include a plurality of toys, and the at least one action may include a plurality of actions.

The first transmission may include a digital signal. The first transmission includes an analog signal and the analog signal may include sound.

Additionally in accordance with a preferred embodiment of the present invention the computer system includes a computer having a MIDI port and wherein the computer may be operative to transmit the digital signal by way of the MIDI port.

Additionally in accordance with a preferred embodiment of the present invention the sound includes music, a pre-recorded sound and/or speech. The speech may include recorded speech and synthesized speech.

Further in accordance with a preferred embodiment of the present invention the at least one toy has a plurality of states including at least a sleep state and an awake state, and the first transmission includes a state transition command, and the at least one action includes transitioning between the sleep state and the awake state.

A sleep state may typically include a state in which the toy consumes a reduced amount of energy and/or in which the toy is largely inactive, while an awake state is typically a state of normal operation.

Still further in accordance with a preferred embodiment of the present invention the first transmission includes a control command chosen from a plurality of available control commands based, at least in part, on a result of operation of the computer game.

Additionally in accordance with a preferred embodiment of the present invention the computer system includes a plurality of computers.

Additionally in accordance with a preferred embodiment of the present invention the first transmission includes computer identification data and the second transmission includes computer identification data.

Additionally in accordance with a preferred embodiment of the present invention the at least one toy is operative to transmit a second transmission via a second wireless transmitter and the computer system is operative to receive the second transmission via a second wireless receiver.

Moreover in accordance with a preferred embodiment of the present invention the system includes at least one input device and the second transmission includes a status of the at least one input device.

Additionally in accordance with a preferred embodiment of the invention the at least one toy includes at least a first toy and a second toy, and wherein the first toy is operative to transmit a toy-to-toy transmission to the second toy via the second wireless transmitter, and wherein the second toy is operative to carry out at least one action based on the toy-to-toy transmission.

Further in accordance with a preferred embodiment of the present invention operation of the computer system is controlled, at least in part, by the second transmission.

Moreover in accordance with a preferred embodiment of the present invention the computer system includes a computer game, and wherein operation of the game is controlled, at least in part, by the second transmission.

The second transmission may include a digital signal and/or an analog signal.

Still further in accordance with a preferred embodiment of the present invention the computer system has a plurality of states including at least a sleep state and an awake state, and the second transmission include a state transition command, and the computer is operative, upon receiving the second transmission, to transition between the sleep state and the awake state.

Still further in accordance with a preferred embodiment of the present invention at least one toy includes sound input apparatus, and the second transmission includes a sound signal which represents a sound input via the sound input apparatus.

Additionally in accordance with a preferred embodiment of the present invention the computer system is also operative to perform at least one of the following actions: manipulate the sound signal; and play the sound signal.

Additionally in accordance with a preferred embodiment of the present invention the sound includes speech, and the computer system is operative to perform a speech recognition operation on the speech.

Further in accordance with a preferred embodiment of the present invention the second transmission includes toy identification data, and the computer system is operative to identify the at least one toy based, at least in part, on the toy identification data.

Still further in accordance with a preferred embodiment of the present invention the first transmission includes toy identification data. The computer system may adapt a mode of operation thereof based, at least in part, on the toy identification data.

Still further in accordance with a preferred embodiment of the present invention the at least one action may include movement of the toy, movement of a part of the toy and/or an output of a sound. The sound may be transmitted using a MIDI protocol.

There is also provided in accordance with another preferred embodiment of the present invention a game system including a computer system operative to control a computer game and having a display operative to display at least one display object, and at least one toy in wireless communication with the computer system, the computer game including a plurality of game objects, and the plurality of game objects includes the at least one display object and the at least one toy.

Further in accordance with a preferred embodiment of the present invention the at least one toy is operative to transmit toy identification data to the computer system, and the computer system is operative to adapt a mode of operation of the computer game based, at least in part, on the toy identification data.

The computer system may include a plurality of computers.

Additionally in accordance with a preferred embodiment of the present invention the first transmission includes computer identification data and the second transmission includes computer identification data.

There is also provided in accordance with a preferred embodiment of the present invention a data transmission apparatus including first wireless apparatus including musical instrument data interface (MIDI) apparatus operative to receive and transmit MIDI data between a first wireless and a first MIDI device and second wireless apparatus including MIDI apparatus operative to receive and transmit MIDI data between a second wireless and a second MIDI device, the first wireless apparatus is operative to transmit MIDI data including data received from the first MIDI device to the second wireless apparatus, and to transmit MIDI data including data received from the second wireless apparatus to the first MIDI device, and the second wireless apparatus is operative to transmit MIDI data including data received from the second MIDI device to the first wireless apparatus, and to transmit MIDI data including data received from the first wireless apparatus to the second MIDI device.

Further in accordance with a preferred embodiment of the present invention the second wireless apparatus includes a plurality of wirelesses each respectively associated with one of the plurality of MIDI devices, and each of the second plurality of wirelesses is operative to transmit MIDI data including data received from the associated MIDI device to the first wireless apparatus, and to transmit MIDI data including data received from the first wireless apparatus to the associated MIDI device.

The first MIDI device may include a computer, while the second MIDI device may include a toy.

Additionally in accordance with a preferred embodiment of the present invention the first wireless apparatus also includes analog interface apparatus operative to receive and transmit analog signals between the first wireless and a first analog device, and the second wireless apparatus also includes analog interface apparatus operative to receive and transmit analog signals between the second wireless and a second analog device, and the first wireless apparatus is also operative to transmit analog signals including signals received from the first analog device to the second wireless apparatus, and to transmit analog signal including signals received from the second wireless apparatus to the first analog device, and the second wireless apparatus is also operative to transmit analog signals including signals received from the second analog device to the first wireless apparatus, and to transmit analog signals including data received from the first wireless apparatus to the second analog device.

There is also provided in accordance with another preferred embodiment of the present invention a method for generating control instructions for a computer controlled toy system, the method includes selecting a toy, selecting at least one command from among a plurality of commands associated with the toy, and generating control instructions for the toy including the at least one command.

Further in accordance with a preferred embodiment of the present invention the step of selecting at least one command includes choosing a command, and specifying at least one control parameter associated with the chosen command.

Still further in accordance with a preferred embodiment of the present invention the at least one control parameter includes at least one condition depending on a result of a previous command.

Additionally in accordance with a preferred embodiment of the present invention at least one of the steps of selecting a toy and the step of selecting at least one command includes utilizing a graphical user interface.

Still further in accordance with a preferred embodiment of the present invention the previous command includes a previous command associated with a second toy.

Additionally in accordance with a preferred embodiment of the present invention the at least one control parameter includes an execution condition controlling execution of the command.

The execution condition may include a time at which to perform the command and/or a time at which to cease performing the command. The execution condition may also include a status of the toy.

Additionally in accordance with a preferred embodiment of the present invention the at least one control parameter includes a command modifier modifying execution of the command.

Still further in accordance with a preferred embodiment of the present invention the at least one control parameter includes a condition dependent on a future event.

Additionally in accordance with a preferred embodiment of the present invention the at least one command includes a command to cancel a previous command.

There is also provided for in accordance with a preferred embodiment of the present invention a signal transmission apparatus for use in conjunction with a computer, the apparatus including wireless transmission apparatus; and signal processing apparatus including at least one of the following analog/digital sound conversion apparatus operative to convert analog sound signals to digital sound signals, to convert digital sound signals to analog sound signals, and to transmit the signals between the computer and a sound device using the wireless transmission apparatus; a peripheral control interface operative to transmit control signals between the computer and a peripheral device using the wireless transmission apparatus; and a MIDI interface operative to transmit MIDI signals between the computer and a MIDI device using the wireless transmission apparatus.

There is also provided in accordance with another preferred embodiment of the present invention a computer system including a computer, and a sound card operatively attached to the computer and having a MIDI connector and at least one analog connecter, wherein the computer is operative to transmit digital signals by means of the MIDI connector and to transmit analog signals by means of the at least one analog connector.

Further in accordance with a preferred embodiment of the present invention the computer is also operative to receive digital signals by means of the MIDI connector and to receive analog signals by means of the at least one analog connector.

Also provided, in accordance with a preferred embodiment of the present invention, is an advertising system including a computer-controlled toy such as a physical toy located at a user location and operative to present advertisement bulletins responsive to a control command, a computer controlling the toy and associated with a network such as Internet and operative to generate the control command and advertisement server apparatus associated with the network and downloading advertisement bulletins to the computer.

Also provided according to another preferred embodiment of the present invention is a computerized toy updating subscription system operative in association with a network, the system including a multiplicity of computerized toys associated with a network and a toy updater associated with the network and operative to periodically send toy updates out to the multiplicity of computerized toys.

Preferably, the toy updater is operative substantially without periodic intervention of the human users of the multiplicity of toys.

In this application the term “radio” includes all forms of “wireless” communication.

### BRIEF DESCRIPTION OF THE DRAWINGS AND APPENDICES

The present invention will be understood and appreciated from the following detailed description, taken in conjunction with the drawings and appendices in which:

FIG. 1A is a partly pictorial, partly block diagram illustration of a computer control system including a toy, constructed and operative in accordance with a preferred embodiment of the present invention;

FIG. 1B is a partly pictorial, partly block diagram illustration a preferred implementation of the toy 122 of FIG. 1A;

FIG. 1C is a partly pictorial, partly block diagram illustration of a computer control system including a toy, constructed and operative in accordance with an alternative preferred embodiment of the present invention;

FIGS. 2A-2C are simplified pictorial illustrations of a portion of the system of FIG. 1A in use;

FIG. 3 is a simplified block diagram of a preferred implementation of the computer radio interface 110 of FIG. 1A;

FIG. 4 is a more detailed block diagram of the computer radio interface 110 of FIG. 3;

FIGS. 5A-5D taken together comprise a schematic diagram of the apparatus of FIG. 4;

FIG. 5E is an schematic diagram of an alternative implementation of the apparatus of FIG. 5D;

FIG. 6 is a simplified block diagram of a preferred implementation of the toy control device 130 of FIG. 1A;

FIGS. 7A-7F, taken together with either FIG. 5D or FIG. 5E, comprise a schematic diagram of the apparatus of FIG. 6;

FIG. 8A is a simplified flowchart illustration of a preferred method for receiving radio signals, executing commands comprised therein, and sending radio signals, within the toy control device 130 of FIG. 1A;

FIGS. 8B-8T, taken together, comprise a simplified flowchart illustration of a preferred implementation of the method of FIG. 8A;

FIG. 9A is a simplified flowchart illustration of a preferred method for receiving MIDI signals, receiving radio signals, executing commands comprised therein, sending radio signals, and sending MIDI signals, within the computer radio interface 110 of FIG. 1A;

FIGS. 9B-9N, taken together with FIGS. 8D-8M, comprise a simplified flowchart illustration of a preferred implementation of the method of FIG. 9A;

FIGS. 10A-10C are simplified pictorial illustrations of a signal transmitted between the computer radio interface 110 and the toy control device 130 of FIG. 1A;

FIG. 11 is a simplified flowchart illustration of a preferred method for generating control instructions for the apparatus of FIG. 1A;

FIGS. 12A-12C are pictorial illustrations of a preferred implementation of a graphical user interface implementation of the method of FIG. 11;

FIG. 13 is a block diagram of a first sub-unit of a multi-port multi-channel implementation of the computer radio interface 110 of FIG. 1A, which sub-unit resides within computer 100 of FIG. 1A;

FIG. 14 is a block diagram of a second sub-unit of a multi-port multi-channel implementation of the computer radio interface 110 of FIG. 1A, which sub-unit complements the apparatus of FIG. 13 and resides exteriorly to computer 100 of FIG. 1A;

FIGS. 15A-15E, taken together, form a detailed electronic schematic diagram of the toy control device of FIG. 6, suitable for the multi-channel implementation of FIGS. 13 and 14;

FIG. 16 is a simplified flowchart illustration of a preferred method by which a computer selects a control channel pair in anticipation of a toy becoming available and starts a game-defining communication over the control channel each time both a toy and a transceiver of the computer radio interface are available;

FIG. 17 is a simplified flowchart illustration of a preferred method for implementing the “select control channel pair” step of FIG. 16;

FIG. 18A is a simplified flowchart illustration of a preferred method for implementing the “select information communication channel pair” step of FIG. 16;

FIG. 18B is a simplified flowchart illustration of a preferred method for performing the “locate computer” step of FIG. 18A;

FIG. 19 is a simplified flowchart illustration of a preferred method of operation of the toy control device 130;

FIG. 20 is a simplified illustration of a remote game server in association with a wireless computer controlled toy system which may include a network computer;

FIG. 21 is a simplified flowchart illustration of the operation of the computer or of the network computer of FIG. 20, when operating in conjunction with the remote server;

FIG. 22 is a simplified flowchart illustration of the operation of the remote game server of FIG. 20;

FIG. 23 is a semi-pictorial semi-block diagram illustration of a wireless computer controlled toy system including a a proximity detection subsystem operative to detect proximity between the toy and the computer;

FIGS. 24A-24E, taken together, form a detailed electronic schematic diagram of a multi-channel implementation of the computer radio interface 110 of FIG. 3 which is similar to the detailed electronic schematic diagrams of FIGS. 5A-5D except for being multi-channel, therefore capable of supporting full duplex applications, rather than single-channel;

FIGS. 25A-25F, taken together, form a detailed schematic illustration of a computer radio interface which connects to a serial port of a computer rather than to the soundboard of the computer;

FIGS. 26A-26D, taken together, form a detailed schematic illustration of a computer radio interface which connects to a parallel port of a computer rather than to the soundboard of the computer;

FIGS. 27A-27J are preferred flowchart illustrations of a preferred radio coding technique which is an alternative to the radio coding technique described above with reference to FIGS. 8E, 8G-8M and 10A-C;

FIGS. 28A-28K, taken together, form a detailed electronic schematic diagram of the multi-port multi-channel computer radio interface sub-unit of FIG. 13;

FIGS. 29A-29I, taken together, form a detailed electronic schematic diagram of the multi-port multi-channel computer radio interface sub-unit of FIG. 14;

FIG. 30 is a partly pictorial, partly block diagram illustration of a computer control system including a toy, constructed and operative in accordance with a further preferred embodiment of the present invention;

FIG. 31 is a block diagram is a simplified block diagram illustrating the combination of the computer radio interface and the toy control device as used in the embodiment of FIG. 30;

FIGS. 32A, 32B and 32C taken together form a simplified block diagram of the EPLD chip of FIG. 28H;

FIG. 33 is a semi-pictorial semi-block diagram illustration of a computerized networked advertisement system constructed and operative in accordance with a preferred embodiment of the present invention in which a physical toy conveys advertisement bulletins to a user of the toy;

FIG. 34 is a data transmission diagram describing data transmissions between various network service providers which support the advertisement system of FIG. 33 according to one preferred embodiment of the present invention;

FIG. 35 is a semi-pictorial semi-block diagram illustration of a computerized networked advertisement system constructed and operative in accordance with a preferred embodiment of the present invention in which a virtual toy conveys advertisement bulletins to a user of the toy;

FIG. 36 is a simplified flowchart illustration of a preferred mode of operation for the user PC of FIG. 34;

FIG. 37 is a simplified flowchart illustration of a preferred mode of operation for the game software server of FIG. 34;

FIG. 38 is a simplified flowchart illustration of a preferred mode of operation for the marketer/advertisement provider of FIG. 34;

FIG. 39 is a simplified flowchart illustration of a preferred mode of operation for the software maintenance center of FIG. 34;

FIGS. 40-58 describe a Living Object Internet Service System (LOIS) constructed and operative in accordance with a preferred embodiment of the present invention.

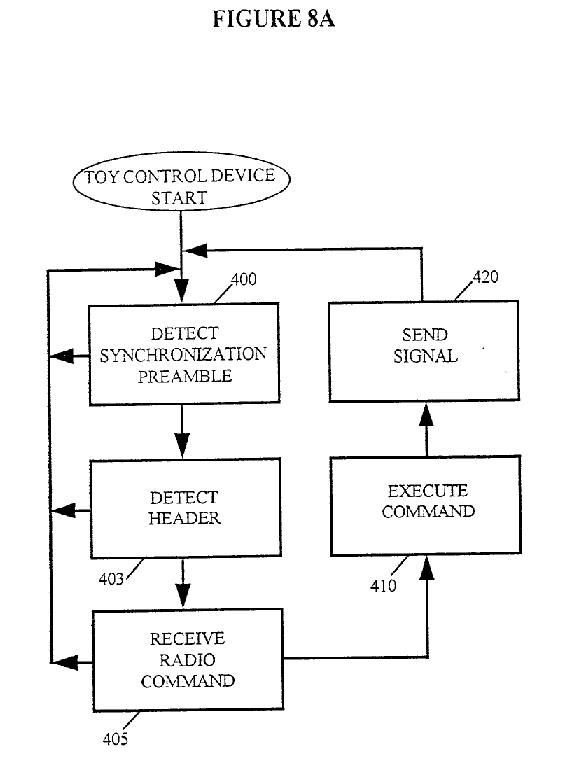

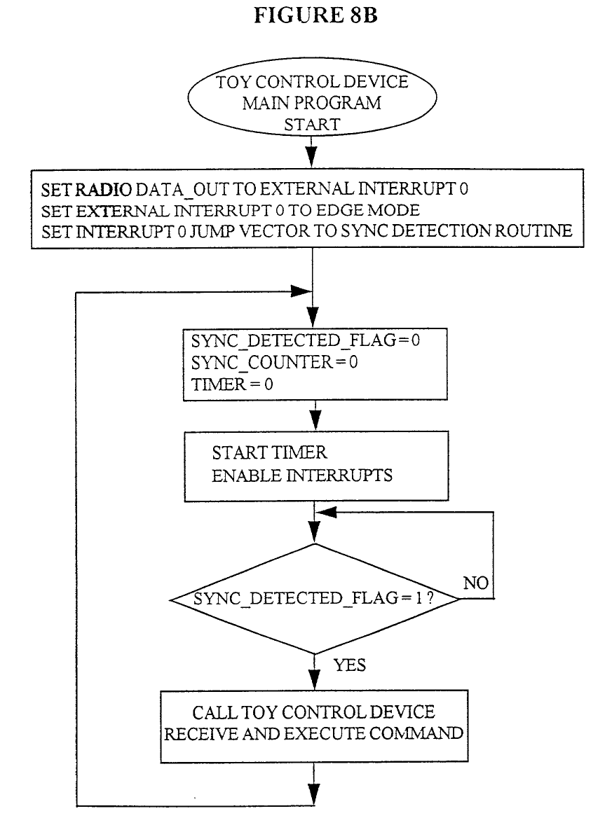

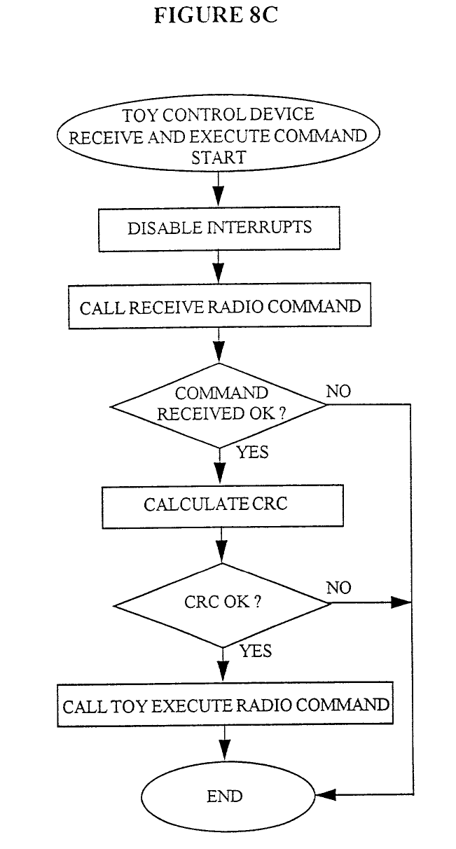

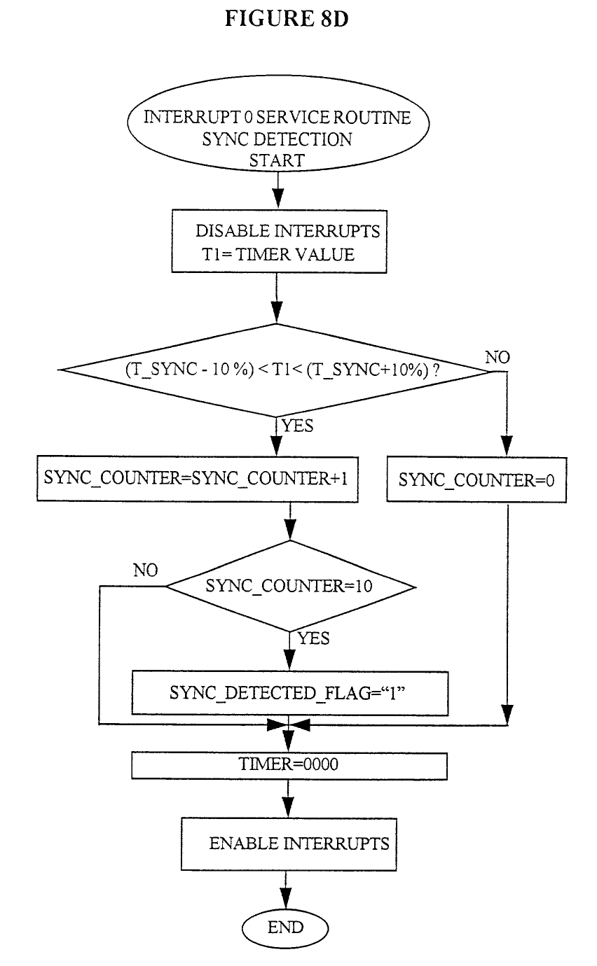

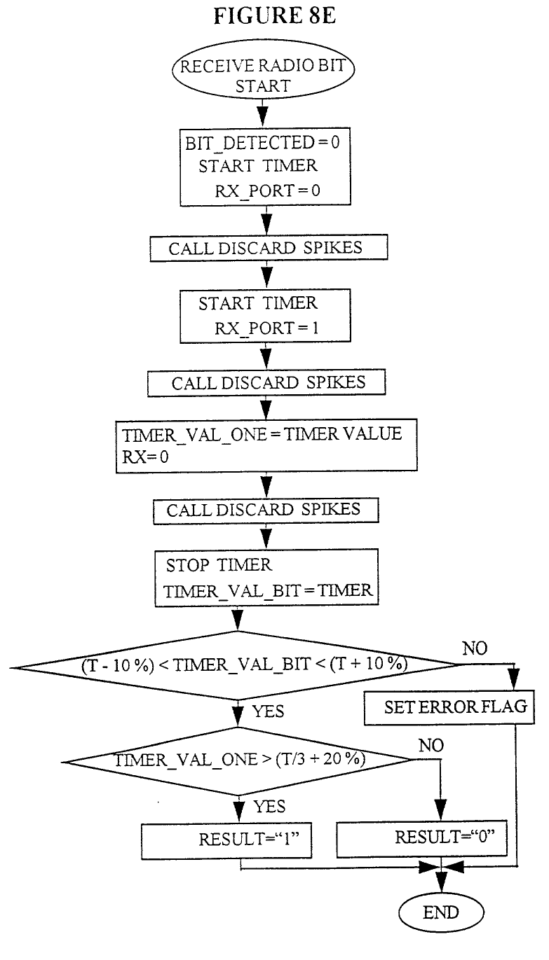

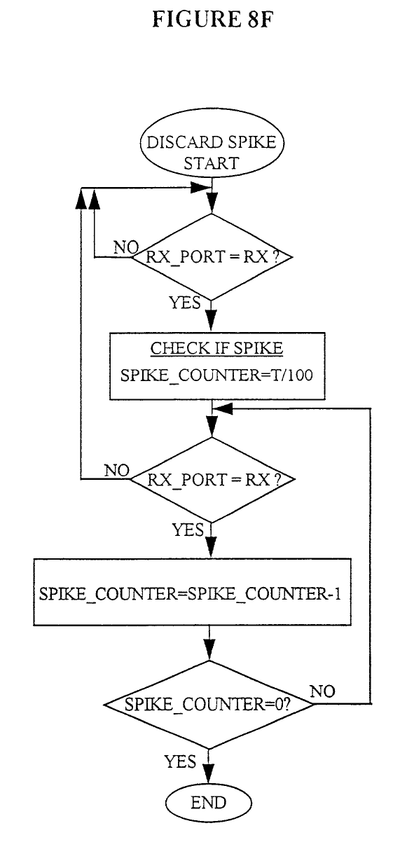

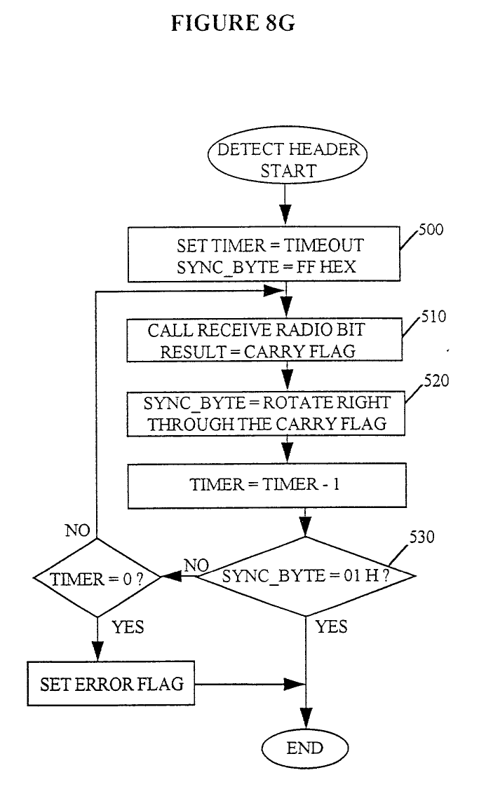

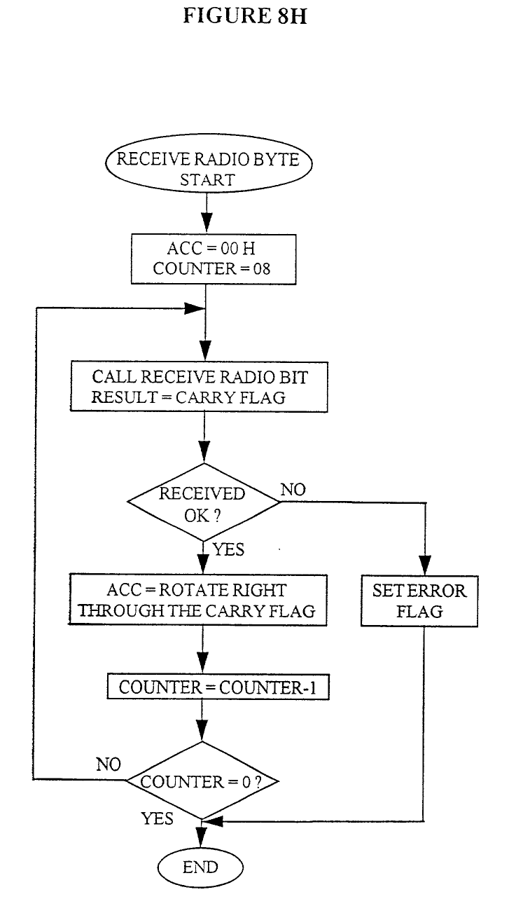

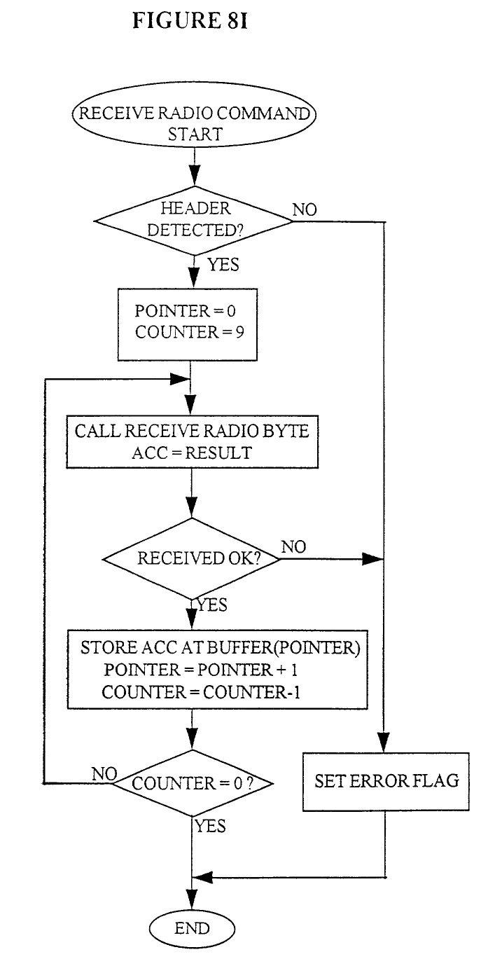

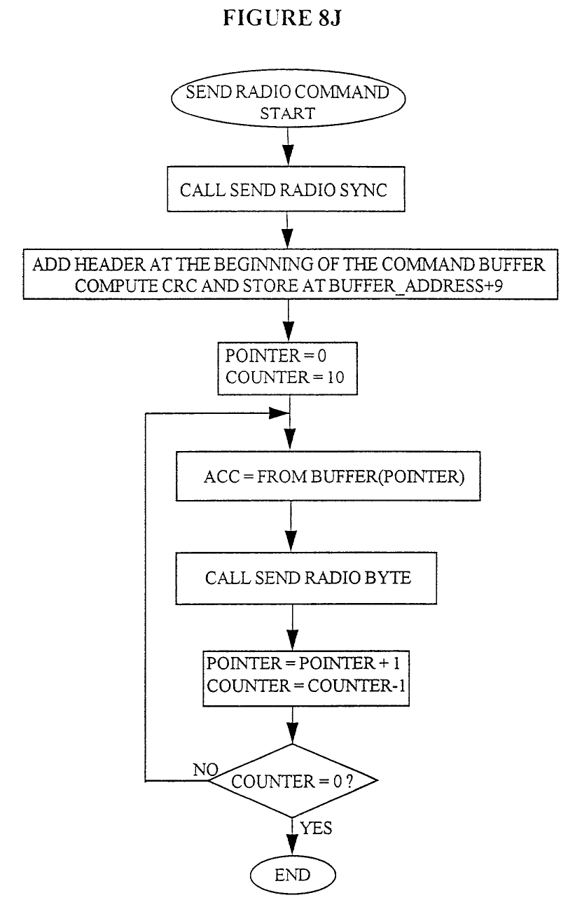

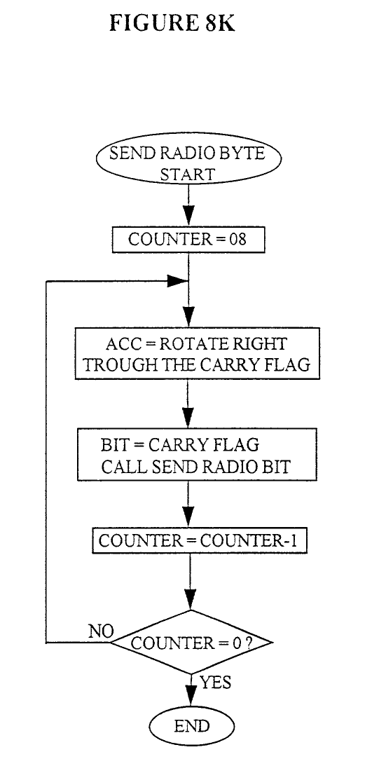

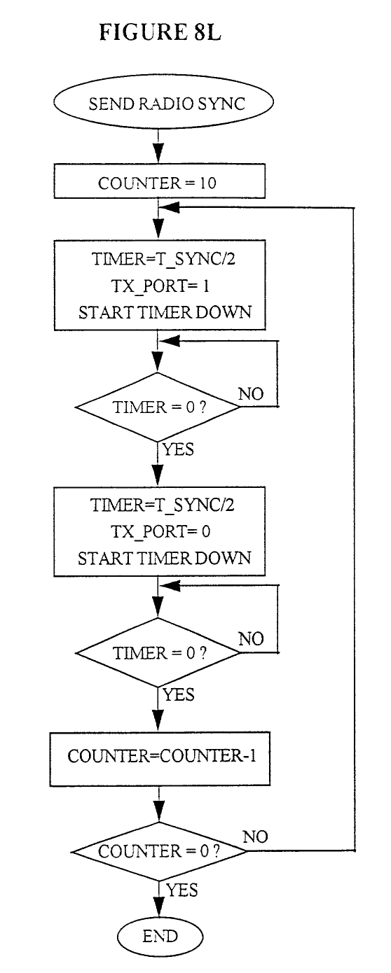

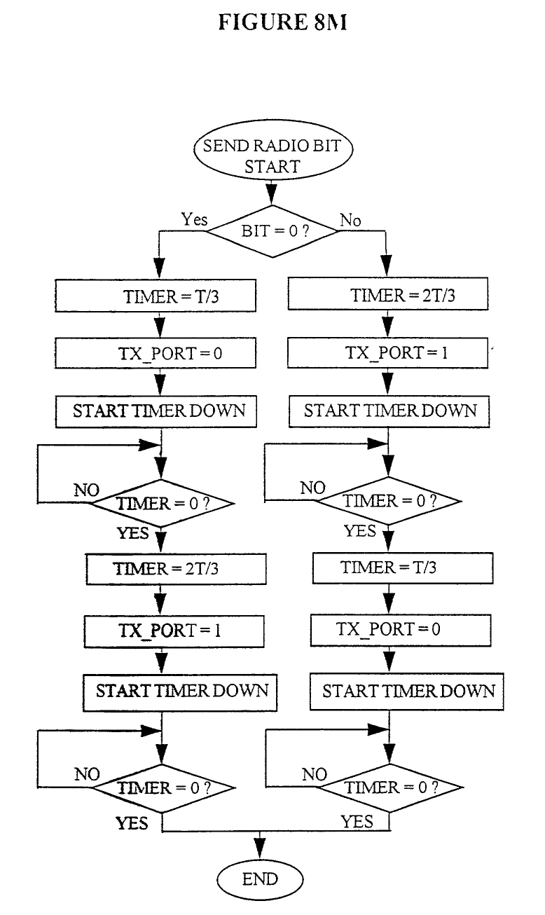

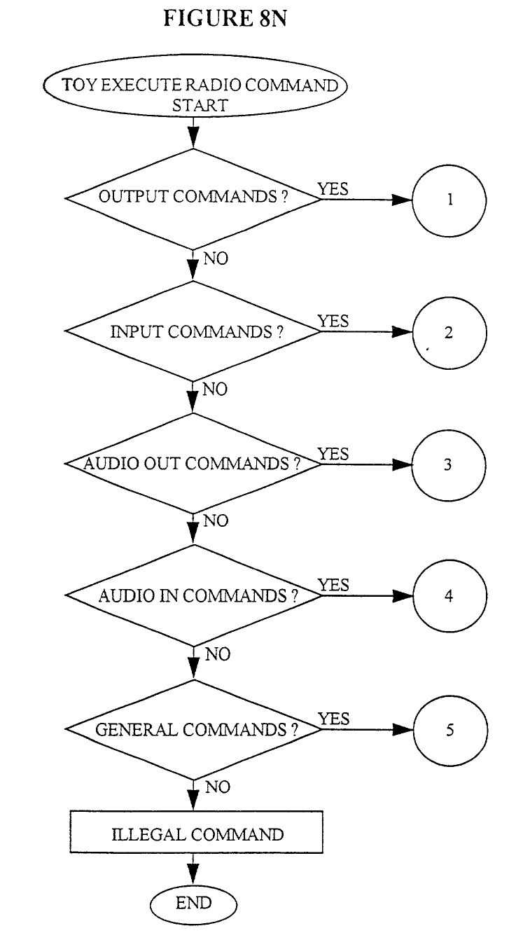

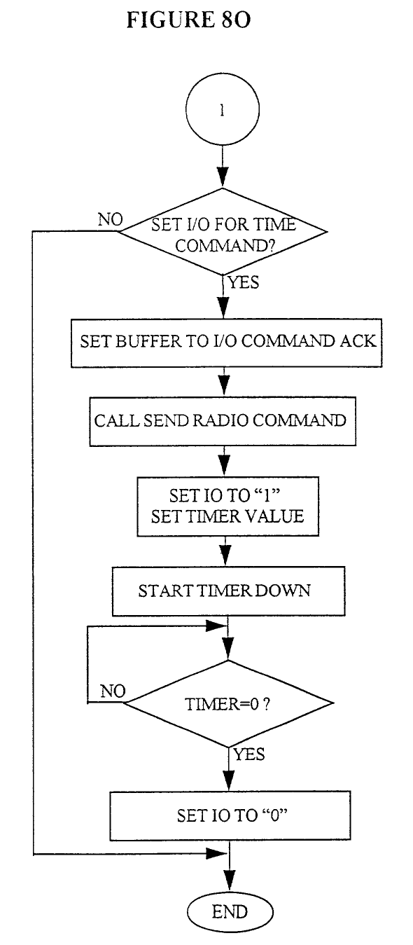

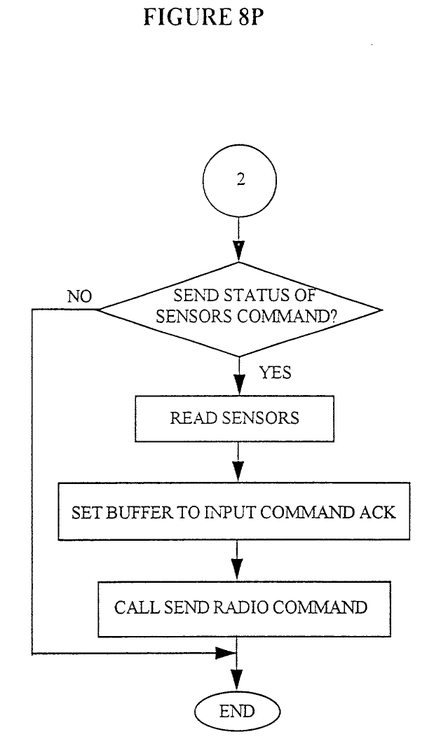

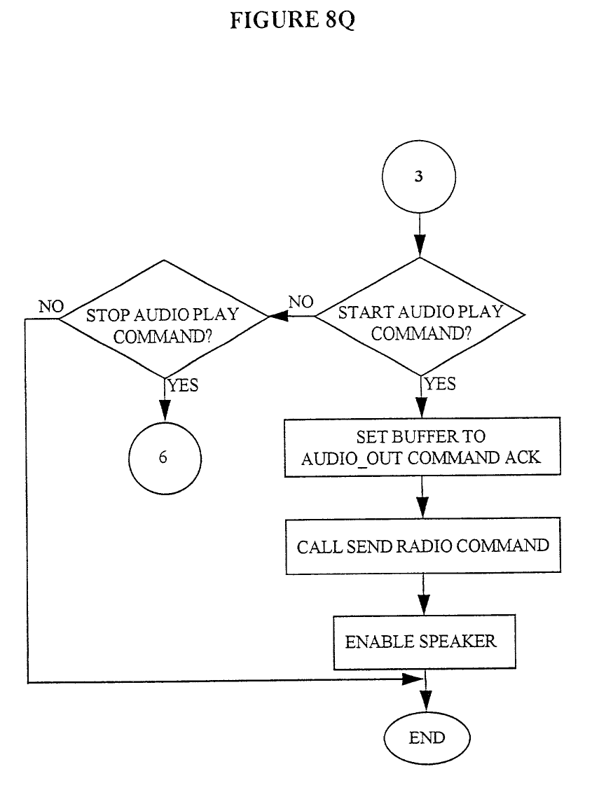

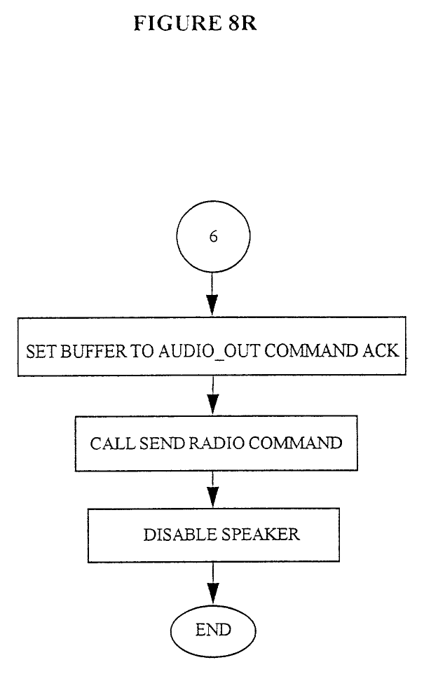

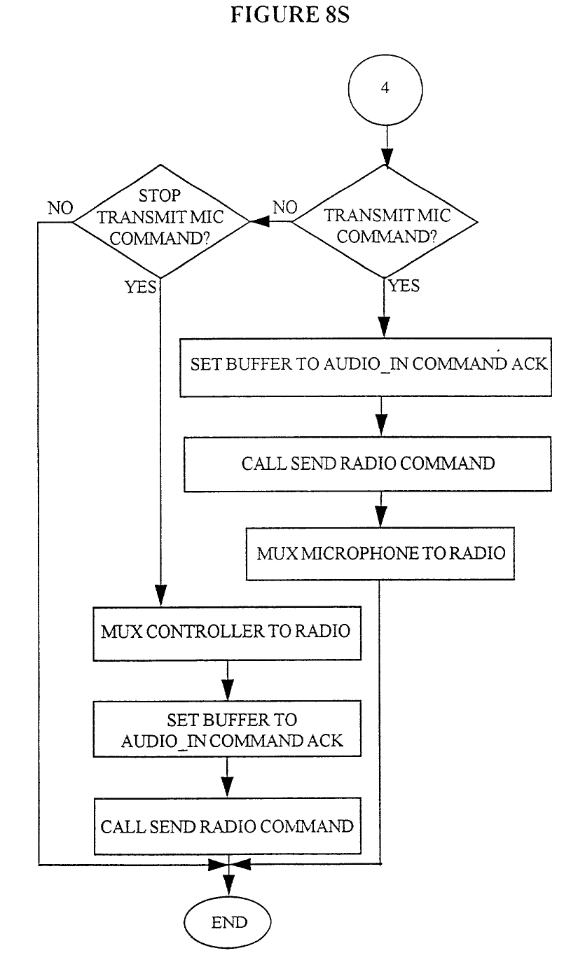

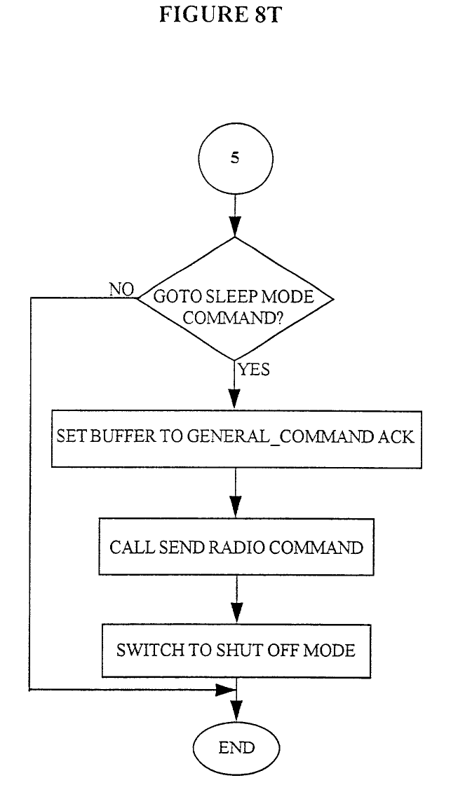

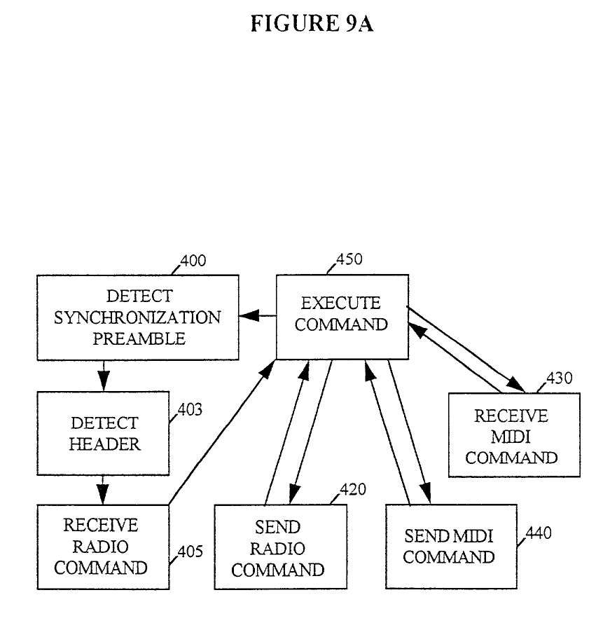

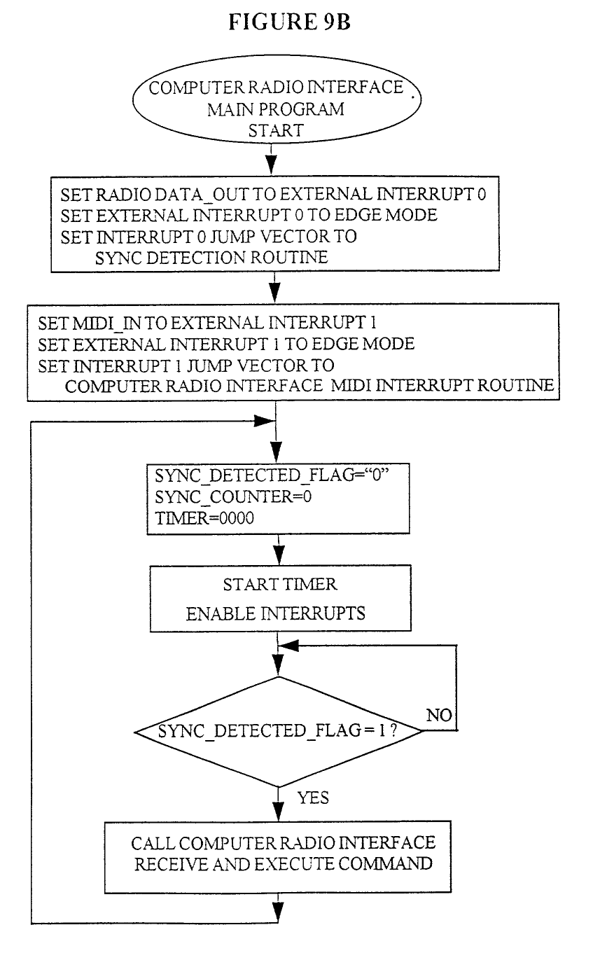

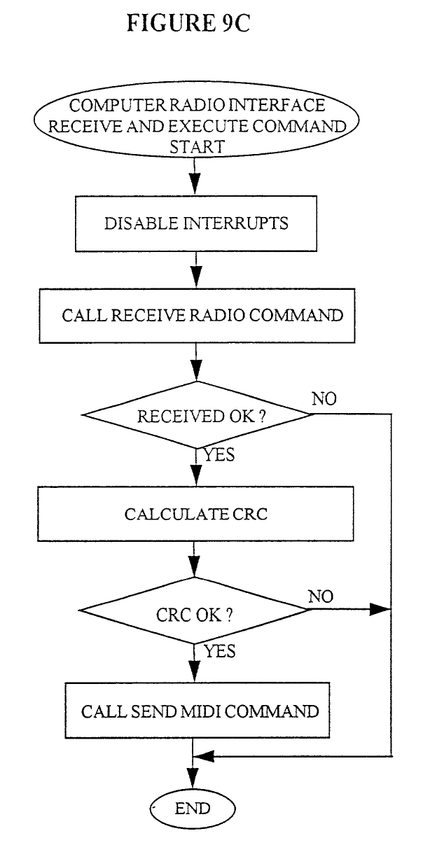

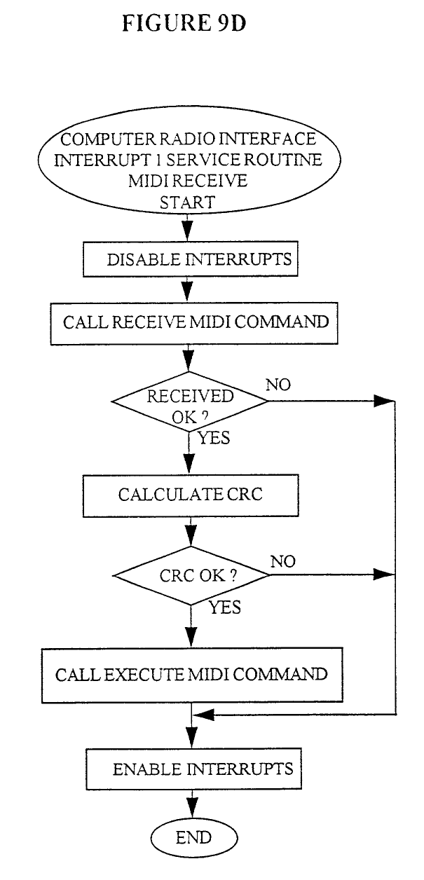

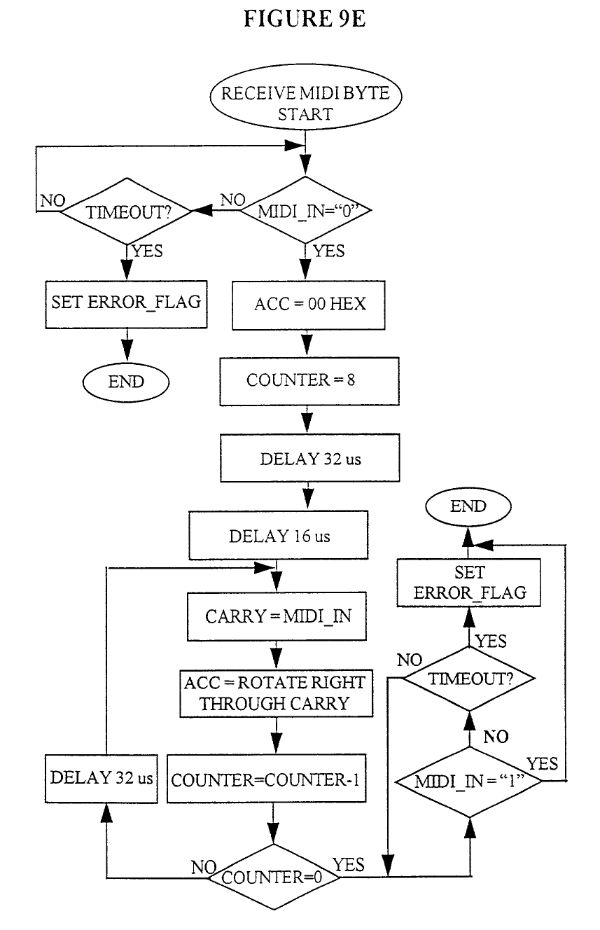

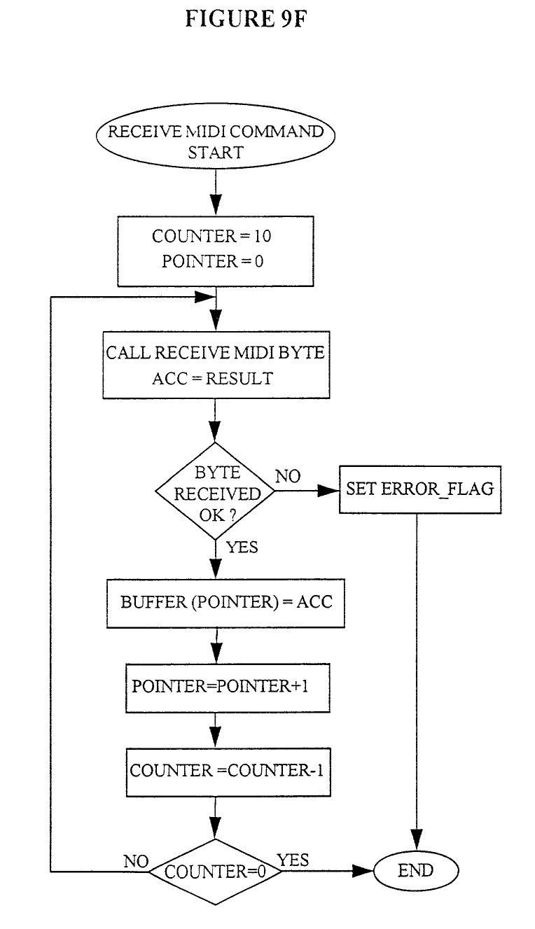

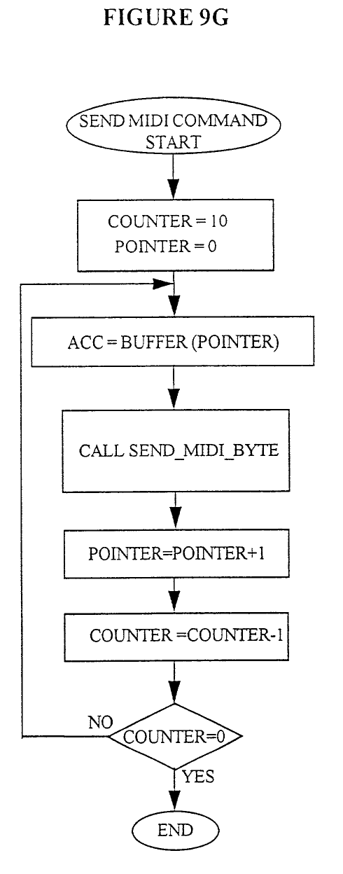

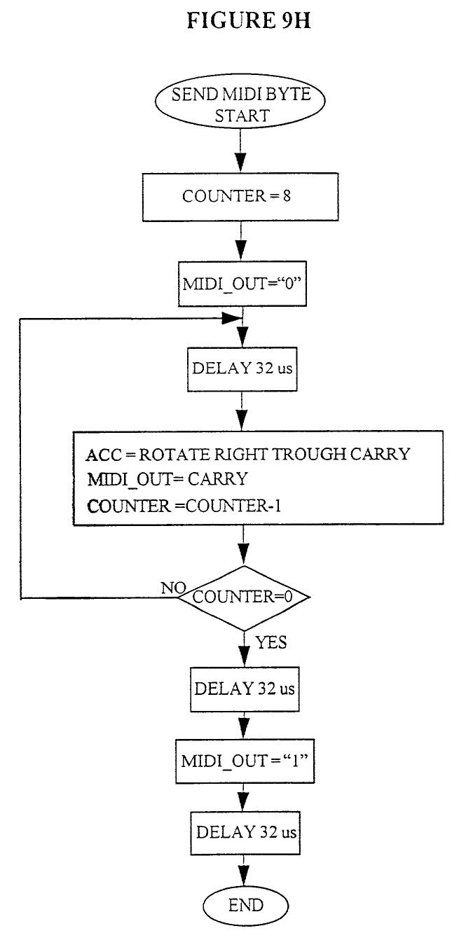

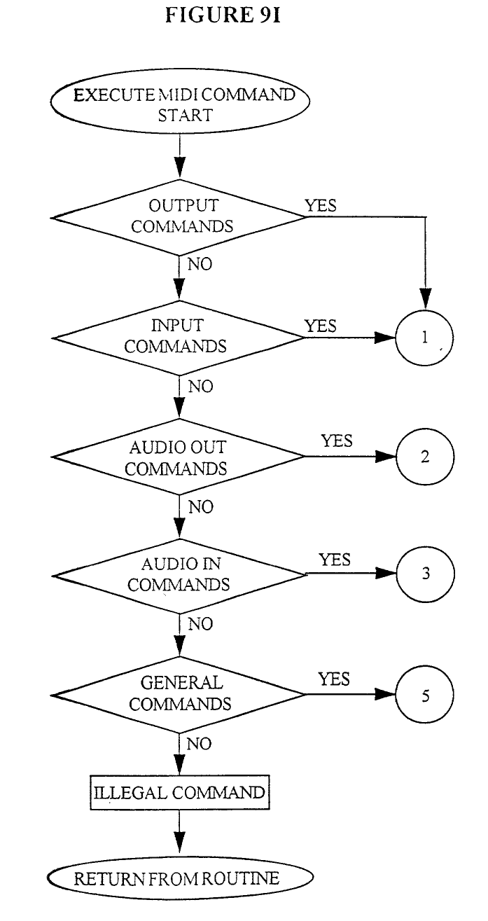

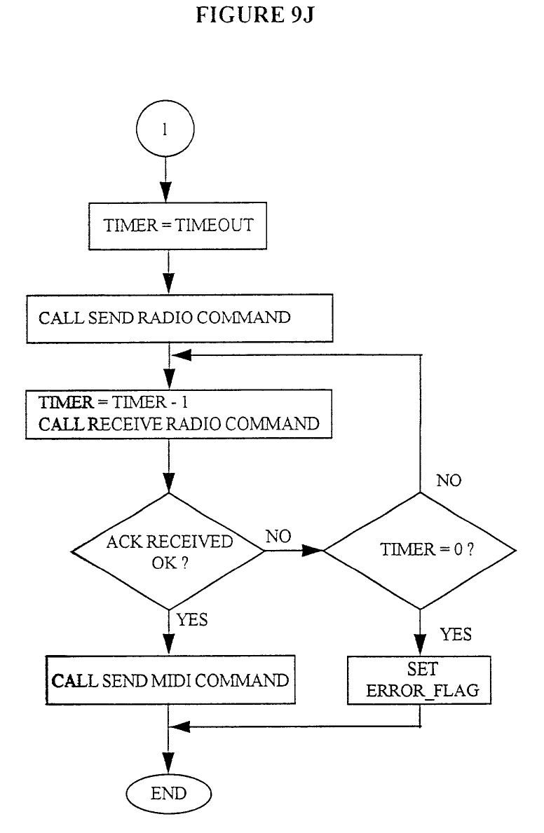

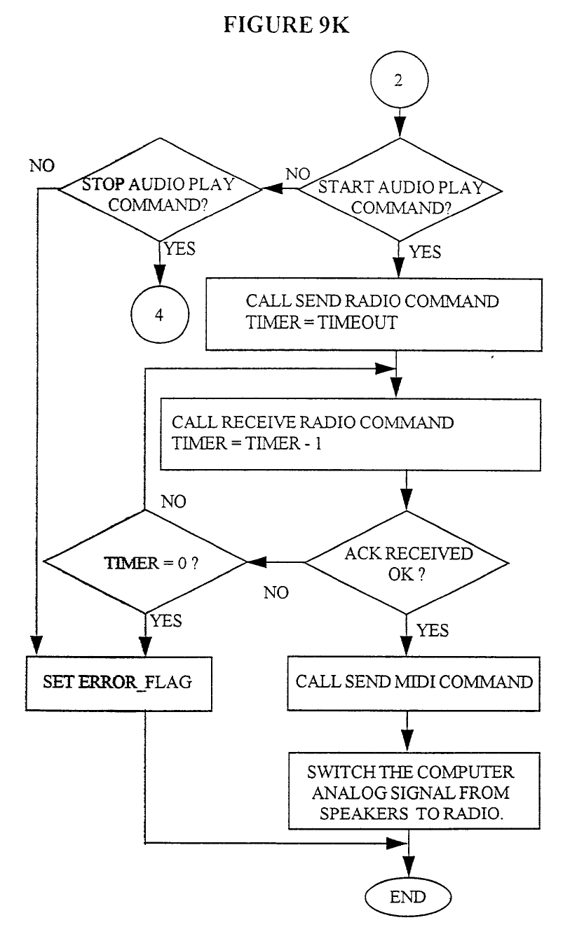

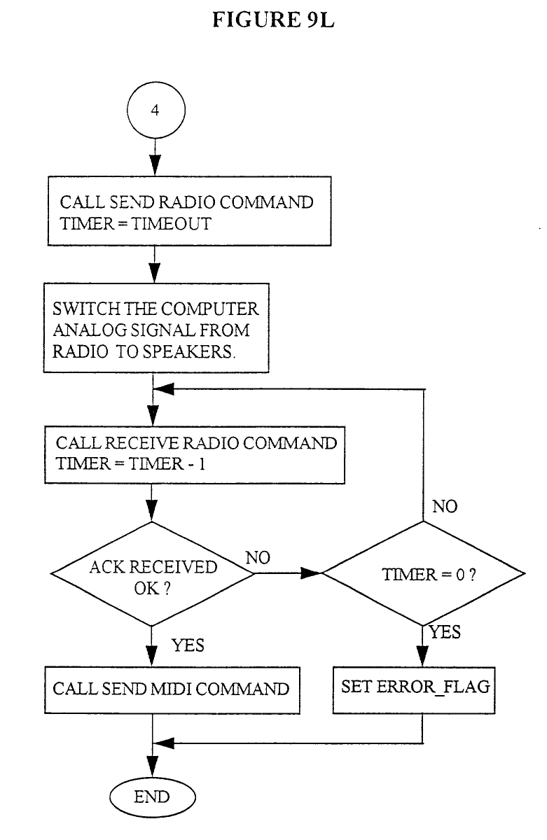

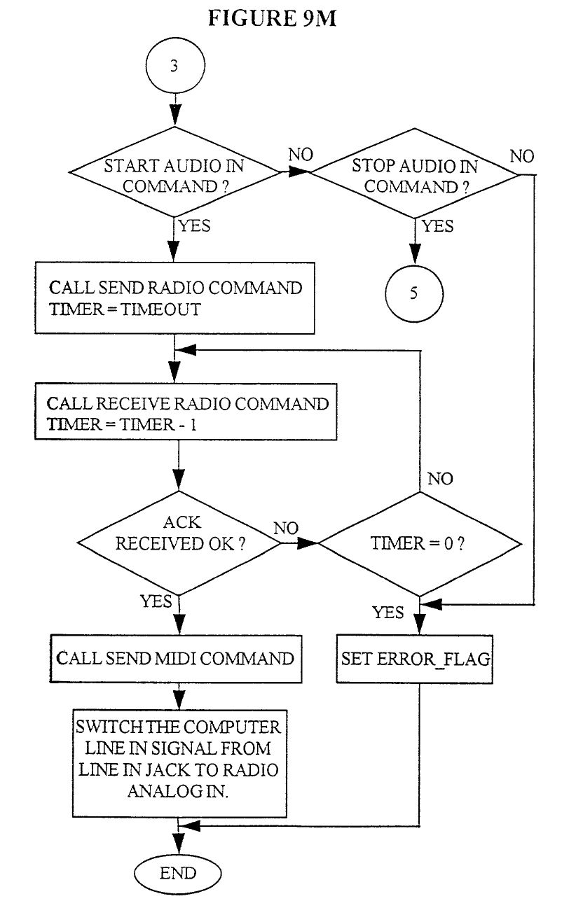

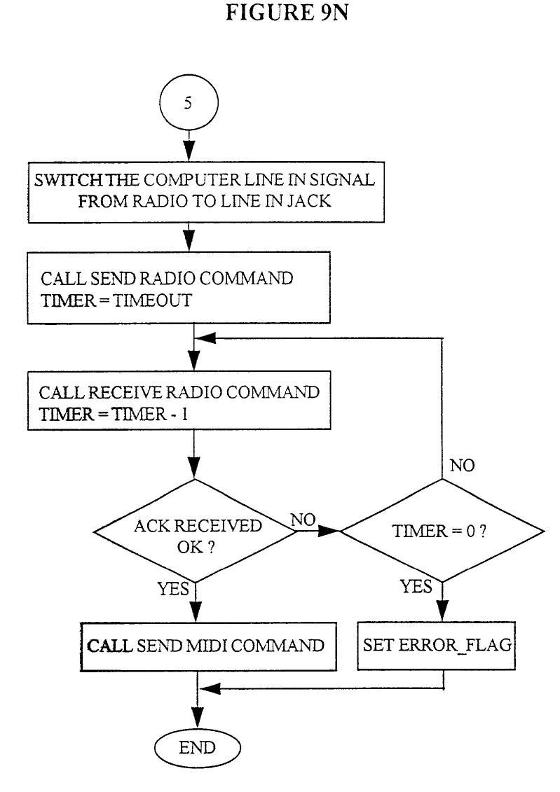

Appendix A is a computer listing of a preferred software implementation of the method of FIGS. 9A-9N, together with the method of FIGS. 8D-8M;

Appendix B is a computer listing of a preferred software implementation of the method of FIGS. 8A-8T;

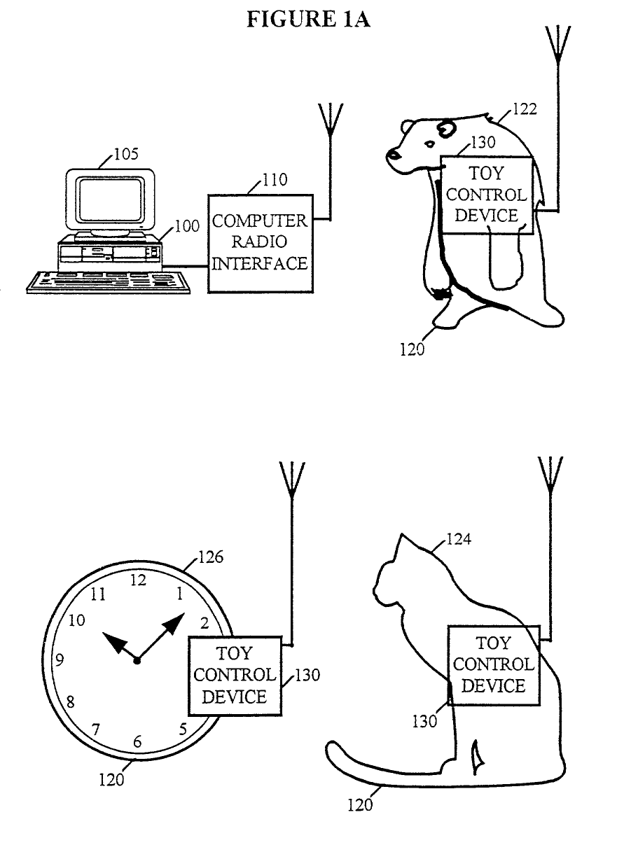

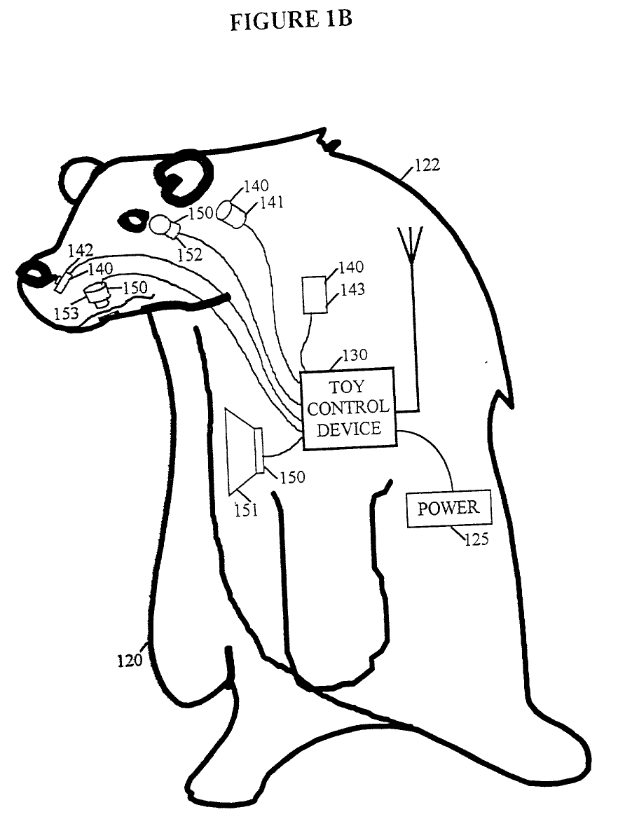

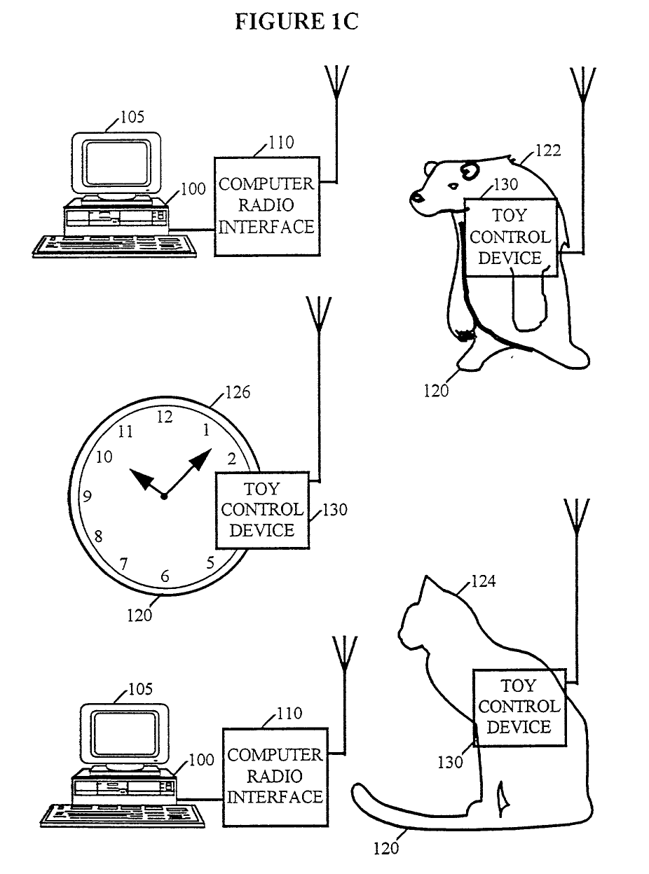

Appendix C is a computer listing of a preferred software implementation of an example of a computer game for use in the computer 100 of FIG. 1;

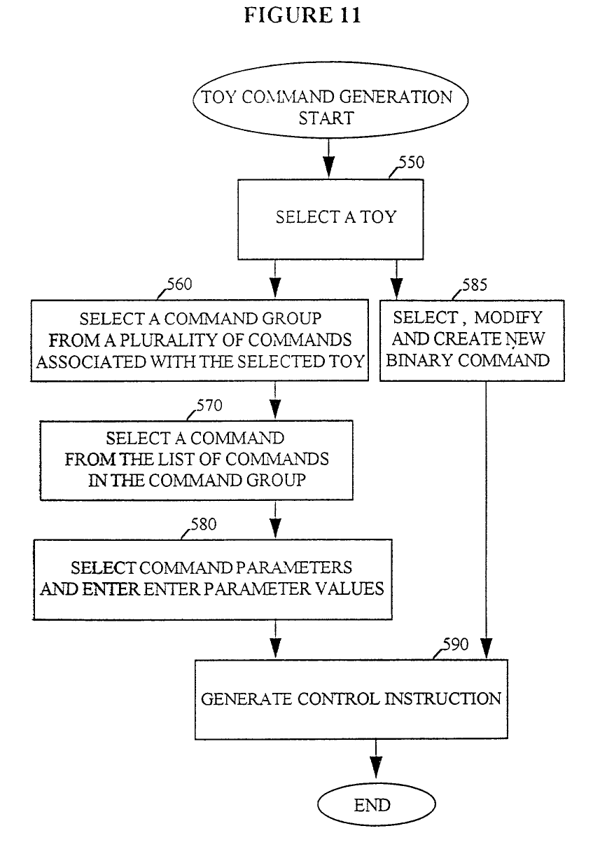

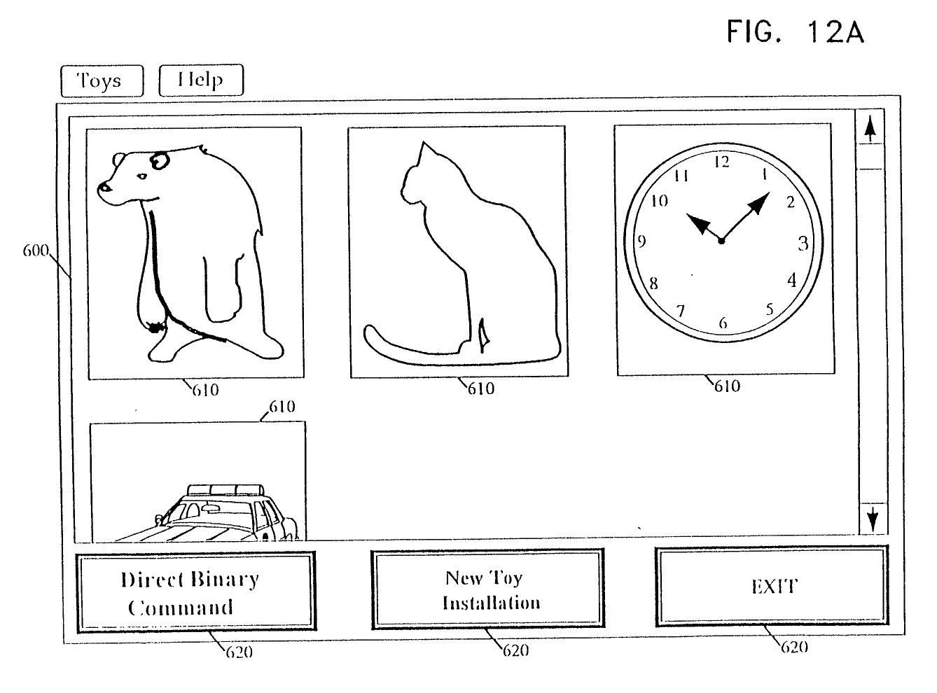

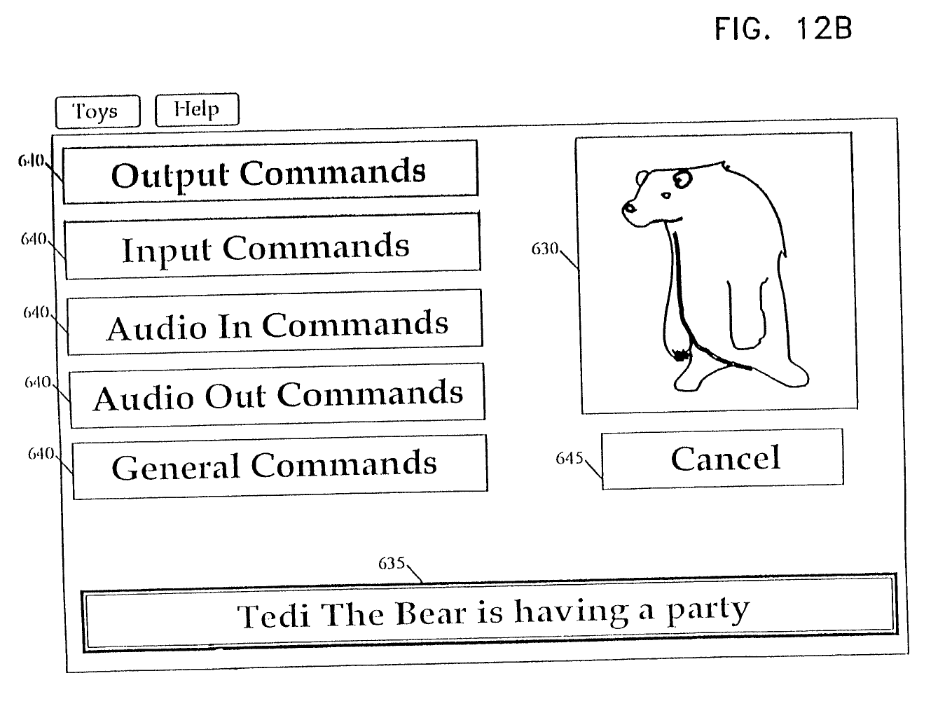

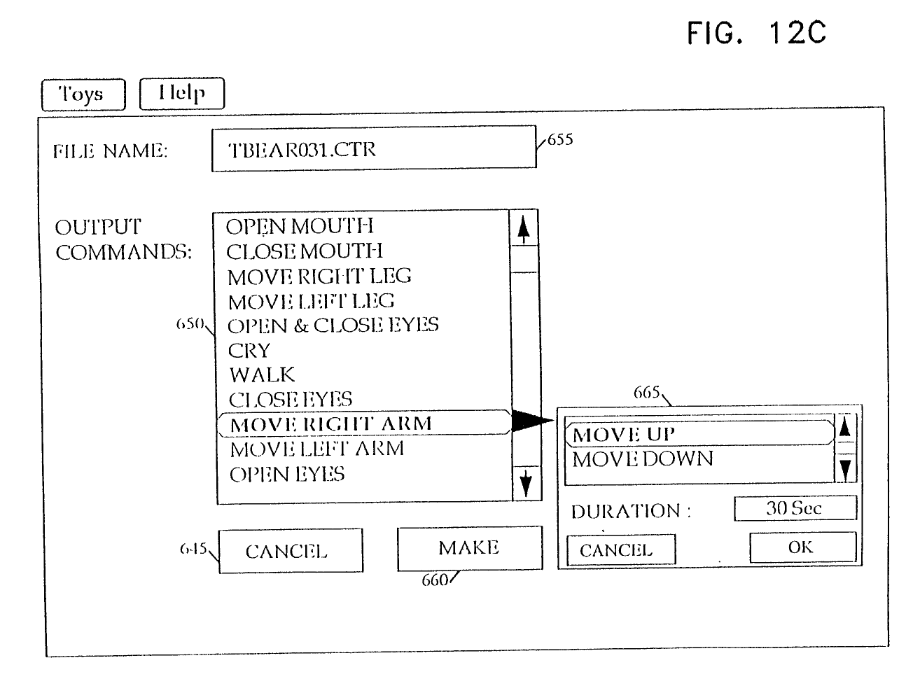

Appendix D is a computer listing of a preferred software implementation of the method of FIGS. 11 and FIGS. 12A-12C.

Appendices E-H, taken together, are computer listings from which a first, DLL-compatible, functions library may be constructed; and

Appendices I-O, taken together, are computer listings of a second functions library which may be used to generate a variety of games for any of the computer control systems shown and described herein.

### DETAILED DESCRIPTION OF PREFERRED EMBODIMENTS

Reference is now made to FIG. 1A which is a partly pictorial, partly block diagram illustration of a computer control system including a toy, constructed and operative in accordance with a preferred embodiment of the present invention. The system of FIG. 1A comprises a computer 100, which may be any suitable computer such as, for example, an IBM-compatible personal computer. The computer 100 is equipped with a screen 105. The computer 100 is preferably equipped with a sound card such as, for example, a Sound Blaster Pro card commercially available from Creative Labs, Inc., 1901 McCarthy Boulevard, Milpitas Calif. 95035 or from Creative Technology Ltd., 67 Ayer Rajah Crescent #03-18, Singapore, 0513; a hard disk; and, optionally, a CD-ROM drive.

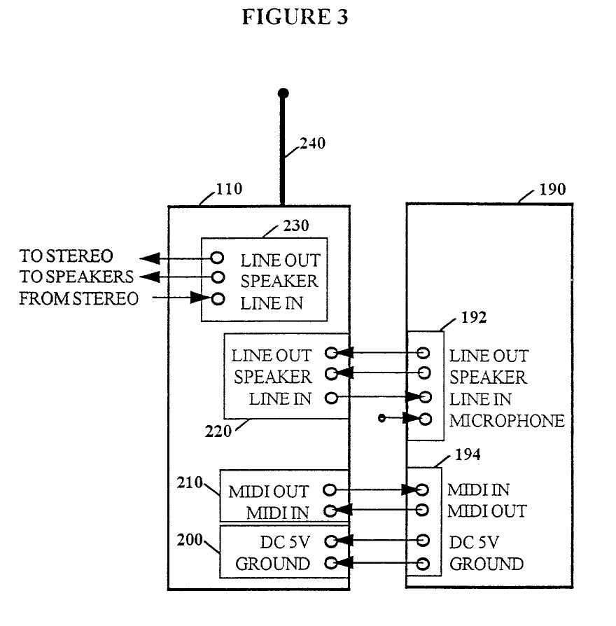

The computer 100 is equipped with a computer radio interface 110 operative to transmit signals via wireless transmission based on commands received from the computer 100 and, in a preferred embodiment of the present invention, also to receive signals transmitted elsewhere via wireless transmission and to deliver the signals to the computer 100. Typically, commands transmitted from the computer 100 to the computer radio interface 110 are transmitted via both analog signals and digital signals, with the digital signals typically being transmitted by way of a MIDI port. Transmission of the analog and digital signals is described below with reference to FIG. 3.

The transmitted signal may be an analog signal or a digital signal. The received signal may also be an analog signal or a digital signal. Each signal typically comprises a message. A preferred implementation of the computer radio interface 110 is described below with reference to FIG. 3.

The system of FIG. 1A also comprises one or more toys 120. The system of FIG. 1A comprises a plurality of toys, namely three toys 122, 124, and 126 but it is appreciated that, alternatively, either one toy only or a large plurality of toys may be used.

Reference is now additionally made to FIG. 1B, which is a partly pictorial, partly block diagram illustration of the toy 122 of FIG. 1A.

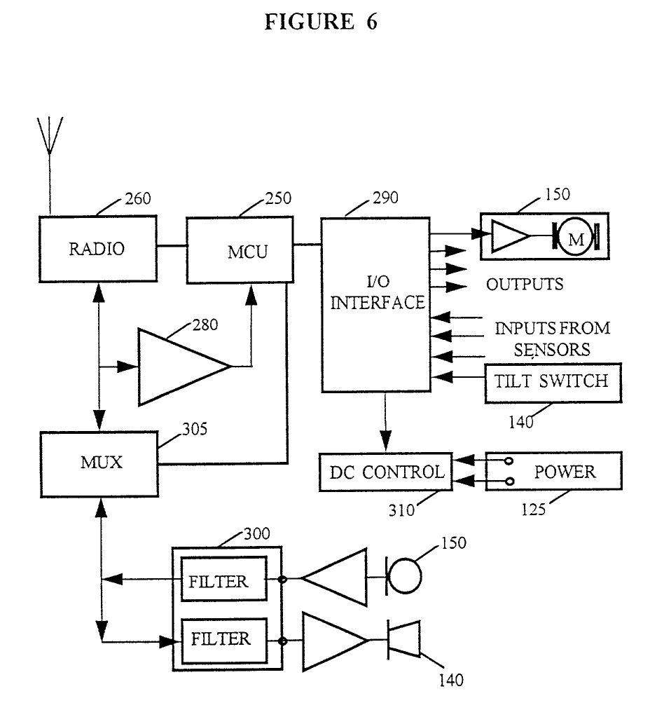

Each toy 120 comprises a power source 125, such as a battery or a connection to line power. Each toy 120 also comprises a toy control device 130, operative to receive a wireless signal transmitted by the computer 100 and to cause each toy 120 to perform an action based on the received signal. The received signal may be, as explained above, an analog signal or a digital signal. A preferred implementation of the toy control device 130 is described below with reference to FIG. 6.

Each toy 120 preferably comprises a plurality of input devices 140 and output devices 150, as seen in FIG. 1B. The input devices 140 may comprise, for example on or more of the following: a microphone 141; a microswitch sensor 142; a touch sensor (not shown in FIG. 1B); a light sensor (not shown in FIG. 1B); a movement sensor 143, which may be, for example, a tilt sensor or an acceleration sensor. Appropriate commercially available input devices include the following: position sensors available from Hamlin Inc., 612 East Lake Street, Lake Mills, Wis. 53551, USA; motion and vibration sensors available from Comus International, 263 Hillside Avenue, Nutley, N.J. 07110, USA; temperature, shock, and magnetic sensors available from Murata Electronics Ltd., Hampshire, England; and switches available from C & K Components Inc., 15 Riverdale Avenue, Newton, Mass. 02058-1082, USA or from Micro Switch Inc., a division of Honeywell, USA. The output devices 150 may comprise, for example, one or more of the following: a speaker 151; a light 152; a solenoid 153 which may be operative to move a portion of the toy; a motor, such as a stepping motor, operative to move a portion of the toy or all of the toy (not shown in FIG. 1B). Appropriate commercially available output devices include the following: DC motors available from Alkatel (dunkermotoren), Postfach 1240, D-7823, Bonndorf/Schwarzald, Germany; stepping motors and miniature motors available from Haydon Switch and Instruments, Inc. (HSI), 1500 Meriden Road, Waterbury,Conn., USA; and DC solenoids available from Communications Instruments, Inc., P.O Box 520, Fairview, N.C. 28730, USA.

Examples of actions which the toy may perform include the following: move a portion of the toy; move the entire toy; or produce a sound, which may comprise one or more of the following: a recorded sound, a synthesized sound, music including recorded music or synthesized music, speech including recorded speech or synthesized speech.

The received signal may comprise a condition governing the action as, for example, the duration of the action, or the number of repetitions of the action.

Typically, the portion of the received signal comprising a message comprising a command to perform a specific action as, for example, to produce a sound with a given duration, comprises a digital signal. The portion of the received signal comprising a sound, for example, typically comprises an analog signal. Alternatively, in a preferred embodiment of the present invention, the portion of the received signal comprising a sound, including music, may comprise a digital signal, typically a signal comprising MIDI data.

The action the toy may perform also includes reacting to signals transmitted by another toy, such as, for example, playing sound that the other toy is monitoring and transmitting.

In a preferred embodiment of the present invention, the toy control device 130 is also operative to transmit a signal intended for the computer 100, to be received by the computer radio interface 110. In this embodiment, the computer radio interface 110 is preferably also operative to poll the toy control device 130, that is, transmit a signal comprising a request that the toy control device 130 transmit a signal to the computer radio interface 110. It is appreciated that polling is particularly preferred in the case where there are a plurality of toys having a plurality of toy control devices 130.

The signal transmitted by the toy control device 130 may comprise one or more of the following: sound, typically sound captured by a microphone input device 141; status of sensor input devices 140 as, for example, light sensors or micro switch; an indication of low power in the power source 125; or information identifying the toy.

It is appreciated that a sound signal transmitted by the device 130 may also include speech. The computer system is operative to perform a speech recognition operation on the speech signals. Appropriate commercially available software for speech recognition is available from companies such as: Stylus Innovation Inc., One Kendall Square, Building 300, Cambridge, Mass. 02139, USA; A&G Graphics Interface, USA, Telephone No. (617)492-0120, Telefax No. (617)427-3625; “Dragon Dictate For Windows”, available from Dragon Systems Inc., 320 Nevada Street, MA. 02160, USA, and “SDKI” available from Lernout & Hausple Speech Products, Sint-Krispijnstraat 7, 8900 Leper, Belgium.

The signal from the radio control interface 110 may also comprise, for example, one or more of the following: a request to ignore input from one or more input devices 140; a request to activate one or more input devices 140 or to stop ignoring input from one or more input devices 140; a request to report the status of one or more input devices 140; a request to store data received from one or more input devices 140, typically by latching a transition in the state of one or more input devices 140, until a future time when another signal from the radio control interface 110 requests the toy control device 130 to transmit a signal comprising the stored data received from the one or more input devices 140; or a request to transmit analog data, typically comprising sound, typically for a specified period of time.

Typically, all signals transmitted in both directions between the computer radio interface 110 and the toy control device 130 include information identifying the toy.

Reference is now made to FIG. 1C, which is a partly pictorial, partly block diagram illustration of a computer control system including a toy, constructed and operative in accordance with an alternative preferred embodiment of the present invention. The system of FIG. 1C comprises two computers 100. It is appreciated that, in general, a plurality of computers 100 may be used. In the implementation of FIG. 1C, all signals transmitted in both directions between the computer radio interface 110 and the toy control device 130 typically include information identifying the computer.

The operation of the system of FIG. 1A is now briefly described. Typically, the computer 100 runs software comprising a computer game, typically a game including at least one animated character. Alternatively, the software may comprise educational software or any other interactive software including at least one animated object. As used herein, the term “animated object” includes any object which may be depicted on the computer screen 105 and which interacts with the user of the computer via input to and output from the computer. An animated object may be any object depicted on the screen such as, for example: a doll; an action figure; a toy, such as, for example, an activity toy, a vehicle, or a ride-on vehicle; a drawing board or sketch board; or a household object such as, for example, a clock, a lamp, a chamber pot, or an item of furniture.

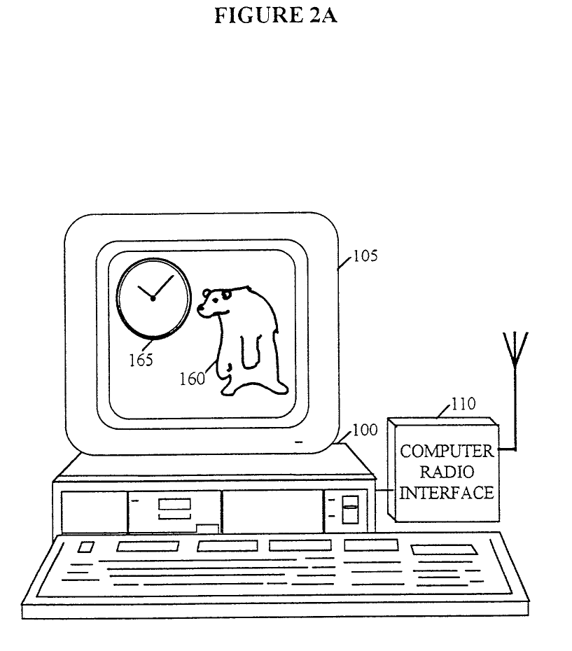

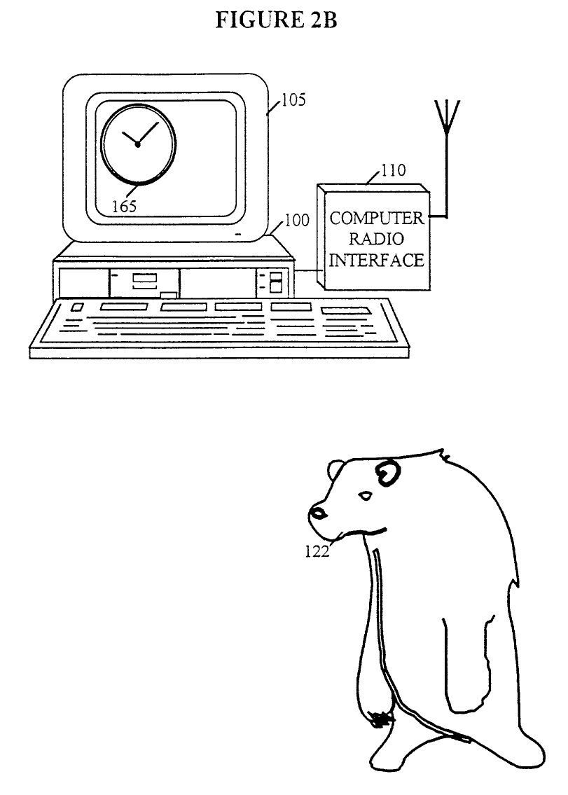

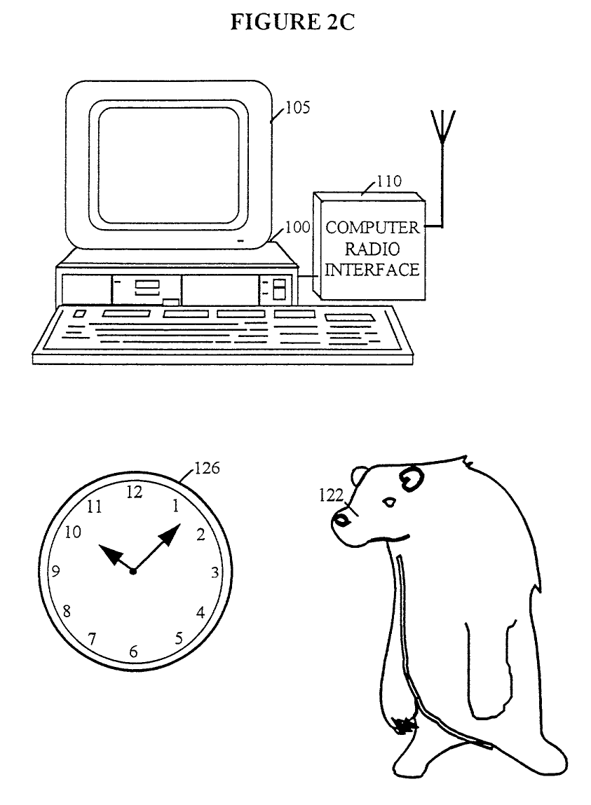

Reference is now additionally made to FIGS. 2A-2C, which depict a portion of the system of FIG. 1A in use. The apparatus of FIG. 2A comprises the computer screen 105 of FIG. 1A. On the computer screen are depicted animated objects 160 and 165.

FIG. 2B depicts the situation after the toy 122 has been brought into range of the computer radio interface 110 of FIG. 1A, typically into the same room therewith. Preferably, the toy 122 corresponds to the animated object 160. For example, in FIG. 2B the toy 122 and the animated object 160, shown in FIG. 2A, are both a teddy bear. The apparatus of FIG. 2B comprises the computer screen 105, on which is depicted the animated object 165. The apparatus of FIG. 2B also comprises the toy 122. The computer 100, having received a message via the computer radio interface 110, from the toy 122, no longer displays the animated object 160 corresponding to the toy 122. The functions of the animated object 160 are now performed through the toy 122, under control of the computer 100 through the computer radio interface 110 and the toy control device 130.

FIG. 2C depicts the situation after the toy 126 has also been brought into range of the computer radio interface 110 of FIG. 1A, typically into the same room therewith. Preferably, the toy 126 corresponds to the animated object 165. For example, in FIG. 2C the toy 126 and the animated object 165, shown in FIGS. 2A and 2B, are both a clock. The apparatus of FIG. 2C comprises the computer screen 105, on which no animated objects are depicted.

The apparatus of FIG. 2C also comprises the toy 126. The computer 100, having received a message via the computer radio interface 110 from the toy 126, no longer displays the animated object 165 corresponding to the toy 126. The functions of the animated object 165 are now performed through the toy 126, under control of the computer 100 through the computer radio interface 110 and the toy control device 130.

In FIG. 2A, the user interacts with the animated objects 160 and 165 on the computer screen, typically using conventional methods. In FIG. 2B the user also interacts with the toy 122, and in FIG. 2C typically with the toys 122 and 126, instead of interacting with the animated objects 160 and 165 respectively. It is appreciated that the user may interact with the toys 122 and 126 by moving the toys or parts of the toys; by speaking to the toys; by responding to movement of the toys which movement occurs in response to a signal received from the computer 100; by responding to a sound produced by the toys, which sound is produced in response to a signal received from the computer 100 and which may comprise music, speech, or another sound; or otherwise.

Reference is now made to FIG. 3 which is a simplified block diagram of a preferred embodiment of the computer radio interface 110 of FIG. 1A. The apparatus of FIG. 3 comprises the computer radio interface 110. The apparatus of FIG. 3 also comprises a sound card 190, as described above with reference to FIG. 1A. In FIG. 3, the connections between the computer radio interface 110 and the sound card 190 are shown.

The computer radio interface 110 comprises a DC unit 200 which is fed with power through a MIDI interface 210 from a sound card MIDI interface 194, and the following interfaces: a MIDI interface 210 which connects to the sound card MIDI interface 194; an audio interface 220 which connects to an audio interface 192 of the sound card 190; and a secondary audio interface 230 which preferably connects to a stereo sound system for producing high quality sound under control of software running on the computer 100 (not shown).

The apparatus of FIG. 3 also comprises an antenna 240, which is operative to send and receive signals between the computer radio interface 110 and one or more toy control devices 130.

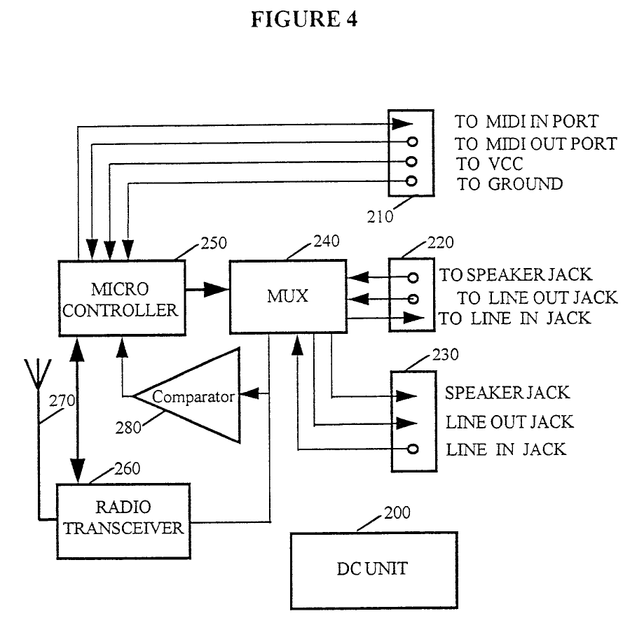

FIG. 4 is a more detailed block diagram of the computer radio interface 110 of FIG. 3. The apparatus of FIG. 4 comprises the DC unit 200, the MIDI interface 210, the audio interface 220, and the secondary audio interface 230. The apparatus of FIG. 4 also comprises a multiplexer 240, a micro controller 250, a radio transceiver 260, a connection unit 270 connecting the radio transceiver 260 to the micro controller 250, and a comparator 280.

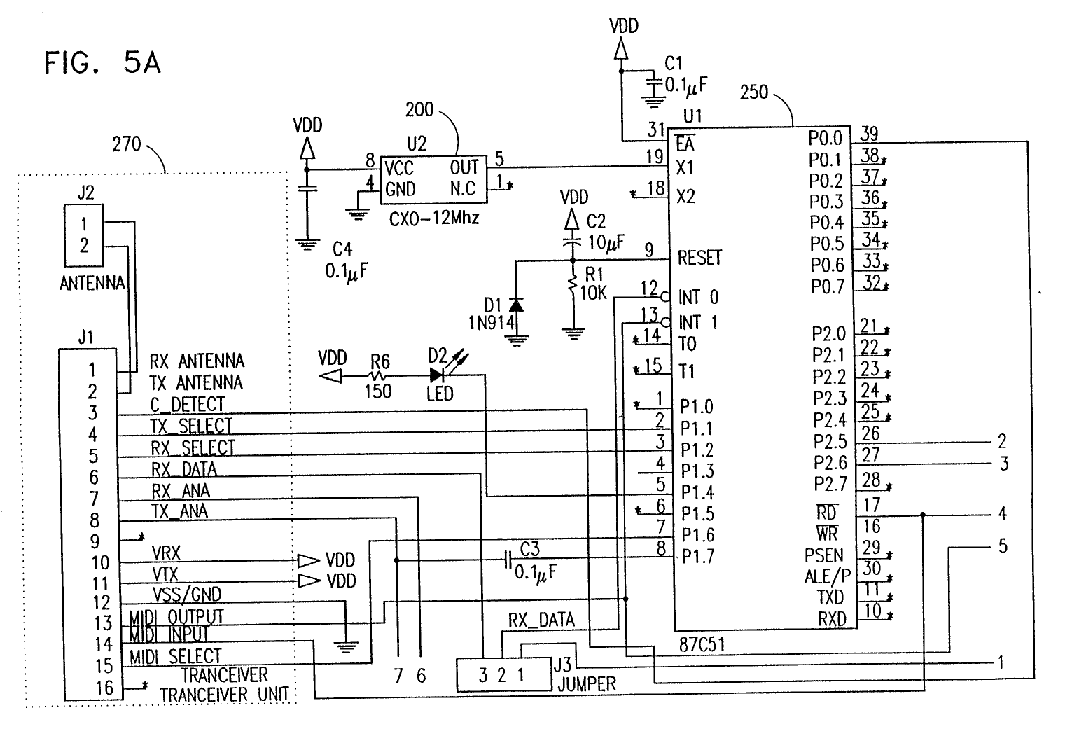

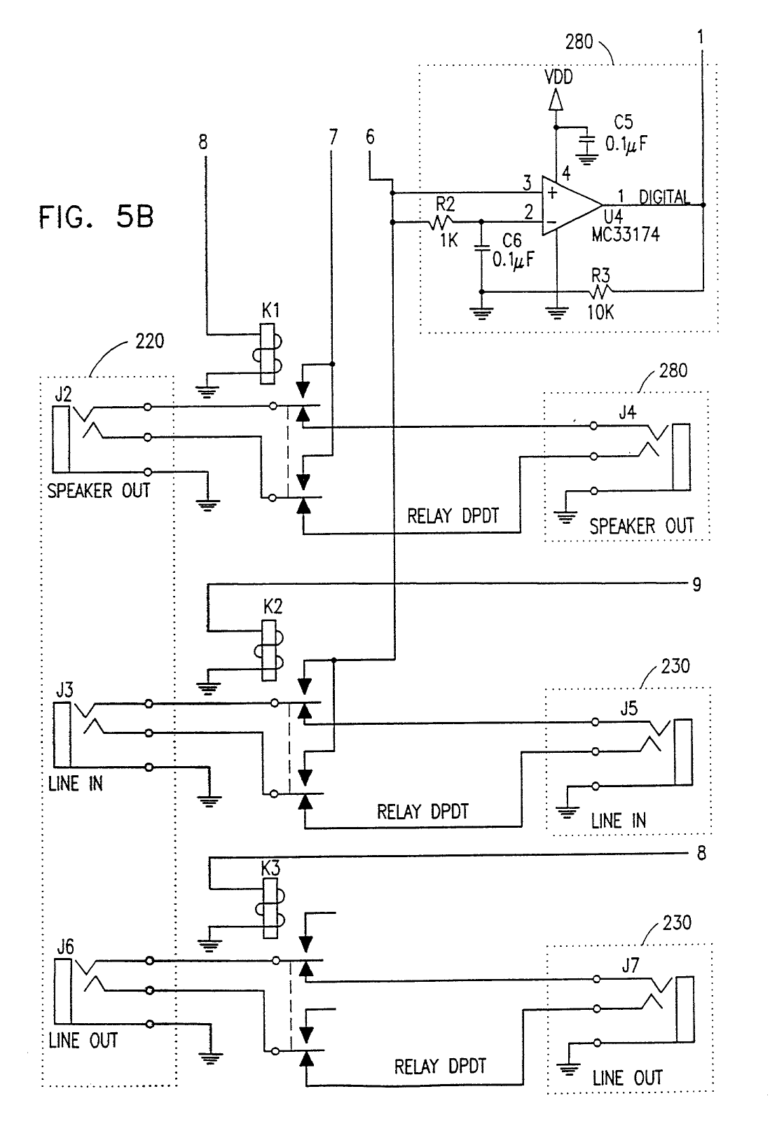

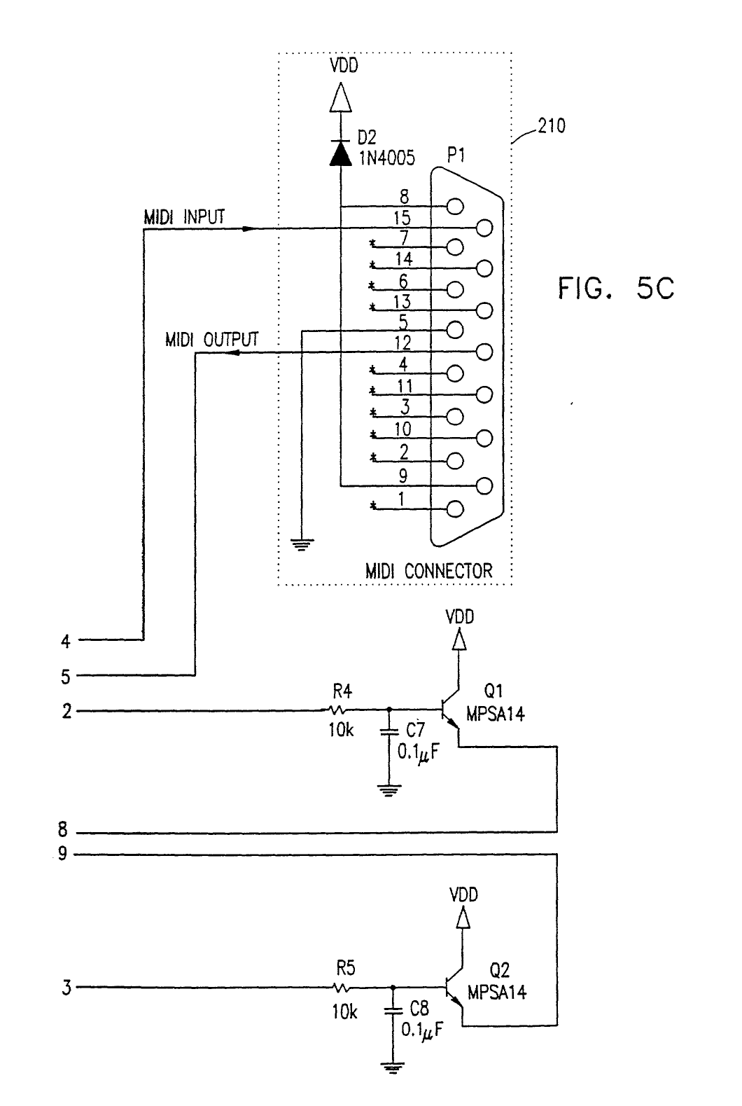

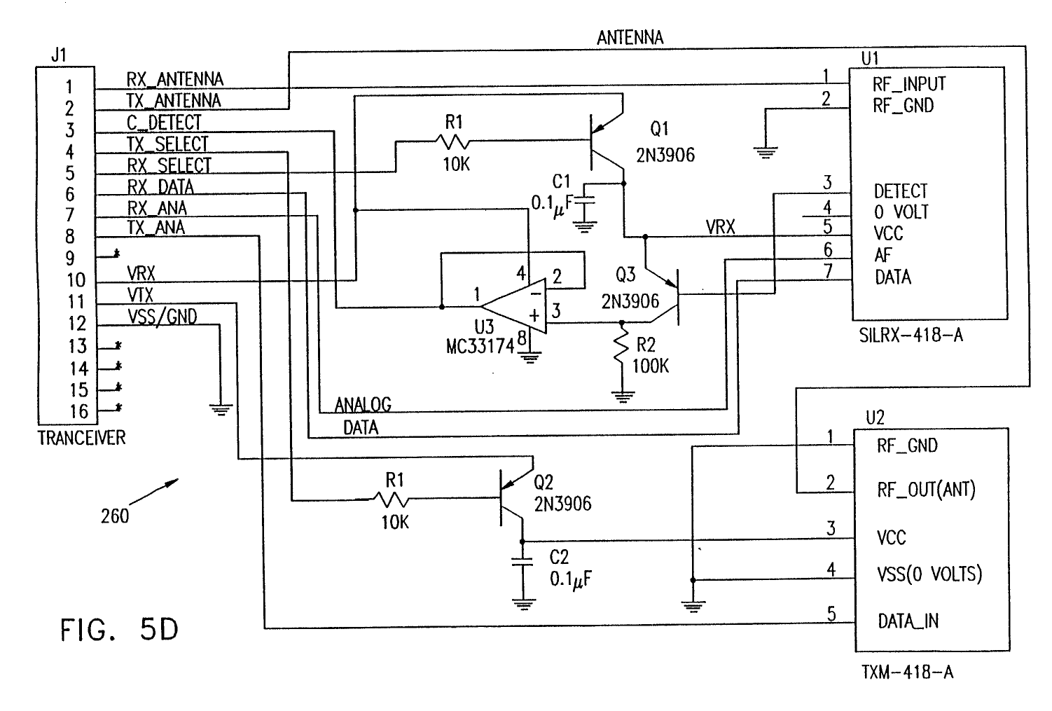

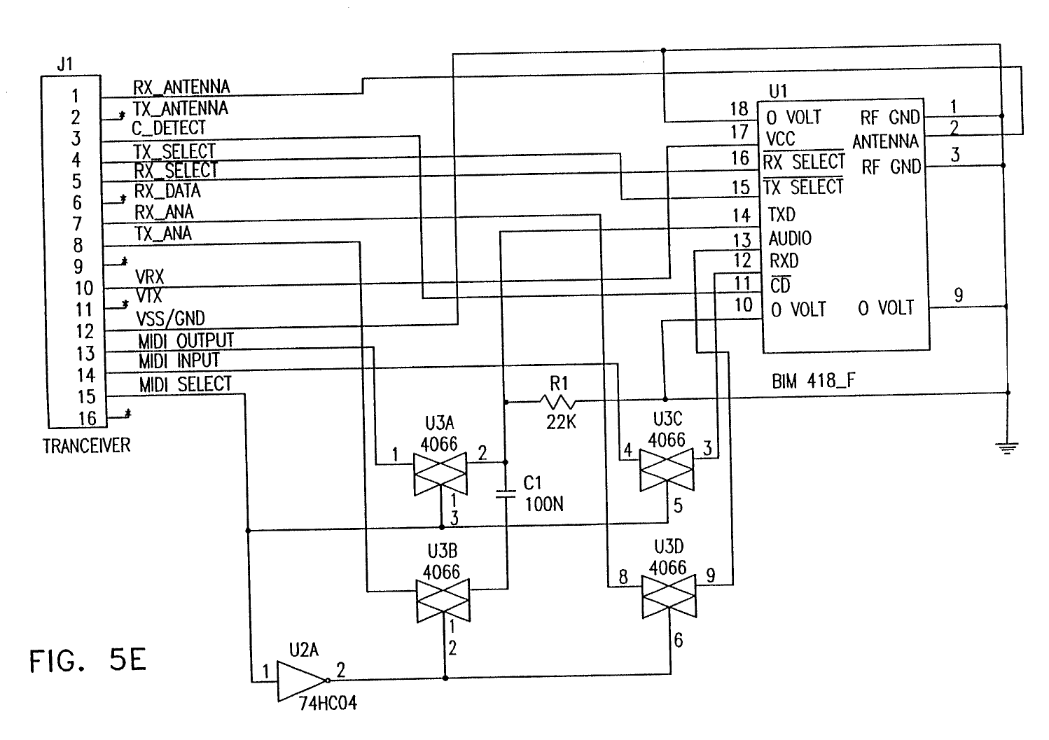

Reference is now made to FIGS. 5A-5D, which taken together comprise a schematic diagram of the apparatus of FIG. 4.

The following is a preferred parts list for the apparatus of FIGS. 5A-5C:

1. K1 Relay Dept, Idec, 1213 Elco Drive, Sunnyvale, Calif. 94089-2211, USA.

2. U1 8751 microcontroller, Intel Corporation, San Tomas 4, 2700 Sun Tomas Expressway, 2nd Floor, Santa Clara 95051, Calif. USA.

3. U2 CXO-12MHZ (crystal oscillator), Raltron, 2315 N.W. 107th Avenue, Miami, Fla. 33172, USA.

4. U4 MC33174, Motorola, Phoenix, Ariz. USA., Tel. No. (602)897-5056.

5. Diodes 1N914, Motorola, Phoenix, Ariz., USA. Tel. No. (602)897-5056.

6. Transistors 2N2222 and MPSA14, Motorola, Phoenix, Ariz., USA. Tel. No. (602)897-5056.

The following is a preferred parts list for the apparatus of FIG. 5D:

1. U1 SILRAX-418-A UHF radio telemetry receive module, Ginsburg Electronic GmbH, Am Moosfeld 85, D-81829, Munchen, Germany.

Alternatively, U1 of FIG. 5D may be replaced by:

U1 433.92 MHz Receive Module Part No. 0927, available from CEL SALES LTD., Cel House, Unit 2, Block 6, Shenstone Trading Estate Bromsgrove, Halesowen, West Midlands B36 3XB, UK.

2. U2 TXM-418-A low power UHF radio telemetry transmit module, Ginsburg Electronic GmbH, Am Moosfeld 85, D-81829, Munchen, Germany.

Alternatively, U2 of FIG. 5D may be replaced by:

U2 433.92 SIL FM Transmitter Module Part No, 5229, available from CEL SALES LTD., Cel House, Unit 2, Block 6, Shenstone Trading Estate Bromsgrove, Halesowen, West Midlands B36 3XB, UK.

Reference is now additionally made to FIG. 5E, which is a schematic diagram of an alternative implementation of the apparatus of FIG. 5D. The following is a preferred parts list for the apparatus of FIG. 5E:

1. U1 BIM-418-F low power, UHF data transceiver module, Ginsburg Electronic GmbH, Am Moosfeld 85, D-81829, Munchen, Germany.

Alternate 1. U1 S20043 spread spectrum full duplex transceiver, AMI Semiconductors—American Microsystems, Inc., Idaho, USA.

Alternate 1. U1 SDT-300 synthesized transceiver, Circuit Design, Inc., Japan.

Alternatively, U1 may be replaced by:

U1 RY3GBO21 RF 900 Mhz units, available from SHARP ELECTRONIC COMPONENTS GROUP, 5700 Northwest, Pacific Rim Boulevard #20, Camas, Wash., USA.

U1 RY3GB100 RF Units For DECT, available from SHARP ELECTRONIC COMPONENTS GROUP, 5700 Northwest, Pacific Rim Boulevard #20, Camas, Wash., USA.

In the parts list for FIG. 5E, one of item 1 or either of the alternate items 1 may be used for U1.

It is appreciated that the appropriate changes will have to be made to all the circuit boards for alternate embodiments of the apparatus.

The apparatus of FIG. 5E has similar functionality to the apparatus of FIG. 5D, but has higher bit rate transmission and reception capacity and is, for example, preferred when MIDI data is transmitted and received.

FIGS. 5A-5E are self-explanatory with regard to the above parts lists.

Reference is now made to FIG. 6 which is a simplified block diagram of a preferred embodiment of the toy control device 130 of FIG. 1A. The apparatus of FIG. 6 comprises a radio transceiver 260, similar to the radio transceiver 260 of FIG. 4. The apparatus of FIG. 6 also comprises a microcontroller 250 similar to the microcontroller 250 of FIG. 4.

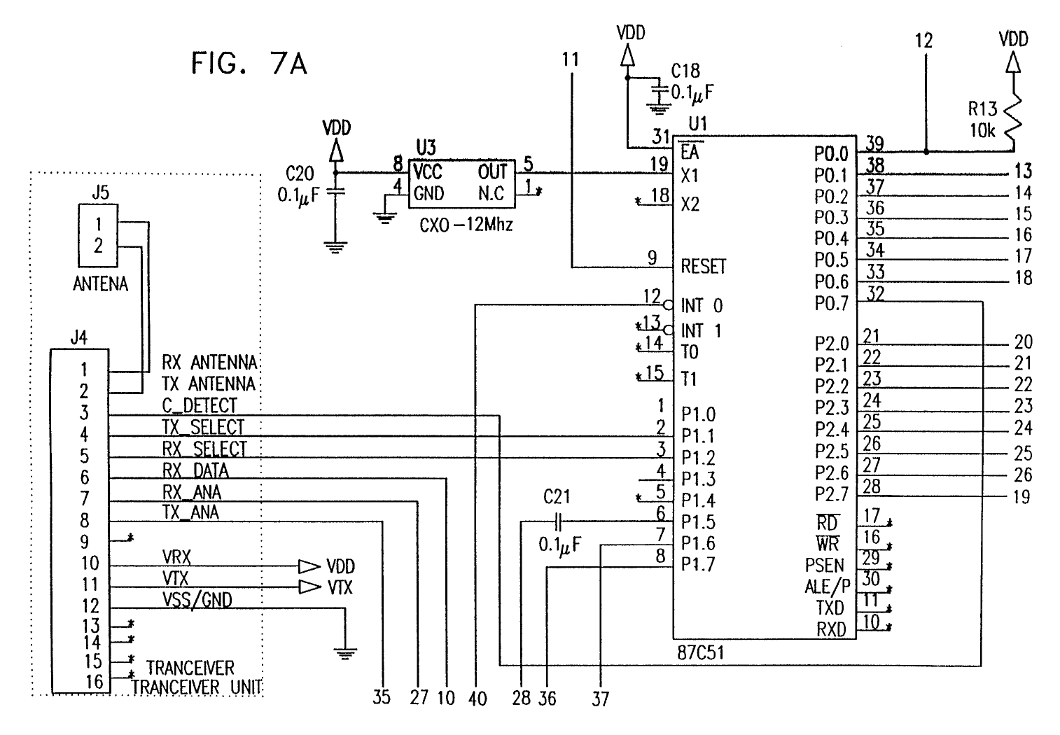

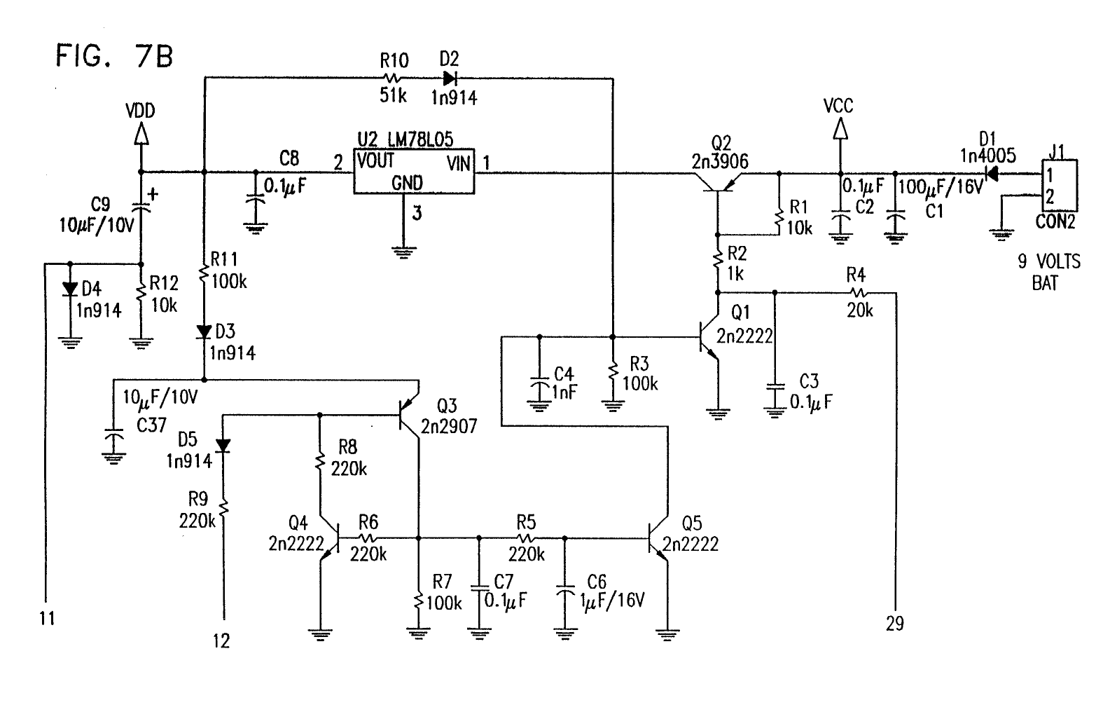

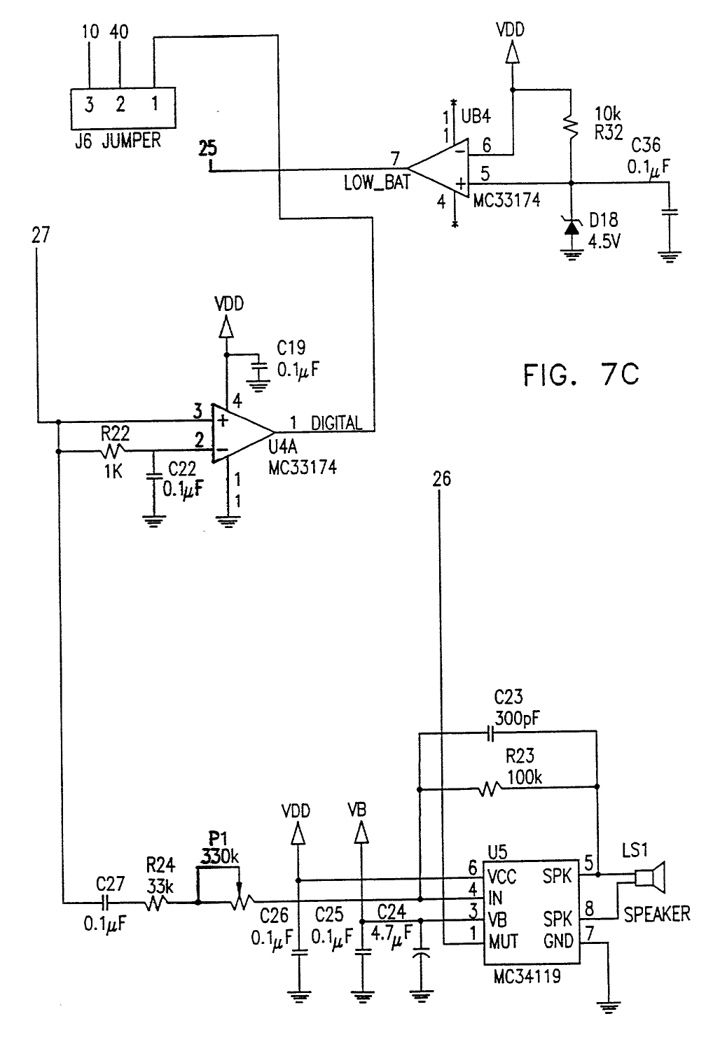

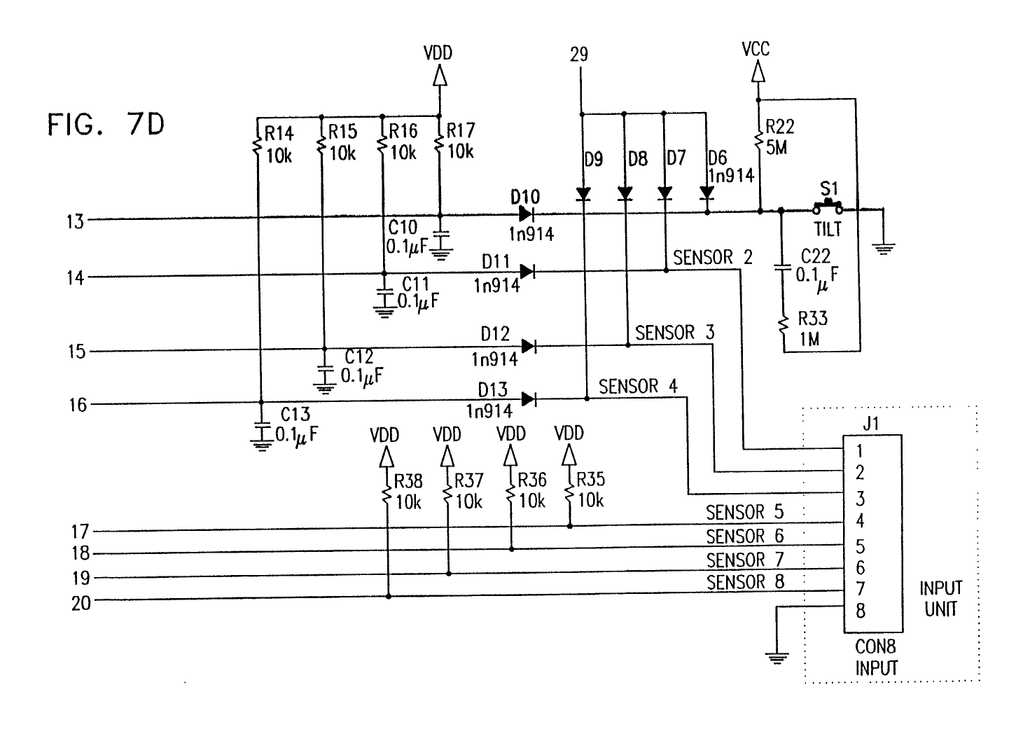

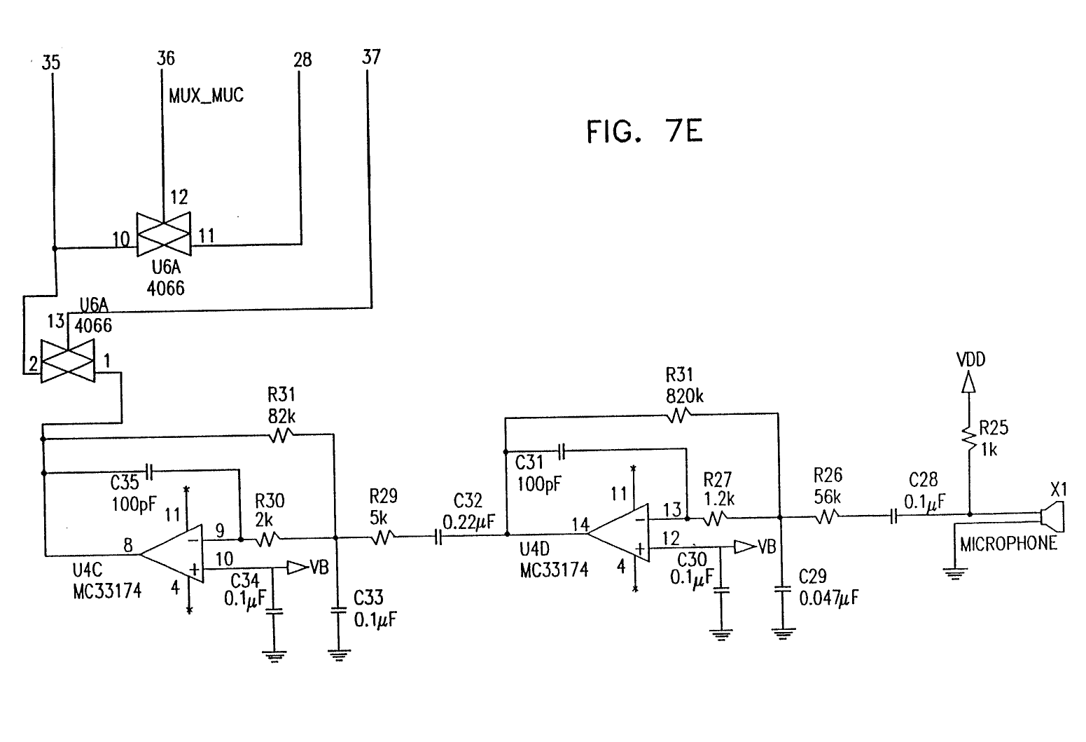

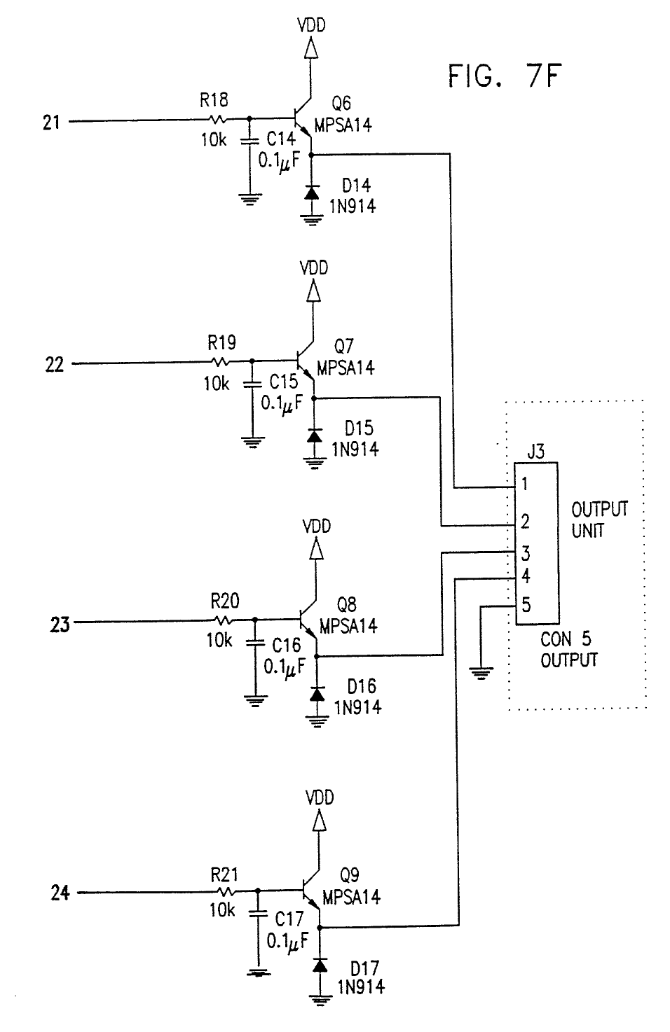

The apparatus of FIG. 6 also comprises a digital input/output interface (digital I/O interface) 290, which is operative to provide an interface between the microcontroller 250 and a plurality of input and output devices which may be connected thereto such as, for example, four input device and four output devices. A preferred implementation of the digital I/O interface 290 is described in more detail below with reference to FIG. 7A-7F.

The apparatus of FIG. 6 also comprises an analog input/output interface (analog I/O interface) 300 operatively connected to the radio transceiver 260, and operative to receive signals therefrom and to send signals thereto.

The apparatus of FIG. 6 also comprises a multiplexer 305 which is operative, in response to a signal from the microcontroller 250, to provide output to the analog I/O interface 300 only when analog signals are being transmitted by the radio transceiver 260, and to pass input from the analog I/O interface 300 only when such input is desired.

The apparatus of FIG. 6 also comprises input devices 140 and output devices 150. In FIG. 6, the input devices 140 comprise, by way of example, a tilt switch operatively connected to the digital I/O interface 290, and a microphone operatively connected to the analog I/O interface 300. It is appreciated that a wide variety of input devices 140 may be used.

In FIG. 6, the output devices 150 comprise, by way of example, a DC motor operatively connected to the digital I/O interface 290, and a speaker operatively connected to the analog I/O interface 300. It is appreciated that a wide variety of output devices 150 may be used.

The apparatus of FIG. 6 also comprises a DC control 310, a preferred implementation of which is described in more detail below with reference to FIGS. 7A-7F.

The apparatus of FIG. 6 also comprises a comparator 280, similar to the comparator 280 of FIG. 4.

The apparatus of FIG. 6 also comprises a power source 125, shown in FIG. 6 by way of example as batteries, operative to provide electrical power to the apparatus of FIG. 6 via the DC control 310.

Reference is now made to FIGS. 7A-7F which, taken together with either FIG. 5D or 5E, comprise a schematic diagram of the toy control device of FIG. 6. If the schematics of FIG. 5E is employed to implement the computer radio interface of FIG. 4, using RY3GB021 as U1 of FIG. 5E, then the same schematics of FIG. 5E are preferably employed to implement the toy control device of FIG. 6 except that RY3GH021 is used to implement U1 rather than RY3GB021.

The following is a preferred parts list for the apparatus of FIGS. 7A-7F:

1. U1 8751 microcontroller, Intel Corporation, San Tomas 4, 2700 Sun Tomas Expressway, 2nd Floor, Santa Clara 95051, Calif. USA.

2. U2 LM78L05, National Semiconductor, 2900 Semiconductor Drive, Santa Clara, Calif. 95052, USA.

3. U3 CXO-12 MHz (crystal oscillator), Raltron, 2315 N.W. 107th Avenue, Miami, FL 33172, USA.

4. U4 MC33174, Motorola, Phoenix, Ariz. USA. Tel. No. (602)897-5056.

5. U5 MC34119, Motorola, Phoenix, Ariz. USA. Tel. No. (602)897-5056.

6. U6 4066, Motorola, Phoenix, Ariz., USA.

Tel. No. (602)897-5056.

7. Diode 1N914, 1N4005, Motorola, Phoenix, Ariz. USA. Tel. No. (602)897-5056.

8. Transistor 2N2222, 2N3906, Motorola, Phoenix, Ariz. USA. Tel. No. (602)897-5056.

9. Transistors 2N2907 and MPSA14, Motorola, Phoenix, Ariz. USA. Tel. No. (602)897-5056.

FIGS. 7A-7F are self-explanatory with reference to the above parts list.

As stated above with reference to FIG. 1A, the signals transmitted between the computer radio interface 110 and the toy control device 130 may be either analog signals or digital signals. It the case of digital signals, the digital signals apreferably comprise a plurality of predefined messages, known to both the computer 100 and to the toy control device 130.

Each message sent by the computer radio interface 110 to the toy control device 130 comprises an indication of the intended recipient of the message. Each message sent by the toy control device 130 to the computer radio interface 110 comprises an indication of the sender of the message.

In the embodiment of FIG. 1C described above, messages also comprise the following:

each message sent by the computer radio interface 110 to the toy control device 130 comprises an indication of the sender of the message; and

each message sent by the toy control device 130 to the computer radio interface 110 comprises an indication of the intended recipient of the message.

A preferred set of predefined messages is as follows:

COMMAND STRUCTURE

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | -8 bits- | | -8 bits- | | -8 bits- | | CRC |
| | add | A-sb | B-sb | C-sb | msb | lsb | | | | | | | |
| | | | | | | | Dat 1 | Dat 1 | Dat 2 | Dat 2 | Dat 3 | Dat 3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 8 bits | |

COMMANDS LIST
From the Computer to the Toy control device.
A. OUTPUT COMMANDS
SET_IO_TO_DATA

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | -8 bits- | | -8 bits- | | -8 bits- | | CRC |
| | add | A-sb | B-sb | C-sb | msb | lsb | | | | | | | |
| | | | | | | | Dat 1 | Dat 1 | Dat 2 | Dat 2 | Dat 3 | Dat 3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 8 bits | |
| 01 | P | 00 | 00 | A | 00 | 01 | 00 | 10 | 00 | D | x | x | |

Set Toy control device output pin to a digital level D.

| | | |
|---|---|---|
| P: | Computer address | 00-03 H |
| A: | unit address- | 00-FF H |
| IO: | i/o number- | 00-03 H |
| D: | Data- | 00-01 H |

Example

| | | |
|---|---|---|
| 1. | 01 00 00 05 00 01 03 01 00 00 | set io 3 to “1” |
| 2. | 01 00 00 05 00 01 03 00 00 00 | set io 3 to “0” |

CHANGE_IO_FOR_TIME

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | -8 bits- | | -8 bits- | | -8 bits- | | CRC |
| | add | A-sb | B-sb | C-sb | msb | lsb | | | | | | | |
| | | | | | | | Dat 1 | Dat 1 | Dat 2 | Dat 2 | Dat 3 | Dat 3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 8 bits | |
| 01 | P | 00 | 00 | A | 00 | 01 | 00 | 10 | 00 | D | T1 | T2 | |

Change Toy control device output pin to D for a period of time and then return to previous state.

| | | |
|---|---|---|
| P: | Computer address | 00-03 H |
| A: | unit address- | 00-FF H |
| IO: | i/o number- | 00-03 H |
| T1,T2: | time- | 00-FF H |
| D: | Data- | 00-01 H |

example

| | | |
|---|---|---|
| 1. | 01 00 00 05 00 02 03 05 00 00 | set io 3 to “1” for 5 seconds |

B. INPUT COMMANDS
SEND_STATUS_OF_SENSORS

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | -8 bits- | | -8 bits- | | -8 bits- | | CRC |
| | add | A-sb | B-sb | C-sb | msb | lsb | | | | | | | |
| | | | | | | | Dat 1 | Dat 1 | Dat 2 | Dat 2 | Dat 3 | Dat 3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 8 bits | |
| 01 | P | 00 | 00 | A | 01 | 00 | x | x | x | x | x | x | |

send the Toy control device status of all sensors.

| | | |
|---|---|---|
| P: | Computer address | 00-03 H |
| A: | unit address- | 00-FF H |

example:

| | | |
|---|---|---|
| 1. | 01 00 00 05 01 00 00 00 00 00 | send current status of sensors |

SENSORS_SCAN_MODE_ON

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | -8 bits- | | -8 bits- | | -8 bits- | | CRC |
| | add | A-sb | B-sb | C-sb | msb | lsb | | | | | | | |
| | | | | | | | Dat 1 | Dat 1 | Dat 2 | Dat 2 | Dat 3 | Dat 3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 8 bits | |
| 01 | P | 00 | 00 | A | 01 | 01 | x | x | x | x | x | x | |

Start scanning the Toy control device sensors, and if one of them is closed (pressed to ‘0’), send back an ack.

| | | |
|---|---|---|
| P: | Computer address | 00-03 H |
| A: | unit address- | 00-FF H |

example:

| | | |
|---|---|---|
| 1 | 01 00 00 05 01 01 00 00 00 00 | scan mode of sensors ON |

SENSORS_SCAN_MODE_ON_ONCE

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | -8 bits- | | -8 bits- | | -8 bits- | | CRC |
| | add | A-sb | B-sb | C-sb | msb | lsb | | | | | | | |
| | | | | | | | Dat 1 | Dat 1 | Dat 2 | Dat 2 | Dat 3 | Dat 3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 8 bits | |
| 01 | P | 00 | 00 | A | 01 | 01 | x | x | x | x | x | x | |

Start scanning the Toy control device sensors, and if one of them is closed (pressed to ‘0’), send back an ack,
then disable scanning the sensors.

| | | |
|---|---|---|
| P: | Computer address | 00-03 H |
| A: | unit address- | 00-FF H |

| | | |
|---|---|---|
| 1 | 01 00 00 05 01 02 00 00 00 00 | scan mode of sensors ON once |

SENSORS_SCAN_MODE_OFF

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | -8 bits- | | -8 bits- | | -8 bits- | | CRC |
| | add | A-sb | B-sb | C-sb | msb | lsb | | | | | | | |
| | | | | | | | Dat 1 | Dat 1 | Dat 2 | Dat 2 | Dat 3 | Dat 3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 8 bits | |
| 01 | P | 00 | 00 | A | 01 | 03 | x | x | x | x | x | x | |

Stop scanning the Toy control device sensors.

| | | |
|---|---|---|
| P: | Computer address | 00-03 H |
| A: | unit address- | 00-FF H |

example:

| | | |
|---|---|---|
| 1 | 01 00 00 05 01 03 00 00 00 00 | scan mode of sensors OFF |

C. AUDIO OUT COMMANDS
START_AUDIO_PLAY

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | -8 bits- | | -8 bits- | | -8 bits- | | CRC |
| | add | A-sb | B-sb | C-sb | msb | lsb | | | | | | | |
| | | | | | | | Dat 1 | Dat 1 | Dat 2 | Dat 2 | Dat 3 | Dat 3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 8 bits | |
| 01 | P | 00 | 00 | A | 02 | 00 | x | x | x | x | x | x | |

Start playing aun audio in a speaker of the Toy control device The Audio is sent to the Toy control device by the
computer sound card and the
Computer radio interface.

| | | |
|---|---|---|
| P: | Computer address | 00-03 H |
| A: | unit address- | 00-FF H |

example:

| | | |
|---|---|---|
| 1 | 01 00 00 05 02 00 00 00 00 00 | Start audio-play |

STOP_AUDIO_PLAY

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | -8 bits- | | -8 bits- | | -8 bits- | | CRC |
| | add | A-sb | B-sb | C-sb | msb | lsb | | | | | | | |
| | | | | | | | Dat 1 | Dat 1 | Dat 2 | Dat 2 | Dat 3 | Dat 3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 8 bits | |
| 01 | P | 00 | 00 | A | 02 | 01 | x | x | x | x | x | x | |

Stop playing au audio in a speaker of the Toy control device.

| | | |
|---|---|---|
| P: | Computer address | 00-03 H |
| A: | unit address- | 00-FF H |

| | | |
|---|---|---|
| 1 | 01 00 00 05 02 01 00 00 00 00 | Stop audio-play |

START_AUDIO_AND_IO_PLAY_FOR_TIME

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | -8 bits- | | -8 bits- | | -8 bits- | | CRC |
| | add | A-sb | B-sb | C-sb | msb | lsb | | | | | | | |
| | | | | | | | Dat 1 | Dat 1 | Dat 2 | Dat 2 | Dat 3 | Dat 3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 8 bits | |
| 01 | P | 00 | 00 | A | 02 | 04 | T1 | T2 | T0 | td | SC | IO | |

Start playing an audio in a speaker of the Toy control device and set an io pin to ‘1’. After time T, stop audio
and set IO to ‘0’. start this command
after a delay td*100 ms if SC=“1” then after the execution of this command, start the input command SCAN
_SENSORS_ON_ONCE (if any
sensor is pressed, even during the audio play, send a message to the computer).

| | | |
|---|---|---|
| P: | Computer address | 00-03 H |
| A: | unit address- | 00-FF H |
| IO: | i/o number- | 0-3 H (if IO>3 then don't set IO) |
| T0,T1,T2 | TIME | 000-FFF H (*100 ms) (T0=MMSB, T1=MSB T0=LSB) |
| td: | delay time befor execute | 0-F H (*100 ms) |

| | | |
|---|---|---|
| 1. | 01 00 00 05 02 04 80 2A 03 00 | Start audio-play and IO # 3 for 6.4 second |
| | | 640=280H |
| | | delay before execution - 10* 100 ms=1 sec |
| 2. | 01 00 00 05 02 04 80 2A 13 00 | Start audio-play and IO # 3 for 6.4 second |
| | | set scan sensors on once mode. |
| | | delay before execution = 10* 100 ms=1 sec |

D. AUDIO IN COMMANDS
TRANSMIT_MIC_FOR_TIME

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | -8 bits- | | -8 bits- | | -8 bits- | | CRC |
| | add | A-sb | B-sb | C-sb | msb | lsb | | | | | | | |
| | | | | | | | Dat 1 | Dat 1 | Dat 2 | Dat 2 | Dat 3 | Dat 3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 8 bits | |
| 01 | P | 00 | 00 | A | 03 | 00 | T1 | T2 | x | x | x | x | |

Requests the Toy control device to Transmit microphone audio from the Toy control device to the Computer radio
interface and to the sound card
of the computer for time T.

| | | |
|---|---|---|
| P: | Computer address | 00-03 H |
| A: | unit address- | 00-FF H |
| T1,T2: | TIME | 00-FF H (SEC) |

example:

| | | |
|---|---|---|
| 1 | 01 00 00 05 03 00 0A 00 00 00 | start mic mode for 10 seconds |

E. GENERAL TOY COMMANDS
GOTO_SLEEP_MODE

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | -8 bits- | | -8 bits- | | -8 bits- | | CRC |
| | add | A-sb | B-sb | C-sb | msb | lsb | | | | | | | |
| | | | | | | | Dat 1 | Dat 1 | Dat 2 | Dat 2 | Dat 3 | Dat 3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 8 bits | |
| 01 | P | 00 | 00 | A | 04 | 01 | x | x | x | x | x | x | |

Requests the Toy control device to go into power save mode (sleep).

| | | |
|---|---|---|
| P: | Computer address | 00-03 H |
| A: | unit address- | 00-FF H |

| | | |
|---|---|---|
| 1 | 01 00 00 05 04 01 00 00 00 00 | switch the Toy control device into sleep mode. |

GOTO_AWAKE_MODE

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | -8 bits- | | -8 bits- | | -8 bits- | | CRC |
| | add | A-sb | B-sb | C-sb | msb | lsb | | | | | | | |
| | | | | | | | Dat 1 | Dat 1 | Dat 2 | Dat 2 | Dat 3 | Dat 3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 8 bits | |
| 01 | P | 00 | 00 | A | 04 | 02 | x | x | x | x | x | x | |

Requests the Toy control device to go into an awake mode.

| | | |
|---|---|---|
| P: | Computer address | 00-03 H |
| A: | unit address- | 00-FF H |

| | | |
|---|---|---|
| 1 | 01 00 00 05 04 02 00 00 00 00 | switch the Toy control device into awake mode. |

TOY_RESET

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | -8 bits- | | -8 bits- | | -8 bits- | | CRC |
| | add | A-sb | B-sb | C-sb | msb | lsb | | | | | | | |
| | | | | | | | Dat 1 | Dat 1 | Dat 2 | Dat 2 | Dat 3 | Dat 3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 8 bits | |
| 01 | P | 00 | 00 | A | 04 | 0F | x | x | x | x | x | x | |

Requests the Toy control device to perform RESET

| | | |
|---|---|---|
| P: | Computer address | 00-03 H |
| A: | unit address- | 00-FF H |

| | | |
|---|---|---|
| 1 | 01 00 00 05 04 0F 00 00 00 00 | Toy reset |

TOY_USE_NEW_RF_CHANNELS

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | -8 bits- | | -8 bits- | | -8 bits- | | CRC |
| | add | A-sb | B-sb | C-sb | msb | lsb | | | | | | | |
| | | | | | | | Dat 1 | Dat 1 | Dat 2 | Dat 2 | Dat 3 | Dat 3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 8 bits | |
| 01 | P | 00 | 00 | A | 04 | 0A | CH1 | CH2 | x | x | x | x | |

Requests the Toy control device to switch to new RF transmit and receive channels.

| | | |
|---|---|---|
| P: | Computer address | 00-03 H |
| A: | unit address- | 00-FF H |
| CH1: | Transmit RF channel number | 0-F H |
| CH2: | Receive RF Channel number | 0-F H |

| | | |
|---|---|---|
| 1 | 01 00 00 05 04 0A 12 00 00 00 | Switch to new RX and TX RF channels |

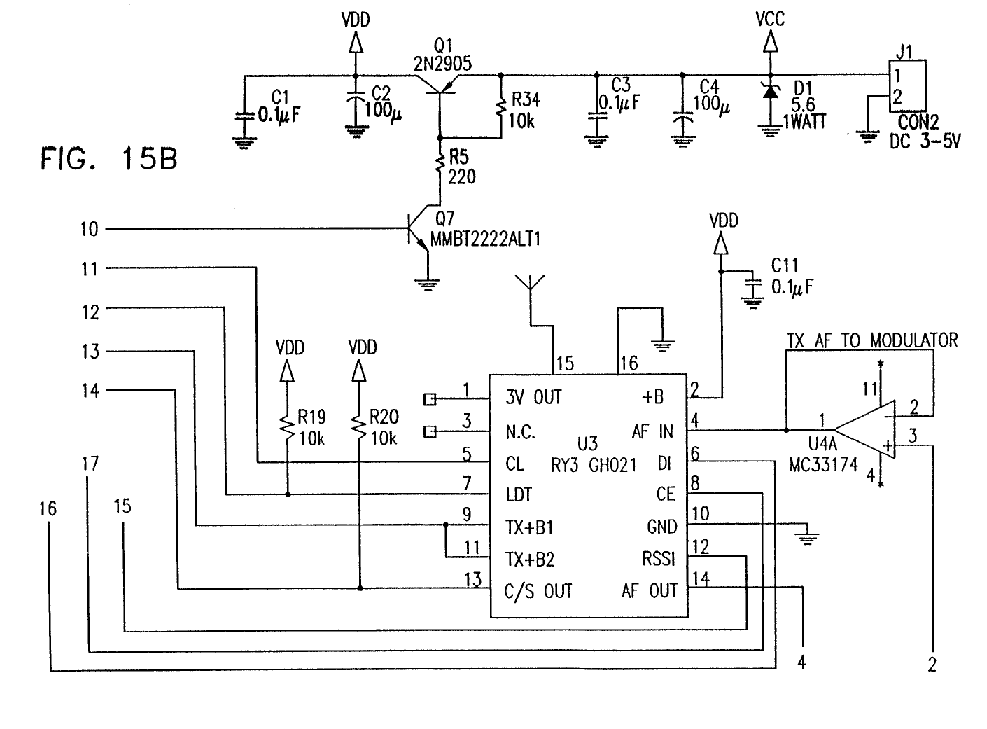

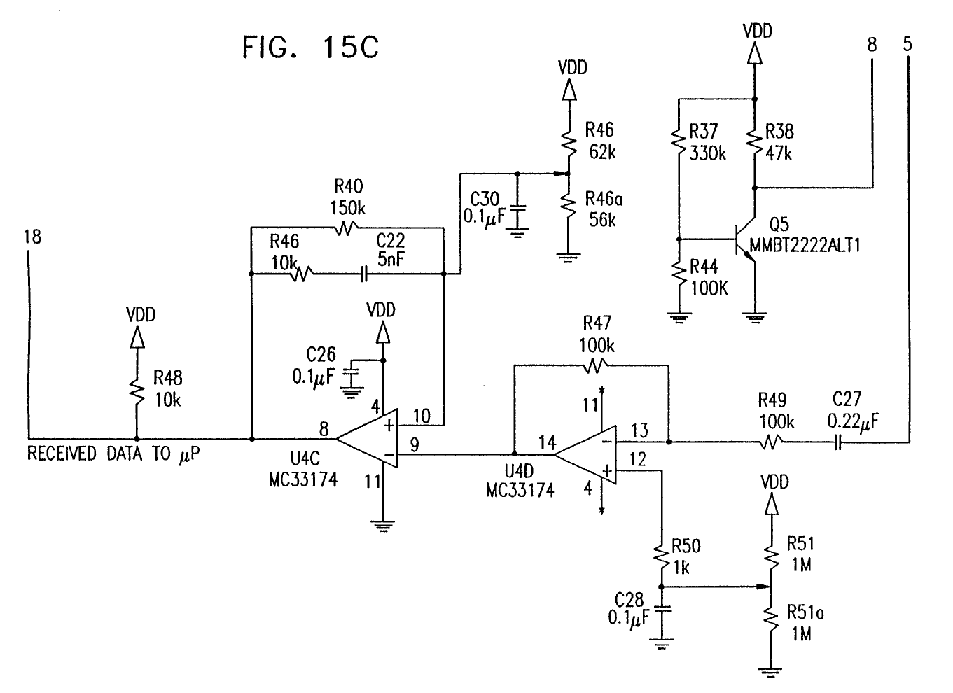

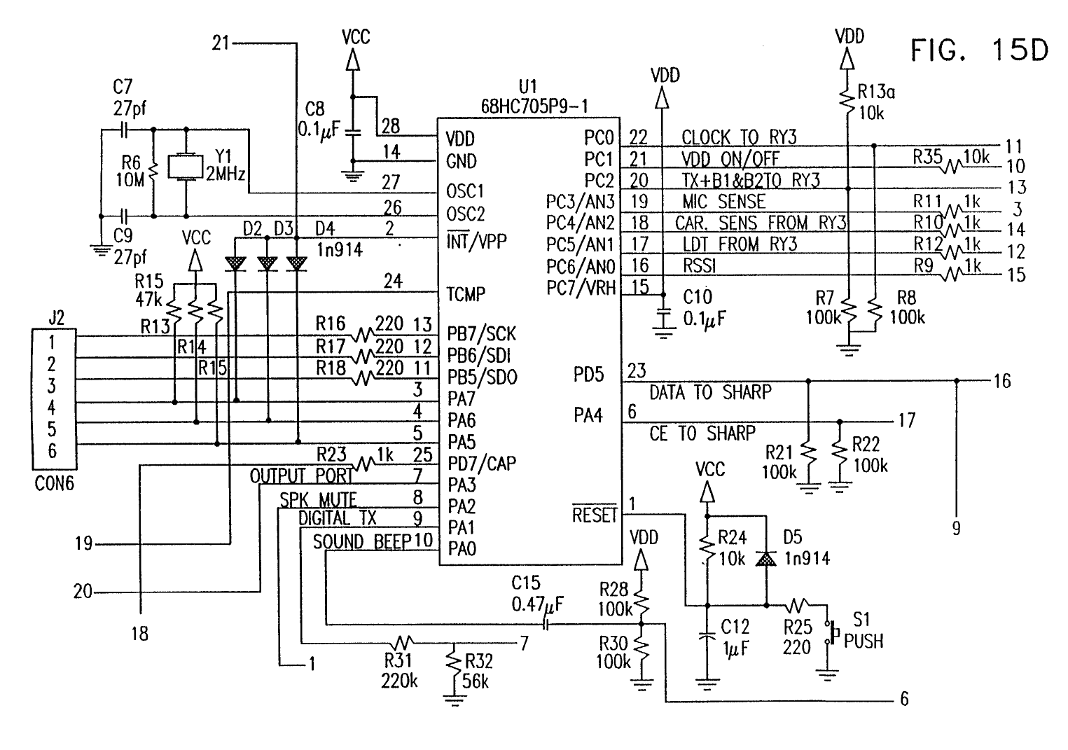

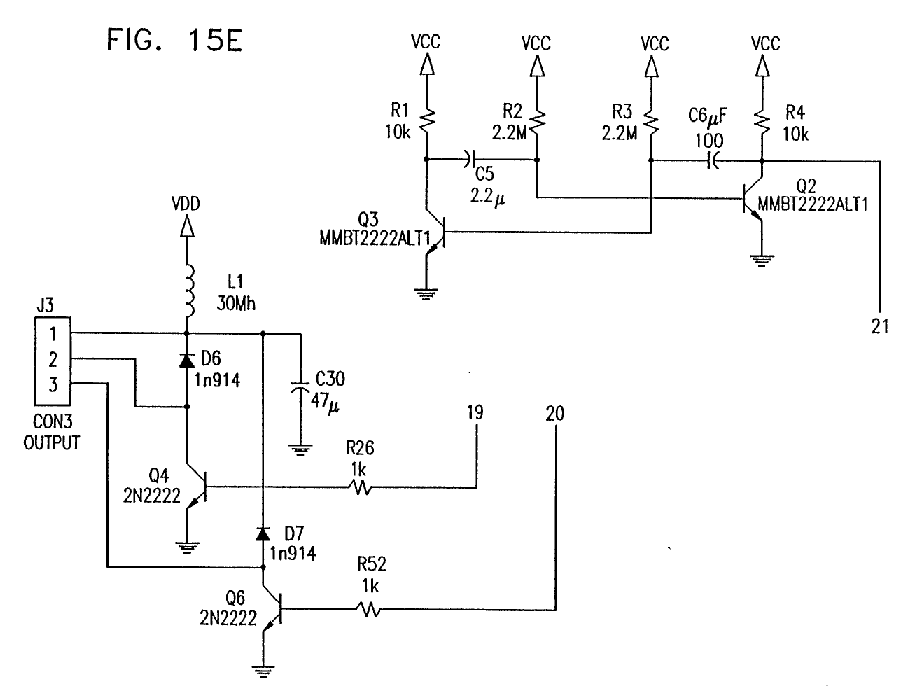

Note: This command is available only with enhanced radio modules (alternate U1 of FIG. 5E) or with the modules
described if FIG. 15A-15E and 24A-25E
E. TELEMETRY
Information sent by the Toy control device, as an ACK to the command received from the Computer radio interface.
OK_ACK

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | -8 bits- | | -8 bits- | | -8 bits- | | CRC |
| | add | A-sb | B-sb | C-sb | msb | lsb | | | | | | | |
| | | | | | | | Dat 1 | Dat 1 | Dat 2 | Dat 2 | Dat 3 | Dat 3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 8 bits | |
| 01 | P | 00 | 00 | A | 0A | 00 | cmd1 | cmd2 | cmd3 | cmd4 | sen1 | sen2 | |

Send back an ACK about the command that was received ok.

| | | |
|---|---|---|
| P: | Computer address | 00-03 H |
| A: | unit address- | 00-FF H |
| cmd 1,2: | Received command MSB ok ack. | 00-FF H |
| cmd 3,4: | Received command LSB ok ack, | 00-FF H |
| sen 1,2 | Sensors 0-7 status | 00-FF H |

| | | |
|---|---|---|
| 1. | 01 60 00 05 0A 00 01 01 FF 00 | OK ack for 0101 command (sensors scan mode |
| | | on command).status: all sensors are not |
| | | pressed (FF). |
| | | the computer_radio_interface number is 6. |
| 2. | 01 60 00 05 0A 00 01 01 FE 00 | OK ack for 0101 command(sensors scan mode |
| | | on command).status: sensor # 8 is pressed |
| | | (FE) |
| | | the computer_radio_interface number is 6. |

E. REQUESTS
Requests Sent by the Toy control device, after an event.
TOY_IS_AWAKE_REQ

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | -8 bits- | | -8 bits- | | -8 bits- | | CRC |
| | add | A-sb | B-sb | C-sb | msb | lsb | | | | | | | |
| | | | | | | | Dat 1 | Dat 1 | Dat 2 | Dat 2 | Dat 3 | Dat 3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 8 bits | |
| 01 | P | 00 | 00 | A | 0A | 00 | c1 | c2 | x | x | x | x | |

Send a message to the Computer radio interface if the Toy control device goes from sleep mode to awake mode.

| | | |
|---|---|---|
| P: | Computer address | 00-03 H |
| A: | unit address- | 00-FF H |
| c1,c2: | status command | AB H |

| | | |
|---|---|---|
| 1 | 01 60 00 05 0A 00 AB 00 FF 00 | Toy is awake message. |

F. CRI (Computer Radio Interface)- commands
Commands that are sent only to the Computer radio interface.
SWITCH_AUDIO_OUT_TO_RADIO_&_TRANSMIT

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | -8 bits- | | -8 bits- | | -8 bits- | | CRC |
| | add | A-sb | B-sb | C-sb | msb | lsb | | | | | | | |
| | | | | | | | Dat 1 | Dat 1 | Dat 2 | Dat 2 | Dat 3 | Dat 3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 8 bits | |
| 01 | P | 00 | 00 | x | 0C | 00 | x | x | x | x | x | x | |

Requests the Computer radio interface to seitch audio_out from the computer sound card to the radio
wireless transceiver and transmit.

| | | |
|---|---|---|
| P: | Computer address | 00-03 H |

SWITCH_AUDIO_OUT_TO_JACK_&_STOP_TRANSMIT

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | -8 bits- | | -8 bits- | | -8 bits- | | CRC |
| | add | A-sb | B-sb | C-sb | msb | lsb | | | | | | | |
| | | | | | | | Dat 1 | Dat 1 | Dat 2 | Dat 2 | Dat 3 | Dat 3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 8 bits | |
| 01 | P | 00 | 00 | x | 0C | 01 | x | x | x | x | x | x | |

Requests the Computer radio interface to seitch audio_out from the radio RF wireless transceiver to the
speakers jack and to stop transmit.

| | | |
|---|---|---|
| P: | Computer address | 00-03 H |

MUTE_RADIO

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | -8 bits- | | -8 bits- | | -8 bits- | | CRC |
| | add | A-sb | B-sb | C-sb | msb | lsb | | | | | | | |
| | | | | | | | Dat 1 | Dat 1 | Dat 2 | Dat 2 | Dat 3 | Dat 3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 8 bits | |
| 01 | P | 00 | 00 | x | 0C | 02 | x | x | x | x | x | x | |

Mute the radio transmit.

| | | |
|---|---|---|
| P: | Computer address | 00-03 H |

G. CRI - ACK
ACK sent only to the Computer by the Computer radio interface, only after CRI commands.
CRI_COMMAND_ACK

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | -8 bits- | | -8 bits- | | -8 bits- | | CRC |
| | add | A-sb | B-sb | C-sb | msb | lsb | | | | | | | |
| | | | | | | | Dat 1 | Dat 1 | Dat 2 | Dat 2 | Dat 3 | Dat 3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 8 bits | |
| 01 | P | 00 | 00 | x | 0D | 00 | cmd1 | cmd2 | cmd3 | cmd4 | x | x | |

This is an ACK for a CRI command this ACK is sent to the computer by the computer-radio-interface, after executing
a command successfully.

| | | |
|---|---|---|
| P: | Computer address | 00-03 H |
| cmd 1,2: | Received CRI command MSB ok ack. | 00-FF H |

| | |
|---|---|
| cmd 3,4: | Received CRI command LSB ok ack.00-FF H |

| | | |
|---|---|---|
| 1. | 01 60 00 00 0D 00 0C 01 00 00 | OK ack for 0C01 CRI command (SWITCH |
| | | AUDIO OUT TO JACK) |
| | | the computer_radio_interface number is 6. |
| 2. | 01 60 00 00 0D 00 0C 0F 00 00 | OK ack for 0C0F CRI command (CRI reset) |
| | | the computer_radio_interface number is 6. |
| | | This ack is also sent on POWER UP RESET |

UN-MUTE_RADIO

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | -8 bits- | | -8 bits- | | -8 bits- | | CRC |
| | add | A-sb | B-sb | C-sb | msb | lsb | | | | | | | |
| | | | | | | | Dat 1 | Dat 1 | Dat 2 | Dat 2 | Dat 3 | Dat 3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 8 bits | |
| 01 | 00 | 00 | 00 | x | 0C | 03 | x | x | x | x | x | x | |

UN-Mute the radio transmit.
CRI_RESET

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | -8 bits- | | -8 bits- | | -8 bits- | | CRC |
| | add | A-sb | B-sb | C-sb | msb | lsb | | | | | | | |
| | | | | | | | Dat 1 | Dat 1 | Dat 2 | Dat 2 | Dat 3 | Dat 3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 8 bits | |
| 01 | P | 00 | 00 | x | 0C | 0F | x | x | x | x | x | x | |

Perform software reset on the Computer radio interface unit.

| | | |
|---|---|---|
| P: | Computer address | 00-03 H |

Reference is now made to FIG. 8A, which is a simplified flowchart illustration of a preferred method for receiving radio signals, executing commands comprised therein, and sending radio signals, within the toy control device 130 of FIG. 1A. Typically, each message as described above comprises a command, which may include a command to process information also comprised in the message. The method of FIG. 8A preferably comprises the following steps:

A synchronization signal or preamble is detected (step 400). A header is detected (step 403).

A command contained in the signal is received (step 405).

The command contained in the-signal is executed (step 410). Executing the command may be as described above with reference to FIG. 1A.

A signal comprising a command intended for the computer radio interface 110 is sent (step 420).

Reference is now made to FIGS. 8B-8T which, taken together, comprise a simplified flowchart illustration of a preferred implementation of the method of FIG. 8A. The method of FIGS. 8B-8T is self-explanatory.

Reference is now made to FIG. 9A, which is a simplified flowchart illustration of a preferred method for receiving MIDI signals, receiving radio signals, executing commands comprised therein, sending radio signals, and sending MIDI signals, within the computer radio interface 110 of FIG. 1A. Some of the steps of FIG. 9A are identical to steps of FIG. 8A, described above. FIG. 9A also preferably comprises the following steps:

A MIDI command is received from the computer 100 (step 430). The MIDI command may comprise a command intended to be transmitted to the toy control device 130, may comprise an audio in or audio out command, or may comprise a general command.

A MIDI command is sent to the computer 100 (step 440). The MIDI command may comprise a signal received from the toy control device 130, may comprise a response to a MIDI command previously received by the computer radio interface 110 from the computer 100, or may comprise a general command.

The command contained in the MIDI command or in the received signal is executed (step 450). Executing the command may comprise, in the case of a received signal, reporting the command to the computer 100, whereupon the computer 100 may typically carry out any appropriate action under program control as, for example, changing a screen display or taking any other appropriate action in response to the received command. In the case of a MIDI command received from the computer 100, executing the command may comprise transmitting the command to the toy control device 130. Executing a MIDI command may also comprise switching audio output of the computer control device 110 between the secondary audio interface 230 and the radio transceiver 260. Normally the secondary audio interface 230 is directly connected to the audio interface 220 preserving the connection between the computer sound board and the peripheral audio devices such as speakers, microphone and stereo system.

Reference is now made to FIGS. 9B-9N, and additionally reference is made back to FIGS. 8D-8M, all of which, taken together, comprise a simplified flowchart illustration of a preferred implementation of the method of FIG. 9A. The method of FIGS. 9B-9M, taken together with FIGS. 8D-BM, is self-explanatory.

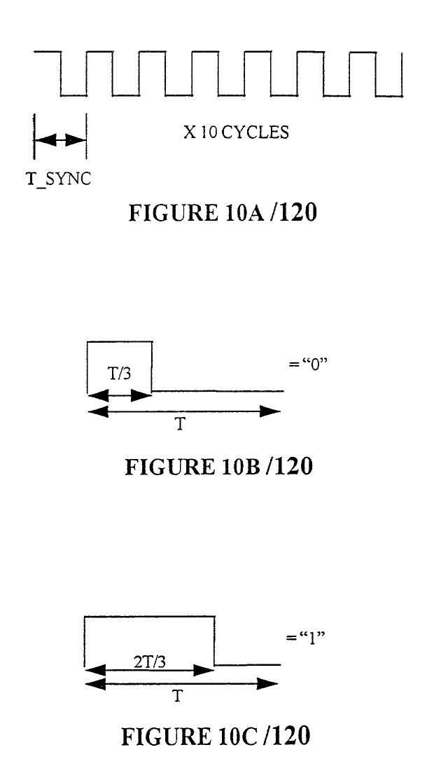

Reference is now additionally made to FIGS. 10A-10C, which are simplified pictorial illustrations of a signal transmitted between the computer radio interface 110 and the toy control device 130 of FIG. 1A. FIG. 10A comprises a synchronization preamble. The duration T_SYNC of the synchronization preamble is preferably 0.500 millisecond, being preferably substantially equally divided into on and off components.

FIG. 10B comprises a signal representing a bit with value 0, while FIG. 10C comprises a signal representing a bit with value 1.

It is appreciated that FIGS. 10B and 10C refer to the case where the apparatus of FIG. 5D is used. In the case of the apparatus of FIG. 5E, functionality corresponding to that depicted in FIGS. 10B and 10C is provided within the apparatus of FIG. 5E.

Preferably, each bit is assigned a predetermined duration T, which is the same for every bit. A frequency modulated carrier is transmitted, using the method of frequency modulation keying as is well known in the art. An “off” signal (typically less than 0.7 Volts) presented at termination 5 of U2 in FIG. 5D causes a transmission at a frequency below the median channel frequency. An “on” signal (typically over 2.3 Volts) presented at pin 5 of U2 in FIG. 5D causes a transmission at a frequency above the median frequency. These signals are received by the corresponding receiver U1. Output signal from pin 6 of U1 is fed to the comparator 280 of FIGS. 4 and 6 that is operative to determine whether the received signal is “off” or “on”, respectively.

It is also possible to use the comparator that is contained within U1 by connecting pin 7 of U1 of FIG. 5D, through pin 6 of the connector J1 of FIG.5D, pin 6 of connector J1 of FIG. 5A, through the jumper to pin 12 of U1 of FIG. 5A.

Preferably, receipt of an on signal or spike of duration less than 0.01 * T is ignored. Receipt of an on signal as shown in FIG. 10B, of duration between 0.01 * T and 0.40 * T is preferably taken to be a bit with value 0. Receipt of an on signal as shown in FIG. 10C, of duration greater than 0.40 * T is preferably taken to be a bit with value 1. Typically, T has a value of 1.0 millisecond.

Furthermore, after receipt of an on signal, the duration of the subsequent off signal is measured. The sum of the durations of the on signal and the off signal must be between 0.90 T and 1.10 T for the bit to be considered valid. Otherwise, the bit is considered invalid and is ignored.

Reference is now made to FIG. 11, which is a simplified flowchart illustration of a method for generating control instructions for the apparatus of FIG. 1A. The method of FIG. 11 preferably includes the following steps:

A toy is selected (step 550). At least one command is selected, preferably from a plurality of commands associated with the selected toy (steps 560-580). Alternatively, a command may be entered by selecting, modifying, and creating a new binary command (step 585).

Typically, selecting a command in steps 560 may include choosing a command and specifying one or more control parameters associated with the command. A control parameter may include, for example, a condition depending on a result of a previous command, the previous command being associated either with the selected toy or with another toy. A control parameter may also include an execution condition governing execution of a command such as, for example: a condition stating that a specified output is to occur based on a status of the toy, that is, if and only if a specified input is received; a condition stating that the command is to be performed at a specified time; a condition stating that performance of the command is to cease at a specified time; a condition comprising a command modifier modifying execution of the command, such as, for example, to terminate execution of the command in a case where execution of the command continues over a period of time; a condition dependent on the occurrence of a future event; or another condition.

The command may comprise a command to cancel a previous command.

The output of the method of FIG. 11 typically comprises one or more control instructions implementing the specified command, generated in step 590. Typically, the one or more control instructions are comprised in a command file. Typically, the command file is called from a driver program which typically determines which command is to be executed at a given point in time and then calls the command file associated with the given command.

Preferably, a user of the method of FIG. 11 performs steps 550 and 560 using a computer having a graphical user interface. Reference is now made to FIGS. 12A-12C, which are pictorial illustrations of a preferred embodiment of a graphical user interface implementation of the method of FIG. 11.

FIG. 12A comprises a toy selection area 600, comprising a plurality of toy selection icons 610, each depicting a toy. The user of the graphical user interface of FIGS. 12A-12C typically selects one of the toy selection icons 610, indicating that a command is to be specified for the selected toy.

FIG. 12A also typically comprises action buttons 620, typically comprising one or more of the following:

a button allowing the user, typically an expert user, to enter a direct binary command implementing an advanced or particularly complex command not otherwise available through the graphical user interface of FIGS. 12A-12C;

a button allowing the user to install a new toy, thus adding a new toy selection icon 610; and

a button allowing the user to exit the graphical user interface of FIGS. 12A-12C.

FIG. 12B depicts a command generator screen typically displayed after the user has selected one of the toy selection icons 610 of FIG. 12A. FIG. 12B comprises an animation area 630, preferably comprising a depiction of the selected toy selection icon 610, and a text area 635 comprising text describing the selected toy.

FIG. 12B also comprises a plurality of command category buttons 640, each of which allow the user to select a category of commands such as, for example: output commands; input commands; audio in commands; audio out commands; and general commands.

FIG. 12B also comprises a cancel button 645 to cancel command selection and return to the screen of FIG. 12A.

FIG. 12C comprises a command selection area 650, allowing the user to specify a specific command. A wide variety of commands may be specified, and the commands shown in FIG. 12C are shown by way of example only.

FIG. 12C also comprises a file name area 655, in which the user may specify the name of the file which is to receive the generated control instructions. FIG. 12C also comprises a cancel button 645, similar to the cancel button 645 of FIG. 12B. FIG. 12C also comprises a make button 660. When the user actuates the make button 660, the control instruction generator of FIG. 11 generates control instructions implementing the chosen command for the chosen toy, and writes the control instructions to the specified file.

FIG. 12C also comprises a parameter selection area 665, in which the user may specify a parameter associated with the chosen command.

Reference is now made to Appendix A, which is a computer listing of a preferred software implementation of the method of FIGS. 8A-8T.

Appendix A is an INTEL hex format file. The data bytes start from character number 9 in each line. Each byte is represented by 2 characters. The last byte (2 characters) in each line, should be ignored.

For example, for a sample line:

The original line reads—:07000000020100020320329F

The data bytes—02010002032032 (02,01,00,02,03, 20,32)

Starting address of the data bytes—

0000 (00,00)

Appendix A may be programmed into the memory of microcontroller 250 of FIG. 6.

Appendix B is a computer listing of a preferred software implementation of the method of FIGS. 9A-9N, together with the method of FIGS. 8D-8M.

Appendix B is an INTEL hex format file. The data bytes start from character number 9 in each line. Each byte is represented by 2 characters. The last byte (2 characters) in each line, should be ignored.

For example, for a sample line:

The original line reads—:070000000201000205A73216

The data bytes—0201000205A732 (02,01,00,02,05, A7,32)

Starting address of the data bytes—

0000 (00,00)

Appendix B may be programmed into the memory of microcontroller 250 of FIG. 4.

Appendix C is a computer listing of a preferred software implementation of an example of a computer game for use in the computer 100 of FIG. 1.

Appendix D is a computer listing of a preferred software implementation of the method of FIGS. 11 and FIGS. 12A-12C.

For Appendices C and D, these programs were developed using VISUAL BASIC. To run the programs you need to install the VISUAL BASIC environment first. The application needs a Visual Basic custom control for performing MIDI I/O similar to the one called MIDIVBX.VBX. VISUAL BASIC is manufactured by Microsoft Corporation, One Microsoft Way, Redmond, Wash. 98052-6399, USA. MIDIVBX.VBX is available from Wayne Radinsky, electronic mail address a-wayner@microsoft.com.

The steps for programming the microcontrollers of the present invention include the use of a universal programmer, such as the Universal Programmer, type EXPRO 60/80, manufactured by Sunshine Electronics Co. Ltd., Taipei, Japan.

The method for programming the microcontrollers with the data of Appendices A and B, includes the following steps:

1. Run the program EXPRO.EXE, which is provided with the EXPRO 60/80″.

2. Choose from the main menu the EDIT/VIEW option.

3. Choose the EDIT BUFFER option.

4. Enter the string E 0000.

5. Enter the relevant data (given in Appendices A or B), byte after byte, starting from the address 0000. In each line there is a new starting address for each data byte which appears in this line.

6. Press ESC.

7. Enter the letter Q.

8. Choose from the main menu the DEVICE option.

9. Choose the MPU/MCU option.

10. Choose the INTEL option.

11. Choose the 87C51.

12. Choose from the main menu the RUNFUNC option.

13. Choose the PROGRAM option.

14. Place the 87C51 chip in the programmer's socket.

15. Enter Y and wait until the OK message.

16. The chip is now ready to be installed in the board.

The method for creating the relevant files for the computer 100, with the data of Appendices C and D, includes using a HEX EDITOR which is able to edit DOS formatted files. A typical HEX and ASCII editor is manufactured by Martin Doppelbauer, Am Spoerkel 17, 44227 Dortmund, Germany, UET401 at electronic mail address hrz.unidozr.uni-dortmund.de.

The steps necessary for creating the files by means of a HEX editor, such as by the Martin Doppelbauer editor include the following:

1. Copy any DOS file to a new file with the desired name and with the extension .EXE. (For example, write COPY AUTOEXEC.BAT TOY1.EXE).

2. Run the program ME.EXE.

3. From the main menu press the letter L(load file).

4. Write the main menu of the new file (for example TOY1.EXE).

5. From the main menu, press the letter (insert).

6. Enter the relevant data (written in Appendices C or D), byte after byte, starting from the address 0000.

7. Press ESC.

8. From the main menu, enter the letter W(write file).

9. Press the RETURN key and exit from the editor by pressing the letter Q.

The above-described embodiment of FIG. 1C includes a description of a preferred set of predefined messages including a category termed “General commands”. Other General Commands are defined by the following description:

MULTIPORT COMMANDS
AVAILABILITY_INTERROGATION_COMMAND

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | -8 bits- | | -8 bits- | | -8 bits- | | CRC |
| | add | A-sb | B-sb | C-sb | msb | lsb | | | | | | | |
| | | | | | | | Dat 1 | Dat 1 | Dat 2 | Dat 2 | Dat 3 | Dat 3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 8 bits | |
| 01 | P | 00 | 00 | A | 04 | 05 | 00 | 00 | 00 | 00 | x | x | |

A computer transmits this command to verify that the radio channel is vacant. If another computer is already
using this channel it will respond with
the Availability Response Command. If no response is received within 250 msec the channel is deemed vacant.

| | | |
|---|---|---|
| P: | Computer address | 00-03 H |
| A: | unit address- | 00-FF H |

AVAILABILITY_RESPONSE_COMMAND

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | -8 bits- | | -8 bits- | | -8 bits- | | CRC |
| | add | A-sb | B-sb | C-sb | msb | lsb | | | | | | | |
| | | | | | | | Dat 1 | Dat 1 | Dat 2 | Dat 2 | Dat 3 | Dat 3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 8 bits | |
| 01 | P | 00 | 00 | A | 04 | 06 | 00 | 00 | 00 | 00 | x | x | |

A computer tramsits this command in response to an Availability Interrogation Command to announce that the
radio channel is in use.

| | | |
|---|---|---|
| P: | Computer address | 00-03 H |
| A: | unit address- | 00-FF H |

TOY_AVAILABILITY_COMMAND

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | -8 bits- | | -8 bits- | | -8 bits- | | CRC |
| | add | A-sb | B-sb | C-sb | msb | lsb | | | | | | | |
| | | | | | | | Dat 1 | Dat 1 | Dat 2 | Dat 2 | Dat 3 | Dat 3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 8 bits | |
| 01 | P | 00 | 00 | A | 04 | 07 | 00 | 00 | 00 | 00 | x | x | |

A Toy transmits this command to declare its existence and receive in response a Channel Pair Selection Command
designating the computer that
will control it and the radio channels to use.

| | | |
|---|---|---|
| P: | Computer address | 00-03 H |
| A: | unit address- | 00-FF H |

CHANNEL_PAIR_SELECTION₋COMMAND

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | -8 bits- | | -8 bits- | | -8 bits- | | CRC |
| | add | A-sb | B-sb | C-sb | msb | lsb | | | | | | | |
| | | | | | | | Dat 1 | Dat 1 | Dat 2 | Dat 2 | Dat 3 | Dat 3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 8 bits | |
| 01 | P | 00 | 00 | A | 04 | 08 | CH1 | CH2 | 00 | 00 | x | x | |

A computer transmits this command in response to a Toy Availability Command to inform the toy the radio
channels to be used.

| | | |
|---|---|---|
| P: | Computer address | 00-03 H |
| A: | unit address- | 00-FF H |
| CH1: | Toy transmit channel | 0-F H |
| CH1: | Toy receive channel | 0-F H |

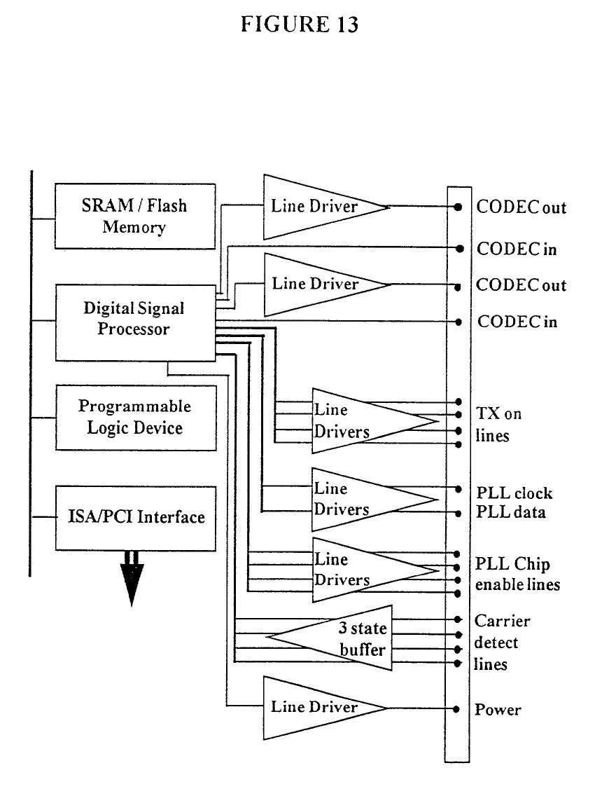

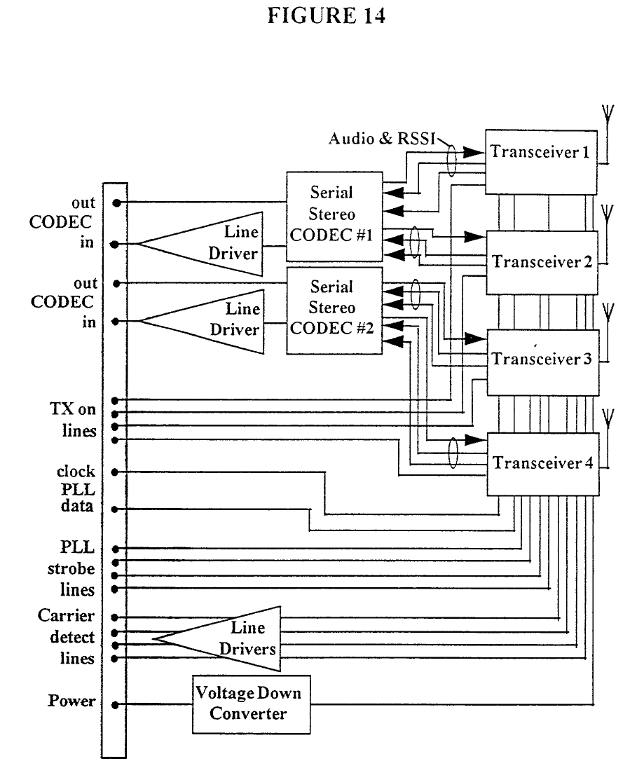

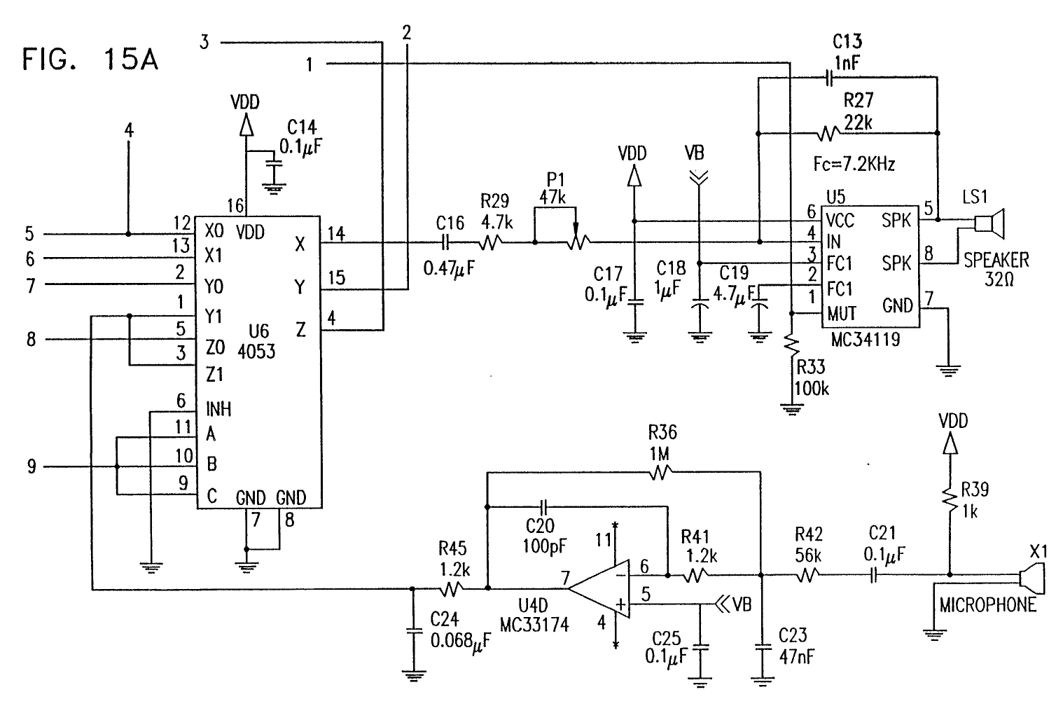

In FIGS. 13 and 14 there are illustrated block diagrams of multiport multi-channel implementation of the computer radio interface 110 of FIG. 1A. FIG. 13 illustrates the processing sub-unit of the computer interface that is implemented as an add-in board installed inside a PC. FIG. 14 is the RF transceiver which is a device external to the computer and connects to the processing subunit by means of a cable. In the present application of the RF unit there are 4 transceivers each capable of utilizing two radio channels simultaneously.

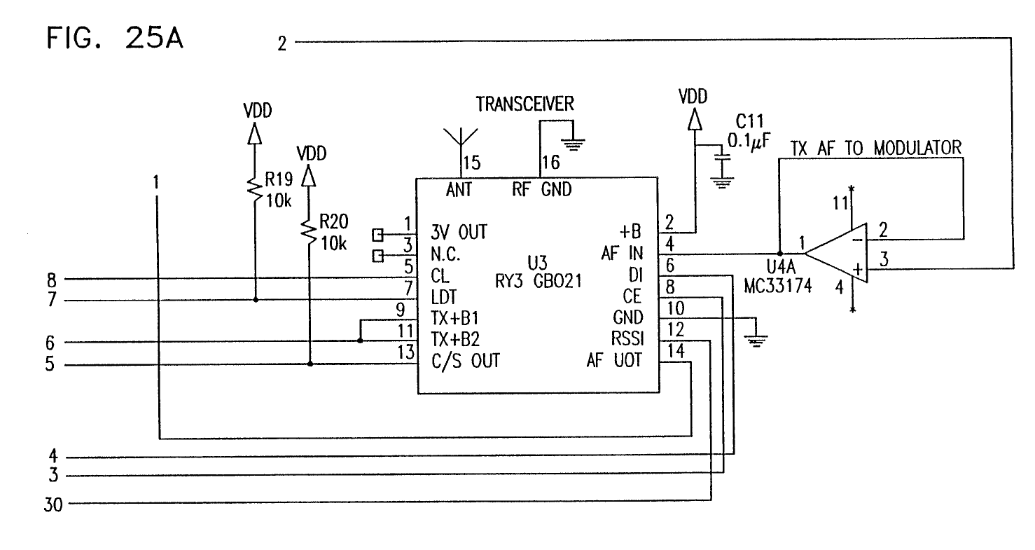

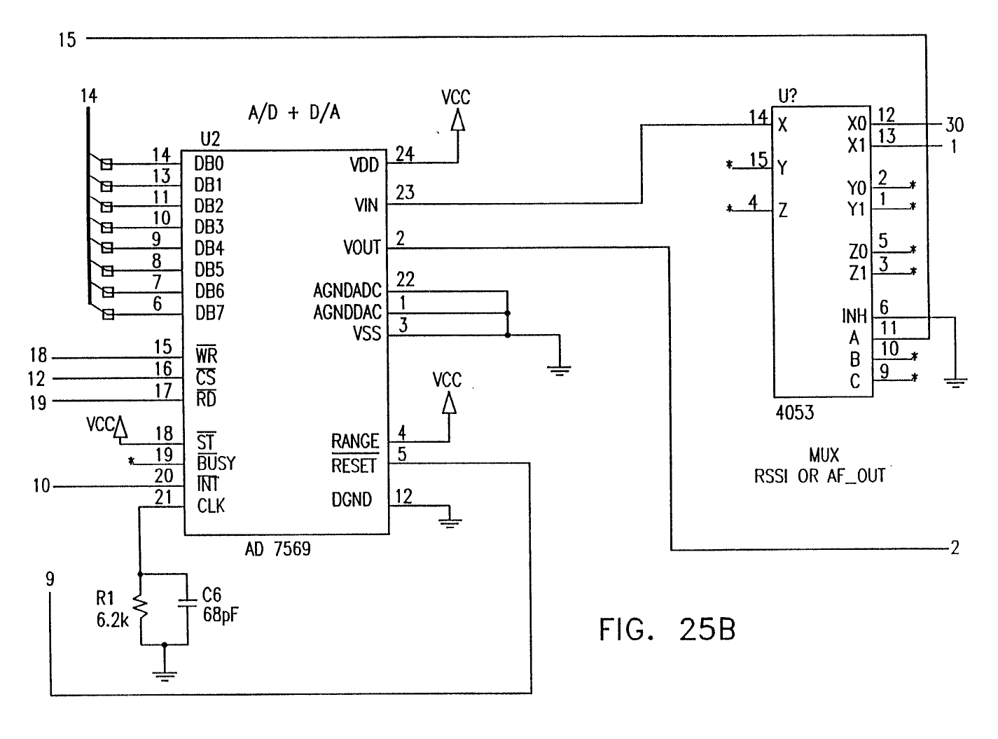

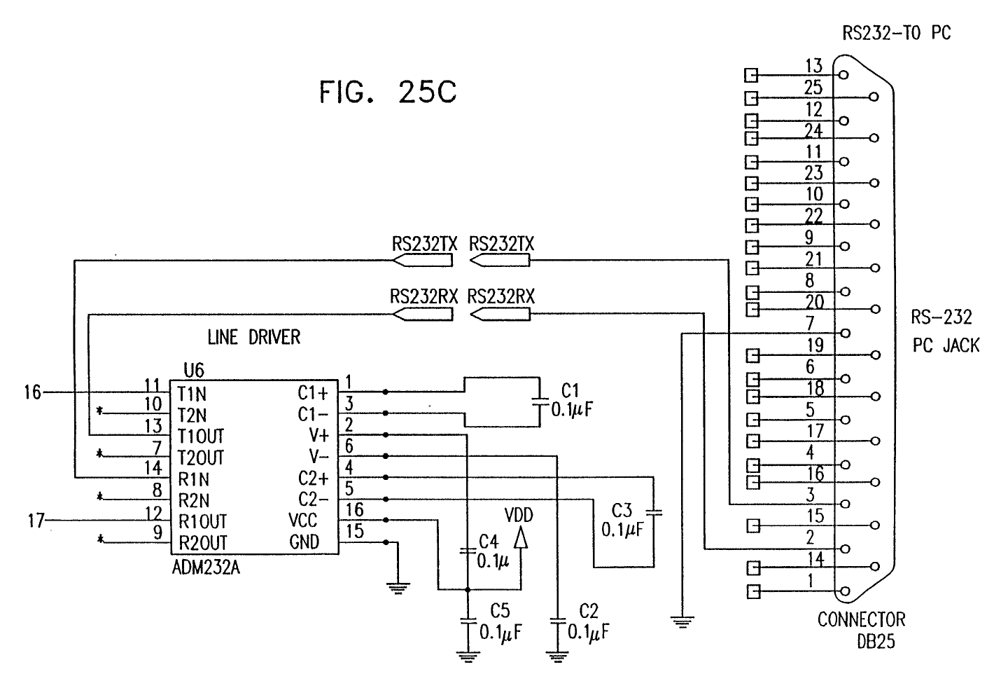

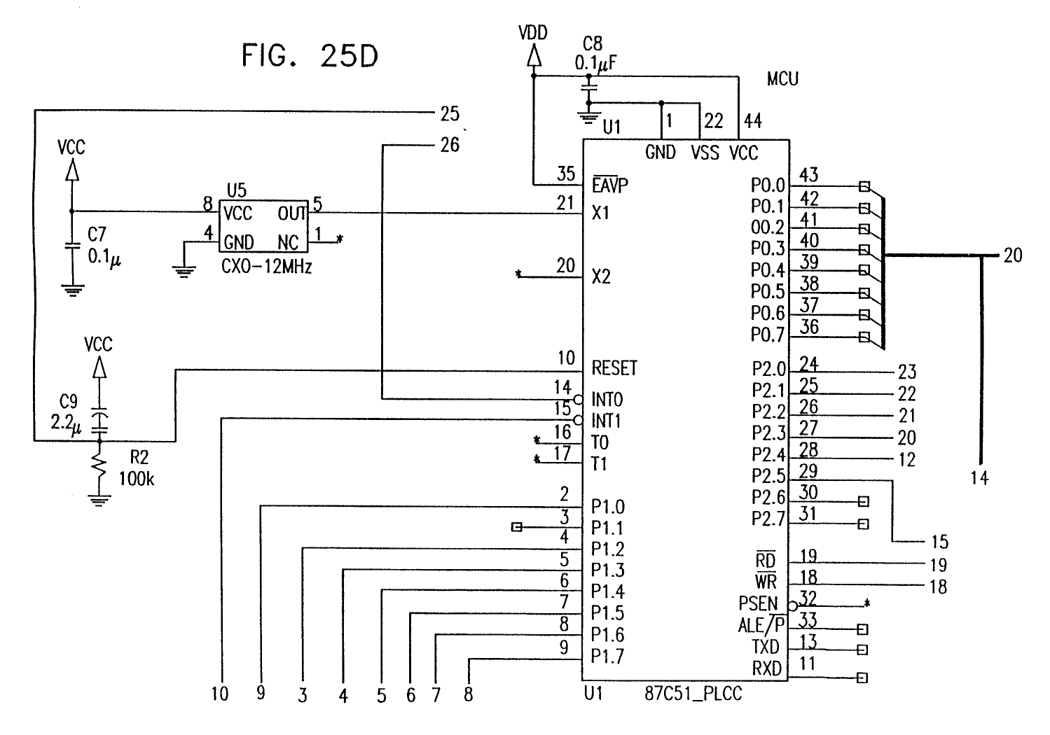

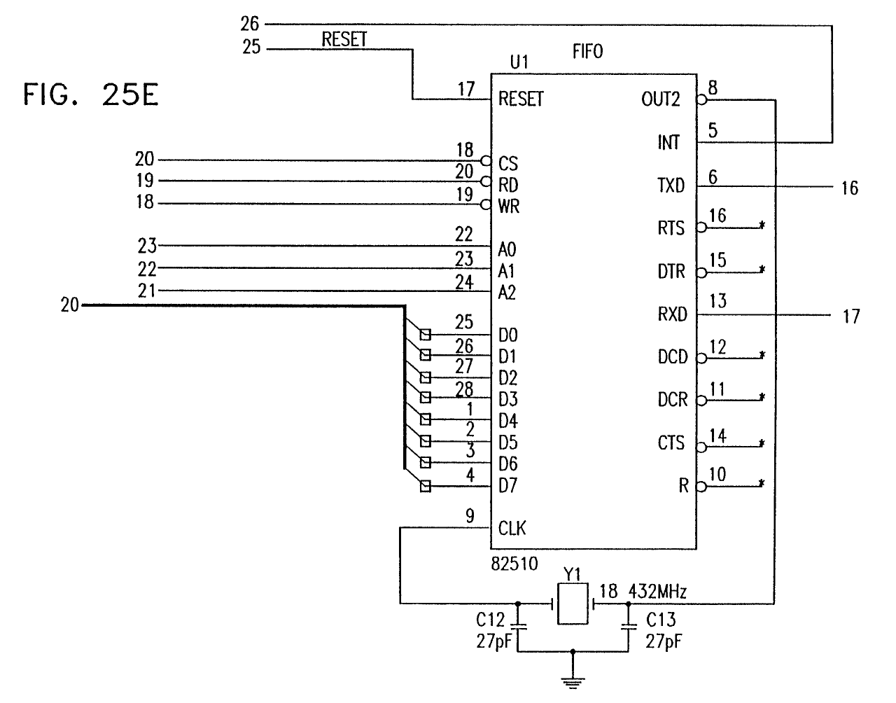

Referring briefly to FIG. 3, it is appreciated that, optionally, both sound and control commands may be transmitted via the MIDI connector 210 rather than transmitting sound commands via the analog connector 220. It is additionally appreciated that the functions of the interfaces 210 and 220 between the computer radio interface 110 and the sound card 190 may, alternatively, be implemented as connections between the computer radio interface 110 to the serial and/or parallel ports of the computer 100, as shown in FIGS. 25A-25F.

If it is desired to provide full duplex communication, each transceiver 260 which forms part of the computer radio interface 110 of FIG. 1A preferably is operative to transmit on a first channel pair and to receive on a different, second channel pair. The transceiver 260 (FIG. 4) which forms part of the toy control device 130 of FIG. 1A preferably is operative to transmit on the second channel and to receive on the first channel.

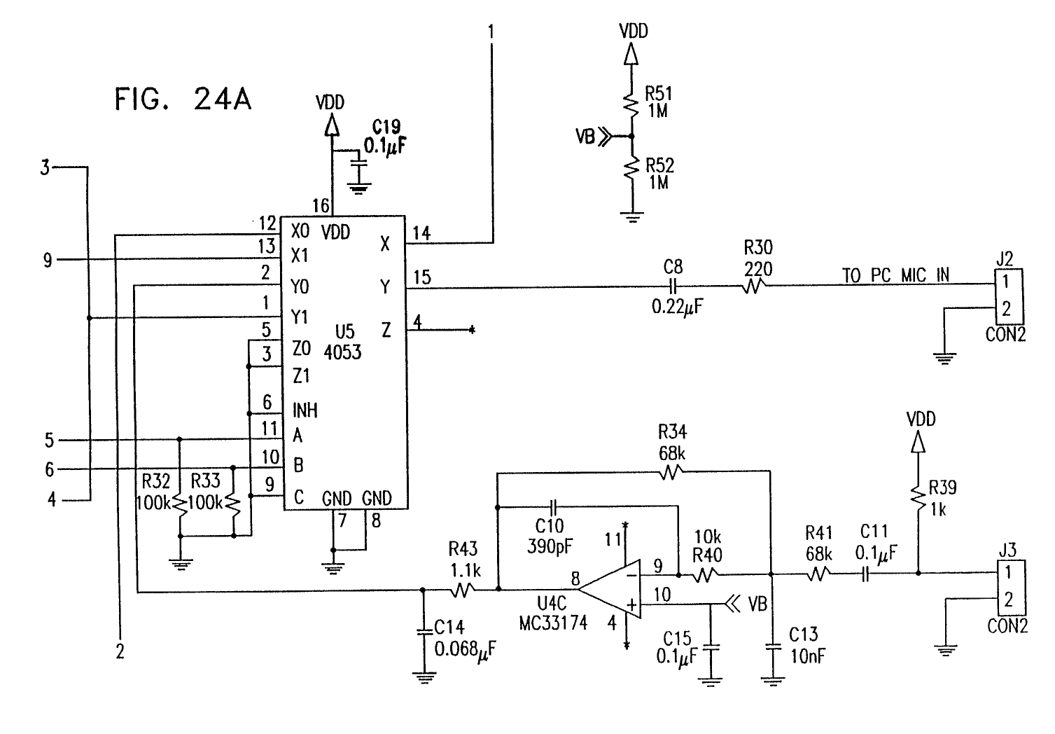

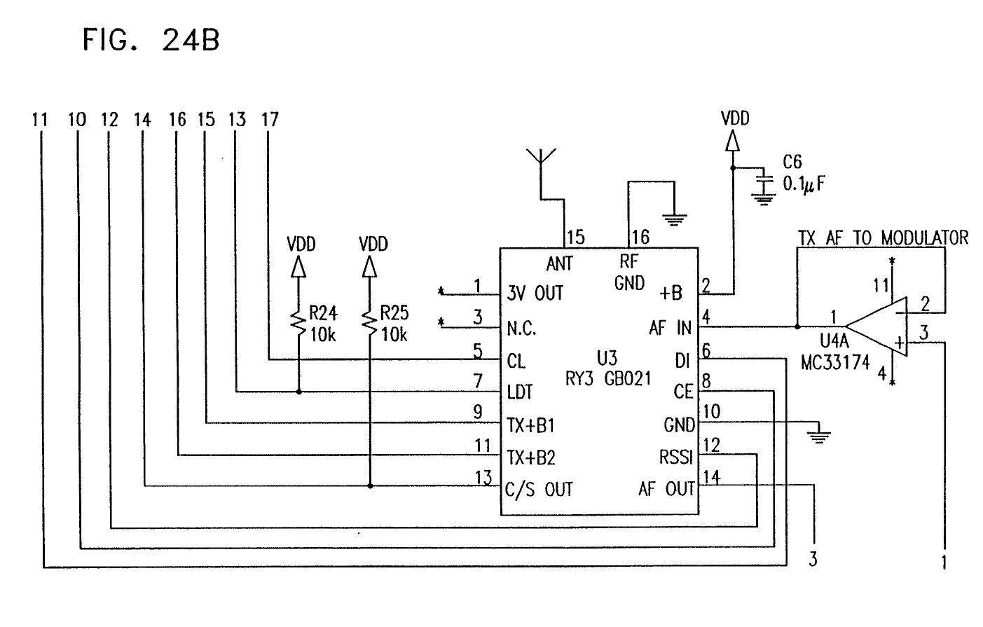

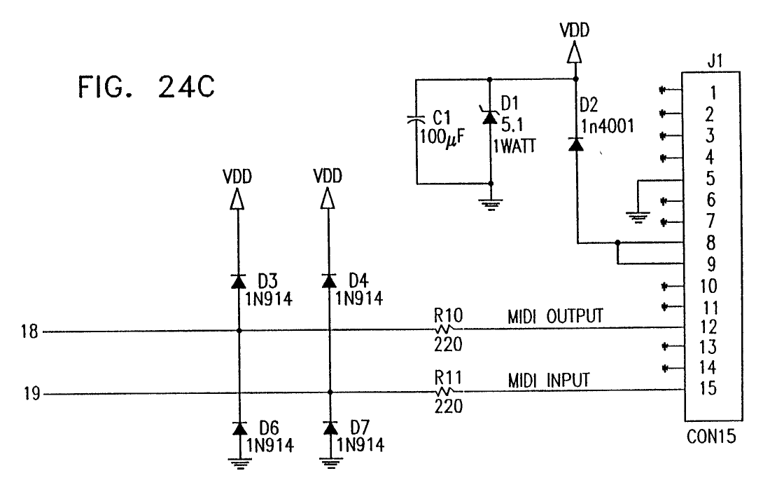

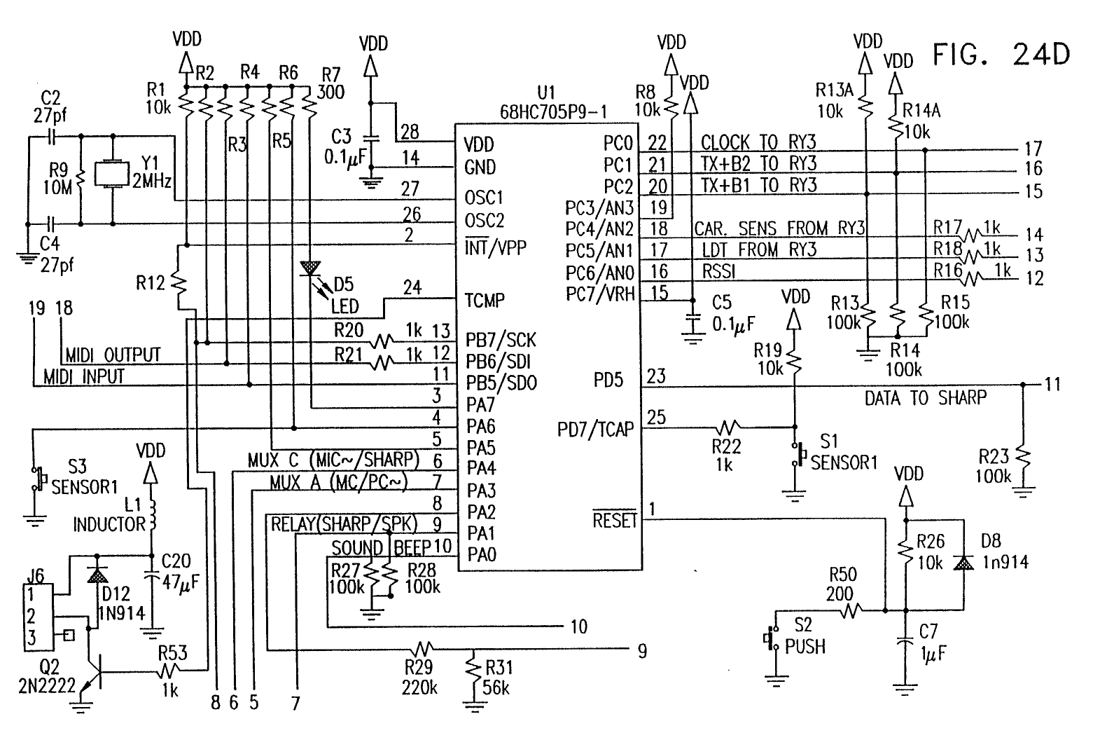

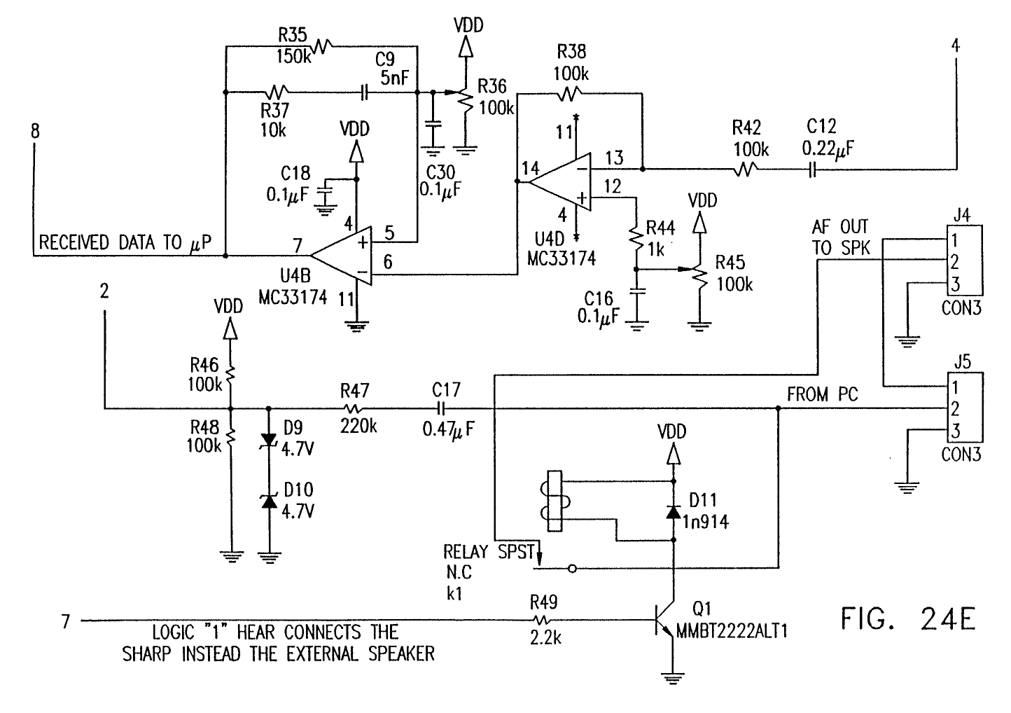

Any suitable technology may be employed to define at least two channel pairs such as narrow band technology or spread spectrum technologies such as frequency hopping technology or direct sequence technology, as illustrated in FIGS. 15A-15E, showing a Multi-Channel Computer Radio Interface, and in FIGS. 24A-24E showing a Multi-Channel Toy Control Device.

Appendices E-H, taken together, are computer listings from which a first, DLL-compatible, functions library may be constructed. The DLL-compatible functions library may be subsequently used by a suitable computer system such as an IBM PC to generate a variety of games for any of the computer control systems shown and described herein. Alternatively, games may be generated using the applications generator of FIGS. 11-12C.

To generate a DLL (dynamic loading and linking ) function library based on Appendices E-H, the following operations are performed:

1) Open Visual C++ 4.0

2) Go to File Menu

3) Choose New from File Menu

4) Choose Project Workspace

5) Choose Dynamic-Link Library

6) The Project Name is : DLL32.MDP

7) Press Create button

8) Go to File Menu

9) Choose New from File Menu

10) Choose Text File

11) Now write the Source

12) Write on the current page a file containing the contents of Appendix E

13) Press the mouse right button and choose: Insert File Into Project

14) Click on DLL32 project

15) On the save dialog write CREATOR.C

16) Press the OK button

17) Go to File Menu

18) Choose New from File Menu

19) Choose Text File

20) Write on this page a file containing the contents of Appendix F;

21) Go to File Menu

22) Press Save

23) On the save dialog write CRMIDI.H

24) Press the OK button

25) Go to File Menu

26) Choose New from File Menu

27) Choose Text File

28) Write on this page a file containing the contents of Appendix

29) Go to File Menu

30) Press Save

31) On the save dialog write a file CREATOR.H

32) Press the OK button

33) Go to File Menu

34) Choose New from File Menu

35) Choose Text File

36) Write on this page a file containing the contents of Appendix H;

37) Press the mouse right button and choose: Insert File Into Project

38) Click on DLL32 project

39) On the save dialog write CREATOR.DEF

40) Press the OK button

41) Go to Insert Menu

42) Press File Into Project . . .

43) On the List Files of Type: Choose Library Files (*.lib)

44) Go to the Visual C++ library directory and choose WINMM.LIB

45) Press the OK button

46) Go to the Build menu

47) Press Rebuild ALL

A description of the commands included in the DLL function library based on Appendices E-H now follows:

A. MIDI input functions 1-2:

1. Open MIDI input device

Syntax: long MIDIInOpen(long Device)

This function opens the MIDI device for input.

Return 0 for success, −1 otherwise.

Delphi Example:

Device:=0;

if MIDIInOpen(Device)<>0 Then

MessageDlg(‘Error opening MIDI input device’, mtError, mbOk, 0);

2. Reset MIDI input device

Syntax: long MIDIInReset(void)

this function resets MIDI input device.

Return 0 for success, −1 otherwise.

Delphi Example:

if MIDIInRest<>0 Then

MessageDlg(‘Error reseting MIDI input device’, mtError, mbOk, 0);

B. MIDI output functions 3-6:

3. Close MIDI input device

Syntax: long MIDIInClose(void)

This function close MIDI input device.

Return 0 for success, −1 otherwise.

Delphi Example:

if MIDIInClose<>0 Then

MessageDlg(‘Error closing MIDI input device’, mtError, mbOk, 0);

4. Open MIDI output device

Syntax: long MIDIOutOpen(long Device)

This function opens MIDI output device.

Return 0 if success, −1 otherwise.

Delphi Example:

Device:=0;

if MIDIOutOpen(Device)<>0 Then

MessageDlg(‘Error opening MIDI output device’, mtError, mbOk, 0);

5. Reset MIDI Output device

Syntax: long MIDIOutReset(void)

This function resets MIDI output device.

Return 0 if success, −1 otherwise.

Delphi Example:

if MIDIOutReset<>0 Then

MessageDlg(‘Error reseting MIDI output device’, mtError, mbOk, 0);

6. Close MIDI output device

Syntax: long MIDIOutClose(void)

This function close MIDI output device.

Return 0 if success, −1 otherwise.

Delphi Example:

Device:=0;

if MIDIOutClose<>0 Then

MessageDlg(‘Error opening MIDI output device’, mtError, mbOk, 0);

C. General functions 7-10:

7. Send Data

Syntax: long SendData(long Data

This function sends 4 bytes to toy card.

Currently used to send 144 for init toy card.

Return 0 if succesfull, −1 otherwise.

Delphi Example:

If SendData(144)<>0 Then

MessageDlg(‘Error sending data to toy’, mtError, mbOk, 0);

8. Send Message

Syntax: long SendMessage(char *Mess)

This function sends string to toy card.

Return 1 if successful, or errorcode otherwise.

Delphi Example:

Mess:=‘01 00 00 00 00 00 05 00 00 00 01 00 03 00 01 00 00 00’;

If SendMessage(Mess)<>1 Then

MessageDlg(‘Error opening MIDI output device’, mtError, mbOk, 0);

9. Check message

Syntax: long CheckMessage(void)

This function returns 0 if no message found from toy card.

Delphi Example:

If CheckMessage Then

Mess:=GetMessage;

10. Get Message

Syntax: char * GetMessage(char *Mess)

This function returns 20 chars toy message if present, or “Time Out” otherwise.

Delphi Example:

If GetMessage =“Time Out” Then

MessageDlg(‘No message received’, mtError, mbOk, 0);

D. Toy control functions 11-16:

11. Get Toy Number

Syntax: char *GetToyNumber(void)

This function returns Toy Number of last receiving message, or “00 00 00 00” if no message was received.

12. Get Sensor Number

Syntax: long GetSensorNumber(void)

This function returns Sensor Number of last receiving message, or 255 if no message was received.

13. Toy Reset

Syntax: long ToyReset(char *ToyNumber)

This function sends a reset string to toy.

Return 0 if successful, or −1 otherwise.

14. Toy Transceive

Syntax: char *ToyTranceive(char *ToyNumber,char *Mess)

This function sends message to toy and waits 3 sec to acknowledge.

Return “Ack. Ok” if received, or “Time Out” if not.

15. Prepare Toy Talk

Syntax: char *PrepareToyTalk(char *ToyNumber, char *WaveFile)

This function prepares toy card to generate sound using toy speaker.

After calling this function, WaveFile may be played and heard at toy speaker.

Return “Ack. Ok” if successful, or “Time Out” otherwise.

16. Go To Sleep Mode

Syntax: char *GoSleep(char *ToyNumber)

This function sends to toy the sleep command.

Return “Ack. Ok” if successful, or “Time Out” otherwise.

Appendices I-O, taken together, are computer listings of a second functions library which may be used to generate a variety of games for any of the computer control systems shown and described herein in conjunction with a Director 5.0 software package, marketed by Macromedia Inc., 600 Townsend St., San Francisco, Calif., 94103.

To generate an XObject function library based on Appendices I-O, the following operations are performed:

1) Create a new directory : C:\XOBJECT\ by writing (MD C:\XOBJECT\)

2) Open Visual C++ 1.5

3) On the File menu choose NEW

4) Generate a file which contains the contents of Appendix I;

5) Choose Save As from the File Menu

6) Give the file generated in step (4) a name by punching C:\XOBJECT\CREATOR.MAK

7) Press the OK button

8) On the File menu choose NEW

9) Generate a file which contains the contents of Appendix J;

10) On the File menu choose Save As.

11) In the File Name: dialog, write C:\XOBJECT\CREATOR.C

12) Press the OK button

13) On the File menu choose NEW

14) Generate a file which contains the contents of Appendix K;

15) On the File menu choose Save As.

16) In the File Name: dialog write C:\XOBJECT\CREATOR.H

17) Press the OK button

18) On the File menu choose NEW

19) Generate a file which contains the contents of Appendix L;

20) On the File menu choose Save As.

21) In the File Name: dialog write C:\XOBJECT\CRMIDI.H

22) Press the OK button

23) On the File menu choose NEW

24) Generate a file which contains the contents of Appendix M;

25) On the File menu choose Save As.

26) In the File Name: dialog write C:\XOBJECT\XOBJECT\.H

27) Press the OK button

28) On the File menu choose NEW

29) Generate a file which contains the contents of Appendix N;

30) On the File menu choose Save As.

31) In the File Name: dialog write C:\XOBJECT\CREATOR.DEF

32) Press the OK button

33) On the File menu choose NEW

34) Generate a file which contains the contents of Appendix O;

35) On the File menu choose Save As.

36) In the File Name: dialog write C:\XOBJECT\CREATOR.RC

37) Press the OK button

38) On the Project Menu choose Open 39) In the File Name dialog write C:\XOBJECT\CREATOR.MAK40) Press Rebuild All from the Project Menu

A description of the commands included in the XObject function library based on Appendices I-O now follows:

A. MIDI input functions 1-3:

1. Open MIDI input device

Syntax: long MIDIInOpen(long Device)

This function opens the MIDIn device for input.

Return 0 for success, −1 otherwise.

Delphi Example:

Device:=0;

if MIDIInOpen(Device)<>0 Then

MessageDlg(‘Error opening MIDI input device’, mtError, mbOk, 0);

2. Reset MIDI input device

Syntax: long MIDIInReset(void)

This function resets MIDI input device.

Return 0 for success, −1 otherwise.

Delphi Example:

if MIDIInRest<>0 Then

MessageDlg(‘Error reseting MIDI input device’, mtError, mbOk, 0);

3. Close MIDI input device

Syntax: long MIDIInclose(void)

This function turns off MIDI input device.

Return 0 for success, −1 otherwise.

Delphi Example:

if MIDInClose<>0 Then

MessageDlg(‘Error closing MIDI input device’, mtError, mbOk, 0);

B. MIDI output functions 4-6:

4. Open MIDI output device

Syntax: long MIDIOutOpen(long Device)

This function opens MIDI output device.

Return 0 if success, −1 otherwise.

Delphi Example:

Device:=0;

if MIDIOutOpen(Device)<>0 Then

MessageDlg(‘Error opening MIDI output device’, mtError, mbOk, 0);

5. Reset MIDI Output device

Syntax: long MIDIOutReset(void)

This function resets MIDI output device.

Return 0 if success, −1 otherwise.

Delphi Example:

if MIDIOutReset<>0 Then

MessageDlg(‘Error reseting MIDI output device’, mtError, mbOk, 0);

6. Close MIDI output device

Syntax: long MIDIOutClose(void)

This function close MIDI output device.

Return 0 if success, −1 otherwise.

Delphi Example:

Device:=0;

if MIDIOutClose<>0 Then

MessageDlg(‘Error opening MIDI output device’, mtError, mbOk, 0);

C. General functions 7-11:

7. New

Syntax: Creator (mNew)

This function creates a new instance of the XObject

The result is 1 if successful, or error code otherwise.

### EXAMPLE

openxlib “Creator.Dll”

Creator(mNew)

. . .

Creator(mDispose)

See also: Dispose

8. Dispose

Syntax: Creator(mNew)

This function disposes of XObject instance.

The result is1 if successful, or error code otherwise.

### EXAMPLE

openxlib “Creator.Dll”

Creator (mNew)

. . .

Creator (mDispose)

See also: New

9. Send Message

Syntax: long SendMessage(char *Mess)

This function sends string to toy card.

Return 1 if successful, or error code otherwise.

Delphi Example:

Mess:=‘00 01 00 00 00 00 00 05 00 00 01 00 03 00 01 00 00 00’;

If SendMessage(Mess)<>1 Then

MessageDlg(‘Error opening MIDI output device’, mtError, mbOk, 0);

10. Check message

Syntax: long CheckMessage(void)

This function returns 0 if no message found from toy card.

Delphi Example:

If CheckMessage Then

Mess:=GetMessage;

11. Get Toy Message

Syntax: GetToyMessage

This function receives message from toy.

The result is a message.

If during 3 sec there is no message, the result is “Time Out”.

### EXAMPLE

set message=GetToyMessage

If message=“Time Out” Then

put “No message receiving”

End If

See also: Check for Message

D. Toy control functions 12-17:

12. Get Toy Number

Syntax: char * GetToyNumber(void)

This function returns Toy Number of last receiving message, or “00 00 00 00” if no message was received.

13. Get Sensor Number

Syntax: long GetSensorNumber(void)

This function returns Sensor Number of last receiving message, or 255 if no message was received.

14. Toy Reset

Syntax: long ToyReset(char *ToyNumber)

This function sends a reset string to toy.

Return 0 if successful, or −1 otherwise.

15. Toy Tranceive

Syntax: char *ToyTranceive(char *ToyNumber,char *Mess)

This function sends to toy message and waits 3 sec to acknowledge.

Return “Ack. Ok” if received, or “Time Out” if not.

16. Prepare Toy Talk

Syntax: char *PrepareToyTalk(char *ToyNumber, char *WaveFile)

This function prepares toy card to generate sound using from toy speaker.

After calling this function, WaveFile may be played and heard at toy speaker.

Return “Ack. Ok” if successful, or “Time Out” otherwise.

17. Go To Sleep Mode

Syntax: char *GoSleep(char *ToyNumber)

This function sends to toy the sleep command.

Return “Ack. Ok” if successful, or “Time Out” otherwise.

To use the XObject function library in conjunction with the Director, the following method may be employed:

1) Open Director Version 5.0 program

2) From File Menu, choose New

3) Press the Movie Option

4) Go to Windows menu and press Cast

5) Go to the first Script on the cast

6) On the Window menu choose Script

7) Write the script of the desired game.

8) Repeat from step 5 until all desired script(s) have been written. Press (Ctrl+Alt+P) to run the Application

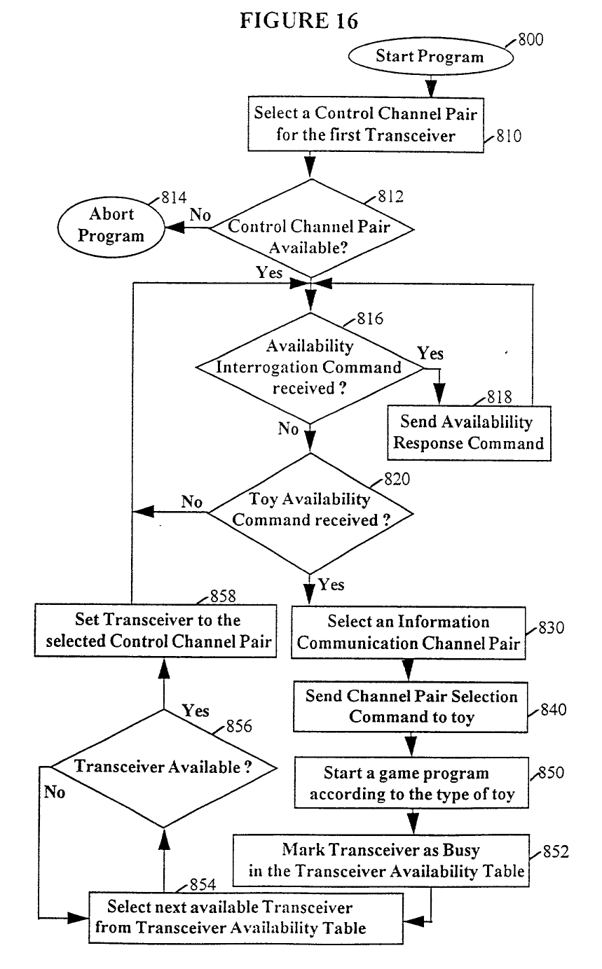

Reference is now made to FIG. 16 which is a simplified flowchart illustration of a preferred method of operation of a computer radio interface (CRI) 110 operative to service an individual computer 100 of FIG. 1A without interfering with other computers or being interfered with by the other computers, each of which is similarly serviced by a similar CRI. Typically, the method of FIG. 16 is implemented in software on the computer 100 of FIG. 1A.

The CRI includes a conventional radio transceiver (260 of FIG. 4) which may, for example, comprise an RY3 GB021 having 40 channels which are divided into 20 pairs of channels. Typically, 16 of the channel pairs are assigned to information communication and the remaining 4 channel pairs are designated as control channels.

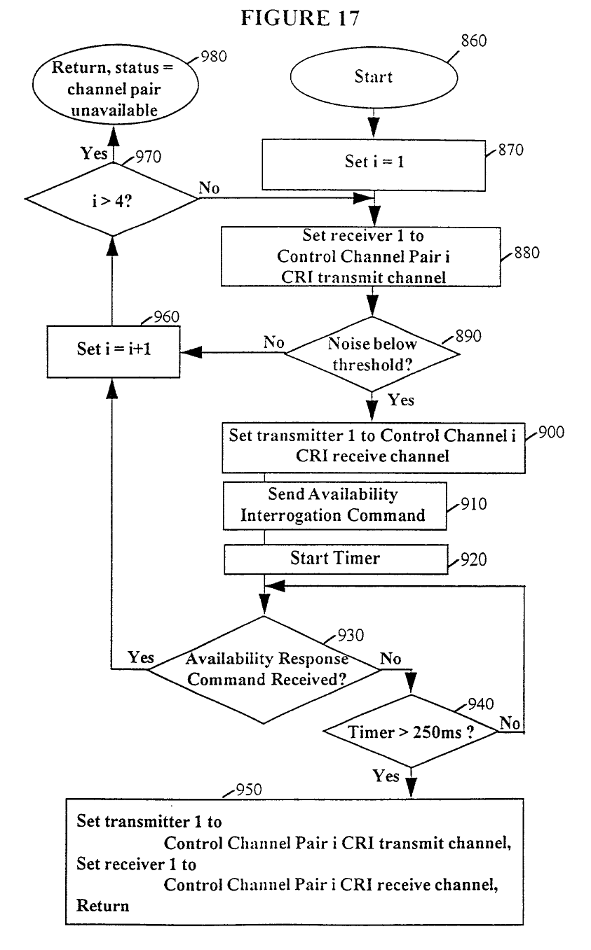

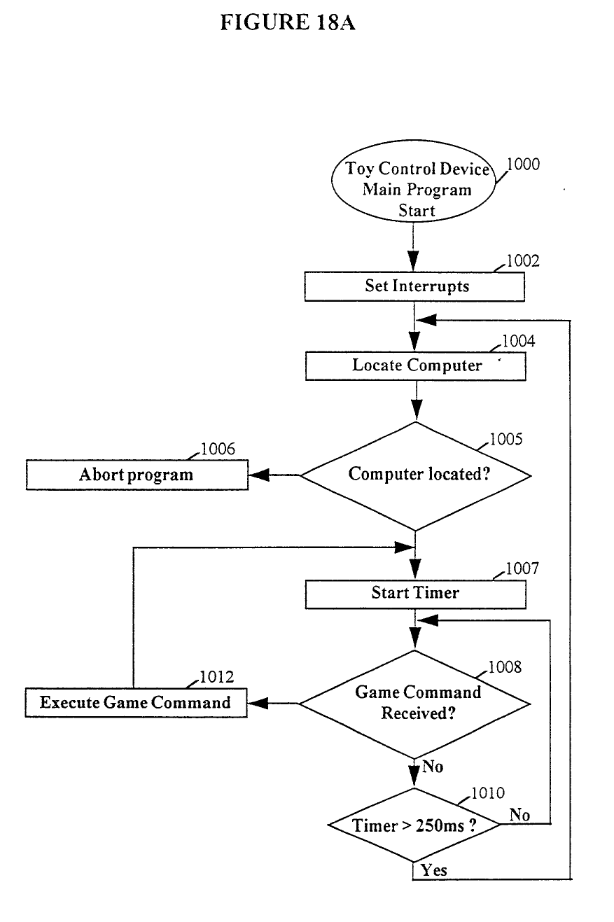

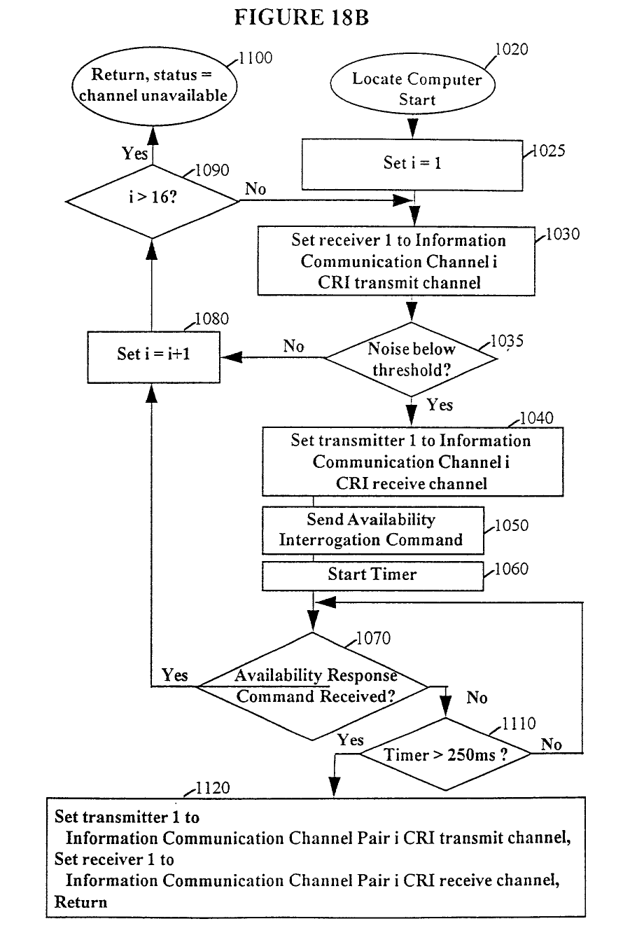

In the method of FIG. 16, one of the 4 control channel pairs is selected by the radio interface (step 810) as described in detail below in FIG. 17. The selected control channel pair i is monitored by a first transceiver (step 820) to detect the appearance of a new toy which is signalled by arrival of a toy availability command from the new toy (step 816). When the new toy is detected, an information communication channel pair is selected (step 830) from among the 16 such channel pairs provided over which game program information will be transmitted to the new toy. A preferred method for implementing step 830 is illustrated in self-explanatory flowchart FIG. 18A. The “Locate Computer” command in FIG. 18A (step 1004) is illustrated in the flowchart of FIG. 18B.

The identity of the selected information communication channel pair, also termed herein a “channel pair selection command”, is sent over the control channel pair to the new toy (step 840). A game program is then begun (step 850), using the selected information communication channel pair. The control channel pair is then free to receive and act upon a toy availability command received from another toy. Therefore, it is desirable to assign another transceiver to that control channel pair since the current transceiver is now being used to provide communication between the game and the toy.

To assign a further transceiver to the now un-monitored control channel, the transceiver which was formerly monitoring that control channel is marked as busy in a transceiver availability table (step 852). The transceiver availability table is then scanned until an available transceiver, i.e. a transceiver which is not marked as busy, is identified (step 854). This transceiver is then assigned to the control channel i (step 858).

FIG. 17 is a simplified flowchart illustration of a preferred method for implementing “select control channel pair” step 810 of FIG. 16. In FIG. 17, the four control channels are scanned. For each channel pair in which the noise level falls below a certain threshold (step 895), the computer sends an availability interrogation command (step 910) and waits for a predetermined time period, such as 250 ms, for a response (steps 930 and 940). If no other computer responds, i.e. sends back an “availability response command”, then the channel pair is deemed vacant. If the channel pair is found to be occupied the next channel is scanned. If none of the four channel pairs are found to be vacant, a “no control channel available” message is returned.

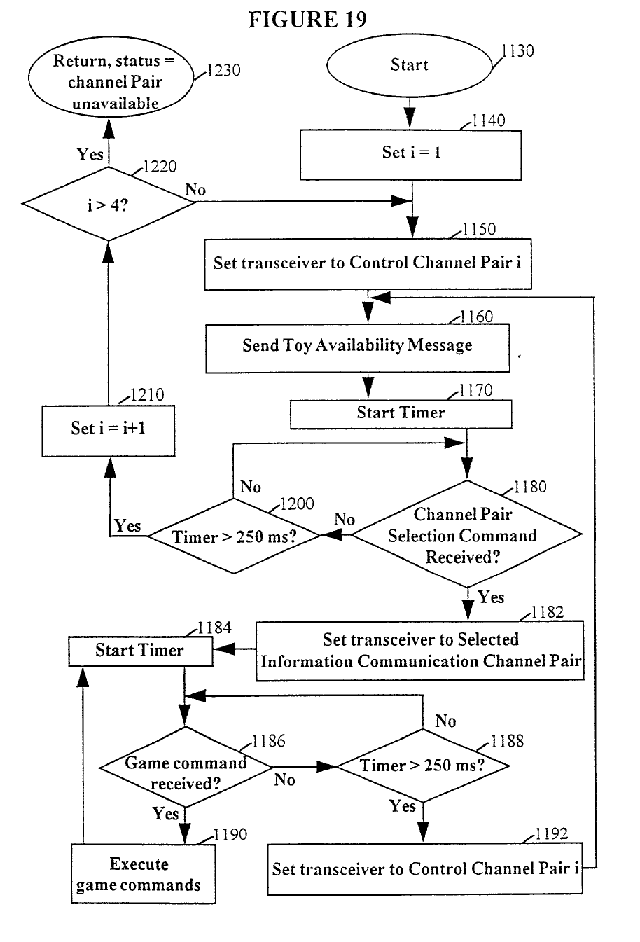

FIG. 19 is a self-explanatory flowchart illustration of a preferred method of operation of the toy control device 130 which is useful in conjunction with the “multi-channel” embodiment of FIGS. 16-18B. i=1, . . . , 4 is an index of the control channels of the system. The toy control device sends a “toy availability command” (step 1160) which is a message advertising the toy's availability, on each control channel i in turn (steps 1140, 1150, 1210), until a control channel is reached which is being monitored by a computer. This becomes apparent when the computer responds (step 1180) by transmitting a “channel pair selection command” which is a message designating the information channel pair over which the toy control device may communicate with the game running on the computer. At this point (step 1190), the toy control device may begin receiving and executing game commands which the computer transmits over the information channel pair designated in the control channel i.

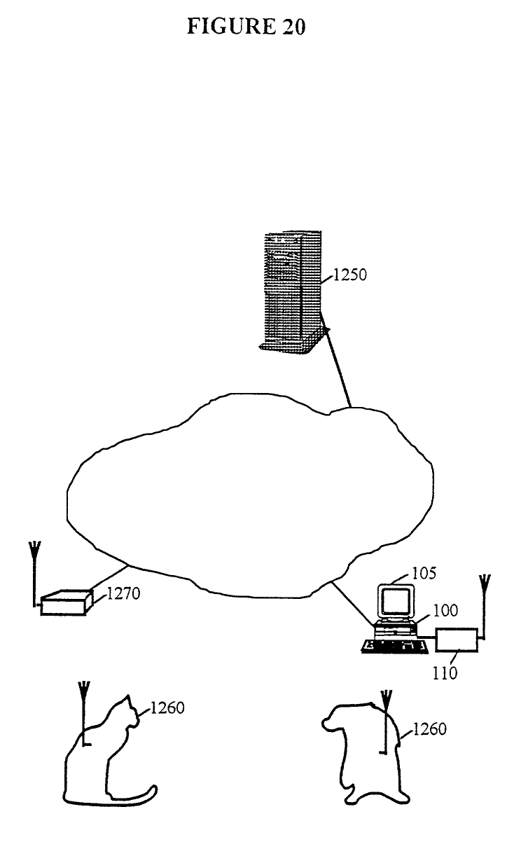

According to a preferred embodiment of the present invention, a computer system is provided, in communication with a remote game server, as shown in FIG. 20. The remote game server 1250 is operative to serve to the computer 100 at least a portion of at least one toy-operating game, which operates one or more toys 1260. Optionally, an entire game may be downloaded from the remote game server 1250. However, alternatively, a new toy action script or new text files may be downloaded from the remote game server 1250 whereas the remaining components of a particular game may already be present in the memory of computer 100.

Downloading from the remote game server 1250 to the computer 100 may take place either off-line, before the game begins, or on-line, in the course of the game. Alternatively, a first portion of the game may be received off-line whereas an additional portion of the game is received on-line.

The communication between the remote game server 1250 and the computer 100 may be based on any suitable technology such as but not limited to ISDN; X.25; Frame-Relay; and Internet.

An advantage of the embodiment of FIG. 20 is that a very simple computerized device may be provided locally, i.e. adjacent to the toy, because all “intelligence” may be provided from a remote source. In particular, the computerized device may be less sophisticated than a personal computer, may lack a display monitor of its own, and may, for example, comprise a network computer 1270.

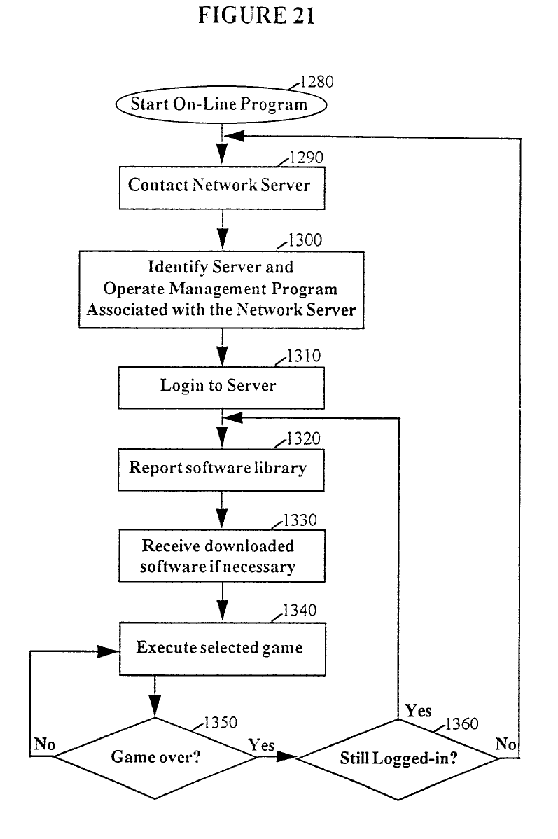

FIG. 21 is a simplified flowchart illustration of the operation of the computer 100 or of the network computer 1260 of FIG. 20, when operating in conjunction with the remote server 1250.

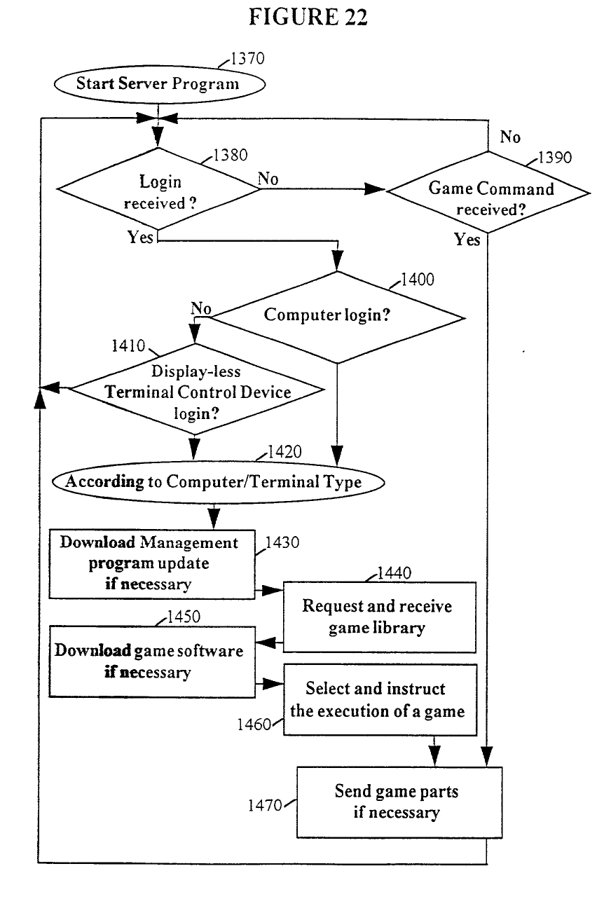

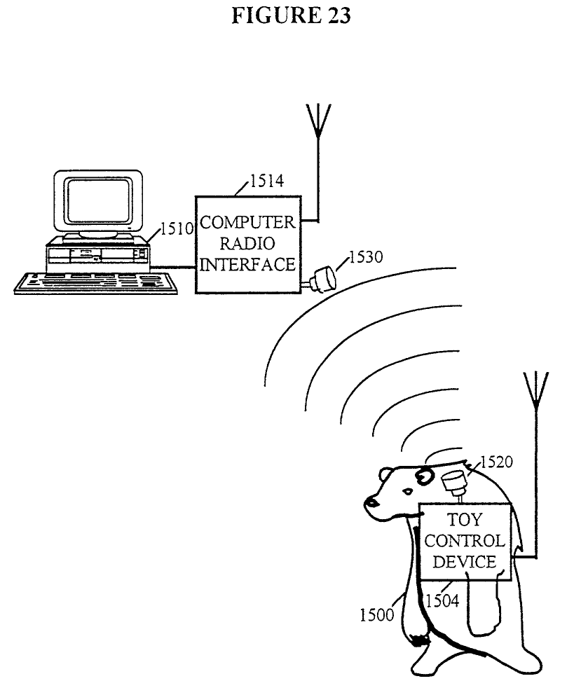

FIG. 22 is a simplified flowchart illustration of the operation of the remote game server 1250 of FIG. 20.

FIG. 23 is a semi-pictorial semi-block diagram illustration of a wireless computer controlled toy system including a toy 1500 having a toy control device 1504, a computer 1510 communicating with the toy control device 1504 by means of a computer radio interface 1514 and a proximity detection subsystem operative to detect proximity between the toy and the computer. The proximity detection subsystem may for example include a pair of ultrasound transducers 1520 and 1530 associated with the toy and computer respectively. The toy's ultrasound transducer 1520 typically broadcasts ultrasonic signals which the computer's ultrasound transducer 1530 detects if the computer and toy are within ultrasonic communication range, e.g. are in the same room.

FIGS. 24A-24E, taken together, form a detailed electronic schematic diagram of a multi-channel implementation of the computer radio interface 110 of FIG. 3 which is similar to the detailed electronic schematic diagrams of FIGS. 5A-5D except for being multi-channel, therefore capable of supporting full duplex applications, rather than single-channel.

FIGS. 25A-25F, taken together, form a detailed schematic illustration of a computer radio interface which connects to a serial port of a computer rather than to the soundboard of the computer.

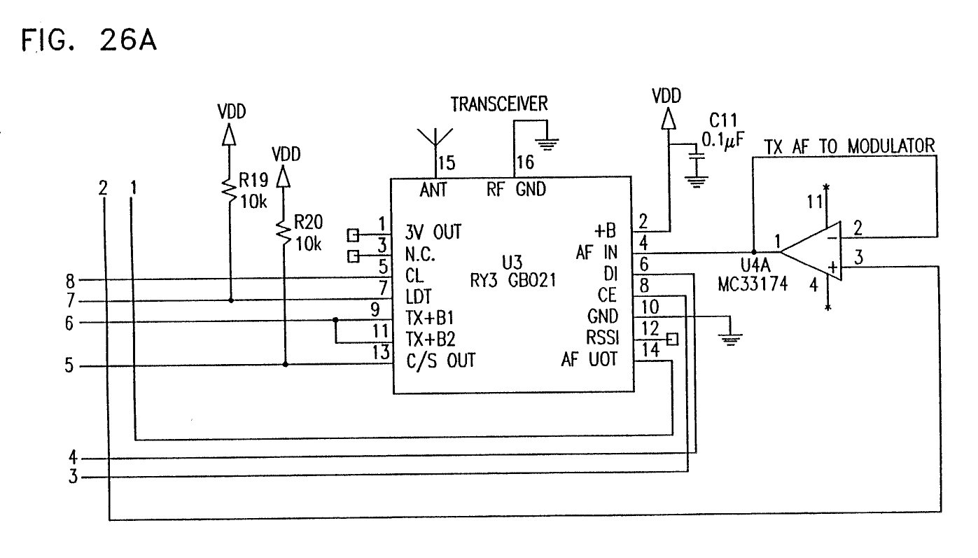

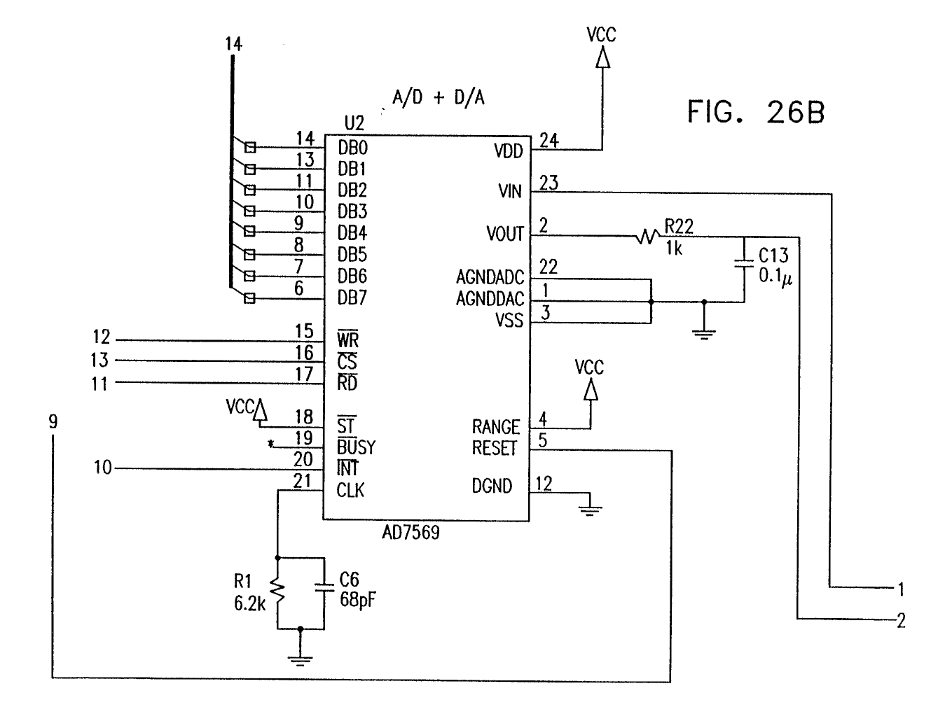

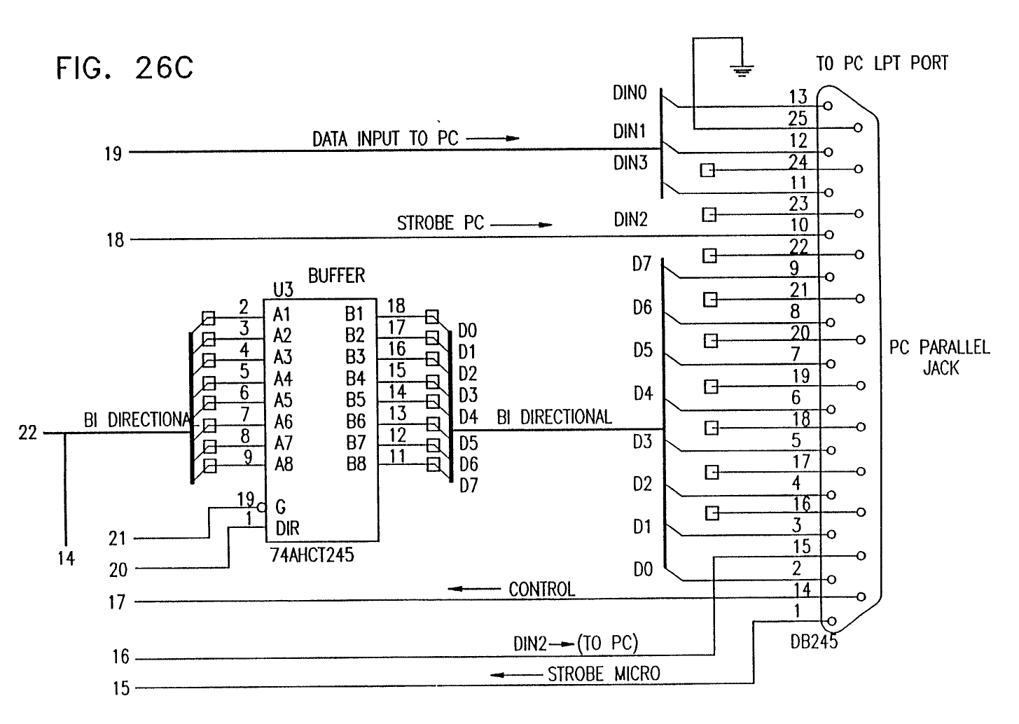

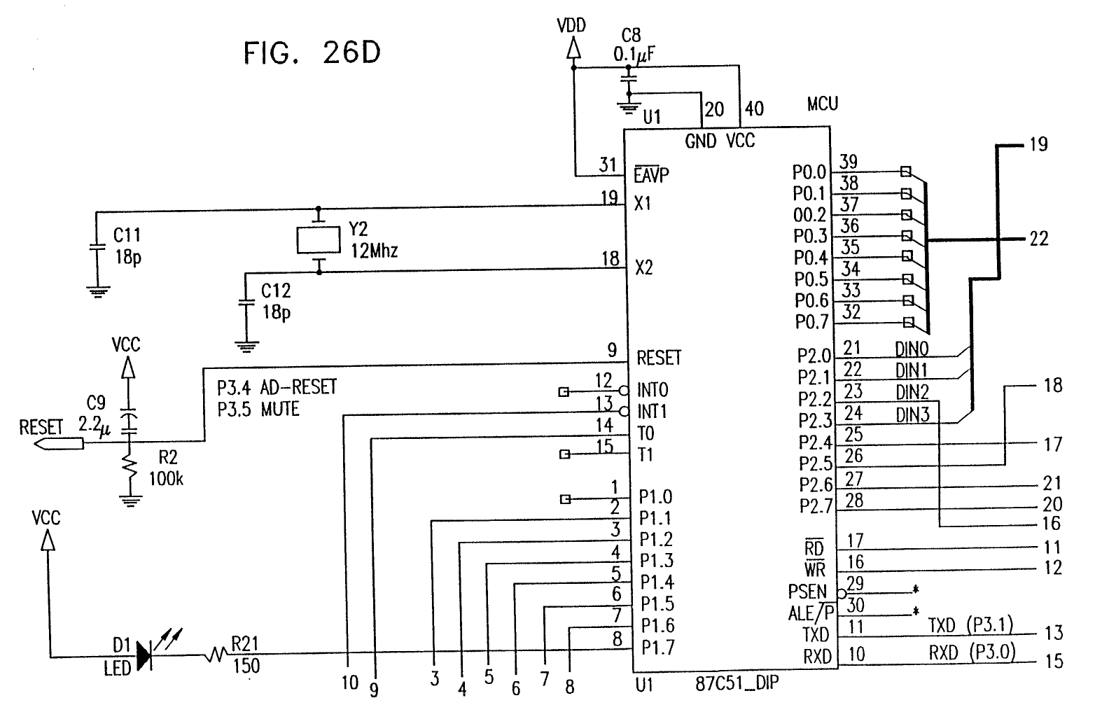

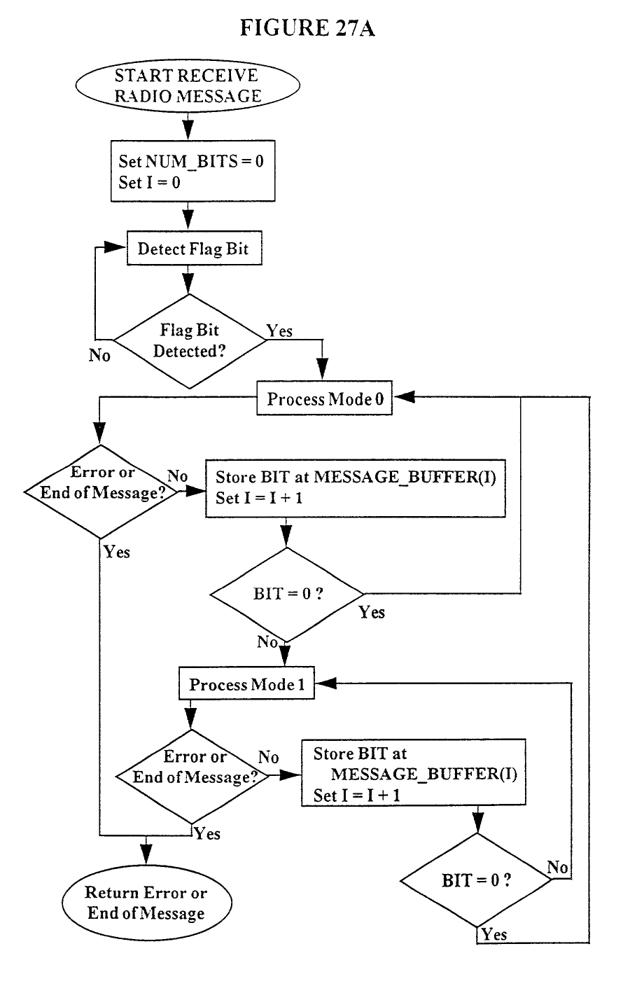

FIGS. 26A-26D, taken together, form a detailed schematic illustration of a computer radio interface which connects to a parallel port of a computer rather than to the soundboard of the computer.

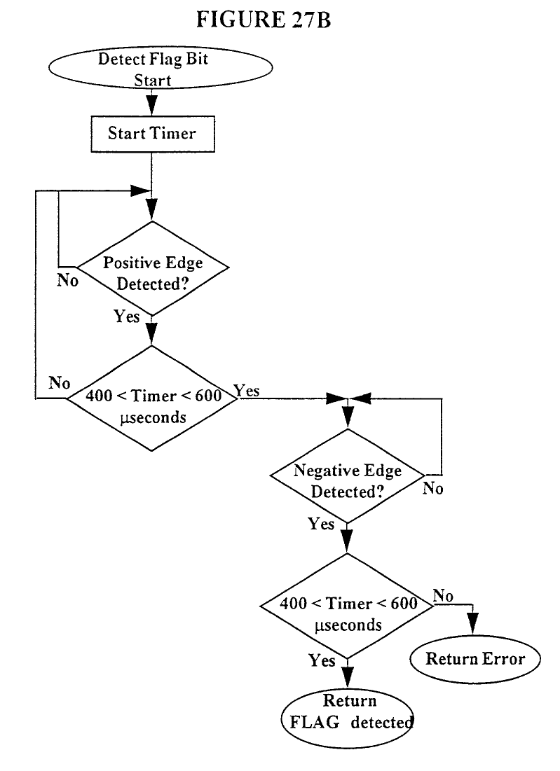

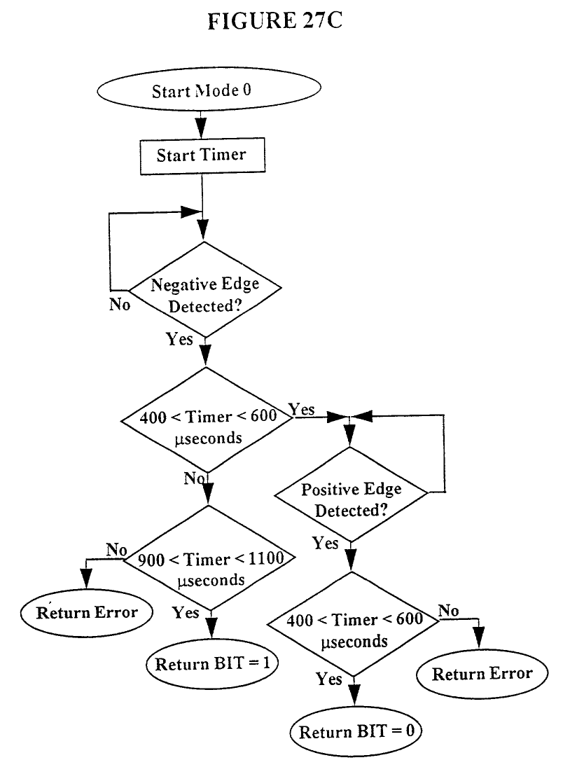

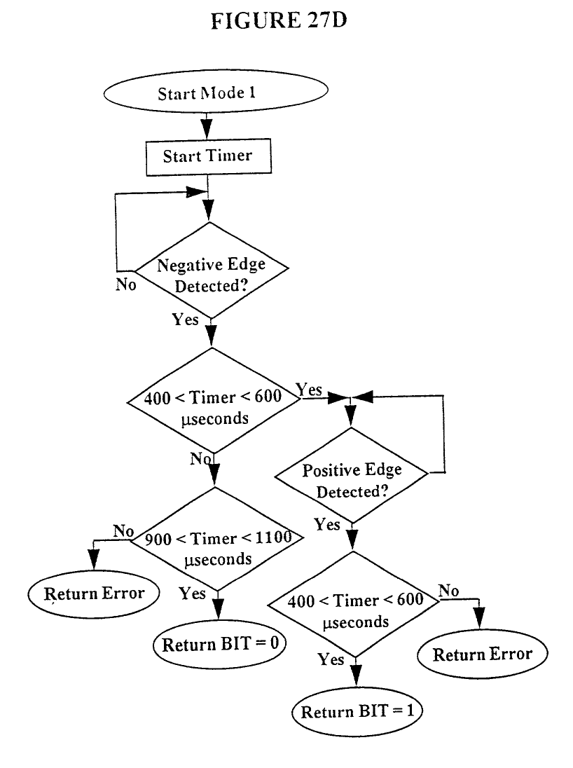

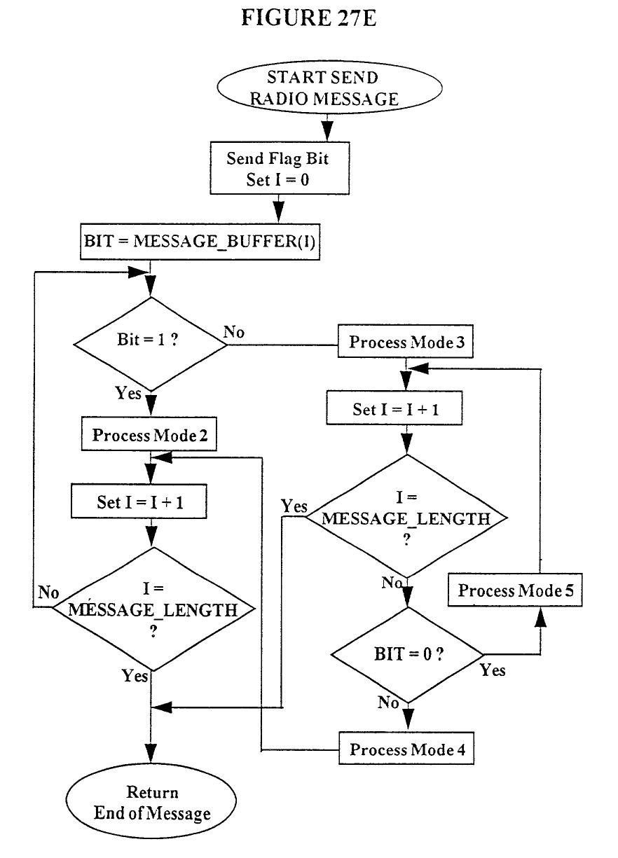

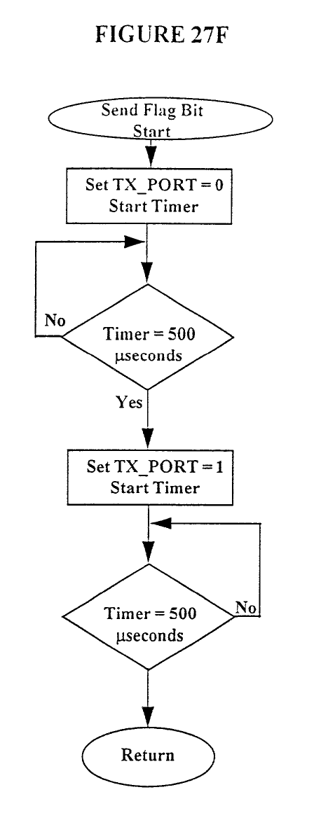

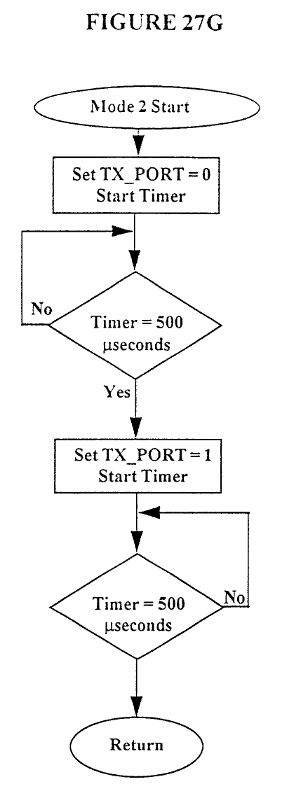

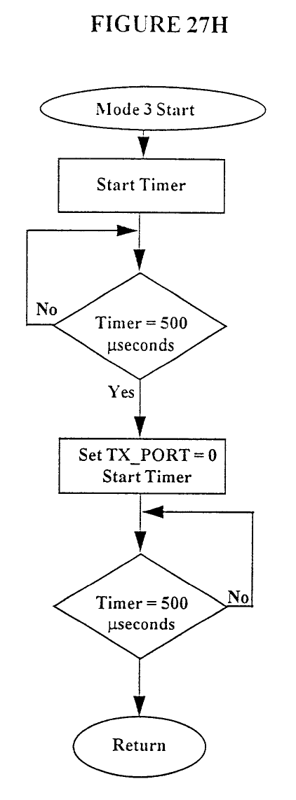

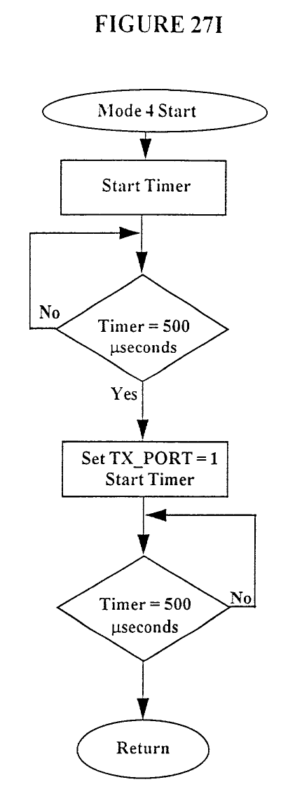

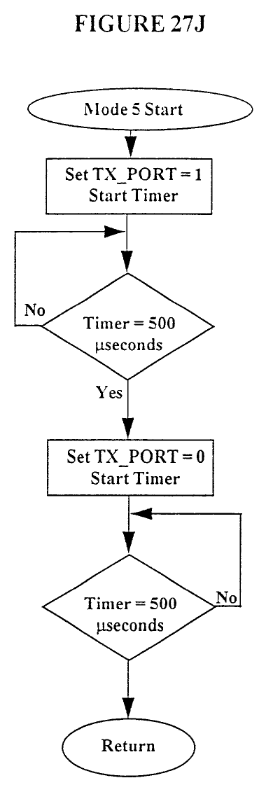

FIGS. 27A-27J are preferred self-explanatory flowchart illustrations of a preferred radio coding technique, based on the Manchester coding, which is an alternative to the radio coding technique described above with reference to FIGS. 8E, 8G-8M and 10A-C.

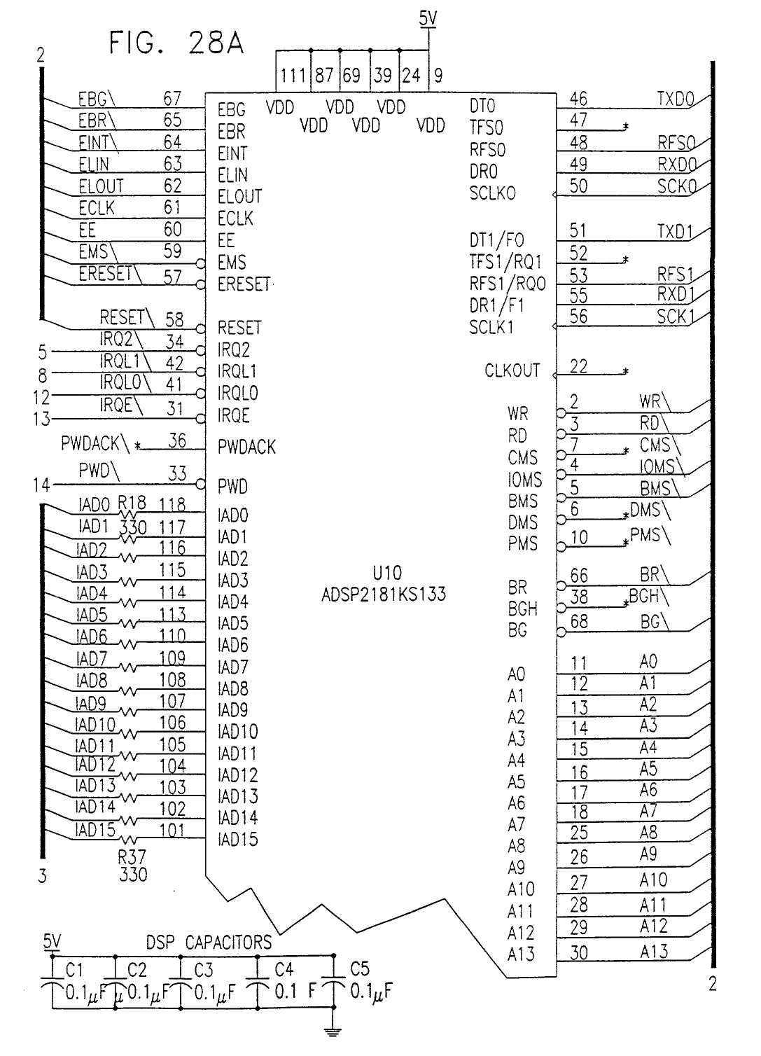

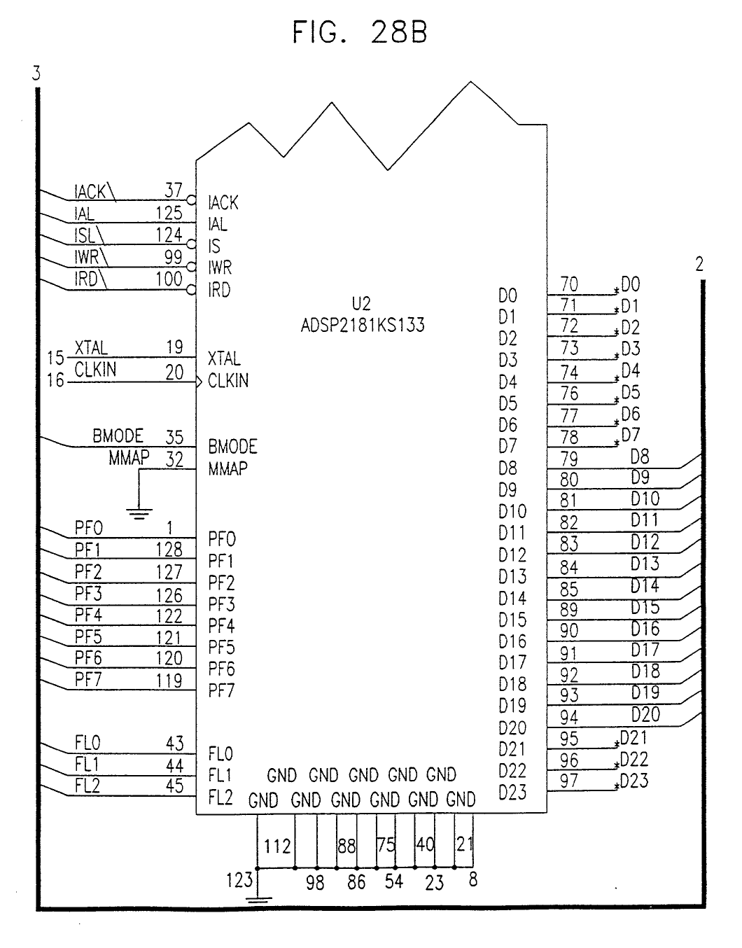

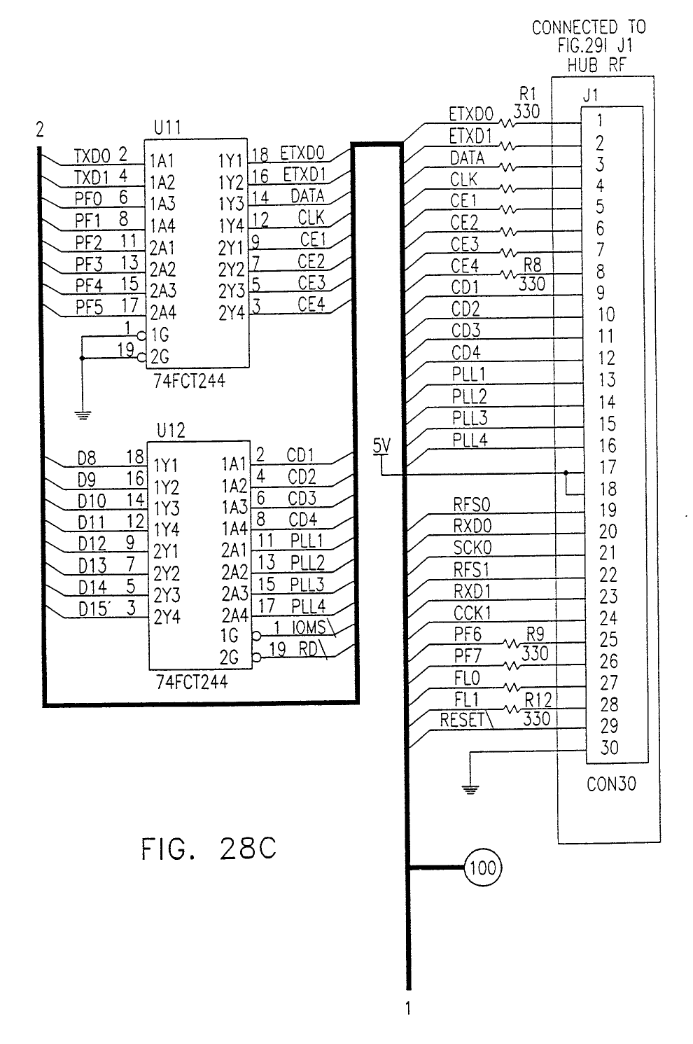

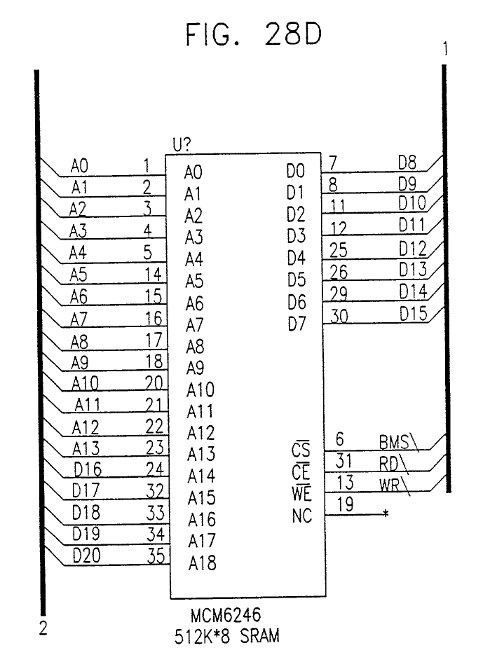

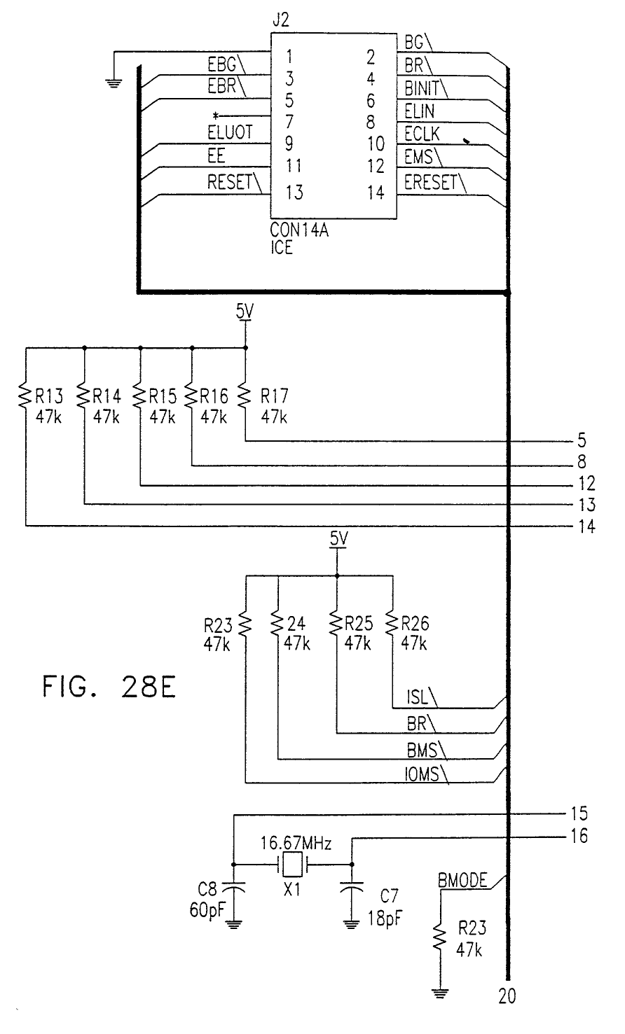

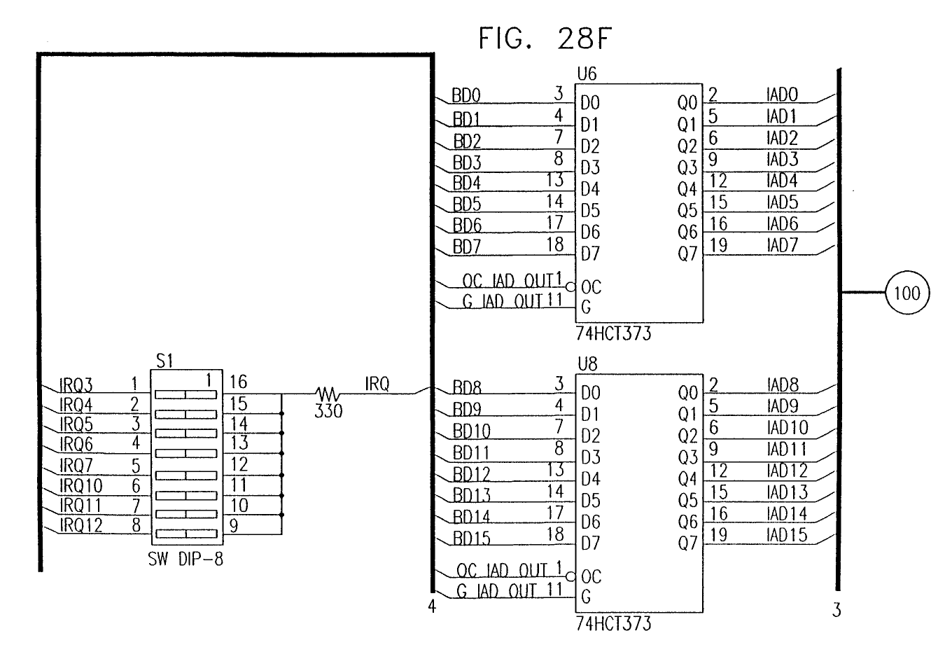

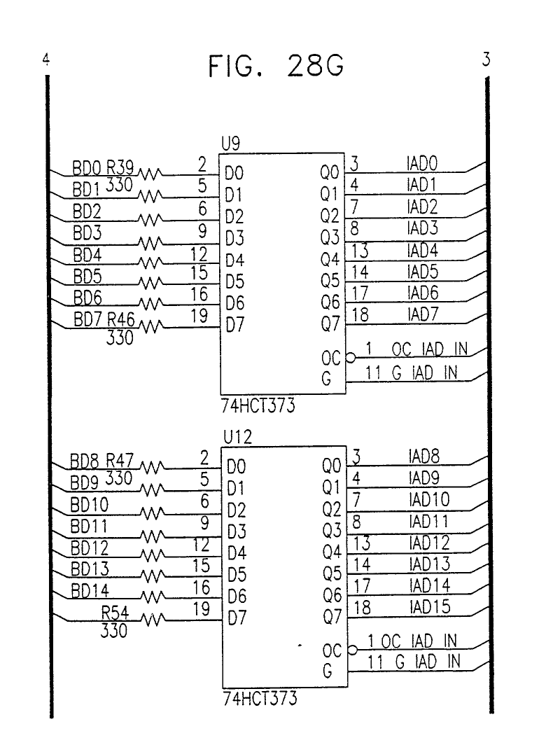

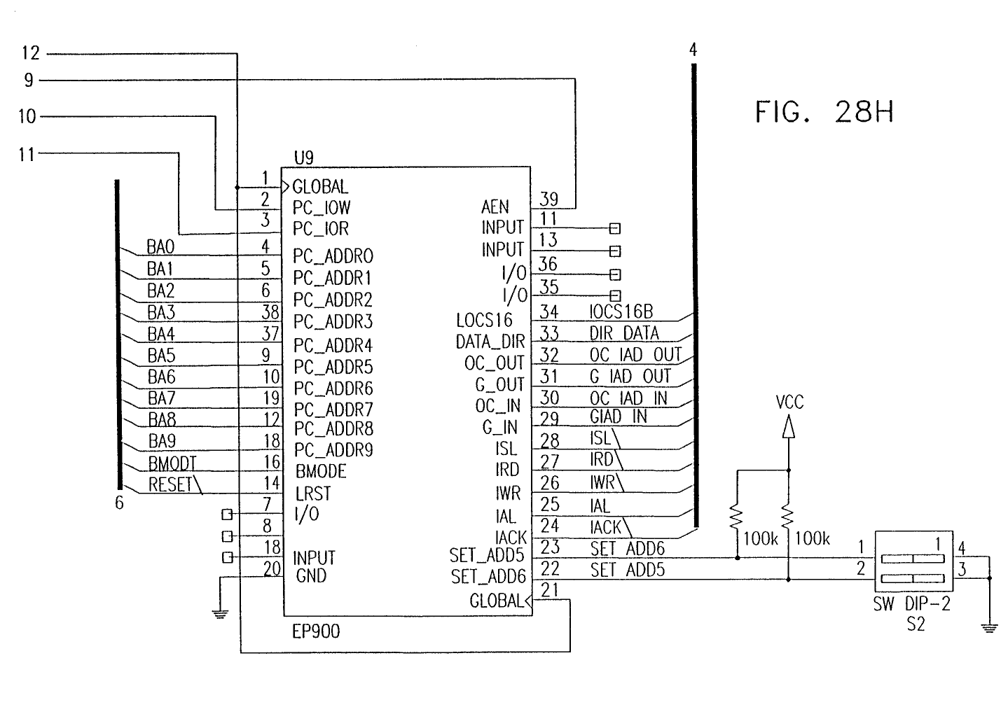

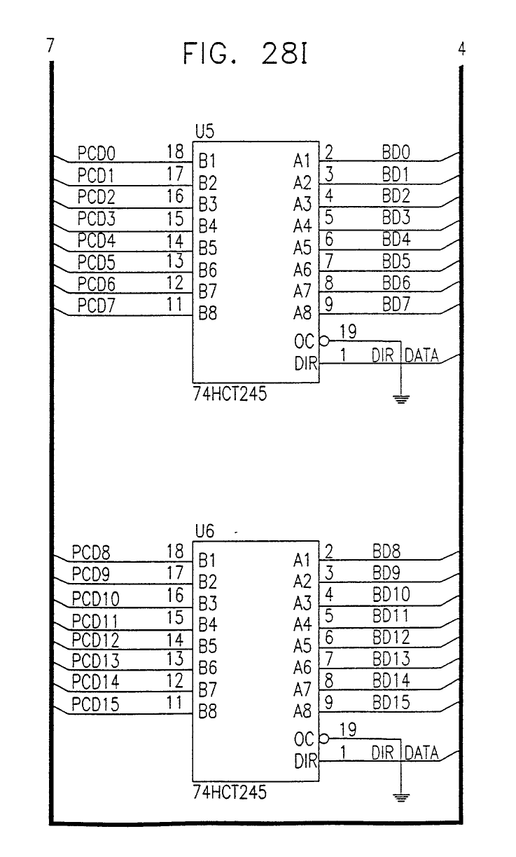

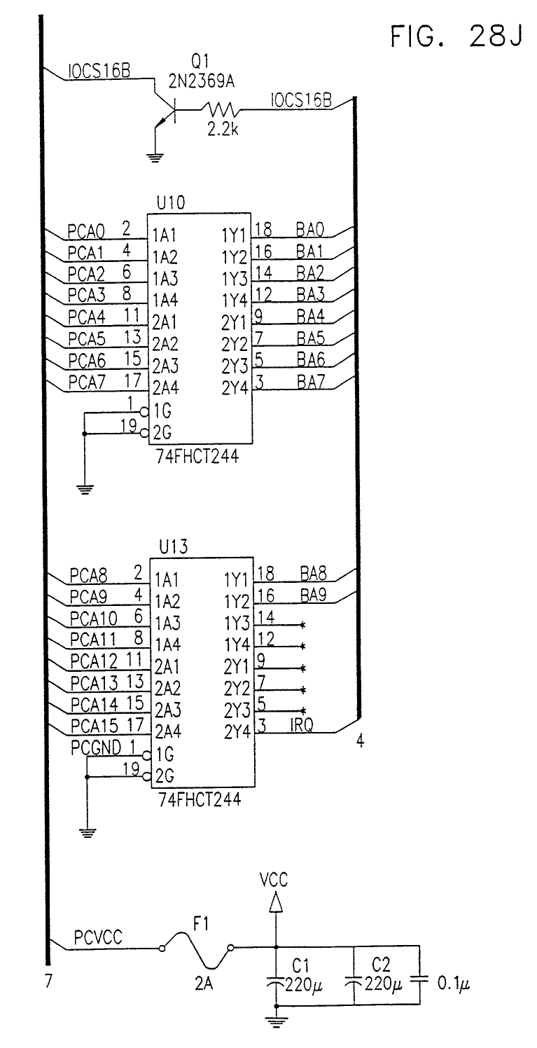

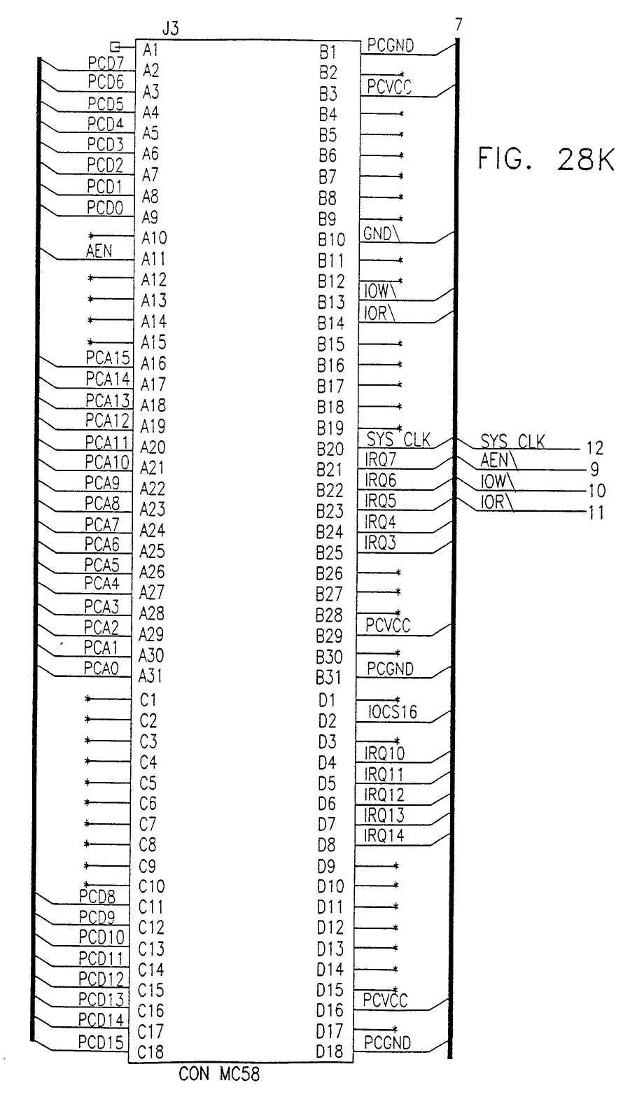

FIGS. 28A-28K, taken together, form a detailed electronic schematic diagram of the multi-port multi-channel computer radio interface sub-unit of FIG. 13.

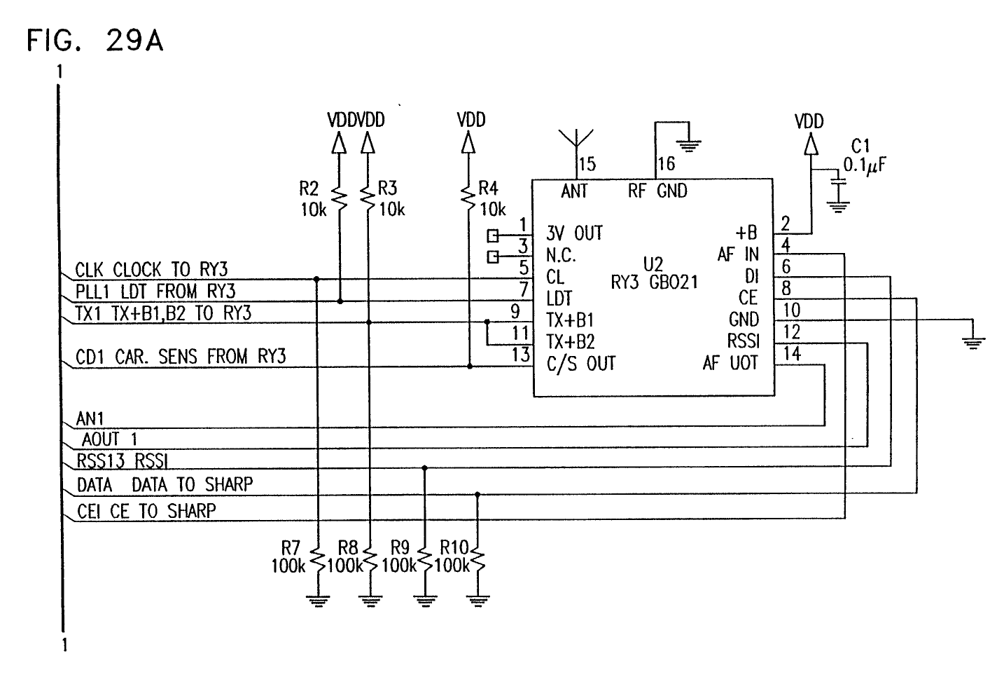

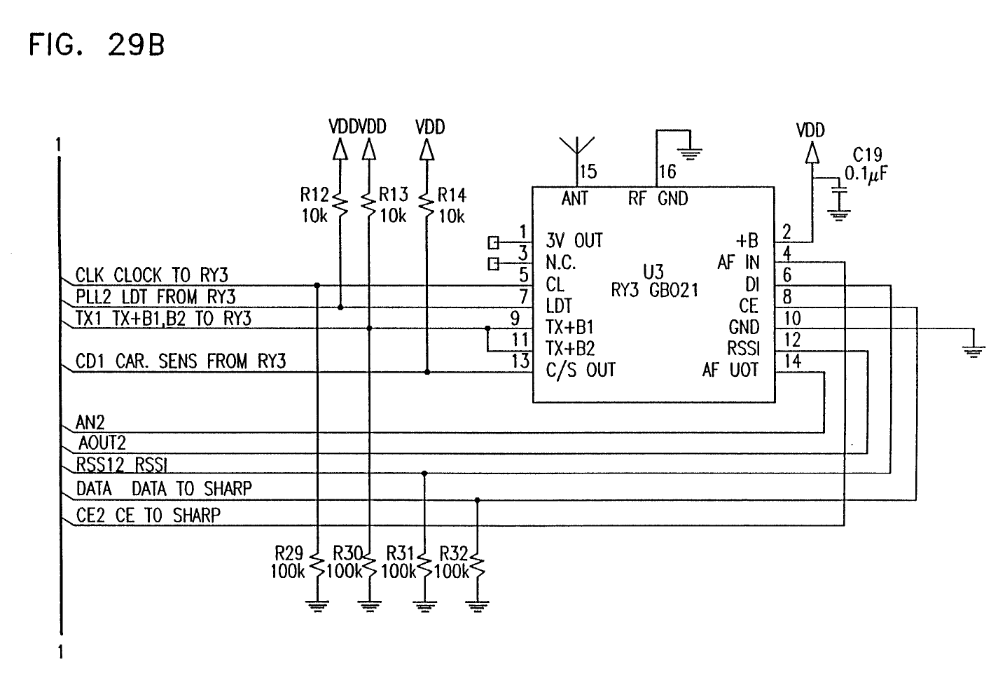

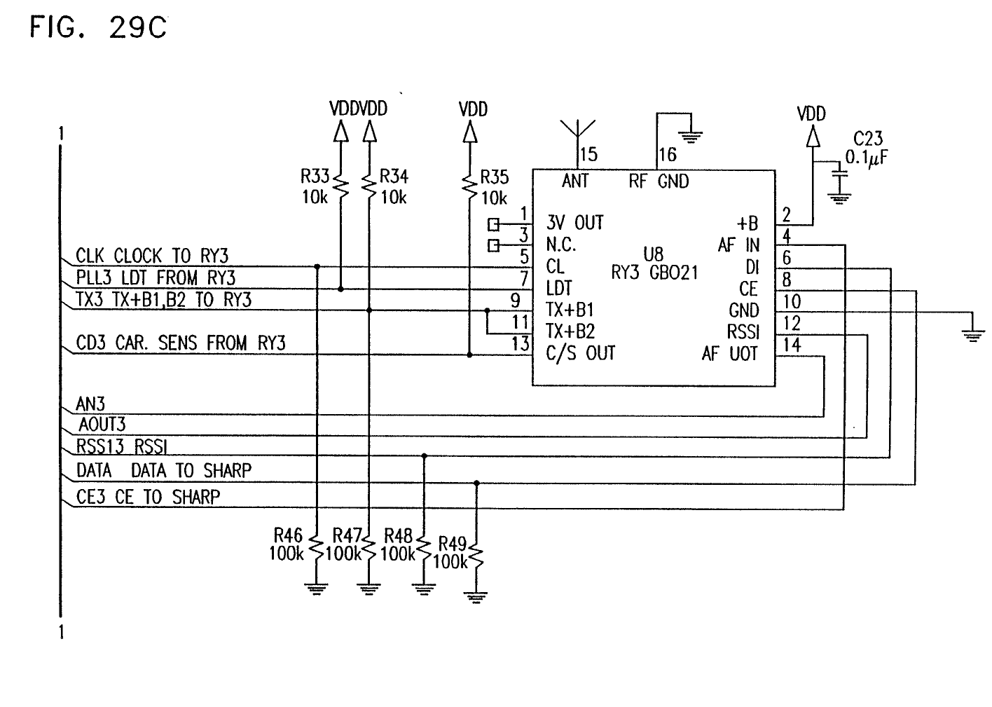

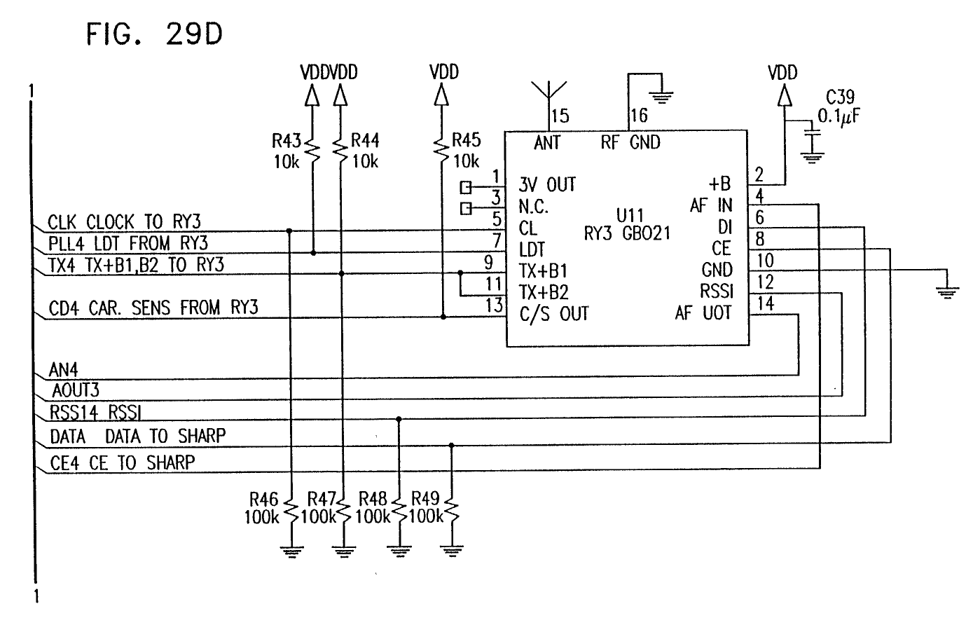

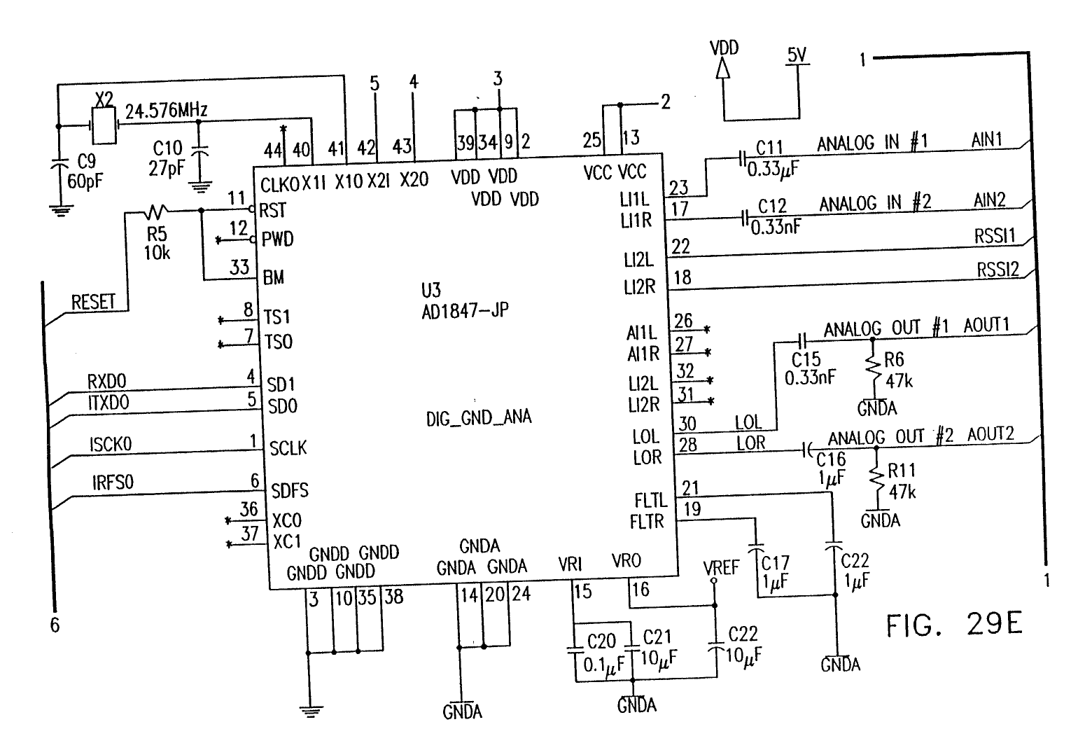

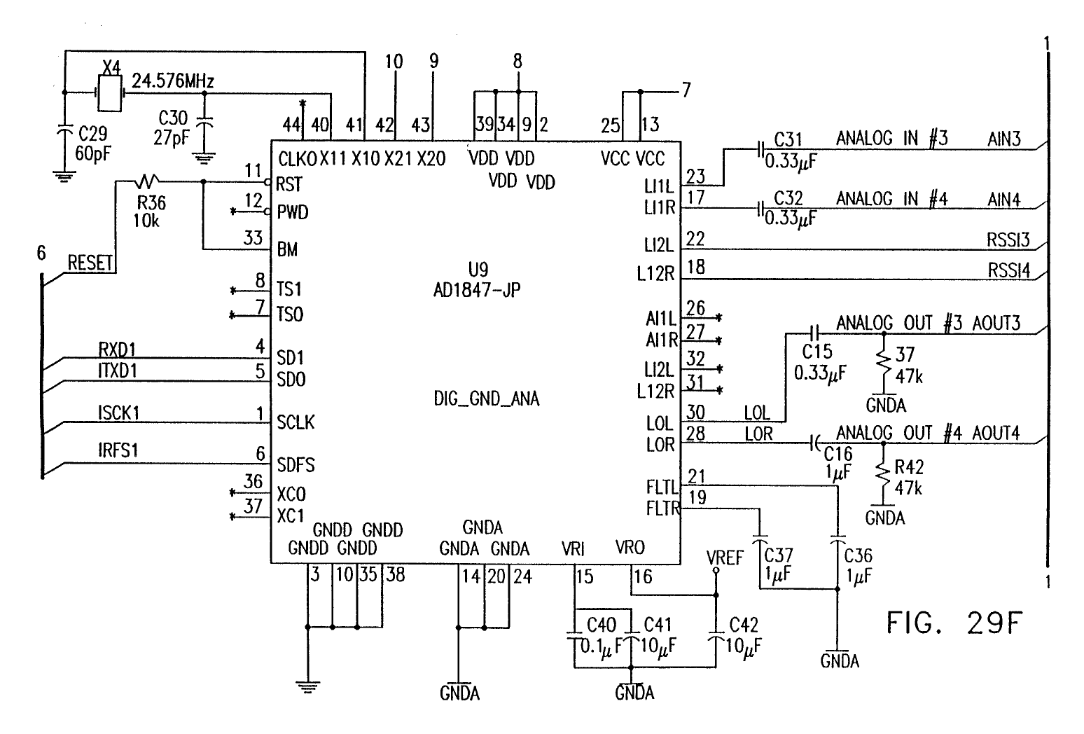

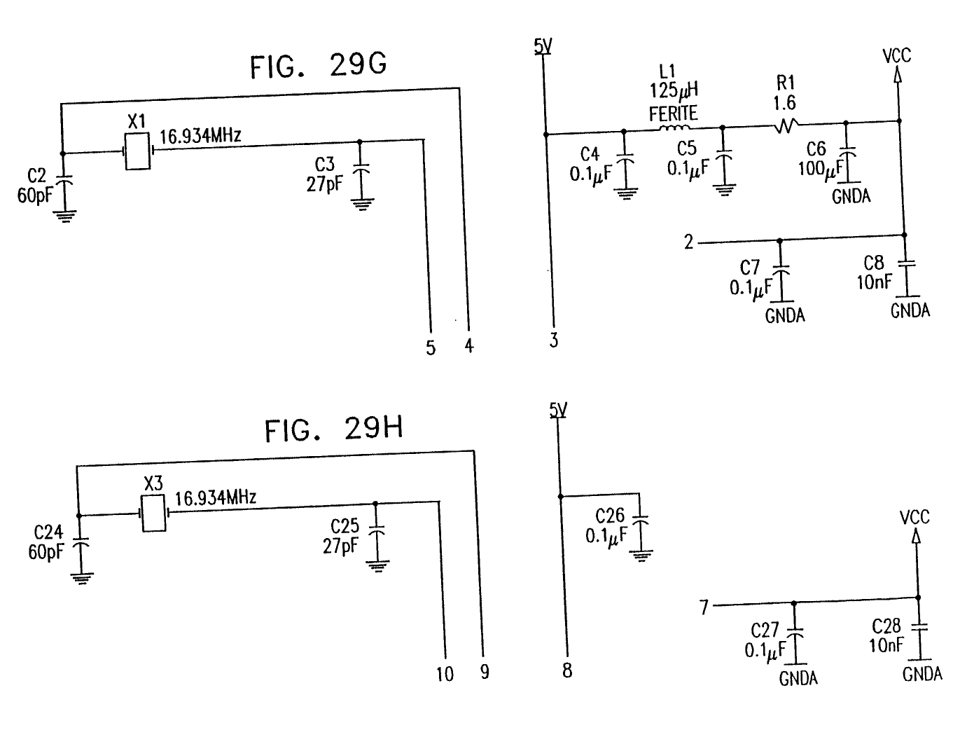

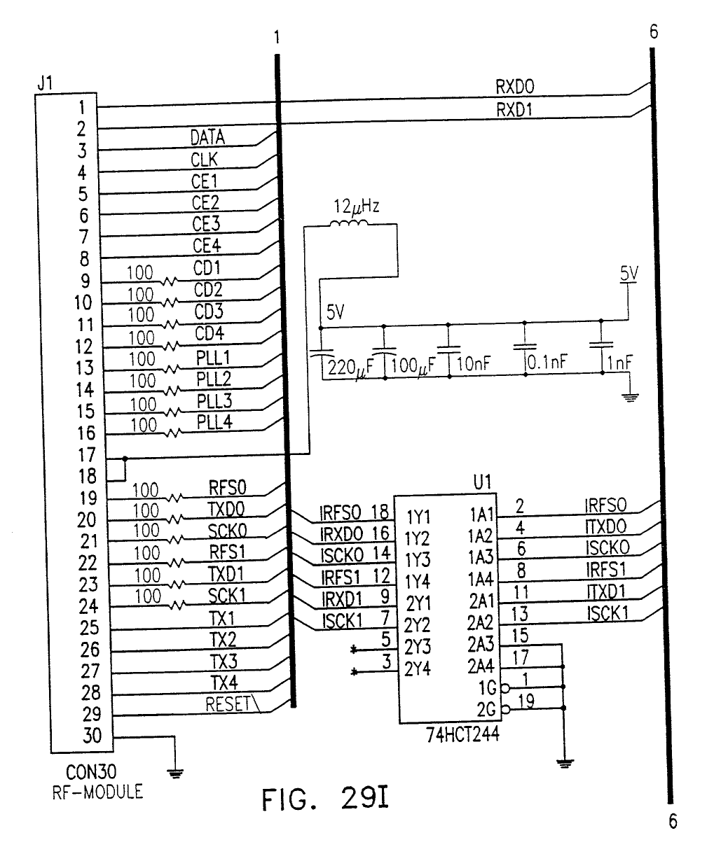

FIGS. 29A-29I, taken together, form a detailed electronic schematic diagram of the multi-port multi-channel computer radio interface sub-unit of FIG. 14.

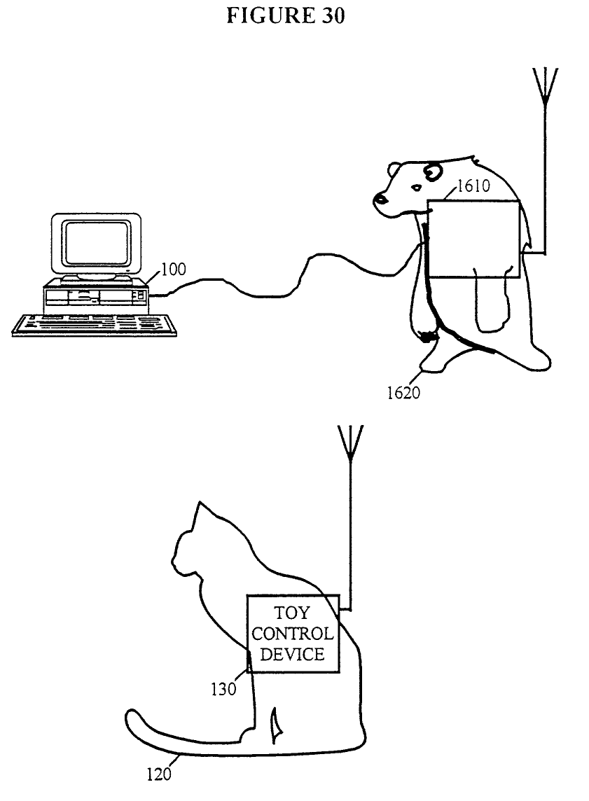

FIG. 30 illustrates a further embodiment of the present invention which includes a combination of a Computer Radio Interface (CRI) and a Toy Control Device (TCD), 1610.

The combined unit 1610 controls a toy 1620 which is connected to the computer 100 by a device, such as a cable, and communicates with other toys, 120, by means such as radio communication, using the computer radio interface 110. The toy 1620 is operated in a similar manner as the toy device 120.

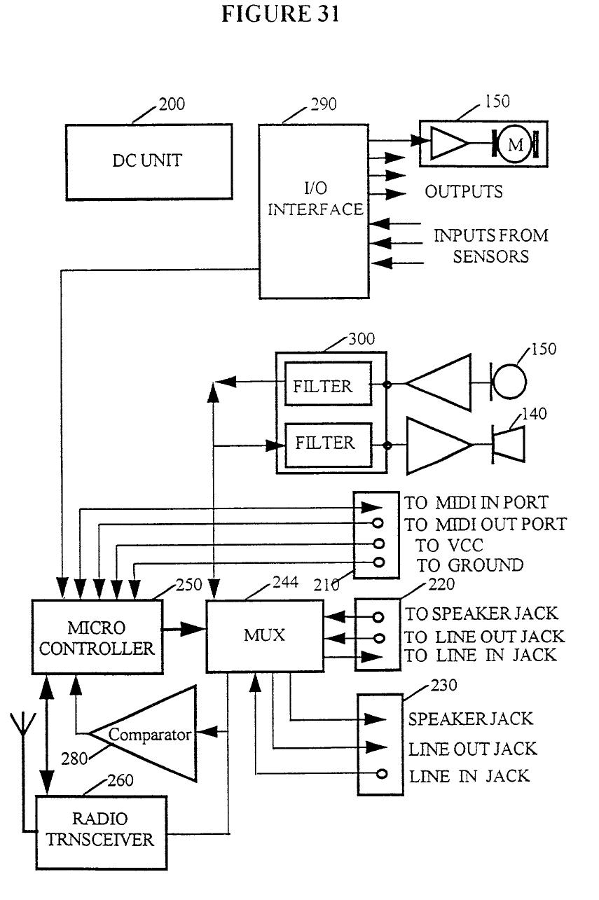

FIG. 31 illustrates a simplified block diagram of the combined unit 1610.

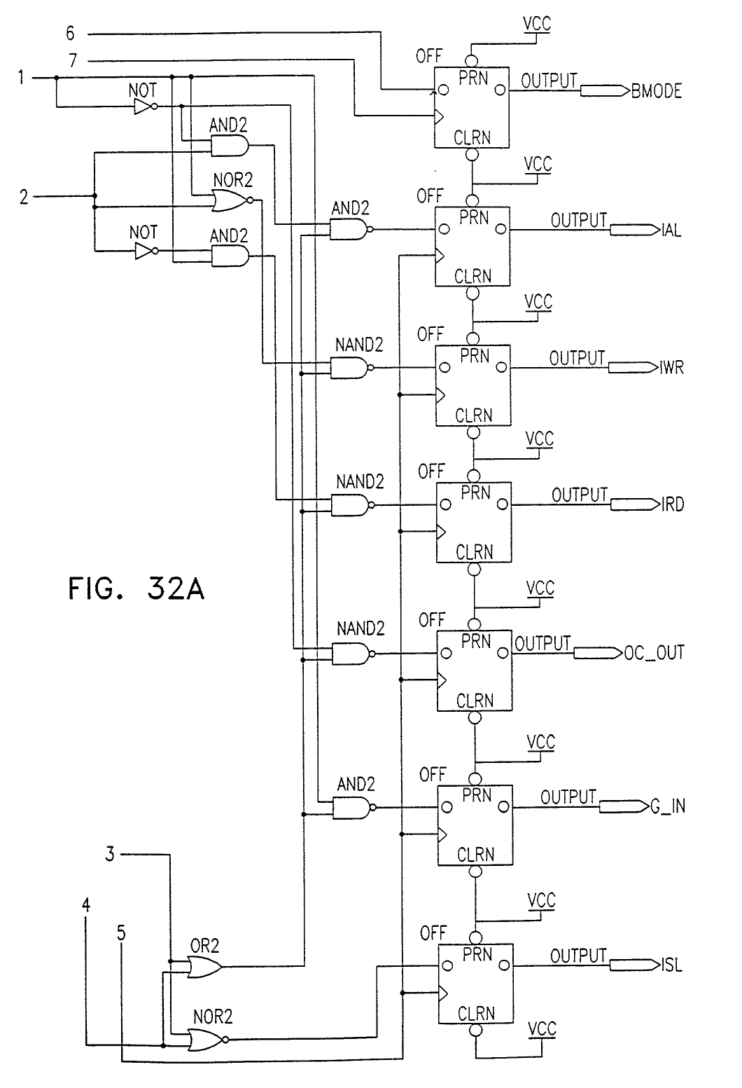

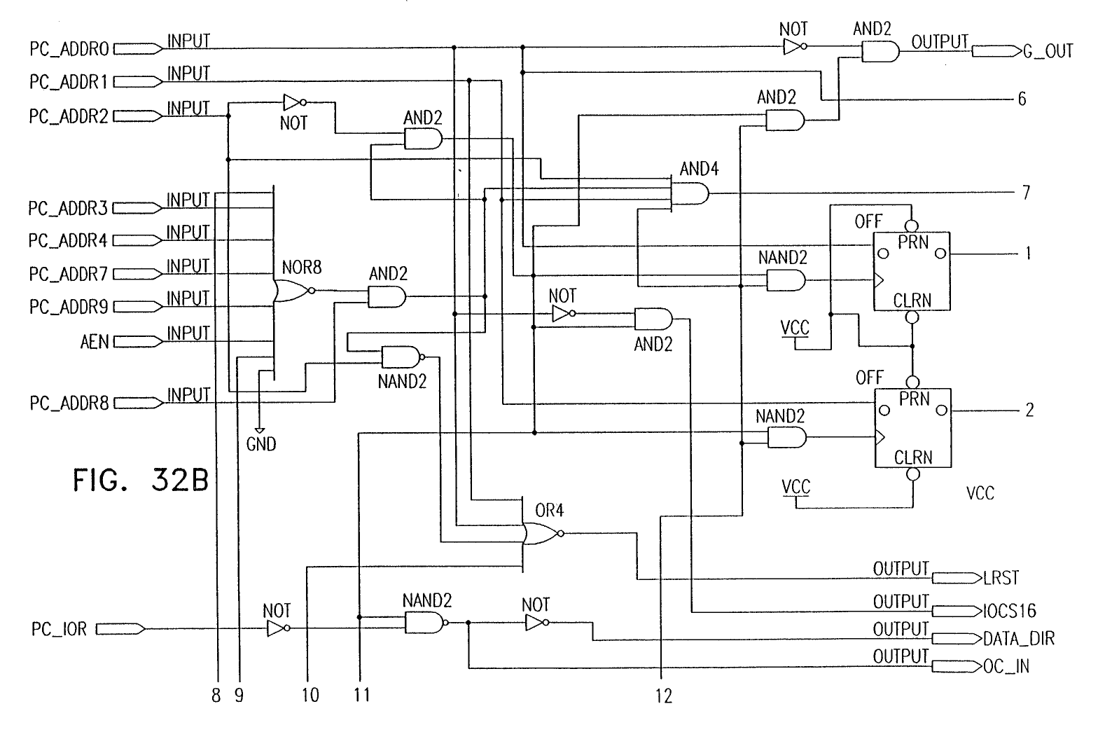

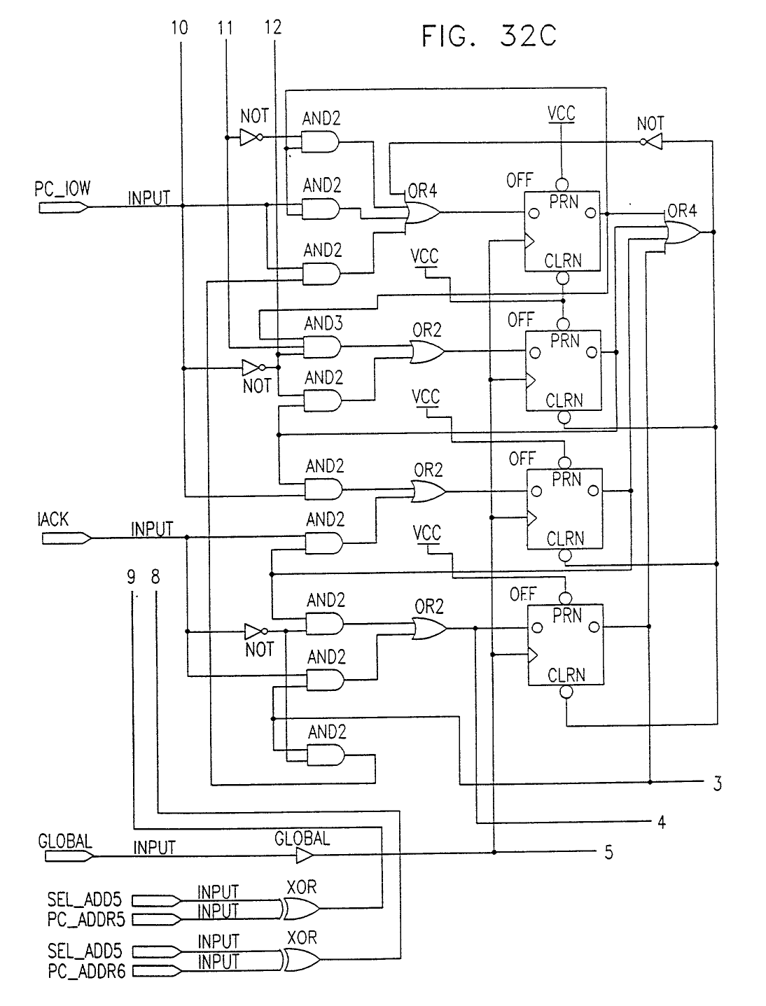

FIGS. 32A, 32B and 32C taken together form a simplified schematic diagram of the EP900 EPLD chip (U9) of FIG. 28H. The code to program the EPLD chip for this schematic diagram preferably uses the programming package “Max Plus II Ver. 6.2” available from Altera Corporation, 3525 Monroe Street, Santa Clara, Calif. 5051, USA.

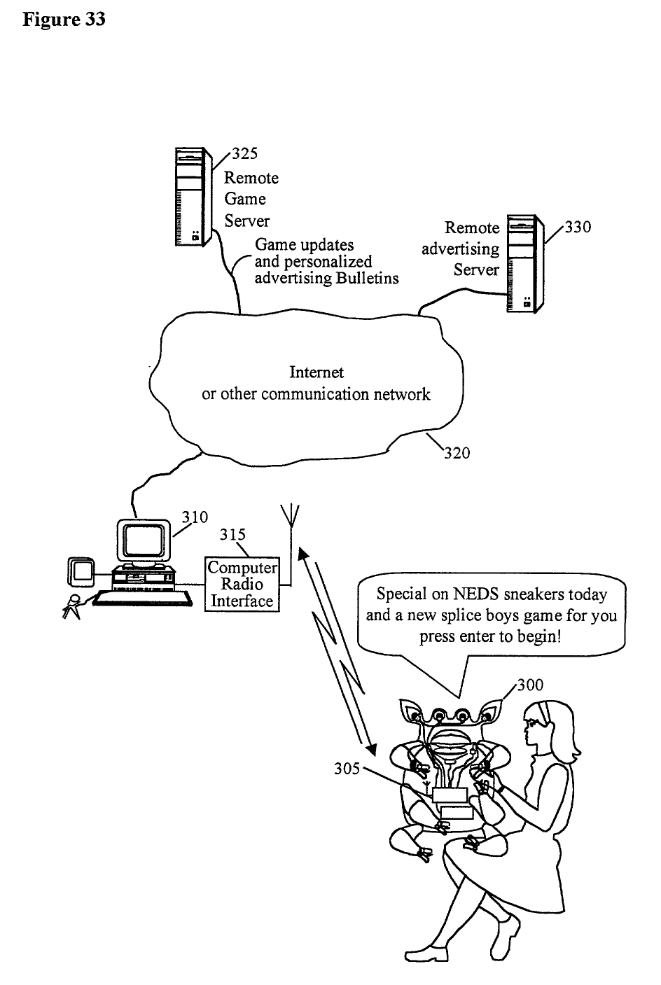

FIG. 33 is a semi-pictorial semi-block diagram illustration of a computerized networked advertisement system constructed and operative in accordance with a preferred embodiment of the present invention.

As shown, a computerized toy or doll 300 is computer-controlled, preferably via a wireless connection between the toy 300 and a computer or workstation 310. The computer or workstation 310 is associated, via the Internet or another communications network 320, with an advertisement server 330.

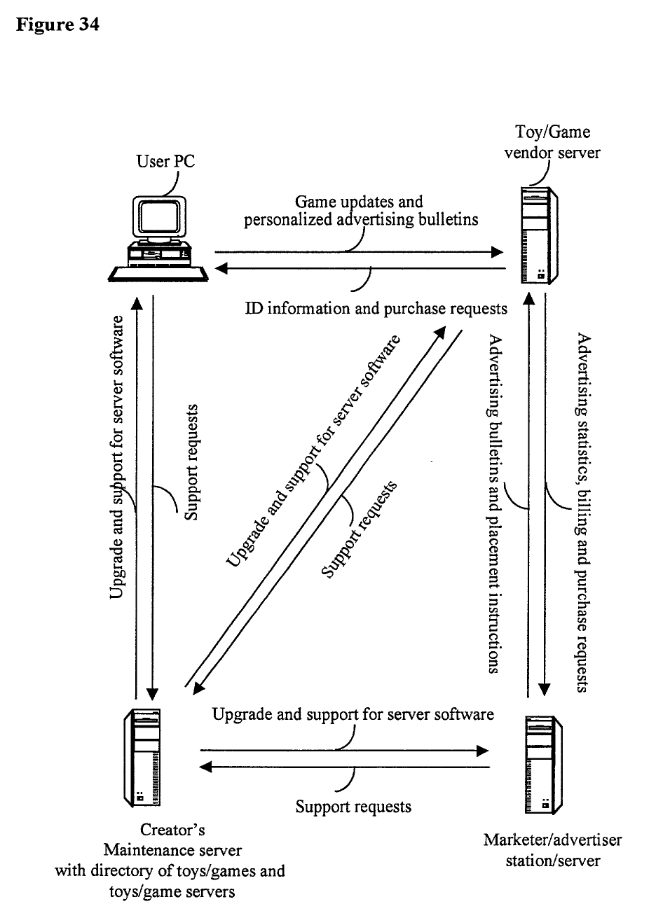

FIG. 34 is a data transmission diagram describing data transmissions between various network service providers which support the advertisement system of FIG. 33 according to one preferred embodiment of the present invention.

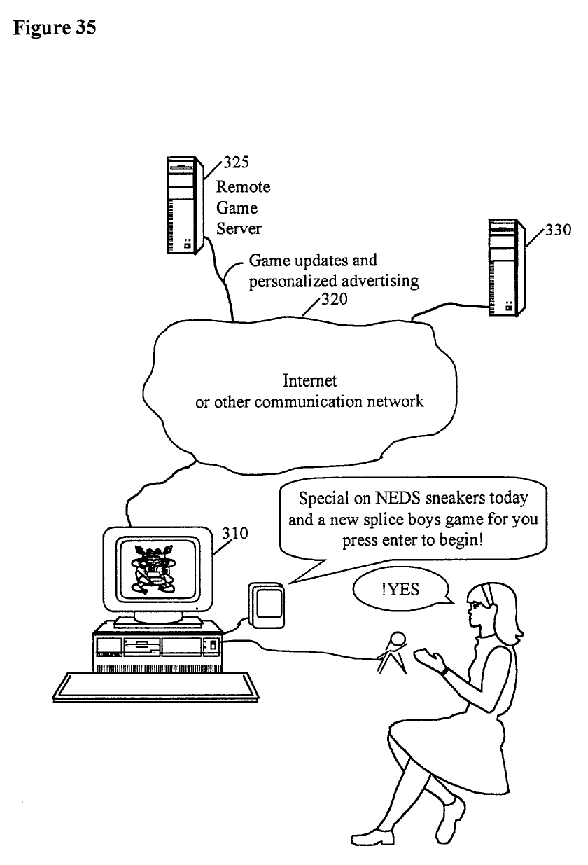

FIG. 35 is a semi-pictorial semi-block diagram illustration of a computerized networked advertisement system constructed and operative in accordance with a preferred embodiment of the present invention in which a virtual toy conveys advertisement bulletins to a user of the toy.

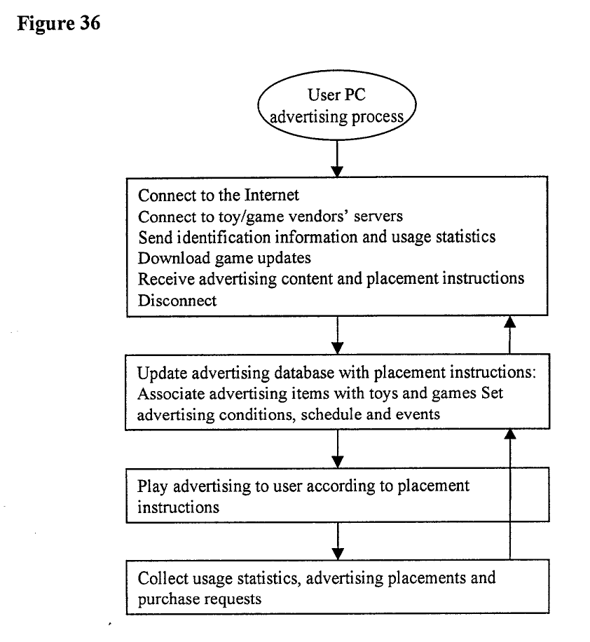

FIG. 36 is a simplified flowchart illustration of a preferred mode of operation for the user PC of FIG. 34.

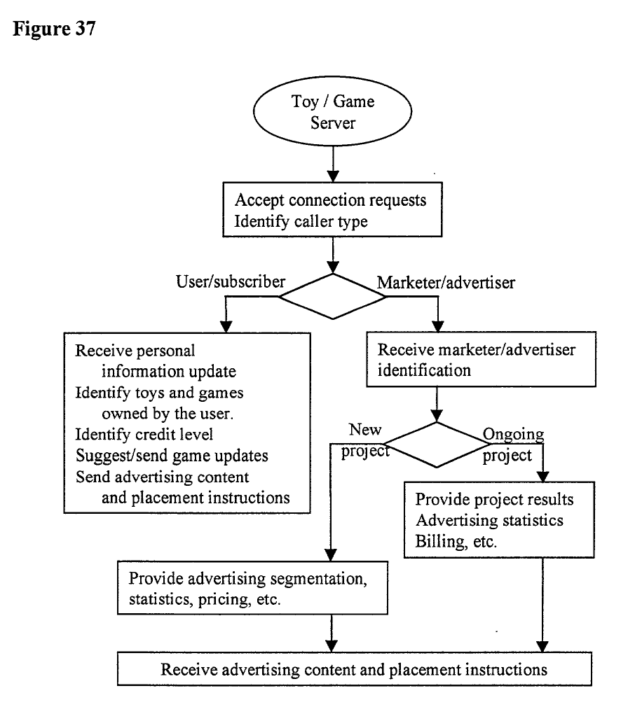

FIG. 37 is a simplified flowchart illustration of a preferred mode of operation for the game software server of FIG. 34.

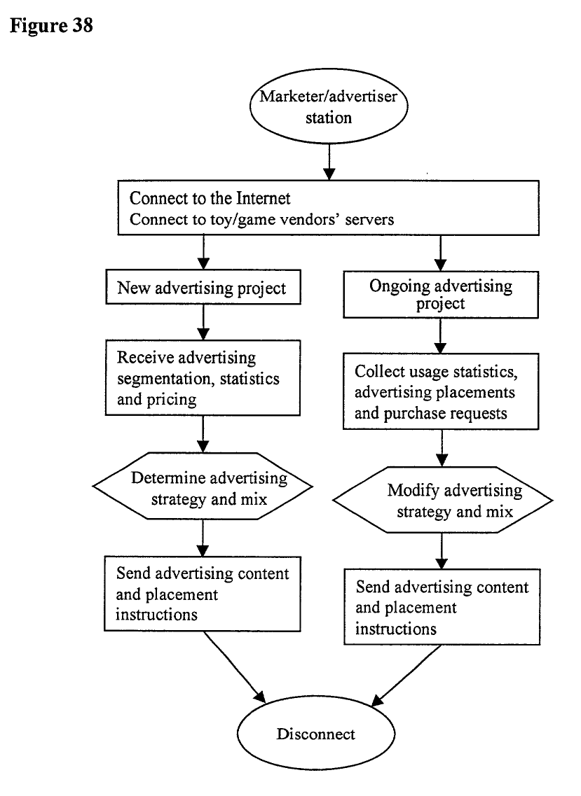

FIG. 38 is a simplified flowchart illustration of a preferred mode of operation for the marketer/advertisement provider of FIG. 34.

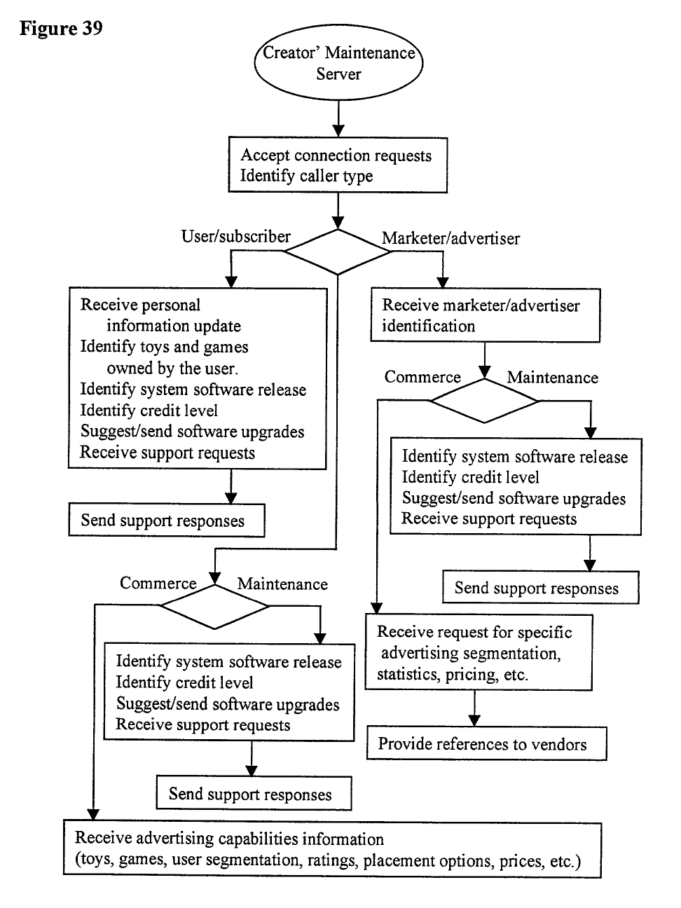

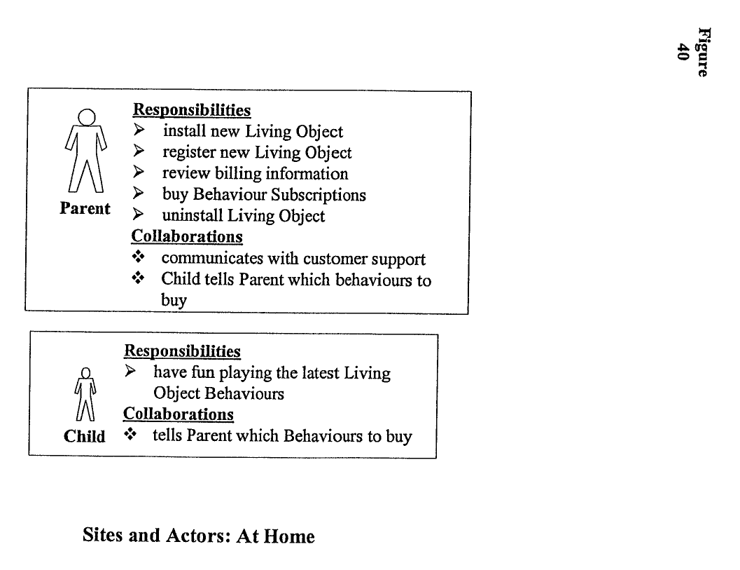

FIG. 39 is a simplified flowchart illustration of a preferred mode of operation for the software maintenance center of FIG. 34.

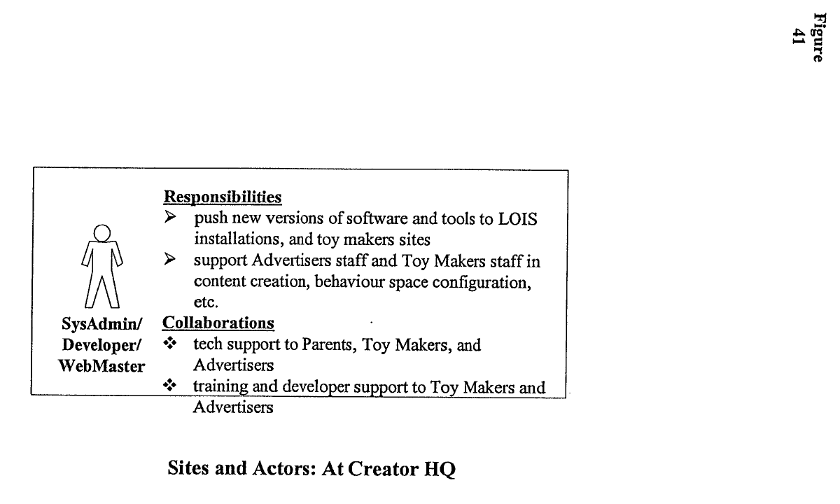

An overview of FIGS. 40-58, which describe a Living Object Internet Service System (LOIS) constructed and operative in accordance with a preferred embodiment of the present invention, is as follows:

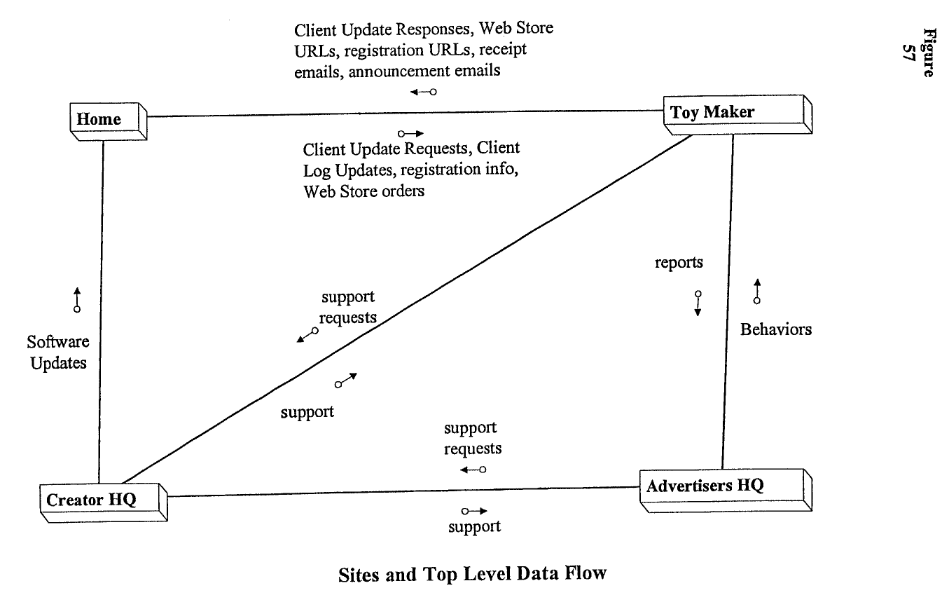

FIG. 56

Sites and Computing Devices: shows what computing devices that participate in LOIS

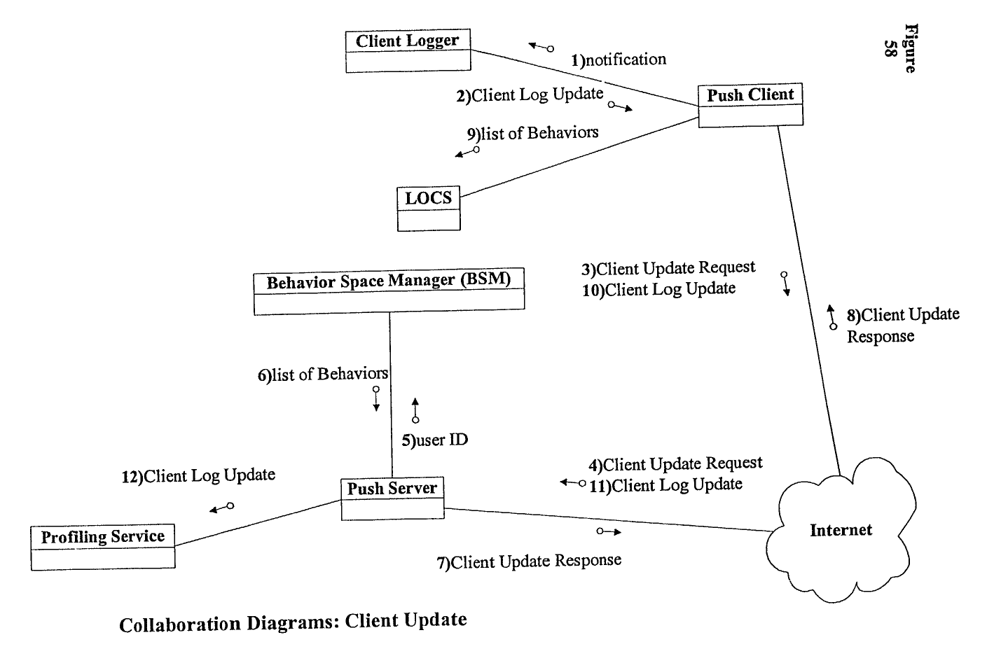

FIG. 57

Sites and Top Level Data Flow: describes the top level data flow between LOIS sites

Sites and Actors

There is a diagram for each site that presents the LOIS actors at that site, their responsibilities, and their collaborations.

FIG. 40

At Home

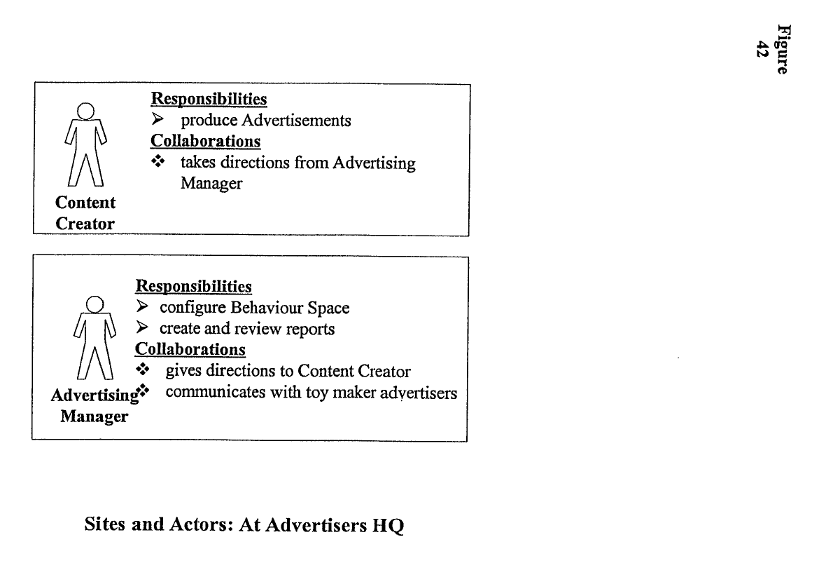

FIG. 41

At Creator HQ

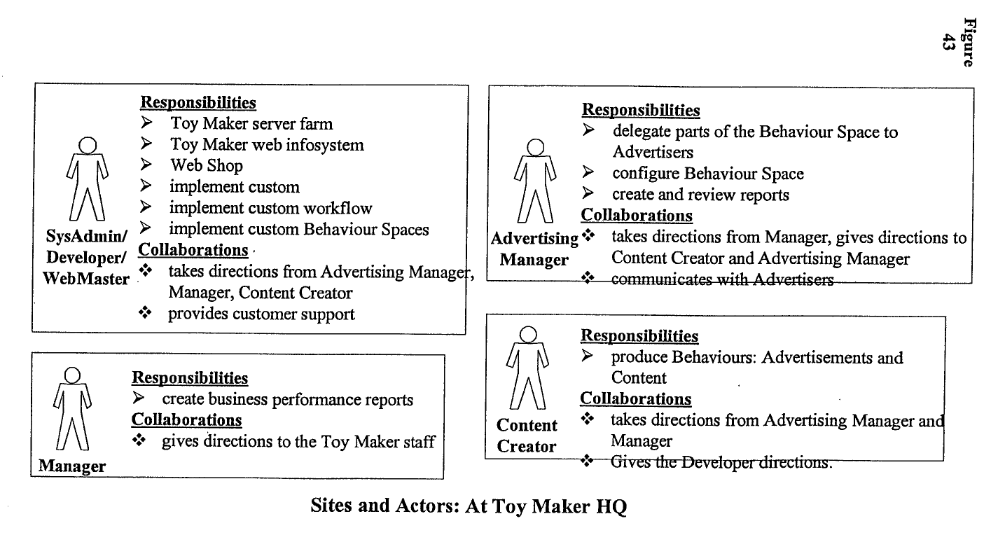

FIG. 42

At Advertisers HQ

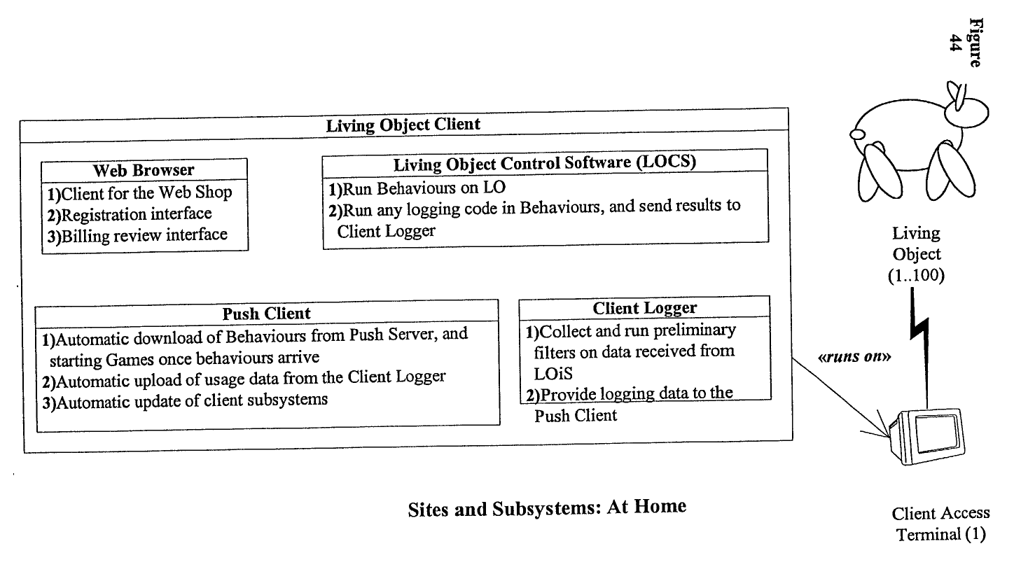

FIG. 43

At Toy Maker HQ

Sites and Subsystems

There is a diagram for each site that presents the subsystems running there, their responsibilities, and the computing devices on which they run.

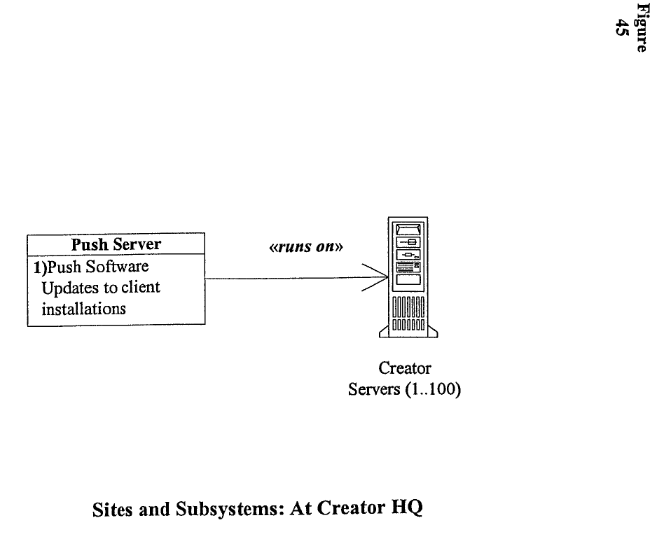

FIG. 44

At Home

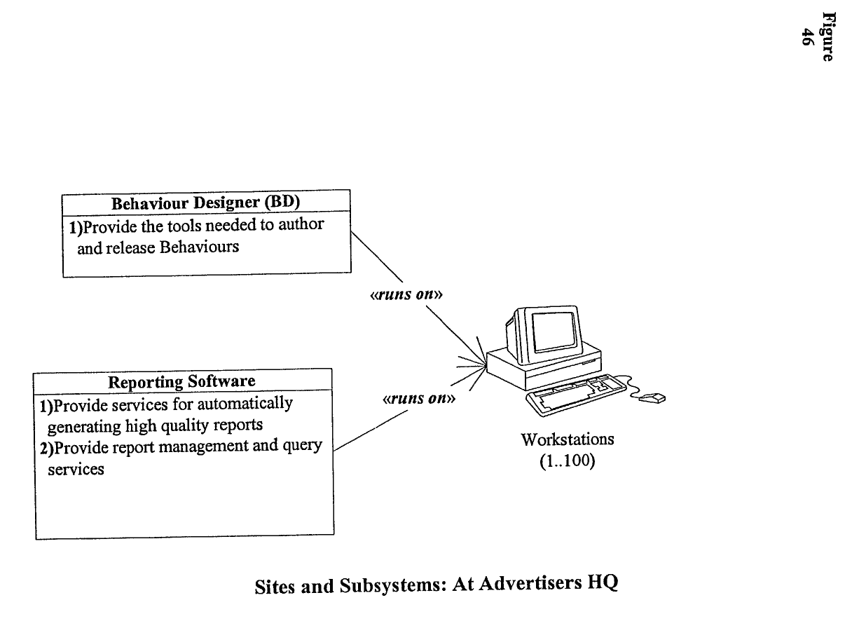

FIG. 45

At Creator HQ

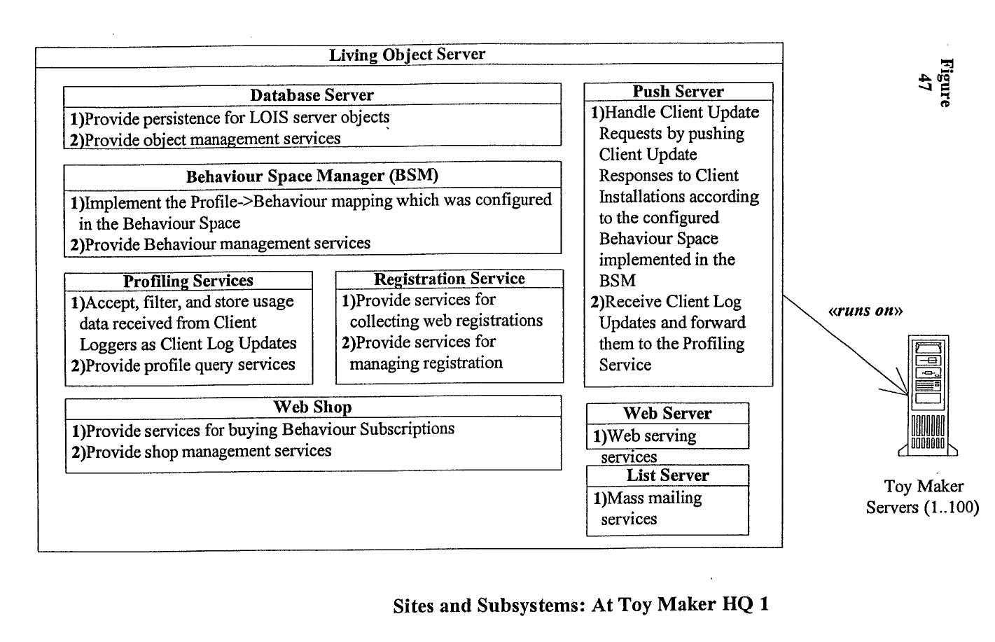

FIG. 46

At Advertisers HQ

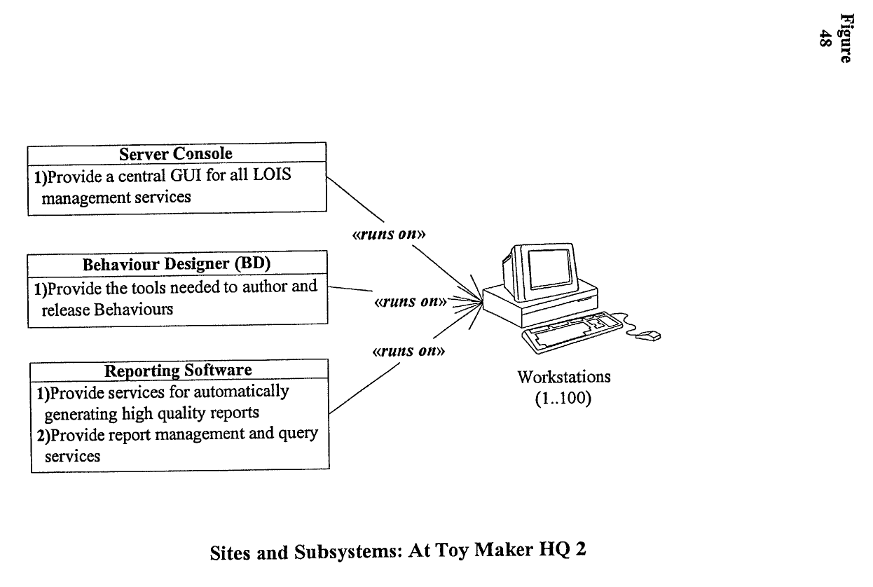

FIG. 47

At Toy Maker HQ 1: presents the Living Object Server

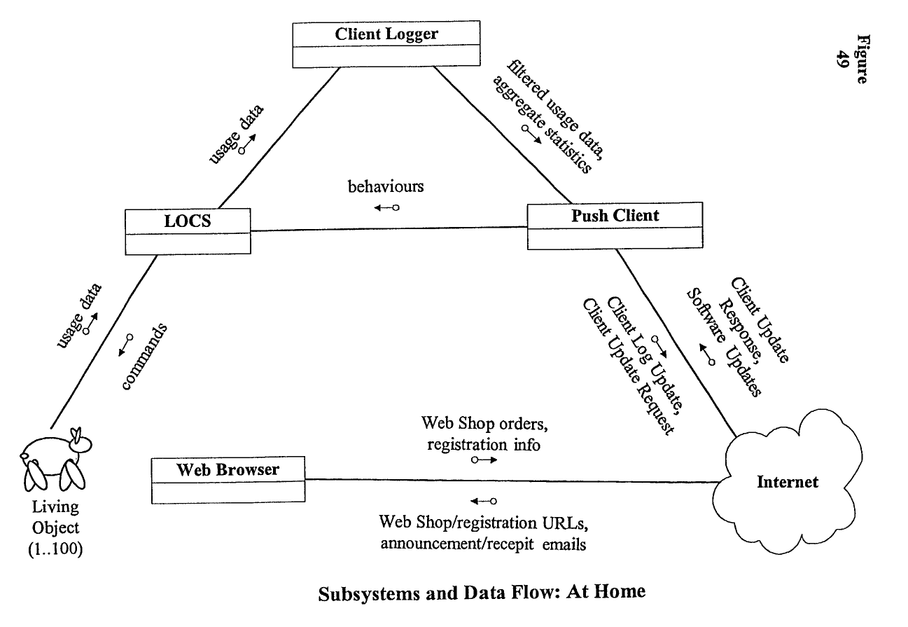

FIG. 48

At Toy Maker HQ 2: presents other LOIS subsystems running at the Toy Maker headquarters

Subsystems and Data Flow

There is a diagram for each site that presents the subsystems running there, and the data flow between them

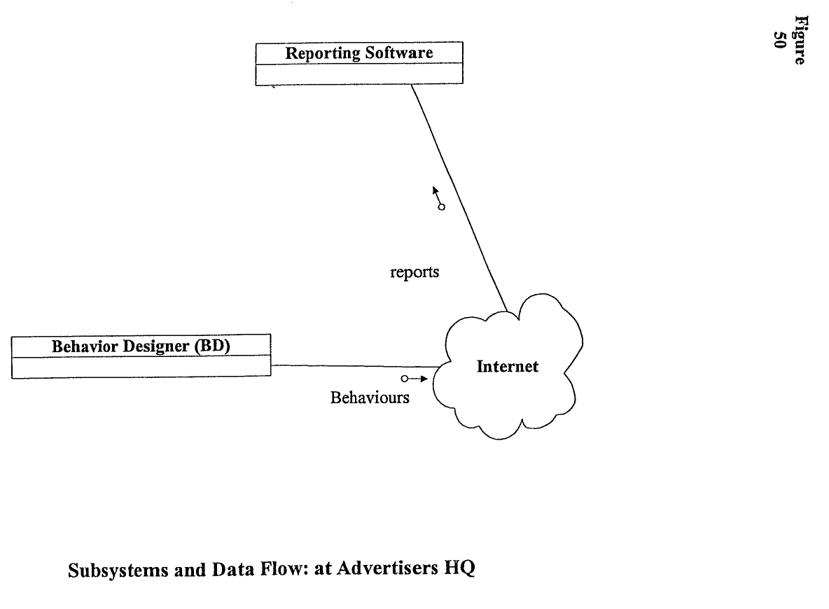

FIG. 49

At Home

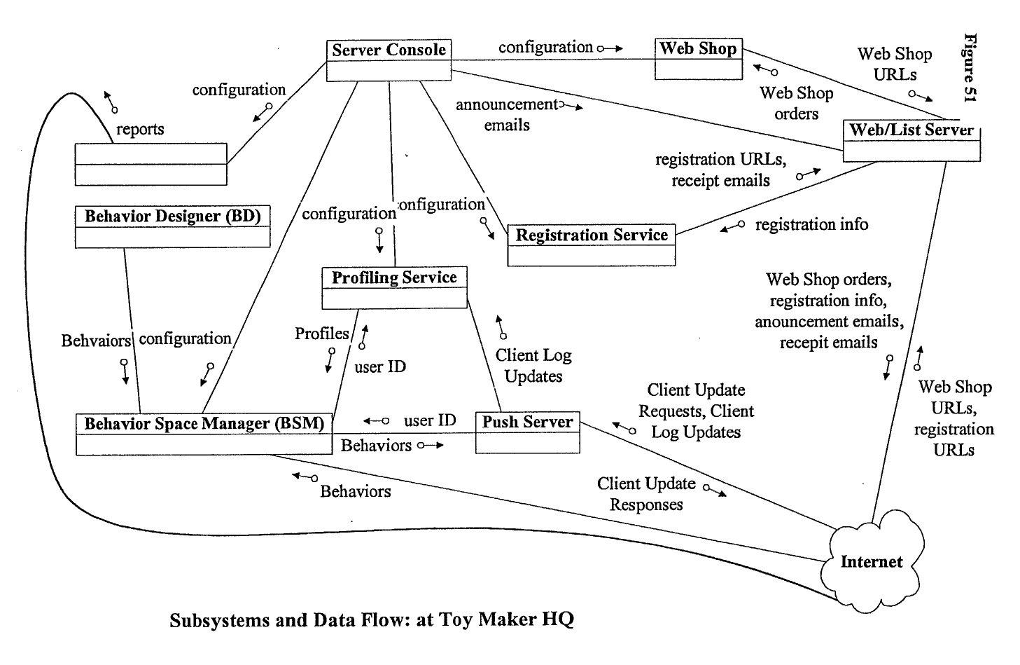

FIG. 50

At Advertisers HQ

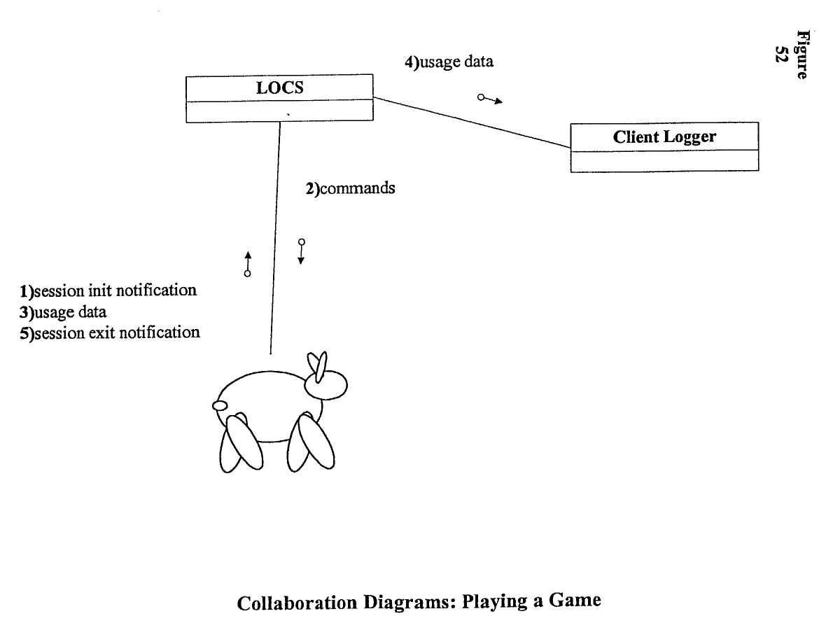

FIG. 51

At Toy Maker HQ

Collaboration Diagrams

There is a diagram for each of the major LOIS dynamics, showing how it accomplished by subsystems collaborating.

FIG. 58

Client Update: the collaborations that accomplish the update of a client installation, with a new Behavior

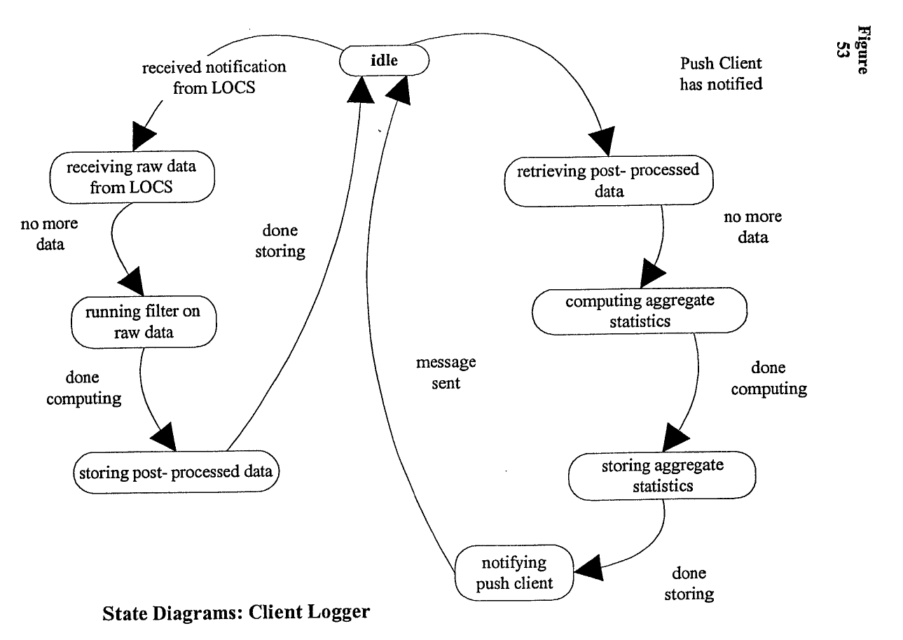

FIG. 52

Playing a Game: describes the collaborations involved in the entire process from authoring to deployment

State Diagrams

There are diagrams for each of the major subsystems in LOIS, showing the inner state transition network of the subsystem.

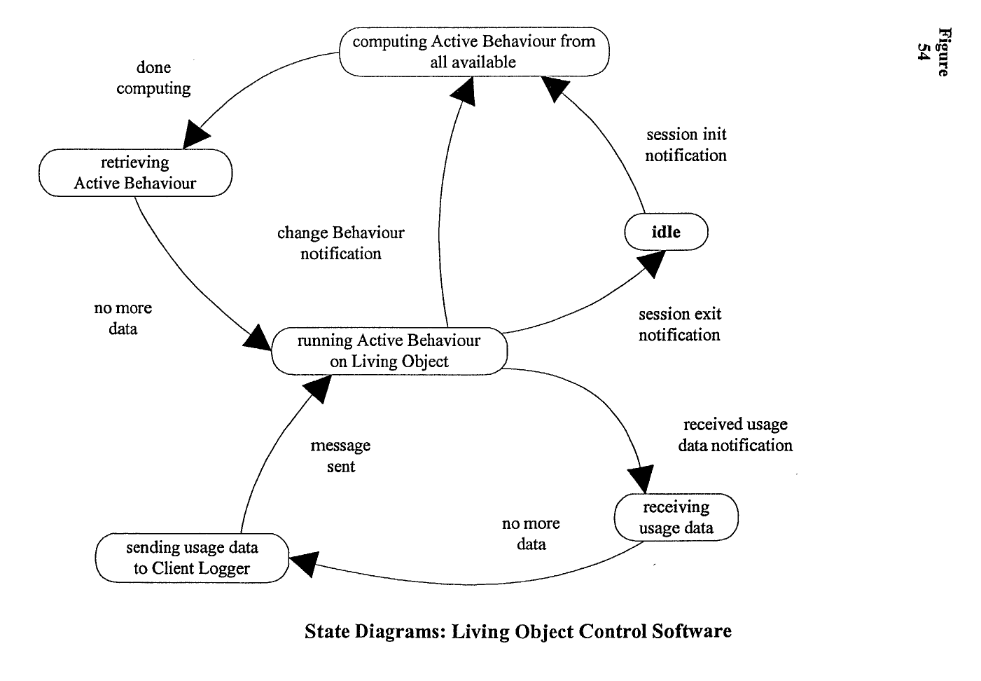

FIG. 53

Client Logger

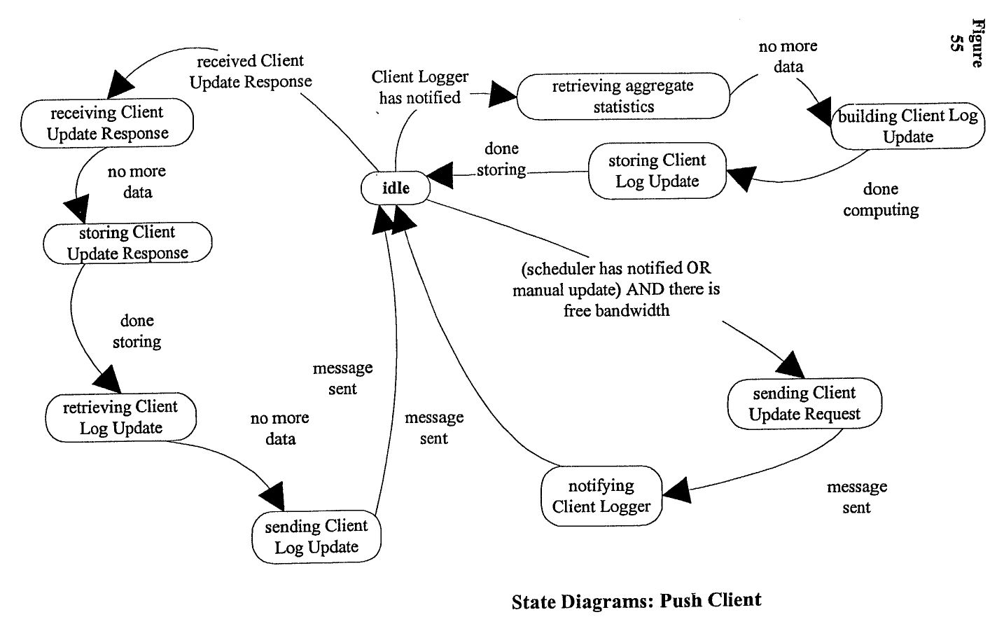

FIG. 54

Push Client

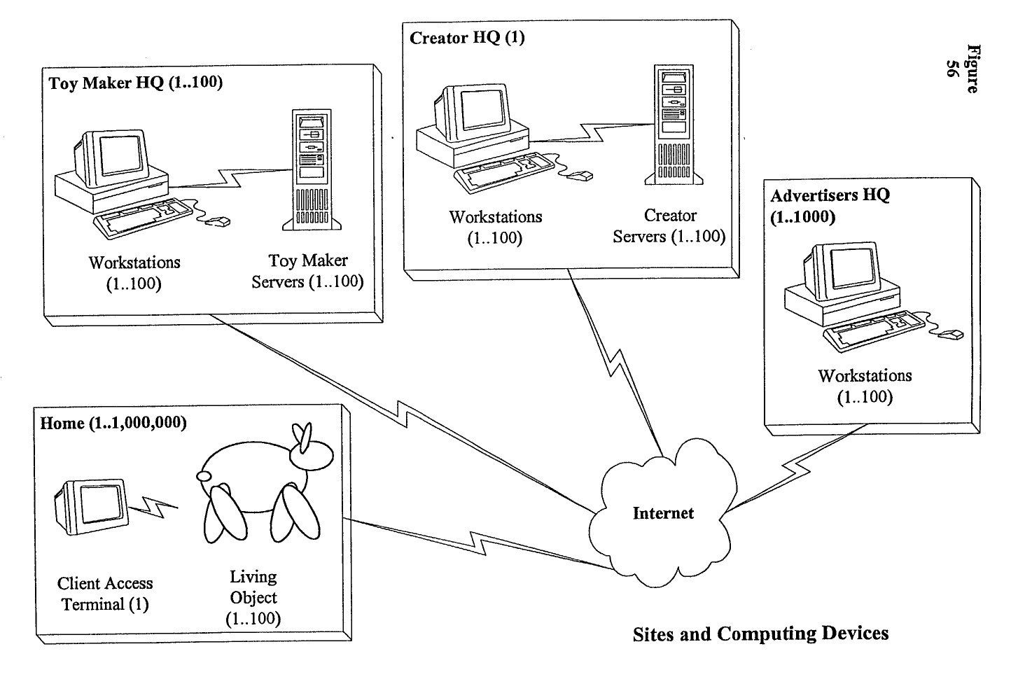

FIG. 55

Living Object Control Software

FIG. 56: Sites and Computing Devices

The diagram shows the sites that participate in LOIS, and the computing devices running LOIS software at these sites.

Notation

1. A 3-D block is a site. A site is defined as the aggregate of all subsystems owned by one organization, or home. The block is labeled with the name of the site and its cardinality.

2. Lightning connectors are communication links.

3. There are three types of computing devices inside the sites: a server, a workstation, and a Living Object.

Elements

1. Home: LOIS can support up to a million Client Installations.

Each client installation features at least one Living Object, and a Client Access Terminal. Initially the only possible computing device is a Win32 PC. In the future Mac, Java, and other platforms will be supported.

2. Toy Maker HQ: Up to a 100 Toy Makers can coexist in the initial implementation of LOIS. Each Toy Maker site features Staff Workstations and Toy Maker Servers.

3. Advertisers HQ: Up to a 1000 Advertisers are supported in the initial implementation of LOIS. Each site features a Staff Workstation.

4. Creator HQ: The Creator site consists of servers and Staff Workstations. There is only one Creator site. “Creator” is a name used for convenience to denote a supplier of living objects technology which may, for example, provide maintenance service for other HQs.

FIG. 57: Sites and Top Level Data Flow

The diagram shows the sites that participate in LOIS, and the computing devices running LOIS software at these sites.

Notation

1. A 3-D block is a site labeled with the site name.

2. A line connector indicates communication between the two connected sites.

3. The circle arrow elements represents the direction of the data flow. The attached text categorizes the data flow.

Connections

1. Toy Maker=>Home

Client Update Responses: these are the Behaviors that the Toy Maker Push Server returns in response to a Client Update Response.Web Shop URLs: these are the URLs the Toy Maker Web Store publishes. This includes catalog pages, search pages, purchase pages, and billing pages.

registration URLs: these are the URLs the Toy Maker Registration Service publishes as forms to accept/modify registration info from users.

receipt emails: emails from the Toy Maker that is receipt for online purchases.

announcement emails: emails from the Toy Maker with announcements that might interest Living Object owners.

2. Home=>Toy Maker HQ

Client Update Requests: these are requests sent according to the Push Client schedule. They contain a unique client id.

Client Log Updates: these are usage reports collected (and filtered/computed) on the client side by the Client,Logger, and sent to the Profiling Service.

registration info: this is the info collected by the registration forms. It is sent to the Registration Service at the Toy Maker site, from the web browser at the Client Installation.

Web Store orders: order sent through the web for specific Behavior Subscriptions.

3. Creator HQ=>Home

Software Updates: these are the latest version of LOIS client software. It is pushed and installed automatically.

4. Advertiser HQ=>Toy Maker HQ

Behaviors: these are Advertisement Behaviors authored on the Advertiser staff workstations, and uploaded to the Toy Maker Server.

5. Toy Maker HQ=>Advertiser HQ reports: that are used by the advertiser to better target users.

6. Creator=>Advertiser/Toy Maker HQ

Support requests/support : Creator provides online technical and end user support.

Sites and Actors

FIGS. 40-42: At Home, At Advertisers HQ, At Creator HQ:

These diagrams show the actors at the LOIS sites that participate in LOIS dynamics.

Notation

1. A 2-D block is an actor. It may represent several actual people. The block is labeled with the role name of the actor. The responsibilities list presents the LOIS dynamics where the actor participates. The collaborations list presents collaborating actors, and their relationships.

Sites and Actors

FIG. 43: At Toy Makers HQ

The diagram shows the members of the Toy Maker organization that participate in LOIS dynamics.

Notation

1. A 2-D block is an actor. It may represent several actual people. The block is labeled with the role name of the actor. The responsibilities list presents the LOIS dynamics where the actor participates. The collaborations list presents collaborating actors, and their relationships.

Elements

1. SysAdmin/Developer/WebMaster: The Toy Maker technical personnel. No other actors at the Toy Maker site are required to have technical skills. The exact skills required depend on: The type of Behaviors produced at the Toy Maker (regular/complex). Complex Behaviors require custom programming, and knowledge of the LOIS API. Most Behaviors can be created by non-technical Content Creators.

The nature of the Behavior Space required by the Toy Maker (regular/complex). Complex mappings between profiles/external data, and Behaviors, require custom programming, and knowledge of the LOIS API. Most of the Behavior Spaces that a Toy Maker will require, can be created by non-technical Advertising Managers.

The number of Client Installations subscribed to the Toy Maker (100,000s/millions). The higher the load on the Toy Maker servers, the harder it is to manage them and guarantee clients the performance they demand. Toy Makers with millions of subscribers will definitely require a skilled system administrator, if only for their web infosystem.

The level of workflow automation required between Advertisement Managers, Content Creators, and Managers (regular/complex). This includes workflow automation for the intranet, as well as for the Toy Maker extranet, communicating with Advertisers. Complex automation requires custom programming, and knowledge of the LOIS API. Simple workflow can be configured by any of the non-technical members of the Toy Maker staff.

The requirements of the Toy Maker web infosystem/Web Store (regular/complex). Complex Web Stores, linked to the Toy Maker main infosystem, require custom programming, and knowledge of the third party Commerce Software. Most Web Stores can be configured by any of the non-technical members of the Toy Maker staff.

The main responsibility of the SysAdmin is keeping the Toy Maker servers running. The Developer helps the Content Creator in creating complex Behaviors and web infosystem components, helps the Advertising Manager in creating complex Behavior A Spaces, and helps everyone in creating complex workflow automations. The WebMaster is responsible for the web infosystem.

2. Content Creator: Creates Behaviors using the Behavior Designer. The Content Creator might also help the WebMaster in preparing a web infosystem that will convince parents to buy Behavior Subscriptions.

3. Advertising Manager: Is responsible for getting more Behavior Subscriptions sold, and for selling parts of the Behavior Space to Advertisers. Also responsible usage and profile data reports.

4. Manager: Manages the operation where Content Behavior Subscriptions are sold to users, and Advertisement Behaviors are pushed to users. Interacts mostly with reporting facilities in LOIS.

Sites and Subsystems

FIG. 44: At Home

The diagram shows LOIS software subsystems, and the computing devices they run on, at the Client Installation.

Notation

1. A 2-D block is a software subsystem. It shows the subsystem name, and a list of its responsibilities. Software subsystems can nest. The responsibilities of a container subsystem are defined all the responsibilities assumed by contained subsystems.

2. Lightning connections represent a communication link between computing devices.

3. Directed connections are labeled with their stereotype.

Elements

1. Living Object: An interactive toy controlled by the LOCS. Communicates through radio link with Client Access Terminal.

2. Client Access Terminal: A personal/network computer running the Living Object Client. Communicates through radio with Living Object.

3. Living Object Client: Defined as the subsystem that includes all software running on a Client Access Terminal: the Client Logger, the LOCS, and the Push Client.

4. Client Logger: A software package which collects usage data from the LOCS, passes it through client side filters, and sends it to the Profiling Service, via the Push Client. It exists to facilitate client side filtering of usage data. For example: instead of sending 100 scores of a 100 vocabulary drills, the Client Logger computes averages, and these are sent to the Toy Maker Profiling Service.

5. Living Object Control Software: (LOCS) The software package which controls the Living Object. It translates Behavior data submitted from the Push Client, into interactive commands which run on the Living Object.

6. Push Client: A third party software package, customized by Creator for LOIS. It provides the client side of the push layer of LOIS.

7. Web Browser: A third party software package. It is used as a client for registration/billing, and for the Web Store. This allows us to simplify the client.

Connections

1. The Living Object Client runs on the Client Access Terminal.

Sites and Subsystems

FIG. 45: At Creator HQ

The diagram shows LOIS software subsystems, and the computing devices they run on, at the Creator headquarters.

Notation

1. A 2-D block is a software subsystem. It shows the subsystem name, and a list of its responsibilities. Software subsystems can nest. The responsibilities of a container subsystem are defined all the responsibilities assumed by contained subsystems.

2. Lightning connections represent a communication link between computing devices.

3. Directed connections are labeled with their stereotype. Elements

1. Creator Server: The server that runs LOIS software at the Creator site.

2. Push Server: A software the provides the server side of the LOIS push layer.

Connections

1. The Push Server runs on the Creator Server.

Sites and Subsystems

FIG. 46: At Advertisers HQ

The diagram shows LOIS software subsystems, and the computing devicesthey run on, at the Advertisers headquarters.

Notation

1. A 2-D block is a software subsystem. It shows the subsystem name, and a list of its responsibilities. Software subsystems can nest. The responsibilities of a container subsystem are defined all the responsibilities assumed by contained subsystems.

2. Lightning connections represent a communication link between computing devices.

3. Directed connections are labeled with their stereotype.

Elements

1. Workstation: The workstation that runs LOIS software at the Advertisers site.

2. Behavior Designer: A friendly application for authoring complex Behaviors. The output of working with this software, is an authored Behavior.

3. Reporting Software: A subsystem that helps the Advertisers understand the who is using LOIS, and how they are using it.

Connections

1. The Behavior Designer runs on the Workstation.

2. The Reporting Software runs on the Workstation.

Sites and Subsystems

FIG. 47: At Toy Maker HQ 1

The diagram shows LOIS software subsystems, and the computing devices they run on, at the Toy Maker headquarters. In this diagram we focus on the elements of the Living Object Server.

Notation

1. A 2-D block is a software subsystem. It shows the subsystem name, and a list of its responsibilities. Software subsystems can nest. The responsibilities of a container subsystem are defined all the responsibilities assumed by contained subsystems.

2. Lightning connections represent a communication link between computing devices.

3. Directed connections are labeled with their stereotype.

Elements

1. Toy Maker Servers: A computing device/s that runs the Living Object Server software.

2. Living Object Server: The subsystem that includes the Push Server, database server, Web Shop, Registration Service, Behavior Space Manager, and Profiling Service, web server, and list server

3. Database server: All subsystems use the ODBMS libraries for handling persistent objects. Most important objects in LOIS are persistent in the database server. Because we are working with ODMG-93 there is no database code such as embedded SQL. We do not mention the database server anymore, since the ODMG mappings allow us to treat it as transparent.

4. Behavior Space Manager: A software subsystem that has two roles. For design-time, it provides services for effectively managing large Behavior Spaces, uploading Behaviors, query and reporting services, etc. For run-time, it provides a function that maps any user ID to a Behavior.

5. Living Object Control Software: (LOCS) The software package which controls the Living Object. It translates Behavior data submitted from the Push Client, into interactive commands which run on the Living Object.

6. Push Client: A third party software package, customized by Creator for LOIS. It provides the client side of the push layer of LOIS.

7. Web Browser: A third party software package. It is used as a client for registration/billing, and for the Web Store. This allows us to simplify the client.

Connections

1. The Living Object Client runs on the Client Access Terminal.

Sites and Subsystems

FIG. 48: At Toy Maker HQ 2

The diagram shows LOIS software subsystems, and the computing devicesthey run on, at the Toy Maker headquarters. In this diagram we focus on the subsystems not in the Living Object Server.

Notation

1. A 2-D block is a software subsystem. It shows the subsystem name, and a list of its responsibilities. Software subsystems can nest. The responsibilities of a container subsystem are defined all the responsibilities assumed by contained subsystems.

2. Lightning connections represent a communication link between computing devices.

3. Directed connections are labeled with their stereotype.

Elements

1. Workstation: A workstation that runs LOIS software.

2. Reporting Software: A subsystem that helps the Toy Maker understand the who is using LOIS, and how they are using it. It works against all existing information, to create customizable reports. It has the capability to create automatic reports, on schedule.

3. Behavior Designer: A friendly application for authoring complex Behaviors. The output of working with this software, is an authored Behavior.

4. Server Console: The main interface to LOIS. Its main features are:

Manage Behaviors and configure the Behavior Space Manager

Configure the Web Shop

Configure the Profiling Service

Configure the Registration Service

Manage Users, registration, billing

Configure automation for the Reporting Software

Initiate sending of announcement emails

Connections

1. All subsystems run on the Workstation.

Subsystems and Data Flow

FIG. 49: At Home

The diagram shows the data flow between the subsystems at the ClientInstallation.

Notation

1. A 2-D block is a software subsystem. It shows the subsystem name.

2. Connections imply communications between the subsystems/devices.

3. Data flow symbols show the direction, and a list of the message classes that flow in the link. Nothing is implied about the order of the data flow.

Connections

1. LOCS<=>Living Object: The LOCS translates Behaviors into commands that can be run on the Living Object. All usage data is sent from the Living Object to the LOCS.

2. LOCS=>Client Logger: Behaviors may contain code that passes specific usage data to the Client Logger.

3. Push Client=>LOCS: New Behaviors are passed to the LOCS.

4. Client Logger=>Push Client: Usage data is filtered by the Client Logger, and only filtered data aggregate statistics are passed to the Push Client.

5. Push Client<=>Internet: The Push Client passes Client Update Requests to the Internet, signifying a Behavior update is requested. It also passes Client Log Updates, that contain data prepared by the Client Logger. From the Internet the Push Client receives Client Update Responses (Behaviors), and software updates that it installs.

6. Web Browser<=>Internet: The web browser is used to browse the Web Store, purchase Behavior Subscriptions, and for LOIS email.

Subsystems and Data Flow

FIG. 50: At Advertisers HQ

The diagram shows the data flow between the subsystems at the Advertisers headquarters.

Notation

1. A 2-D block is a software subsystem. It shows the subsystem name.

2. Connections imply communications between the subsystems/devices.

3. Data flow symbols show the direction, and a list of the message classes that flow in the link. Nothing is implied about the order of the data flow.

Connections

1. Internet=>Reporting Software: Usage reports are received from the Toy Maker, and are used to create campaigns.

2. Behavior Designer=>Internet: Advertisement Behaviors are uploaded to the Toy Maker Server, where they will be pushed to Client Installations.

Subsystems and Data Flow

FIG. 51: At Toy Maker HQ

The diagram shows the data flow between the subsystems at the ToyMaker headquarters.

Notation

1. A 2-D block is a software subsystem. It shows the subsystem name.

2. Connections imply communications between the subsystems/devices.

3. Data flow symbols show the direction, and a list of the message classes that flow in the link. Nothing is implied about the order of the data flow.

Connections

1. Server Console=>Reporting Software: The Server Console applies configuration to the Reporting Software.

2. Server Console=>Profiling Service: The Server Console applies configuration to the Profiling Service.

3. Server Console=>Registration Service: The Server Console applies configuration to the Registration Service.

4. Server Console=>Web Store: The Server Console applies configuration to the Web Store.

5. Server Console=>Behavior Space Manager: The Server Console applies configuration to the Behavior Space Manager.

6. Behavior Designer=>Behavior Space Manager: Behaviors are authored and passed to the BSM, where they are added to all available Behaviors.

7. Server Console=>Web/List Server: announcement emails are authored/uploaded and edited in the Server Console, then passed to the List Server for mass mailing.

8. Behavior Space Manager<=>Profiling Service: The Behavior Space Manager performs queries on profiling data using user IDs as keys.

9. Behavior Space Manager<=>Push Server: The Push Server passes user IDs of Client Update Requests to the BSM. It maps them to Behaviors that are returned to the Push Server.

10. Push Server=>Profiling Service: Client Log Updates from Client Loggers are sent to the Profiling Service from the Push Server.

11. Internet=>Behavior Space Manager: Behaviors authored at the Advertisers site are sent to the BSM, where they are added to all available Behaviors, and any special rules are applied.

12. Internet<=>Push Server: The Push Server sends out Behaviors, and receives requests, and usage data.

13. Web Shop<=>Web/List Server: Web Shop URLs are produced on the fly by the Web Shop. It also accepts orders from the web server.

14. Web/List Server<=>Registration Service: This data flow is required for registration services.

15. Web/List Server<=>Internet: This data flow is required for registration services, Web Store services, and email communications.

Collaboration Diagrams

FIG. 58: Client Update

The diagram shows the collaborations involved in a client update.

Notation

1. A 2-D block is a software subsystem. It shows the subsystem name.

2. Connections imply communications between the subsystems/devices.

3. Data flow symbols show the direction, and a list of the message classes that flow in the link. Each message shows its sequential order in the diagram.

Dynamics

1. The Push Client notifies the Client Logger that a client update is about to take place. It does this on schedule, and only when ‘bandwidth niceness’ permits.

2. The Client Logger passes the usage data to the Push Client. This is asynchronous to the rest of the process, but must happen during the client update.

3. The Push Client sends Client Update Request with the user ID.

4. The Client Update Request is received by the Push Server.

5. The Push Server requests a mapping from the BSM by passing it a user ID.

6. The BSM replies with a list of Behaviors that are fitting for the Client Installation.

7. The Behaviors are packaged into a Client Update Response and sent to the Push Client.

8. The Push Client receives the Client Update Response.

9. The Behaviors are sent to the LOCS after being extracted from the Client Update Response.

10. Asynchronous to the rest of the process, but during the Client Update, a Client Log Update is sent from the Push Client, from the usage data sent by the Client Logger.

11. Push Server receives the Client Log Update.

12. Client Log Update is sent to the Profiling Service.

Collaboration Diagrams

FIG. 52: Playing a Game

The diagram shows the collaborations involved when a game is played on the Living Object.

Notation

1. A 2-D block is a software subsystem. It shows the subsystem name.

2. Connections imply communications between the subsystems/devices.

3. Data flow symbols show the direction, and a list of the message classes that flow in the link. Each message shows its sequential order in the diagram.

Dynamics

1. The Living Object notifies the LOCS of a session init event. This could be because it has sensed the Child, or because the Child initiated a session.

2. The LOCS and the Living Object now communicate commands and interactions, that implement the running Behavior.

3. During the session the Living Object passes any usage data that the running Behavior specifies to the LOCS.

4. The Usage Data is sent to the Client Logger.

5. Eventually a session exit event is raised by the Living Object. This may be because a timeout has occurred.

State Diagrams

FIG. 53: Client Logger

The diagram shows the internal states and transitions at the ClientLogger subsystem.

Notation

1. A round block is a state. It shows the name of the state.

2. Directed connections imply a possible state transition.

The text shows the condition for the transition.

Notes

There are 2 super states for the Client Logger. They are shown as two loops from the idle state. The first is initiated by the LOCS, and the second by the Push Client.

Having the Client Logger compute statistics at the latest possible time (when Push Client notifies it is going online), provides better accuracy.

State Diagrams

FIG. 54: Living Object Control

Software

The diagram shows the internal states and transitions at the LOCS.

Notation

1. A round block is a state. It shows the name of the state.

2. Directed connections imply a possible state transition. The text shows the condition for the transition.

Notes

Most of the time the LOCS is either idle, or running Active Behavior on Living Object. When changing Behavior, or initializing a new one, LOCS computes a new active behavior, and retrieves it from disk. When instructed to do so by the active behavior, LOCS will send any usage data to the Client Logger.

State Diagrams

FIG. 55: Push Client

The diagram shows the internal states and transitions at the PushClient.

Notation

1. A round block is a state. It shows the name of the state.

2. Directed connections imply a possible state transition.

The text shows the condition for the transition.

Notes

There are three super states at the Push Client, shown as three loops going out of the idle state. When conditions permit us to go online, a Client Update Request is sent and the Client Logger is notified to prepare any last minute statistics. When the Client Logger notifies they are ready, a Client Log Update is prepared. When Client Update Responses are received, the Client Log Update is uploaded to the Push Server.

Various terms used in the specification and claims are now discussed:

Advertisement Class;

A type of Behavior which was paid for by an Advertiser, but is not different in other aspect from Content.Advertiser

Class;

An organization that buys Behavior Space from the Toy Maker, and populates it with Behaviors it creates.

Advertising Manager Actor;

The member of Toy Maker or Advertiser staff ultimately responsible for a Behavior Space. Advertising Managers collaborate to split the entire Behavior Space between them. The Toy Maker Advertising Manager has supreme control over the entire Behavior Space.

List Server Subsystem;

The Living Object Server subsystem that manages mass mailings of announcements and receipts.

Behavior Class;

The smallest unit of the living object behavior published from the Behavior Designer. It defines Living Object interactivity for some period of time. A Behavior may be dependent on other Behaviors.

Behavior Designer Subsystem;

(BD) A Creator application, part of LOIS, that allows Content Creators to create interactive Behaviors.

Behavior Space Class;

An object that models a part of the entire behavior space, defined as the mapping that defines at any time and situation, what Behavior should be run at each client. Example: the Behavior Space called: ‘Young Children Afternoon’ defines what behaviors young children will receive for their afternoons.

Behavior Space Manager (BSM) Subsystem;

The software installed on the Living Object Server that manages the Toy Maker Behavior Spaces. It implements the mappings between Profiles and Behaviors (i.e. narrow-casting/personalization).

Behavior Subscription Class;

A subscription that a Parent purchases at the Web Store, or receives with a purchased Living Object. If a User is subscribed to a Behavior Subscription, then LOIS will guarantee the delivery of certain Behaviors to the subscriber.

Child Actor;

A user that interacts with a Living Object.

Client Access Terminal Subsystem;

A computer that runs the Living Object Client software. Exists in the Client Installation.

Client Installation Subsystem;

A subsystem that includes the Child, Parent, Client Access Terminal, and any number of Living Objects.

Client Log Update Class;

A message sent from the Client Logger to the Profiling Service, sent through the push software. It contains filtered usage data of the Living Object.

Client Logger Subsystem;

A client subsystem responsible for collecting usage data, and sending it to the Profiling Service, after running client side filters, and perhaps computing client side aggregate statistics.

Client Update Request Class;

A message from the Push Client to the Push Server, through the push software, with a User id. It implies the client is ready to receive a Client Update Response.

Client Update Response Class;

A message from the Push Server to the Push Client, through the push software. Contains a group of Behaviors.

Content Class;

A type of Behavior that was purchased at the Web Shop, or distributed as a customer service.

Content Creator Actor;

The member of the Toy Maker or Advertiser staff that creates Behaviors.

Database Server Subsystem;

The software that provides object and schema storage/query/management services for other Toy Maker subsystems. Runs on the Living Object Server.

Game Class;

The time between the session init notification, and the session exit notification. This is the time the Living Object recognizes the Child, and the child wants to interact. Any number of Behaviors may be run during a single game.

Living Object Subsystem;

(LO) An interactive computing device controlled by the Living Object Control Software

Living Object Client Subsystem;

The subsystem that includes all software running on a Client Access Terminal: the Client Logger, Living Object Control Software, and the Push Client.

Living Object Control Software Subsystem;

(LOCS) The software that controls the Living Object. It runs behaviors. Runs on the Client Access Terminal.

Living Object Internet System System;

(LOIS) The system that provides Toy Makers and Advertisers with effective, high-resolution control over Behavior Spaces, and the transparent publishing of the correct Behaviors to millions of subscribers.

Living Object Server Subsystem;

The subsystem that includes the Push Server, database server, Web Shop, Registration Service, Behavior Space Manager, and Profiling Service, web server, and list server. It is at the Toy Maker site.

Living Object Provider Software Subsystem;

The subsystem that includes all software running at Site Maker and Advertiser sites: Behavior Designer, Server Console, Behavior Space Manager, Profiling Service, Push Server, database server, Reporting Software, Registration Service, and Web Shop.

Manager Actor;

The member of the Toy Maker in charge of setting business policy and analyzing business performance reports.

Parent Actor;

The user that purchases, registers, and installs Living Objects, purchases subscriptions, and helps the Child.

Profile Class;

The object that models all usage and registration information concerning a User.

Profile Group Class;

A customizable set of Profiles defining a meaningful group. Example: pre-schoolers on weekdays.

Profiling Service Subsystem;

The Living Object Server subsystem that manages profiling data. Runs on the Living Object Server.

Push client Subsystem;

The software installed on the Client Access Terminal that provides push services over the Internet.

Push server Subsystem;

The software installed on the Living Object Server, and the Creator server, that provides push services over the Internet.

Registration Service Subsystem;

The software that handles user registration through the web.

Reporting Software Subsystem;

The software that generates reports and analysis from usage data generated by the Profiling Service.

Server Console Subsystem;

The end-user software used to control LOIS. Runs on the Toy Makers workstations.

Software Update Class;

A message from the Creator Server to the Push Client, through the push software. Contains updates to the Client Software.

Staff Workstation Subsystem;

A computer/s that runs the Behavior Designer/Server Console/Reporting Software, and any web development tools, at the Toy Maker or Advertiser site.

Toy Maker Organization;

An organization which sells Living Objects, and runs a subscription fee/advertisement revenue based operation, creating and distributing Behaviors.

User Class;

The object that models a Client Installation, and is persistent at the Living Object Server.

Web Shop Subsystem;

A WWW site that allows Parents and Children to browse, sample, and purchase Content. Content is purchased as a Behavior Subscription.

One possible implementation of a LOIS system is now described.

1.1. Goals of First Implementation

The first implementation of LOIS is targeted at toy makers, who wish to centrally manage their living toys, which are at user's homes. These are the high level goals of the project:

Easy installation and usage for parents and kids

Easy control of living object behaviors by toy makers and/or toy content providers, but with very high resolution

Leverage the strengths of the latest commercial push software

Provide a basic framework for future product plans more specifically, it is best if we could provide a software which will not require any modifications in source code, when it is tightly integrated in the future, with the Creator software for managing the behavior tree of a living object

1.2. Services and their Use Case Analysis

The product should provide the following services, grouped by the users targeted by the service: children, parent, and big corporations. We describe the services, and an analysis of the related use cases.

1.2.1. Child services

The main service offered to children, who are the direct users of the living objects, is the transparent updating of object behaviors.

Name

Client side of living object update

Actors

The child is involved only in that he may trigger the use case, but there are other ways for it to be triggered. The child is the actor the use case is servicing.

Goal

That the living object be updated automatically.

Forces in Context

1) Automatic, transparent

2) Graceful, silent handling of errors

3) Error correction, guaranteed delivery

4) Bandwidth ‘niceness’

5) Security, privacy

6) Several providers per toy

Trigger

Depends on exact configuration.

1) Generally users will configure the push client to run updates at specific intervals, so the trigger is the scheduler

2) Users may manually initiate a download

### SUMMARY

This use case captures the scenario where the client requests and receives a new living object update.

1) client asks server for new updates

2) new updates are sent to the client

3) at the end of each complete living object update, Creator software is notified

Pre-conditions

1) No download will occur if the client is completely ‘refreshed’

2) The push client must be installed first

3) The client must be registered first

Post-conditions

1) There is now a new complete living object update on the users HD

2) Creator client software is notified

Related use cases

1) Registration is a requirement

2) Configuring the living object update process determines what is updated

1.2.2. Parent Services

Parents are responsible for all aspects of operating and updating the living object at their home, which the children cannot perform.

1.2.2.1. Installation

The product should be safe and easy to install, so parents can install new toys painlessly.

Name

Installation of push client

Actors

Parent

Goal

That the push client be installed correctly, so that registration can commence.

Forces in Context

1) Installshield type installation

2) There could have been previous installation, i.e. this could be a 2nd, 3rd, etc. living object

3) There are several different types of win=OSs

4) The client itself must look unique and reflect some corporate identity, definitely not the 3rd party push software maker identity

Trigger

User manually starts the installation process from CD, or from a downloaded file

### SUMMARY

This use case captures the first, and later installations of the LOIS client.

1) User is asked several configuration parameters, or if this is not a first toy, old parameters are used

2) User advances to the registration use case

Pre-conditions

User downloaded the package, or has a CD

Post-conditions

Everything is setup for registration

Related use cases

1) Registration should follow immediately, or be deferred to a later time at the users convenience

1.2.2.2. Registration

These services include everything involving registration and billing.

Name

Registration

Actors

Parent

Goal

That the specific living object, recently purchased, be registered at the central database, or that information previously entered in registration be modified

Forces in Context

1) Should be similar in feel (to the user) to web site registrations

2) Security, privacy

3) The exact nature of the registration info connected is not fixed, and is determined by the big corporation

4) Layout and styling are important

5) There is probably required, and optional registration information

6) Changing registration information should be the same type of experience for the user

7) There is some information which needs to be passed to the server which should not be generated manually, but which is burnt on the installation CDROM

Trigger

1) User has completed the installation of push client, and moves on to registration immediately or at a later time

2) User wishes to refresh any of his registration attributes

### SUMMARY

This use case captures the scenario where the user registers, or modifies his registration information.

1) User is taken to the registration web site automatically

2) User fills in form, or changes a form with existing values

3) User submit form

4) If form is complete user is shown a thank

5) User is emailed a receipt

Pre-conditions

That the push client be installed

Post-conditions

Living object is now registered, user has received receipt

Related use cases

1) Installation of push client should be completed

2) Configuring the registration process determines the specifics of the process

Name

Reviewing billing information

Actors

Parent

Goal

That the actor be able to review-his billing status anytime, i.e. his subscriptions, history etc.

Forces in Context

1) Should be a simple web page

2) Should include the option to communicate with technical, and billing support of the big corporation

3) Security, privacy

4) Support of multiple currencies

Trigger

User initializes the use case by going to a secure URL. This may be done by clicking the ‘review billing’ button in the push client, or on the big corporations web site

### SUMMARY

This use case captures the scenario where the user checks his billing status

1) User logs in to the billing page

2) All information is displayed on one page

3) User may cancel any outstanding subscriptions

4) User may contact billing or technical support through the page

Pre-conditions

That the user have at least one living object installed and registered

Post-conditions

User is now aware of the exact details concerning any billing she was involved with

Related use cases

1) Registration should have been completed

1.2.2.3. Buying Behaviors

This service allows parents to purchase subscriptions, behaviors, and groups of living object behaviors, over a secure web store front.

Name

Buying behaviors

Actors

Parent

Goal

That the actor be able to purchase behaviors for his living object

Forces in Context

1) Security, privacy

2) Should have the look and feel of normal web store fronts

3) Behaviors might be available as a single update, subscription, or a group of updates

4) Support of multiple currencies

Trigger

User may reach the web store though the big corporations web site, by clicking on a ‘check out new behaviors’ button in the push client, or by interacting with the living object

### SUMMARY

This use case captures the scenario where the user buys behaviors.

1) User logs in to the web store

2) User surfs the store, and adds to shopping bag wanted items

3) User is presented with billing information

4) User reviews billing, and once she approves the central server is notified about a change in policy concerning the user

Pre-conditions That the user have at least one living object installed and registered

Post-conditions

Server should now attempt to push the new behaviors to the user

Related use cases

1) Registration should have been completed

1.2.3. Big Corporation Services

The focus of the initial implementation is providing useful services to big corporations. The goal of these services is to allow them to provide constantly updating behaviors for the home users living objects, to make sure that the behaviors match the home user preferences, and to sell behaviors over the Internet. Several types of services are required to support these goals. We do not examine the ‘install server software’ use case, since it is assumed that Creator technical personnel will perform this task.

1.2.3.1. Control Over Narrow-Casting

We preferably provide the services to allow the big corporations extra-fine resolution control over personalization aspects of the living object updates process, so that they can effectively narrow-cast to the individual users. Another very important requirement of these services, is that they scale to 100,000 users.

Name

Configuring the registration process

Actors

Big corporation

Goal

That the actor be able to configure the registration process

Forces in Context

1) security

2) Corporation wants to know as much as possible about users

3) Corporations don't want users to be totally aware of item 2

4) Corporations want to layout and style the process to their liking

5) Each corporation requires different registration information

6) There are some universally common aspects of such questionnaires, such as ‘user name’, ‘user email’, etc. Thus we can give the users a jump start by providing several default questionnaires

Trigger

Big corporations have a button which takes them to the web page which configures the process

### SUMMARY

This use case captures the scenario where the user determines the specifics of registration

1) User adds/removes an existing question from the registration form

2) User edits an existing question: is it optional or required? What is its text? Is it a choice question, or a text box? Must it be numeric?

3) User can loop back to step 1

4) User designs an HTML template for the questionnaire, starting from the automatically generated template defined by the registration details

Pre-conditions

That the big corporation server software is installed

Post-conditions

Big corporation now has a registration web page for its users of living objects

Related use cases

1) The Registration is determined by the results of this use case

2) Configuring the living object update process uses the registration information

Name

Gathering user profiling data

Actors

Big corporation server

Goal

That the actor be able to automatically gather all profiling data, and place it in the correct context, i.e. the user object which represents the user generating the data

Forces in Context

1) Privacy

2) Corporation wants to know as much as possible about users

3) Corporations don't want users to be totally aware of item 2

4) Profiling data may come from: server logs of behavior downloads, living objects, registration, purchases of behaviors

5) This data may be potentially huge, we must allow some filtering, compression, or summaries to control the volume

6) The data must be placed in the correct context in the central database to support analysis

Trigger

1) Server registers a download

2) Living object sends profiling data

3) Registration data has been accepted

4) A purchase in the web store has occurred

### SUMMARY

This use case captures the scenario where the server automatically gathers and sorts profiling data from a variety of sources. It is an automated process, where the user can only control which data is gathered (should be all by default), i.e. there is a form with checkboxes where the user may stop the server from gathering data from a specific aspect of the system

Pre-conditions

That registration be configured

Post-conditions

Big corporation now has all possible data about all its users

Related use cases

1) The Configuring the registration process use case determines which data is available from registration

2) The Server side of update process use case contributes data

3) The Handle the server side of a purchase use case contributes data

Name

Configuring the living object update process

Actors

Big corporation

Goal

That the actor be able to configure the living object update

Forces in Context

1) Security

2) Corporation want to match users with behaviors according to their ideas of ‘match’

3) Corporations can have very different ideas on what ‘match’means exactly

4) There is something in common among all ‘match’ ideas, namely that they can be best described as a vector of rules, and several rules which probably everybody will use, such as: ‘decide by age’, ‘decide by subscription information’, ‘decide by locale’, etc.

5) The match should be made (if needed) against all available profile data

6) Non-technical users should be able to configure a pretty good update process using rules which we should provide in the base package

7) Each living object should have its own set of configured rules

8) There are several views (by profile, toy, living object update) for designing an update process, users want to be able to choose

Trigger

Big corporations have a button which takes them to the web page which configures the process

### SUMMARY

This use case captures the scenario where the user determines the specifics of the living object update process. Here is an example:

1) User chooses a specific living object to configure

2) User adds/removes rules from the process. Rules are chosen from available rule classes

3) User modifies existing rules. Each available rule class has configuration parameters

4) User rearranges, copies and pastes rules

5) User can loop back to step 2

6) User tests the update process she has configured for the living object, and views prototypical results

Pre-conditions

1) That the living object has been defined in the central server

2) That registration format is configured

Post-conditions

Big corporation now has a configured living object update process which will manifest itself in every update

Related use cases

1) Add new living object updates is a requirement

1.2.3.2.

Name

Server side of update process

Actors

Big corporation server

Goal

That the actor be able to implement the update process previously defined

Forces in Context

1) Security, privacy

2) There could be up to 100,000 users, where 100s of them are updating at once

3) Servers are expensive, so the process should be optimal as can be

4) Corporations should be able to increase their load capacity in a scalable manner, i.e. without a lot of work

5) The update process itself could have been configured in any number of ways

6) We must log everything

7) The process could be interrupted while running (e.g. user disconnects, et.) so saving exact state is important

8) There has to be built in default behavior when overloaded, so we never end up in a limbo state

Trigger

LOIS push client connects to the server and requests an update

### SUMMARY

This use case captures the scenario where the server is refreshing the clients

1) Server receives an update request

2) Server runs through the rules configured earlier, resulting in any number of updates which are now to be passed to the client

3) Server passes updates to the client

Pre-conditions

1) That registered clients exist

2) That the living object update process has been completely defined

Post-conditions

Clients have been updated, or have been partially updated

Related use cases

1) Add new living object updates is a requirement

2) Configuring the living object update process is a requirement

1.2.3.3. Control Over Living Object Behavior Database

The goal of these services is to allow the big corporations to create an easy to manage, large store of behaviors for living objects.

Name

Add new living object to the database

Actors

Big corporation

Goal

That the actor be able to add new living objects to the living objects database on the server

Forces in Context

1) Security

2) Living objects can be very different from each other

3) There is much that all living objects share—they are all controlled by many living object updates, but only one at a time

Trigger

Actor pushes a button which takes him to the ‘add living object’ wizard

### SUMMARY

This use case captures the scenario where the actor tells the system that it must recognize a new living object

1) User fills in the minimum details needed to define a new living object

2) Server creates a new object modeling the living object

Pre-conditions

That the big corporation server software is installed

Post-conditions

The server is now aware of the new living object

Related use cases

1) Add new living object updates is the next logical step

Name

Add new living object updates

Actors

Big corporation and their advertisers

goal

That the actor be able to add new living objects updates to the server

Forces in Context

1) Security

2) There can be many types of updates: text, scripts, multimedia, executables, etc.

3) This is one the most common processes, so it should be as streamlined as possible

4) This is the simplest place to interface between Creator written software which produces behavior packs

5) This may be done at different places in the Internet

Trigger

Actor pushes a button which takes him to the ‘add living object update’ wizard

### SUMMARY

This use case captures the scenario where the actor tells the system that to add a new living object update to a specific living object

1) User chooses a living object

2) User uploads the update package

3) Server should notify all relevant observing objects of this new update

Pre-conditions

1) That the living object has been defined in the central server

2) That the actor has specific files from which to create the living object update. The creation of these updates is beyond the scope of this document

Post-conditions

The server is now aware of the new living object update, and it will be available in the web store, rules manager, and analysis subsystems

Related use cases

1) Add new living object to the database is a requirement

1.2.3.4.

Name

Manage living object updates

Actors

Big corporation

goal

That the actor be able to manage living object updates

Forces in Context

1) Security

2) There can be many types of updates: text, scripts, multimedia, executables, etc.

3) This is one the most common processes, so it should be as streamlined as possible

4) There could be hundreds of living object updates, so users must be able to quickly find the update they need to manage

5) We have no capability to manage the internals of an update pack, but it is important to provide a basis for interfacing with Creator software in this use case

Trigger

Actor pushes a button which takes him to the ‘manage living object update’ wizard

### SUMMARY

This use case captures the scenario where the actor tells the system that to remove a living object update, change its properties, or replace it by another update

1) User chooses a living object

2) User chooses a living object update

3) User removes the living object update or edits its properties or replaces it by another she has previously prepared

Pre-conditions

That the living object update has been defined in the central server

Post-conditions

The living object is now different in one update from what it was Related use cases

1) Add new living object updates is a requirement

1.2.3.5. Control over the Web Behaviors Store

Corporations want to make money selling behaviors on the web. This means they need a tool to create and manage a store of behaviors.

Name

Layout and style the web behaviors store

Actors

Big corporation

goal

That the actor be able to determine what the store where living object updates are sold in will look like

Forces in Context

1) Security

2) Big corporations want their stores to look unique

3) There is much in common among all stores: they are basically a searchable, easy to navigate catalog

4) Thus we can provide default templates

5) The templates must be simple to work with, with only HTML knowledge as a requirement

6) Users will want to integrate the store with the rest of their WWW infosystem

7) Users might already (and probably will already) have some kind of store, billing system, etc. of their own, as part of their web site

Trigger

Actor pushes a button which takes him to the ‘style the web behaviors store’ wizard

### SUMMARY

This use case captures the scenario where the actor manages all aspects of the web store

1) User chooses a page in the store, i.e. search results page, product page, etc.

2) User chooses a template

3) User reviews the effect of the template on the system by previewing

4) User replaces the current template with the new one and submits the change

Pre-conditions

1) That living object updates are configured

2) That users have HTML files to use as templates for the store.

Note that these could have originated from our default templates, or they could have been written according to our documentation

Post-conditions

The store is now styled according to the users preferences

Related use cases

1) Manage living object updates is where big corporations determine prices, subscription information, etc. for living object updates

2) Handle the server side of a purchase is where the server interpolates the store templates into complete HTML pages sent to the users web browser

1.2.3.6.

Name

Handle the server side of a purchase

Actors

Big corporation server

goal

That the actor be able to respond correctly to web orders of living object updates, and to page requests for the catalog

Forces in Context

1) Security

2) Many users could purchase at once, probably loOs

3) Billing, taxes

Trigger

Web browser client enters the store and starts interacting with it

### SUMMARY

This is just a normal web store process, like many others

Pre-conditions

1) That templates for the web store are configured

2) That living object updates exist

3) That registered users exist

Post-conditions

The purchase is logged, billing details updated, living object update

Related use cases

1) Layout and style the web behaviors store is where big corporations determine what the HTML pages will look like

2) Manage living object updates is where big corporations determine prices, subscription information, etc. for living object updates

1.2.3.7. Control Over Users

Corporations require a group of services that allow them to manage the user database and related information: billing and profiling data.

Name

Manage users

Actors

Big corporation

goal

That the actor be able to manually control the user database

Forces in Context

1) Security

2) 100,000 users

3) Big corporations have people who can work with RDBMSs through Access

4) Our users are objects which need to encapsulate many different types of information, which we cannot know in advance. This includes all profiling data

Trigger

Actor presses button which takes him to the user management application

### SUMMARY

This is just a normal add/delete/modify type of use case

Pre-conditions

That users were registered

Post-conditions

User objects have been modified

Related use cases

1) Configuring the registration process determines a lot of the properties of the corporations user object

2) Almost every other use case dumps logs into the user object

1.2.3.8. Analysis Services

To help them in decision such as: ‘what type of behaviors should we create today?’ and in other decisions, big corporations require analysis of usage patterns and profiles. These services allow them to generate and view reports.

Name

Analyzing usage

Actors

Big corporation

goal

That the actor be able to generate and view sophisticated reports about system usage

Forces in Context

1) Big data

2) Corporations have standard report formats and tools

3) We cannot know in advance ALL the report types needed, but we can assume that several will definitely be needed

Trigger

Ad management exec from Disney starts the reporting tool

### SUMMARY

This depends on the tool used. Generally it should be:

1) Define a time period

2) Define a segment of users

3) Run a query on them, refine

4) Put query results in template and send to manager

Pre-conditions

1) That there is usage data in the database

Post-conditions

A report has been generated

Related use cases

1) Server side of update process is where the data we post-process here gets created

2) Gathering user profiling data also determines what gets logged

A preferred LOIS Advertising system is now described.

1) Segmentation

Through television advertisers can reach segments of the population defined by constraints like:

5-9 year old females that watch TV on weekday afternoons

The content provider at the TV station airs a show that is known to attract that kind of viewing audience, and sells it to an interested advertiser. There are several unsolvable problems in this system: The segmentation is never accurate, the advertiser is limited to very simple constraints, effective market feedback is not immediate, and the advertiser cannot choose the time at which the ad will air. In LOIS there are constraints like:

8 year old males that like sci-fi stuff

8 year old males that like fantasy stuff

8 year old males that like military stuff

That allow for very accurate targeting. Since children are quite different from each other, advertisers can now construct accurate campaigns. The LOIS Behavior Space management system allows advertisers to:

Create campaigns with arbitrarily complex segmentation

Control campaigns in real-time in very high resolution

Collect accurate reports automatically

Choose any time of the day for their advertisement

LOIS supports of course the classical matching of advertisement to content type. The toy maker may sell slots inside subscription/free content to advertisers, as in TV/radio/web.

2) Content vs. Advertisements

Behaviors decompose into Content and Advertisements. Parents and Children will not be aware of this decomposition. The behaviors they receive contain no information about it. This is just like TV. Broadcast technology is transparent to the insides of what is being aired. Video editing software is aware of the distinction. It might provide special tools for composing video from ads and content. The LOIS design is similar. At the Toy Maker and Advertiser sites content is distinct from advertisements: different logs are kept for each, content is usually purchased as a Behavior Subscription while advertisements are not, and other differences. But this information never enters the Toy Maker<=>Client Installations extranet. This does not mean that children and parents will never know what is an ad and what is content. Television stations choose (mostly) to tell viewers when switching between the two. It is considered appropriate, and is also considered the Right Thing(r) in the LOIS context. Toy Makers and Advertisers may agree to more subtle forms of advertisement, but these cannot be too subtle, or they will annoy parents and children.

One embodiment of a LOIS system is now described: Living Objects(tm) Internet Services (LOIS) is the general name for a group of software products that are a part of the broad family of Creator's Living Objects(tm) technology. Like the entire family, LOIS is an enabling technology. LOIS enables Creator's customers to establish Sophisticated Internet services. LOIS is offered by Creator to its customers for two obvious reasons:

To help the customers develop effective services easily and reliably.

To help Creator establish its leadership and competitive advantage in the market.

There are two types of LOIS products designed to serve two types of applications (and markets):

INTERNET services for vendors selling consumer products such as toys and smart home appliances.

INTRANET services for operators of entertainment and shopping sites.

Both products are made of two parts: a server product and a client product.

There is plenty of products to enable companies to develop and provide various types of Internet services. Creator do not intend to compete with these products and LOIS is designed to complement the available product with features that are not available elsewhere.

2.1. The Internet Advantage

In Intranet applications of Living Objects the client side, namely the PC, runs several programs concurrently. Each of these programs control one or more devices such as toys or smart home appliances. These devices and their control programs may be from different vendors. Therefore this situation is named “Multi Vendor Environment”. To enable all these programs to share the required peripherals such as the radio base station, the computer screen and the Internet Creator provides the Executive. The Executive program is responsible to run the control program and provide them with all the necessary peripheral services including Internet access.

2.2. The Intranet Advantage

Living Objects Intranet Services are implemented in large sites with several radio base stations in radio communication with many Living Objects. Each radio base station covers a part of the site and the living Objects are mobile throughout the site. Therefore the Living Objects may roam between the radio base stations conserving continuous communication with the central computer. This situation is unique for Intranet application and is not supported by available Intranet software packages.

2.3. The LOIS Advantage

An advantage of LOIS that is common to all applications is the LOIS SDK. This part of the SDK product enables Creator's customers to develop, quickly, inexpensively and reliably, sophisticated applications for the Living Objects technology. The LOIS SDK integrates between available development tools for Internet applications and the special features and requirements of the other Living Objects products.

3. The Invention Definition

The Living Objects(tm) Internet Services (LOIS) is a software product, a member of the Living Objects(tm) family of products from Creator. Living Objects is a group of enabling technologies that enable easy development of “robots” with the capability of natural interaction with humans. The Living Objects is a family of products, including hardware, control software, application software development kit and the Internet server software. Living Objects is oriented for diverse markets. The primary markets are:

Toys

Smart home

Amusement parks

Retail outlets—Point of Sale

Living Objects technology is marketed by Creator to vendors of finished products to these markets. The vendors use the Living Objects technology to develop sophisticated products for their markets.

The Living Objects Internet Server is used in two circumstances:

By vendors of finished products to provide services over the Internet to their customers.

By operators (of amusement parks, retail outlets, etc.) to communicate between their sites.

Typical Internet based services are:

Customer support / central sites administration.

Distribution of system software updates.

Marketing of new software products.

Central management and distribution of personal / site information.

Research and analysis of the usage of system features and preferences by end-users

Advertising

The Living Objects Internet Server enables the vendors and the operators to establish their Internet service easily, reliably and fast.

4. Creator's Goals LOIS is developed in anticipation of the future competition to Creator's Living Objects. Creator's plan is to secure its leading position as a supplier of “Living Objects” technology by providing the market with the best offering in three aspects:

Cost mainly the cost of the hardware

Sophistication mainly the sophistication of the applicat development tools

Breath of the family of the Living Objects products

The use of the Internet to provide some kind of service to products related to computers and software is very common today, if not essential. Therefore, Creator assumes that vendors and operators of products based on the Living Toys technology will seek ways to provide services over the Internet to their clients (vendors) or sites (operators). Offering an Internet solution as a part of the Living Objects family creates a definite marketing advantage.

The Living Objects Internet Server serves the following goals for Creator:

Competitive Advantage

Captive Customers

Market Information

Revenues and Profits Though LOIS is an accessory product in the Living Objects family, it is regarded as a profit center and it is expected to provide about 10% of the total revenues of the Living Objects family.

5. Perceived Customers' Objectives

5.1. Objectives of Toy Vendors

The Living Object technology is based on the concept of a toy (one or more) in radio communication with a near-by personal computer that controls the toy(s). The personal computer may be in continuous or dial-up communication with the Internet Server of the manufacturer of the toy(s). Toy vendors will purchase LOIS and use it for the following reasons:

Customer support

Increase sales through on-line sales

Split software sales (previews, complete product, updates & extensions)

Fan club subscriptions

On-line games

Electronic coupons

Advertising

Collecting and analyzing buying patterns and users' demographics

5.2. Objectives of Smart home Vendors

Customer support

Maintain brand name and customer loyalty

Electronic coupons

Advertising

Collecting and analyzing buying patterns and users' demographics

5.3. Objectives of Amusement parks Operators

Site support

Inter-site communication

Inter-site visitor identification

Fan club subscriptions

Home and on-line games

Electronic coupons

Advertising

Collecting and analyzing buying patterns and users' demographics

5.4. Objectives of Retail Operators

Site support

Inter-site communication

Inter-site client identification

Maintain client loyalty through buyers clubs

Increase sales through on-line sales

Electronic coupons

Advertising

Collecting and analyzing buying patterns and users' demographics

6. System Architecture

LOIS is made of two main parts: the server side and the client side, in two basic configurations:

Internet or Server/Client—

Typical of the toys and the smart home markets, the client software resides in a personal computer in occasional communication with the server. Intranet or Server/Node

Typical of the amusement parks and the retail outlets markets, the client software resides in the site's central computer, acting as an Intranet node in continuous communication with the server.

It is noted that vendors of products to the toys market and the smart home market may also use the Server-Node configuration to communicate with retail outlets and that operators of amusement parks and retail outlets may also use the Server-Client configuration to communicate with their customers at home.

The rest of this document is dedicated to Internet-Server/Client configuration and the toys and smart homes applications.

6.1. Client Architecture

6.1.1. operating System Support

LOIS client software should be able to run on all the following platforms.

Windows 95 (windows 98)

Windows NT Client

Windows CE

Macintosh

Java/NC

It is expected that a pure Java based software will be able to run on all these platforms.

6.1.2. Multi-Vendor Environment

Creator sells technology to its customers. The customers uses the technology to develop devices (toys, smart home appliances, etc.) and the PC software to run them. The most basic situation is where there is one device and one program to control it. A multi device environment is when there are several devices controlled by a single program. A multi-program environment is when there are several devices that are controlled by several different programs. On one hand all the programs run independently, on the other hand all the programs access the same Computer Radio Interface (CRI, also named Radio Hub or Radio Base Station). This creates a complicated situation that requires a sophisticated mechanism to support it. The most complicated situation is when there are several programs from several vendors running concurrently on the same PC controlling different devices. This may be common with toys and a must with smart home appliances.

Internet applications creates an even more complicated multi-vendor environment. LOIS must support the situation where there are several programs, some of them of different vendors, trying to access several different web-sites.

There are two basic possibilities to support multi-vendor environment:

Cooperation Tools

The control software packages are self-contained and independent of each other. Creator provides its customers with a piece of software that is incorporated into the vendor's software package. This piece of software enables cooperation between several programs to perform concurrent access to shared peripherals such as the CRI and the Internet. All access requests by control programs to shared peripherals are performed by a call to the Cooperation Tool. The tools linked to the various programs are able to cooperate between themselves and provide concurrent access to the required peripheral.

Common Executive

Creator provides an Executive program that launches an runs all the control programs. All access requests to shared peripherals are submitted by the control programs to the Executive and by the executive to the required peripheral.

A further requirement is that LOIS do not interfere with the operation of any common manual browser and other Internet software products such as “push technology”, Internet-Telephony, etc.

The Executive approach is the common solution (the operating system solution). It is simpler to support coordination between programs b means of an executive. It is also easier to support downgrade compatibility (where new program can enjoy new features while old programs can still run). The Executive approach has a significant marketing power for Creator. This advantage to Creator may intimidate large vendors.

6.1.3. Dialer Support

The client software is able of creating an Internet connection automatically. Therefore the client software is able of launching the Internet dialer and performing all the required actions (such as password entry) to establish the connection to the Internet Service Provider (ISP). Since there are many ISPs and many dialers the client software is able to adapt itself automatically to the Internet environment of the user.

A preferred Advertising Distribution And Management (ADAM) system for a Living Objects Internet Services (LOIS) system is now described:

The Invention

Providing means for the placement of advertising via computerized toys and dolls. These means enable: Advertising via a character that is friendly with the target audience

Sharply focused target audience

Customizing the advertising content to the user (sex, age, location, preferences)

Providing varying advertising content to the same user, thus avoiding boredom.

Sharing advertising space between advertisers

Customizing the advertising to the situation, such as time of day, day of the week

Providing advertising that changes and develops with time

Changing the advertising after the toy or the doll are sold to the user

Overview of the System

(From now on the term toy refers to toys and dolls in general)

Living Objects(tm) (LO) is a technology that enables the implementation of toys that are controlled by a computer, specifically a regular home computer. The toys are able to play sophisticated games with their users, effectively imitating human behavior. The user is able to interact with the toy on human terms and the toy is able to adopt the game content to the particular requirement of the user at that time.

The games are implemented as software programs that are executed by the computer. Game software can be distributed bundled with the toy or separately, as an after-market product. Games can be developed by the vendor of the toy or by an independent game developer, for toys available in the market. Games are typically distributed by means of computer diskettes and CD-ROMs.

The toys can provide advertising content to the user, mainly by verbal means. Advertising space can be used by the vendors of the toys and the game software to promote their own products and services or can be sold by the vendors to other parties.

The computer can connected to the Internet and via the Internet to various Internet sites (web sites). The primary reason to connect to the Internet is to download upgrades of system software from Creator's web site and updates of game software from the vendor's sites. This mechanism can serve also to distribute and download advertising content. The advertising Internet sites can be Creator's web site, sites of the toys and game vendors and sites (of advertising companies) that specialize in the distribution of advertising content to Living Object toys. Advertising content is primarily sound, namely verbal content with or without music and associated motion (e.g. song and dance). Advertising items can be placed before, after or within specific games or independently.

ADAM for LOIS Topology and Configuration ADAM for LOIS consists of four main subsystems:

Living Object User System

The Living Object User System is the infrastructure software (and hardware) that enables the computer to execute the game software and control the Living Object toys. The Living Object User System contains the LOIS Client software that enables the computer to connect to the Internet and to the sites of the various vendors and communicate with them as needed. ADAM User Client is a software module that enable the computer to exchange advertising data and content with the Internet sites.

Vendor's LOIS Server

Vendor's LOIS Server is a Creator's product, provided to Creator's customers (developers and distributors of Living Object toys and games) to enable them to maintain continuous connection with their clients. The Vendor LOIS Server is a software package for an Internet Server that communicates with the LOIS User Client software. The ADAM module for the Vendor LOIS Server supports all the communication needs and programming facilities required to distribute advertising through the Internet.

Advertiser's ADAM Client

The Advertiser ADAM Client is a software program that enables an advertiser to communicate with various LOIS servers and their ADAM modules and:

Research and select the appropriate advertising vehicles (namely toys and games in the market).

Prepare the advertising content in the appropriate format

Distribute the advertising content to the appropriate LOIS Servers

Further control the advertising process

The Advertiser ADAM Client can be used by the vendor to design and implement advertising of other products and by other advertisers (or advertising agencies) to distribute advertising content through Vendor LOIS Servers. Advertisers that are not vendors can have their own LOIS Servers to distribute advertising content but it is unlikely that the users' LOIS (ADAM) Client will initiate contact directly to advertisers' sites. Creator's LOIS Server

Creator's LOIS Server supports the entire LOIS network and particularly the ADAM application. Creator's web site provides software upgrades and support to at the other three entities: the users, the vendors and the advertisers. ADAM Properties

ADAM is a unique mechanism for advertising. ADAM collects detailed information about each and every user. This information is gathered by the user system and communicated to the vendor's server. The advertiser can therefore send the advertisement to an accurately focused audience. The advertiser can associate the advertisement with specific situations such as specific game situations (discussing cloths) or environmental situations (wake-up, dinner). An advertising can presented to different users at different situations. All this is provided and managed by means of a distributed database of the following data objects, communicated and processed by the four subsystems of the ADAM for LOIS system.

It is appreciated that the software components of the present invention may, if desired, be implemented in ROM (read-only memory) form. The software components may, generally, be implemented in hardware, if desired, using conventional techniques.

It is appreciated that the particular embodiment described in the Appendices is intended only to provide an extremely detailed disclosure of the present invention and is not intended to be limiting.

It is appreciated that various features of the invention which are, for clarity, described in the contexts of separate embodiments may also be provided in combination in a single embodiment. Conversely, various feature, of the invention which are, for brevity, described in the context of a single embodiment may also be provided separately or in any suitable subcombination.

It will be appreciated by persons skilled in the art that the present invention is not limited to what has been particularly shown and described hereinabove. Rather, the scope of the present invention is defined only by the claims which are:

1. A wireless computer controlled toy system comprising:
a computer system operative to transmit a first transmission via a first wireless transmitter; and
at least one toy comprising a first wireless receiver, said toy receiving said first transmission via said first wireless receiver and operative to carry out at least one action based on said first transmission.

2. A system according to claim 1 wherein the computer system comprises a computer game.

3. A system according to claim 2 wherein the first transmission comprises a control command chosen from a plurality of available control commands based, at least in part, on a result of operation of the computer game.

4. A system according to claim 1 wherein said at least one toy is operative to transmit a second transmission via a second wireless transmitter and wherein the computer system is operative to receive the, second transmission via a second wireless receiver.

5. A system according to claim 4 wherein operation of the computer system is controlled, at least in part, by the second transmission.

6. A system according to claim 1 wherein the at least one action comprises movement of the toy.

7. A system according to claim 1 wherein the at least one action comprises movement of a part of the toy.

8. A system according to claim 1 wherein the at least one action comprises output of a sound.

9. A system according to claim 8 wherein the sound comprises music.

10. A system according to claim 8 wherein the sound comprises a pre-recorded sound.

11. A system according to claim 8 wherein the sound comprises speech.

12. A system according to claim 11 wherein the speech comprises recorded speech.

13. A sy tem according to claim 11 wherein the speech comprises synth sized speech.

14. A system according to claim 1 wherein the at least one toy comprises a plurality of toys.

15. A system according to claim 1 wherein the at least one action comprises a plurality of actions.

16. A system according to claim 1 wherein the first transmission comprises a digital signal.

17. A system according to claim 1 wherein the first transmission comprises an analog signal.

18. A system according to claim 17 wherein the analog signal comprises sound.

19. A system according to claim 1 wherein the at least one toy has a plurality of states comprising at least a sleep state and an awake state, and
wherein the first transmission comprises a state transition command, and
wherein the at least one action comprises transitioning between the sleep state and the awake state.

20. A system according to claim 4 wherein the computer system has a plurality of states comprising at least a sleep state and an aw e state, and
wherein the second transmission comprises a state transition command, and
wherein the computer is operative, upon receiving the second transmission, to transition between the sleep state and the awake state.

21. A system according to claim 4 wherein the second transmission comprises toy identification data, and
wherein the computer system is operative to identify the at least one toy based, at least in part, on the toy identification data.

22. A system according to claim 21 wherein the computer system is operative to adapt a mode of operation thereof based, at least in part, on the toy identification data.

23. A system according to claim 4 wherein the at least one toy comprises sound input apparatus,
wherein the second transmission comprises a sound signal which represents a sound input via the sound input apparatus.

24. A system according to claim 23 wherein the sound comprises speech,
wherein the computer system is operative to perform a speech recognition operation on the speech.

25. A game system comprising:
a computer system operative to control a computer game and having a display operative to display at least one display object; and
at least one toy in wireless communication with said computer system,
wherein the computer game comprises a plurality of game objects, and
wherein the plurality of game objects comprises the at least one display object and the at least one toy.

26. A game system according to claim 25 wherein the at least one toy is operative to transmit toy identification data to the computer system, and
wherein the computer system is operative to adapt a mode of operation of the computer game based, at least in part, on the toy identification data.

27. A data transmitter comprising:
first wireless apparatus comprising musical instrument data interface (MIDI) apparatus operative to receive and transmit MIDI data between a first wireless and a first MIDI device; and
second wireless apparatus comprising MIDI apparatus operative to receive and transmit MIDI data between a second wireless and a second MIDI device,
wherein the first wireless apparatus is operative to transmit MIDI data comprising data received from the first MIDI device to the second wireless apparatus, and to transmit MIDI data comprising ata received from the second wireless apparatus to the first MIDI device, and
wherein the second wireless apparatus is operative to transmit MIDI data comprising data received from the second MIDI device to the first wireless apparatus, and to transmit MIDI data comprising data received from the first wireless apparatus to the second MIDI device.

28. A data transmitter according to claim 27 and also comprising a plurality of MIDI devices,
wherein the second wireless apparatus comprises a plurality of wirelesses each respectively associated with one of the plurality of MIDI devices, and
wherein each of the second plurality of wirelesses is operative to transmit MIDI data comprising data received from the associated MIDI device to the first wireless apparatus, and to transmit MIDI data comprising data received from the first wireless apparatus to the associated MIDI device.

29. Apparatus according to claim 27 wherein the first MIDI device comprises a computer.

30. Apparatus according to claim 27 wherein the second MIDI device comprises a toy.

31. Apparatus according to claim 27 wherein the first wireless apparstus also comprises analog interface apparatus operative to receive and transmit analog signals between the first wireless and a first analog device, and wherein
the second wireless apparatus also comprises analog interface apparatus operative to receive and transmit analog signals between the second wireless and a second analog device, and
wherein the first wireless apparatus is also operative to transmit analog signals comprising signals received from the first analog device to the second wireless apparatus, and to transmit analog signal comprising signals received from the second wireless apparatus to the first analog device, and
wherein the second wireless apparatus is also operative to transmit analog signals comprising signals received from the second analog device to the first wireless apparatus, and to transmit analog signals comprising data received from the first wireless apparatus to the second analog device.

32. A method for generating control instructions for a wireless computer controlled toy system, the method comprising:
selecting a toy;
selecting at least one command from among a plurality of commands associated with the toy; and
generating control instructions for the toy comprising said at least one command.

33. A method according to claim 32 wherein the step of selecting at least one command comprises:
choosing a command; and
specifying at least one control parameter associated with said chosen command.

34. A method according to claim 33 wherein said at least one control parameter comprises at least one condition depending on a result of a previous command.

35. A method according to claim 32 wherein at least one of the step of selecting a toy and the step of selecting at least one command comprises utilizing a graphical user interface.

36. A method according to claim 34 wherein said previous command comprises a previous command associated with a second toy.

37. A method according to claim 33 wherein said at least one control parameter comprises an execution condition controlling execution of said command.

38. A method according to claim 37 wherein said execution condition comprises a time at which to perform said command.

39. A method according to claim 33 wherein said execution condition comprises a time at which to cease performing said command.

40. A method according to claim 33 wherein said execution condition comprises a status of said toy.

41. A method according to claim 33 wherein said at least one control parameter comprises a command modifier modifying execution of the command.

42. A method according to claim 33 wherein said at least one control parameter comprises a condition dependent on a future event.

43. A method according to claim 32 wherein said at least one command comprises a command to cancel a previous command.

44. A system according to claim 1 wherein the computer system comprises a plurality of computers.

45. A system according to claim 25 wherein the computer system comprises a plurality of computers.

46. A signal transmitter for use in conjunction with a computer, the transmitter comprising:
a wireless transmitter; and
a signal processor comprising at least one of the following:
an analog/digital sound converter operative to convert analog sound signals to digital sound signals, to convert digital sound signals to analog sound signals, and to transmit said signals between the computer and a sound device using said wireless transmitter;
a peripheral control interface operative to transmit control signals between the computer and a peripheral device using said wireless transmitter, and
a MIDI interface operative to transmit MIDI signals between the computer and a MIDI device using said wireless transmitter.

47. A system according to claim 4 wherein the second transmission comprises a digital signal.

48. A system according to claim 4 wherein the second transmission comprises an analog signal.

49. A computer system comprising:
a computer;
a sound card operatively attached to the computer and having a MIDI connector and at least one analog connecter; and
a wireless transceiver operatively connected to the sound card,
wherein the computer is operative to transmit digital signals by means of the MIDI connector and to transmit analog signals by means of the at least one analog connector.

50. A system according to claim 49 and wherein the computer is also operative to receive digital signals by means of the MIDI connector and to receive analog signals by means of the at least one analog connector.

51. A system according to claim 4 and also comprising at least one input device and wherein said second transmission includes a status of said at least one input device.

52. A system according to claim 21 wherein the first transmission comprises toy identification data.

53. A method according to claim 44 wherein the first transmission comprises computer identification data.

54. A method according to claim 45 wherein the first transmission comprises computer identification data.

55. A method according to claim 44 wherein the second transmission comprises computer identification data.

56. A method according to claim 45 wherein the second transmission comprises computer identification data.

57. A system according to claim 16 wherein the computer system comprises a computer having a MIDI port and wherein the computer is operative to transmit the digital signal by way of the MIDI port.

58. A ysem according to claim 8 wherein the sound is transmitted using a MIDI protocol.

59. A system according to claim 23 wherein the computer system is operative to record the sound signal.

60. A system according to claim 59 wherein the computer system is also operative to perform at least one of the following actions: manipulate the sound signal; and play the sound signal.

61. A system according to claim 5 wherein the computer system comprises a computer game, and
wherein operation of the computer game is controlled, at least in part, by the second transmission.

62. A system according to claim 4 wherein the at least one toy comprises at least a first toy and a second toy, and
wherein the first toy is operative to transmit a toy-to-toy transmission to the second toy via said second wireless transmitter, and
wherein the second toy is operative to carry out at least one action based on said toy-to-toy transmission.

63. A system according to any of claims 1-24 wherein said first wireless transmitter comprises at least one multi-channel wireless transmitters each operative to transmit over a different one of a plurality of channels.

64. A system according to claim 63 wherein said at least one toy comprises a plurality of toys and wherein said at least one multi-channel wireless transmitter comprises a plurality of multi-channel wireless transmitters, thereby to provide simultaneous communication with each of the plurality of toys.

65. A system according to any of claims 1-24 wherein said first wireless receiver comprises at least one multi-channel wireless receiver each operative to receive over a selected one of a plurality of channels.

66. A system according to claim 4 wherein the first and second transmitters transmit over first and second channels respectively and the first and second receivers receive over said first and second channels respectively, thereby to provide full duplex communication between the computer system and the toy.

67. A system according to claim 64 wherein said computer system is operative to carry out a plurality of programs simultaneously, wherein said plurality of programs comprises a plurality of computer games respectively manipulating said plurality of toys via said plurality of channels.

68. A system according to claim 63 wherein said computer system is operative to transmit over at least one individual channel from among the plurality of channels only after previously identifying that the individual channel is available, thereby to allow simultaneous operation of more than one computer system.

69. A system according to claim 64 wherein said plurality of channels comprises at least one control channel over which the computer system communicates with each of the plurality of toys in order to assign individual toys to individual channels from among said plurality of channels.

70. A system according to any of claims 1-24 wherein said computer system comprises a toy-computer proximity detector operative to detect proximity of the toy and the computer.

71. A system according to claim 4 wherein said proximity detector includes a radio energy level determining subsystem operative to determine the level of energy at which said second transmission arrives at the computer system.

72. A system according to claim 4 wherein said proximity detector includes an ultra-sonic receiver associated with one of the toy and the computer system and an ultra-sonic transmitter associated with the other one of the toy and the computer system.

73. A system according to any of claims 1-24 wherein the computer system is in communication with a remote game server operative to serve at least a portion of at least one toy-operating game which operates said at least one toy and wherein said computer system is operative to receive at least a portion of said at least one toy-operating game from said remote game server.

74. A system according to claim 73 wherein at least a portion of said game is received from said remote game server off-line, before the game is played.

75. A system according to claim 73 wherein said computer system is operative to receive at least a portion of said at least one toy-operating game from said remote game server on-line as the game is being played.

76. A system according to any of claims 73-75 wherein said portion of said game comprises at least one of the following game portions:
a toy action script; and
a sound file.

77. A system according to claim 1 wherein said first wireless transmitter resides in an additional toy controllable by the computer system via wire, said wireless transmitter being connected via wire to said computer system.

78. A wireless toy system comprising:
at least one toy comprising a first wireless receiver;
a network computer in communication with a remote game serving computer network;
wherein the game serving computer network is operative to serve onto the network computer at least a portion of at least one toy-operating game which operates said at least one toy and wherein said network computer comprises a first wireless transmitter operative to transmit a first transmission to said first wireless receiver, and wherein said toy is operative to carry out at least one action based on said first transmission.

79. A method according to claim 32 and also comprising transmitting said control instructions to said toy.

80. A MIDI (musical instrument digital interface) method for operating a radio controlled device, the method comprising:
providing a computer system and a radio interface interfacing between the computer system and the radio controlled device; and
transmitting MIDI control commands and sound between the computer system and the radio interface via a connector of the computer system which is governed by the MIDI protocol.

81. A method for operating a radio controlled device, the method comprising:
providing a computer system and a radio interface interfacing between the computer and the radio controlled device; and
transmitting control commands and sound between the computer system and the radio interface via a serial port of the computer system.

82. A method for operating a radio controlled device, the method comprising:
providing a computer system and a radio interface interfacing between the computer and the radio controlled device; and
transmitting control commands and sound between the computer system and the radio interface via a parallel port of the computer system.

83. A system according to any of claims 73-75 wherein said portion of said game comprises a text file and wherein said computer system comprises a text-to-speech converter operative to convert said text file to a speech file for transmission to the toy via said first wireless transmitter.

84. A system according to claim 73 wherein the computer system is in communication with the remote game server via the Internet.

85. An advertising system comprising:
a computer-controlled toy located at a user location and operative to present advertisement bulletins responsive to a control command;
a computer controlling the toy and associated with a network and operative to generate the control command; and
advertisement server apparatus associated with the network and downloading advertisement bulletins to the computer.

86. A system according to claim 85 and also comprising said network and wherein said network comprises Internet.

87. A system according to claim 85 wherein the toy comprises a physical toy.

88. A computerized toy updating subscription system operative in association with a network, the system comprising:
a multiplicity of computerized toys associated with a network; and
a toy updater associated with the network and operative to periodically send toy updates out to the multiplicity of computerized toys.

89. A system according to claim 88 wherein the toy updater is operative substantially without periodic intervention of the human users of the multiplicity of toys.
